(19) United States
(12) Patent Application Publication
(10) Pub. No.: US 2020/0325375 A1
(43) Pub. Date: Oct. 15, 2020

(54) REFRIGERATION CYCLE APPARATUS AND METHOD OF DETERMINING REFRIGERANT ENCLOSURE AMOUNT IN REFRIGERATION CYCLE APPARATUS

(71) Applicant: DAIKIN INDUSTRIES, LTD., Osaka (JP)

(72) Inventors: Eiji KUMAKURA, Osaka (JP); Takuro YAMADA, Osaka (JP); Atsushi YOSHIMI, Osaka (JP); Ikuhiro IWATA, Osaka (JP); Mitsushi ITANO, Osaka (JP); Daisuke KARUBE, Osaka (JP); Yuuki YOTSUMOTO, Osaka (JP); Kazuhiro TAKAHASHI, Osaka (JP); Yuzo KOMATSU, Osaka (JP); Shun OHKUBO, Osaka (JP); Tatsuya TAKAKUWA, Osaka (JP)

(73) Assignee: DAIKIN INDUSTRIES, LTD., Osaka (JP)

(21) Appl. No.: 16/912,130

(22) Filed: Jun. 25, 2020

Related U.S. Application Data
(63) Continuation-in-part of application No. 16/954,613, filed on Jun. 17, 2020.

(30) Foreign Application Priority Data
Dec. 18, 2017 (JP) 2017-242183
Dec. 18, 2017 (JP) 2017-242185
Dec. 18, 2017 (JP) 2017-242186
Dec. 18, 2017 (JP) 2017-242187
Oct. 5, 2018 (JP) PCT/JP2018/037483
Oct. 17, 2018 (JP) PCT/JP2018/038746
Oct. 17, 2018 (JP) PCT/JP2018/038747
Oct. 17, 2018 (JP) PCT/JP2018/038748
Oct. 17, 2018 (JP) PCT/JP2018/038749

(51) Int. Cl. C09K 5/04

(52) U.S. Cl. CPC C09K 5/045; C09K 2205/22; C09K 2205/126

(57) ABSTRACT

A refrigeration cycle apparatus capable of keeping a LCCP low when a heat cycle is performed using a sufficiently small-GWP refrigerant, and a method of determining a refrigerant enclosure amount in the refrigeration cycle apparatus are provided. An outdoor unit (20) including a compressor (21) and an outdoor heat exchanger (23), an indoor unit (30) including an indoor heat exchanger (31), and a refrigerant pipe (5, 6) that connects the outdoor unit (20) and the indoor unit (30) to each other are provided. A refrigerant containing at least 1,2-difluoroethylene is enclosed in a refrigerant circuit (10) that is constituted by connecting the compressor (21), the outdoor heat exchanger (23), and the indoor heat exchanger (31) to one another. An enclosure amount of the refrigerant in the refrigerant circuit (10) per 1 kW of refrigeration capacity satisfies a condition of 160 g or more and 560 g or less.

### TECHNICAL FIELD

The present disclosure relates to a refrigeration cycle apparatus and a method of determining a refrigerant enclosure amount in the refrigeration cycle apparatus.

### BACKGROUND ART

Conventionally, heat cycle systems such as air conditioning apparatuses frequently use R410A as a refrigerant. R410A is a two-component mixed refrigerant of difluoromethane (CH₂F₂; HFC-32 or R32) and pentafluoroethane (C₂HF₅; HFC-125 or R125), and is a pseudo-azeotropic composition.

However, R410A has a global warming potential (GWP) of 2088. In recent years, R32 which is a refrigerant having a lower GWP of 675 is being more used as a result of growing concern about global warming.

Due to this, for example, PTL 1 (International Publication No. 2015/141678) suggests various low-GWP mixed refrigerants alternative to R410A.

### SUMMARY OF THE INVENTION

### Technical Problem

An example of an index concerning prevention of global warming may be an index called life cycle climate performance (LCCP). The LCCP is an index concerning prevention of global warming, and is a numerical value obtained by adding an energy consumption when greenhouse effect gases to be used are manufactured (indirect impact) and a leakage to the outside air (direct impact) to a total equivalent warning impact (TEWI). The unit of the LCCP is kg-CO₂. That is, the TEWI is obtained by adding a direct impact and an indirect impact calculated using respective predetermined mathematical expressions. The LCCP is calculated using the following relational expression.

LCCP=GWPRM×W+GWP×W×(1−R)+N×Q×A

In the expression, GWPRM is a warming effect relating to manufacturing of a refrigerant, W is a refrigerant filling amount, R is a refrigerant recovery amount when an apparatus is scrapped, N is a duration of using the apparatus (year), Q is an emission intensity of CO₂, and A is an annual power consumption.

Regarding the LCCP of the refrigeration cycle apparatus, when the filling amount in the refrigerant circuit is too small, an insufficiency of the refrigerant decreases cycle efficiency, resulting in an increase in the LCCP; and when the filling amount in the refrigerant circuit is too large, the impact of the GWP increases, resulting in an increase in the LCCP. Moreover, a refrigerant having a lower GWP than R32 which has been frequently used tends to have a low heat-transfer capacity, and tends to have a large LCCP as the result of the decrease in cycle efficiency.

The content of the present disclosure aims at the above-described point and an object of the present disclosure is to provide a refrigeration cycle apparatus capable of keeping a LCCP low when a heat cycle is performed using a sufficiently small-GWP refrigerant, and a method of determining a refrigerant enclosure amount in the refrigeration cycle apparatus.

### Solution to Problem

A refrigeration cycle apparatus according to a first aspect includes a heat source unit, a service unit, and a refrigerant pipe. The heat source unit includes a compressor and a heat-source-side heat exchanger. The service unit includes a service-side heat exchanger. The refrigerant pipe connects the heat source unit and the service unit to each other. A refrigerant containing at least 1,2-difluoroethylene is enclosed in a refrigerant circuit that is constituted by connecting the compressor, the heat-source-side heat exchanger, and the service-side heat exchanger to one another. An enclosure amount of the refrigerant in the refrigerant circuit satisfies a condition of 160 g or more and 560 g or less per 1 kW of refrigeration capacity of the refrigeration cycle apparatus.

Note that the refrigeration capacity of the refrigeration cycle apparatus represents a rated refrigeration capacity.

Since the refrigerant containing at least 1,2-difluoroethylene is enclosed in the refrigerant circuit by an amount of 160 g or more and 560 g or less per 1 kW of refrigeration capacity, when the refrigeration cycle apparatus performs a heat cycle using a refrigerant with a sufficiently small GWP, the LCCP can be kept low.

Note that, for the inner capacity (the volume of a fluid with which the inside can be filled) of the heat-source-side heat exchanger, when the refrigerant circuit is not provided with a refrigerant container (for example, a low-pressure receiver or a high-pressure receiver, excluding an accumulator belonging to a compressor), the inner capacity is preferably 0.4 L or more and 2.5 L or less. When the refrigerant circuit is provided with a refrigerant container, the inner capacity is preferably 1.4 L or more and less than 5.0 L.

Moreover, for the inner capacity (the volume of a fluid with which the inside can be filled) of the heat-source-side heat exchanger included in the heat source unit provided with only one fan, when the heat source unit has a casing having a blow-out port for blowing out the air which has passed through the heat-source-side heat exchanger in a side surface in an installed state (when the heat source unit is trunk type or the like), the inner capacity is preferably 0.4 L or more and less than 3.5 L. For the inner capacity (the volume of a fluid with which the inside can be filled) of the heat-source-side heat exchanger included in the heat source unit provided with two fans, when the heat source unit has a casing having a blow-out port for blowing out the air which has passed through the heat-source-side heat exchanger in a side surface in an installed state (when the heat source unit is trunk type or the like), the inner capacity is preferably 3.5 L or more and less than 5.0 L.

A refrigeration cycle apparatus according to a second aspect includes a heat source unit, a first service unit, a second service unit, and a refrigerant pipe. The heat source unit includes a compressor and a heat-source-side heat exchanger. The first service unit includes a first service-side heat exchanger. The second service unit includes a second service-side heat exchanger. The refrigerant pipe connects the heat source unit, the first service unit, and the second service unit to one another. A refrigerant containing at least 1,2-difluoroethylene is enclosed in a refrigerant circuit that is constituted by connecting the first service-side heat exchanger and the second service-side heat exchanger in parallel to the compressor and the heat-source-side heat exchanger. An enclosure amount of the refrigerant in the refrigerant circuit per 1 kW of refrigeration capacity satisfies a condition of 190 g or more and 1660 g or less.

Since the refrigerant containing at least 1,2-difluoroethylene is enclosed in the refrigerant circuit including the plurality of service-side heat exchangers connected in parallel to each other, by an amount of 190 g or more and 1660 g or less per 1 kW of refrigeration capacity, when the refrigeration cycle apparatus performs a heat cycle using a refrigerant with a sufficiently small GWP, the LCCP can be kept low.

Note that, for the inner capacity (the volume of a fluid with which the inside can be filled) of the heat-source-side heat exchanger, when the first service unit does not have an expansion valve on the liquid side of the first service-side heat exchanger and the second service unit also does not have an expansion valve on the liquid side of the second service-side heat exchanger, the inner capacity is preferably 1.4 L or more and less than 5.0 L. When the first service unit has an expansion valve on the liquid side of the first service-side heat exchanger and the second service unit also has an expansion valve on the liquid side of the second service-side heat exchanger, the inner capacity is preferably 5.0 L or more and 38 L or less.

Moreover, for the inner capacity (the volume of a fluid with which the inside can be filled) of the heat-source-side heat exchanger included in the heat source unit provided with only one fan, when the heat source unit has a casing having a blow-out port for blowing out the air which has passed through the heat-source-side heat exchanger in a side surface in an installed state (when the heat source unit is trunk type or the like), the inner capacity is preferably 0.4 L or more and less than 3.5 L. For the inner capacity (the volume of a fluid with which the inside can be filled) of the heat-source-side heat exchanger included in the heat source unit provided with two fans, when the heat source unit has a casing having a blow-out port for blowing out the air which has passed through the heat-source-side heat exchanger in a side surface in an installed state (when the heat source unit is trunk type or the like), the inner capacity is preferably 3.5 L or more and 7.0 L or less. For the inner capacity (the volume of a fluid with which the inside can be filled) of the heat-source-side heat exchanger included in the heat source unit that blows out upward the air which has passed through the heat-source-side heat exchanger, the inner capacity is preferably 5.5 L or more and 38 L or less.

A refrigeration cycle apparatus according to a third aspect is the refrigeration cycle apparatus according to the first or second aspect, wherein the refrigerant comprises trans-1,2-difluoroethylene (HFO-1132(E)), trifluoroethylene (HFO-1123), and 2,3,3,3-tetrafluoro-1-propene (R1234yf).

The refrigeration cycle apparatus can perform a refrigeration cycle using a refrigerant having properties including a sufficiently small GWP, and a refrigeration capacity (possibly referred to as cooling capacity or capacity) and a coefficient of performance (COP) equivalent to those of R410A.

A refrigeration cycle apparatus according to a fourth aspect is the refrigeration cycle apparatus according to the third aspect, wherein when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments AA′, A′B, BD, DC′, C′C, CO, and OA that connect the following 7 points:

point A (68.6, 0.0, 31.4),
point A′ (30.6, 30.0, 39.4),
point B (0.0, 58.7, 41.3),
point D (0.0, 80.4, 19.6),
point C′ (19.5, 70.5, 10.0),
point C (32.9, 67.1, 0.0), and
point O (100.0, 0.0, 0.0),
or on the above line segments (excluding the points on the line segments BD, CO, and OA);
the line segment AA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment DC′ is represented by coordinates (x, 0.0082x²−0.6671x+80.4, −0.0082x²−0.3329x+19.6),
the line segment C′C is represented by coordinates (x, 0.0067x²−0.6034x+79.729, −0.0067x²−0.3966x+20.271), and
the line segments BD, CO, and OA are straight lines.
A refrigeration cycle apparatus according to a fifth aspect is the refrigeration cycle apparatus according to the third aspect, wherein
when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments GI, IA, AA′, A′B, BD, DC′, C′C, and CG that connect the following 8 points:
   point G (72.0, 28.0, 0.0),
   point I (72.0, 0.0, 28.0),
   point A (68.6, 0.0, 31.4),
   point A′ (30.6, 30.0, 39.4),
   point B (0.0, 58.7, 41.3),
   point D (0.0, 80.4, 19.6),
   point C′ (19.5, 70.5, 10.0), and
   point C (32.9, 67.1, 0.0),
   or on the above line segments (excluding the points on the line segments IA, BD, and CG);
the line segment AA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment DC′ is represented by coordinates (x, 0.0082x²−0.6671x+80.4, −0.0082x²−0.3329x+19.6),
the line segment C′C is represented by coordinates (x, 0.0067x²−0.6034x+79.729, −0.0067x²−0.3966x+20.271), and
the line segments GI, IA, BD, and CG are straight lines.
A refrigeration cycle apparatus according to a sixth aspect is the refrigeration cycle apparatus according to the third aspect, wherein
when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments JP, PN, NK, KA′, A′B, BD, DC′, C′C, and CJ that connect the following 9 points:
   point J (47.1, 52.9, 0.0),
   point P (55.8, 42.0, 2.2),
   point N (68.6, 16.3, 15.1),
   point K (61.3, 5.4, 33.3),
   point A′ (30.6, 30.0, 39.4),
   point B (0.0, 58.7, 41.3),
   point D (0.0, 80.4, 19.6),
   point C′ (19.5, 70.5, 10.0), and
   point C (32.9, 67.1, 0.0),
   or on the above line segments (excluding the points on the line segments BD and CJ);
the line segment PN is represented by coordinates (x, −0.1135x²+12.112x−280.43, 0.1135x²−13.112x+380.43),
the line segment NK is represented by coordinates (x, 0.2421x²−29.955x+931.91, −0.2421x²+28.955x−831.91),
the line segment KA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment DC′ is represented by coordinates (x, 0.0082x²−0.6671x+80.4, −0.0082x²−0.3329x+19.6),
the line segment C′C is represented by coordinates (x, 0.0067x²−0.6034x+79.729, −0.0067x²−0.3966x+20.271), and
the line segments JP, BD, and CG are straight lines.
A refrigeration cycle apparatus according to a seventh aspect is the refrigeration cycle apparatus according to the third aspect, wherein
when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments JP, PL, LM, MA′, A′B, BD, DC′, C′C, and CJ that connect the following 9 points:
   point J (47.1, 52.9, 0.0),
   point P (55.8, 42.0, 2.2),
   point L (63.1, 31.9, 5.0),
   point M (60.3, 6.2, 33.5),
   point A′ (30.6, 30.0, 39.4),
   point B (0.0, 58.7, 41.3),
   point D (0.0, 80.4, 19.6),
   point C′ (19.5, 70.5, 10.0), and
   point C (32.9, 67.1, 0.0),
   or on the above line segments (excluding the points on the line segments BD and CJ);
the line segment PL is represented by coordinates (x, −0.1135x²+12.112x−280.43, 0.1135x²−13.112x+380.43)
the line segment MA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment DC′ is represented by coordinates (x, 0.0082x²−0.6671x+80.4, −0.0082x²−0.3329x+19.6),
the line segment C′C is represented by coordinates (x, 0.0067x²−0.6034x+79.729, −0.0067x²−0.3966x+20.271), and
the line segments JP, LM, BD, and CG are straight lines.
A refrigeration cycle apparatus according to an eighth aspect is the refrigeration cycle apparatus according to the third aspect, wherein
when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments PL, LM, MA′, A′B, BF, FT, and TP that connect the following 7 points:
   point P (55.8, 42.0, 2.2),
   point L (63.1, 31.9, 5.0),
   point M (60.3, 6.2, 33.5),
   point A′ (30.6, 30.0, 39.4),
   point B (0.0, 58.7, 41.3),
   point F (0.0, 61.8, 38.2), and
   point T (35.8, 44.9, 19.3),
   or on the above line segments (excluding the points on the line segment BF);
the line segment PL is represented by coordinates (x, −0.1135x²+12.112x−280.43, 0.1135x²−13.112x+380.43),
the line segment MA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment FT is represented by coordinates (x, 0.0078x²−0.7501x+61.8, −0.0078x²−0.2499x+38.2),
the line segment TP is represented by coordinates (x, 0.00672x²−0.7607x+63.525, −0.00672x²−0.2393x+36.475), and
the line segments LM and BF are straight lines.
A refrigeration cycle apparatus according to a ninth aspect is the refrigeration cycle apparatus according to the third aspect, wherein
when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments PL, LQ, QR, and RP that connect the following 4 points:
   point P (55.8, 42.0, 2.2),
   point L (63.1, 31.9, 5.0),
   point Q (62.8, 29.6, 7.6), and
   point R (49.8, 42.3, 7.9),
   or on the above line segments;
the line segment PL is represented by coordinates (x, −0.1135x²+12.112x−280.43, 0.1135x²−13.112x+380.43),
the line segment RP is represented by coordinates (x, 0.00672x²−0.7607x+63.525, −0.00672x²−0.2393x+36.475), and
the line segments LQ and QR are straight lines.
A refrigeration cycle apparatus according to a tenth aspect is the refrigeration cycle apparatus according to the third aspect, wherein
when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments SM, MA′, A′B, BF, FT, and TS that connect the following 6 points:
   point S (62.6, 28.3, 9.1),
   point M (60.3, 6.2, 33.5),
   point A′ (30.6, 30.0, 39.4),
   point B (0.0, 58.7, 41.3),
   point F (0.0, 61.8, 38.2), and
   point T (35.8, 44.9, 19.3),
   or on the above line segments,
the line segment MA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment FT is represented by coordinates (x, 0.0078x²−0.7501x+61.8, −0.0078x²−0.2499x+38.2),
the line segment TS is represented by coordinates (x, −0.0017x²−0.7869x+70.888, −0.0017x²−0.2131x+29.112), and
the line segments SM and BF are straight lines.
A refrigeration cycle apparatus according to an eleventh aspect is the refrigeration cycle apparatus according to the first or second aspect, wherein
the refrigerant comprises trans-1,2-difluoroethylene (HFO-1132(E)) and trifluoroethylene (HFO-1123) in a total amount of 99.5 mass % or more based on the entire refrigerant, and
the refrigerant comprises 62.0 mass % to 72.0 mass % of HFO-1132(E) based on the entire refrigerant.

The refrigeration cycle apparatus can perform a refrigeration cycle using a refrigerant having properties including a sufficiently small GWP, a coefficient of performance (COP) and a refrigeration capacity (possibly referred to as cooling capacity or capacity) equivalent to those of R410A, and being classified with lower flammability (class 2L) according to the standard of the American Society of Heating, Refrigerating and Air-Conditioning Engineers (ASHRAE).
A refrigeration cycle apparatus according to a twelfth aspect is the refrigeration cycle apparatus according to the first or second aspect, wherein
the refrigerant comprises HFO-1132(E) and HFO-1123 in a total amount of 99.5 mass % or more based on the entire refrigerant, and
the refrigerant comprises 45.1 mass % to 47.1 mass % of HFO-1132(E) based on the entire refrigerant.

The refrigeration cycle apparatus can perform a refrigeration cycle using a refrigerant having properties including a sufficiently small GWP, a coefficient of performance (COP) and a refrigeration capacity (possibly referred to as cooling capacity or capacity) equivalent to those of R410A, and being classified with lower flammability (class 2L) according to the standard of the American Society of Heating, Refrigerating and Air-Conditioning Engineers (ASHRAE).
A refrigeration cycle apparatus according to a thirteenth aspect is the refrigeration cycle apparatus according to the first or second aspect, wherein
the refrigerant comprises trans-1,2-difluoroethylene (HFO-1132(E)), trifluoroethylene (HFO-1123), 2,3,3,3-tetrafluoro-1-propene (R1234yf), and difluoromethane (R32),
   wherein
when the mass % of HFO-1132(E), HFO-1123, R1234yf, and R32 based on their sum in the refrigerant is respectively represented by x, y, z, and a,
if 0<a≤11.1, coordinates (x,y,z) in a ternary composition diagram in which the sum of HFO-1132(E), HFO-1123, and R1234yf is (100−a) mass % are within the range of a figure surrounded by straight lines GI, IA, AB, BD′, D′C, and CG that connect the following 6 points:
   point G (0.026a²−1.7478a+72.0, −0.026a²+0.7478a+28.0, 0.0),
   point I (0.026a²−1.7478a+72.0, 0.0, −0.026a²+0.7478a+28.0),
   point A (0.0134a²−1.9681a+68.6, 0.0, −0.0134a²+0.9681a+31.4),
   point B (0.0, 0.0144a²−1.6377a+58.7, −0.0144a²+0.6377a+41.3),
   point D′ (0.0, 0.0224a²+0.968a+75.4, −0.0224a²−1.968a+24.6), and
   point C (−0.2304a²−0.4062a+32.9, 0.2304a²−0.5938a+67.1, 0.0),
   or on the straight lines GI, AB, and D′C (excluding point G, point I, point A, point B, point D′, and point C);
if 11.1<a≤18.2, coordinates (x,y,z) in the ternary composition diagram are within the range of a figure surrounded by straight lines GI, IA, AB, BW, and WG that connect the following 5 points:
   point G (0.02a²−1.6013a+71.105, −0.02a²+0.6013a+28.895, 0.0),
   point I (0.02a²−1.6013a+71.105, 0.0, −0.02a²+0.6013a+28.895),
   point A (0.0112a²−1.9337a+68.484, 0.0, −0.0112a²+0.9337a+31.516),
   point B (0.0, 0.0075a²−1.5156a+58.199, −0.0075a²+0.5156a+41.801), and
   point W (0.0, 100.0−a, 0.0),
   or on the straight lines GI and AB (excluding point G, point I, point A, point B, and point W);
if 18.2<a≤26.7, coordinates (x,y,z) in the ternary composition diagram are within the range of a figure surrounded by straight lines GI, IA, AB, BW, and WG that connect the following 5 points:
   point G (0.0135a²−1.4068a+69.727, −0.0135a²+0.4068a+30.273, 0.0),
   point I (0.0135a²−1.4068a+69.727, 0.0, −0.0135a²+0.4068a+30.273),
   point A (0.0107a²−1.9142a+68.305, 0.0, −0.0107a²+0.9142a+31.695),
   point B (0.0, 0.009a²−1.6045a+59.318, −0.009a²+0.6045a+40.682), and
   point W (0.0, 100.0−a, 0.0),
   or on the straight lines GI and AB (excluding point G, point I, point A, point B, and point W);
if 26.7<a≤36.7, coordinates (x,y,z) in the ternary composition diagram are within the range of a figure surrounded by straight lines GI, IA, AB, BW, and WG that connect the following 5 points:
   point G (0.0111a²−1.3152a+68.986, −0.0111a²+0.3152a+31.014, 0.0),
   point I (0.0111a²−1.3152a+68.986, 0.0, −0.0111a²+0.3152a+31.014),
   point A (0.0103a²−1.9225a+68.793, 0.0, −0.0103a²+0.9225a+31.207),
   point B (0.0, 0.0046a²−1.41a+57.286, −0.0046a²+0.41a+42.714), and
   point W (0.0, 100.0−a, 0.0),
   or on the straight lines GI and AB (excluding point G, point I, point A, point B, and point W);
   and
if 36.7<a≤46.7, coordinates (x,y,z) in the ternary composition diagram are within the range of a figure surrounded by straight lines GI, IA, AB, BW, and WG that connect the following 5 points:
   point G (0.0061a²−0.9918a+63.902, −0.0061a²−0.0082a+36.098, 0.0),
   point I (0.0061a²−0.9918a+63.902, 0.0, −0.0061a²−0.0082a+36.098),
   point A (0.0085a²−1.8102a+67.1, 0.0, −0.0085a²+0.8102a+32.9),
   point B (0.0, 0.0012a²−1.1659a+52.95, −0.0012a²+0.1659a+47.05), and
   point W (0.0, 100.0−a, 0.0),
   or on the straight lines GI and AB (excluding point G, point I, point A, point B, and point W).

The refrigeration cycle apparatus can perform a refrigeration cycle using a refrigerant having properties including a sufficiently small GWP, and a refrigeration capacity (possibly referred to as cooling capacity or capacity) and a coefficient of performance (COP) equivalent to those of R410A.
A refrigeration cycle apparatus according to a fourteenth aspect is the refrigeration cycle apparatus according to the first or second aspect, wherein
the refrigerant comprises trans-1,2-difluoroethylene (HFO-1132(E)), trifluoroethylene (HFO-1123), 2,3,3,3-tetrafluoro-1-propene (R1234yf), and difluoromethane (R32),
   wherein
when the mass % of HFO-1132(E), HFO-1123, R1234yf, and R32 based on their sum in the refrigerant is respectively represented by x, y, z, and a,
if 0<a≤11.1, coordinates (x,y,z) in a ternary composition diagram in which the sum of HFO-1132(E), HFO-1123, and R1234yf is (100−a) mass % are within the range of a figure surrounded by straight lines JK′, K′B, BD′, D′C, and CJ that connect the following 5 points:
   point J (0.0049a²−0.9645a+47.1, −0.0049a²−0.0355a+52.9, 0.0),
   point K′ (0.0514a²−2.4353a+61.7, −0.0323a²+0.4122a+5.9, −0.0191a²+1.0231a+32.4),
   point B (0.0, 0.0144a²−1.6377a+58.7, −0.0144a²+0.6377a+41.3),
   point D′ (0.0, 0.0224a²+0.968a+75.4, −0.0224a²−1.968a+24.6), and
   point C (−0.2304a²−0.4062a+32.9, 0.2304a²−0.5938a+67.1, 0.0),
   or on the straight lines JK′, K′B, and D′C (excluding point J, point B, point D′, and point C);
if 11.1<a≤18.2, coordinates (x,y,z) in the ternary composition diagram are within the range of a figure surrounded by straight lines JK′, K′B, BW, and WJ that connect the following 4 points:
   point J (0.0243a²−1.4161a+49.725, −0.0243a²+0.4161a+50.275, 0.0),
   point K′ (0.0341a²−2.1977a+61.187, −0.0236a²+0.34a+5.636,−0.0105a²+0.8577a+33.177),
   point B (0.0, 0.0075a²−1.5156a+58.199, −0.0075a²+0.5156a+41.801), and
   point W (0.0, 100.0−a, 0.0),
   or on the straight lines JK′ and K′B (excluding point J, point B, and point W);
if 18.2<a≤26.7, coordinates (x,y,z) in the ternary composition diagram are within the range of a figure surrounded by straight lines JK′, K′B, BW, and WJ that connect the following 4 points:
   point J (0.0246a²−1.4476a+50.184, −0.0246a²+0.4476a+49.816, 0.0),
   point K′ (0.0196a²−1.7863a+58.515, −0.0079a²−0.1136a+8.702, −0.0117a²+0.8999a+32.783),
   point B (0.0, 0.009a²−1.6045a+59.318, −0.009a²+0.6045a+40.682), and
   point W (0.0, 100.0−a, 0.0),
   or on the straight lines JK′ and K′B (excluding point J, point B, and point W);
if 26.7<a≤36.7, coordinates (x,y,z) in the ternary composition diagram are within the range of a figure surrounded by straight lines JK′, K′A, AB, BW, and WJ that connect the following 5 points:
   point J (0.0183a²−1.1399a+46.493, −0.0183a²+0.1399a+53.507, 0.0),
   point K′ (−0.0051a²+0.0929a+25.95, 0.0, 0.0051a²−1.0929a+74.05),
   point A (0.0103a²−1.9225a+68.793, 0.0, −0.0103a²+0.9225a+31.207),
   point B (0.0, 0.0046a²−1.41a+57.286, −0.0046a²+0.41a+42.714), and
   point W (0.0, 100.0−a, 0.0),
   or on the straight lines JK′, K′A, and AB (excluding point J, point B, and point W); and
if 36.7<a≤46.7, coordinates (x,y,z) in the ternary composition diagram are within the range of a figure surrounded by straight lines JK′, K′A, AB, BW, and WJ that connect the following 5 points:
   point J (−0.0134a²+1.0956a+7.13, 0.0134a²−2.0956a+92.87, 0.0),
   point K′ (−1.892a+29.443, 0.0, 0.892a+70.557),
   point A (0.0085a²−1.8102a+67.1, 0.0, −0.0085a²+0.8102a+32.9),
   point B (0.0, 0.0012a²−1.1659a+52.95, −0.0012a²+0.1659a+47.05), and
   point W (0.0, 100.0−a, 0.0),
   or on the straight lines JK′, K′A, and AB (excluding point J, point B, and point W).

The refrigeration cycle apparatus can perform a refrigeration cycle using a refrigerant having properties including a sufficiently small GWP, and a refrigeration capacity (possibly referred to as cooling capacity or capacity) and a coefficient of performance (COP) equivalent to those of R410A.
A refrigeration cycle apparatus according to a fifteenth aspect is the refrigeration cycle apparatus according to the first or second aspect, wherein
the refrigerant comprises trans-1,2-difluoroethylene (HFO-1132(E)), difluoromethane (R32), and 2,3,3,3-tetrafluoro-1-propene (R1234yf), wherein
when the mass % of HFO-1132(E), R32, and R1234yf based on their sum in the refrigerant is respectively represented by x, y, and z, coordinates (x,y,z) in a ternary composition diagram in which the sum of HFO-1132(E), R32, and R1234yf is 100 mass % are within the range of a figure surrounded by line segments IJ, JN, NE, and EI that connect the following 4 points:
   point I (72.0, 0.0, 28.0),
   point J (48.5, 18.3, 33.2),
   point N (27.7, 18.2, 54.1), and
   point E (58.3, 0.0, 41.7),
   or on these line segments (excluding the points on the line segment EI;
the line segment IJ is represented by coordinates (0.0236y²−1.7616y+72.0, y, −0.0236y²+0.7616y+28.0);
the line segment NE is represented by coordinates (0.012y²−1.9003y+58.3, y, −0.012y²+0.9003y+41.7); and
the line segments JN and EI are straight lines.

The refrigeration cycle apparatus can perform a refrigeration cycle using a refrigerant having properties including a sufficiently small GWP, a refrigeration capacity (possibly referred to as cooling capacity or capacity) equivalent to that of R410A, and being classified with lower flammability (class 2L) according to the standard of the American Society of Heating, Refrigerating and Air-Conditioning Engineers (ASHRAE).
A refrigeration cycle apparatus according to a sixteenth aspect is the refrigeration cycle apparatus according to the first or second aspect, wherein
the refrigerant comprises HFO-1132(E), R32, and R1234yf, wherein
when the mass % of HFO-1132(E), R32, and R1234yf based on their sum in the refrigerant is respectively represented by x, y, and z, coordinates (x,y,z) in a ternary composition diagram in which the sum of HFO-1132(E), R32, and R1234yf is 100 mass % are within the range of a figure surrounded by line segments MM′, MN, NV, VG, and GM that connect the following 5 points:
   point M (52.6, 0.0, 47.4),
   point M′(39.2, 5.0, 55.8),
   point N (27.7, 18.2, 54.1),
   point V (11.0, 18.1, 70.9), and
   point G (39.6, 0.0, 60.4),
   or on these line segments (excluding the points on the line segment GM);
the line segment MM′ is represented by coordinates (0.132y²−3.34y+52.6, y, −0.132y²+2.34y+47.4);
the line segment M′N is represented by coordinates (0.0596y²−2.2541y+48.98, y, −0.0596y²+1.2541y+51.02);
the line segment VG is represented by coordinates (0.0123y²−1.8033y+39.6, y, −0.0123y²+0.8033y+60.4); and
the line segments NV and GM are straight lines.

The refrigeration cycle apparatus can perform a refrigeration cycle using a refrigerant having properties including a sufficiently small GWP, a refrigeration capacity (possibly referred to as cooling capacity or capacity) equivalent to that of R410A, and being classified with lower flammability (class 2L) according to the standard of the American Society of Heating, Refrigerating and Air-Conditioning Engineers (ASHRAE).
A refrigeration cycle apparatus according to a seventeenth aspect is the refrigeration cycle apparatus according to the first or second aspect, wherein
the refrigerant comprises HFO-1132(E), R32, and R1234yf, wherein
when the mass % of HFO-1132(E), R32, and R1234yf based on their sum in the refrigerant is respectively represented by x, y and z, coordinates (x,y,z) in a ternary composition diagram in which the sum of HFO-1132(E), R32, and R1234yf is 100 mass % are within the range of a figure surrounded by line segments ON, NU, and UO that connect the following 3 points:
   point O (22.6, 36.8, 40.6),
   point N (27.7, 18.2, 54.1), and
   point U (3.9, 36.7, 59.4),
   or on these line segments;
the line segment ON is represented by coordinates (0.0072y²−0.6701y+37.512, y, −0.0072y²−0.3299y+62.488);
the line segment NU is represented by coordinates (0.0083y²−1.7403y+56.635, y, −0.0083y²+0.7403y+43.365); and
the line segment UO is a straight line.

The refrigeration cycle apparatus can perform a refrigeration cycle using a refrigerant having properties including a sufficiently small GWP, a refrigeration capacity (possibly referred to as cooling capacity or capacity) equivalent to that of R410A, and being classified with lower flammability (class 2L) according to the standard of the American Society of Heating, Refrigerating and Air-Conditioning Engineers (ASHRAE).
A refrigeration cycle apparatus according to an eighteenth aspect is the refrigeration cycle apparatus according to the first or second aspect, wherein
the refrigerant comprises HFO-1132(E), R32, and R1234yf, wherein
when the mass % of HFO-1132(E), R32, and R1234yf based on their sum in the refrigerant is respectively represented by x, y, and z, coordinates (x,y,z) in a ternary composition diagram in which the sum of HFO-1132(E), R32, and R1234yf is 100 mass % are within the range of a figure surrounded by line segments QR, RT, TL, LK, and KQ that connect the following 5 points:
   point Q (44.6, 23.0, 32.4),
   point R (25.5, 36.8, 37.7),
   point T (8.6, 51.6, 39.8),
   point L (28.9, 51.7, 19.4), and
   point K (35.6, 36.8, 27.6),
   or on these line segments;
the line segment QR is represented by coordinates (0.0099y²−1.975y+84.765, y, −0.0099y²+0.975y+15.235);
the line segment RT is represented by coordinates (0.0082y²−1.8683y+83.126, y, −0.0082y²+0.8683y+16.874);
the line segment LK is represented by coordinates (0.0049y²−0.8842y+61.488, y, −0.0049y²−0.1158y+38.512);
the line segment KQ is represented by coordinates (0.0095y²−1.2222y+67.676, y, −0.0095y²+0.2222y+32.324); and
the line segment TL is a straight line.

The refrigeration cycle apparatus can perform a refrigeration cycle using a refrigerant having properties including a sufficiently small GWP, a refrigeration capacity (possibly referred to as cooling capacity or capacity) equivalent to that of R410A, and being classified with lower flammability (class 2L) according to the standard of the American Society of Heating, Refrigerating and Air-Conditioning Engineers (ASHRAE).
A refrigeration cycle apparatus according to a nineteenth aspect is the refrigeration cycle apparatus according to the first or second aspect, wherein
the refrigerant comprises HFO-1132(E), R32, and R1234yf, wherein
when the mass % of HFO-1132(E), R32, and R1234yf based on their sum in the refrigerant is respectively represented by x, y, and z, coordinates (x,y,z) in a ternary composition diagram in which the sum of HFO-1132(E), R32, and R1234yf is 100 mass % are within the range of a figure surrounded by line segments PS, ST, and TP that connect the following 3 points:
   point P (20.5, 51.7, 27.8),
   point S (21.9, 39.7, 38.4), and
   point T (8.6, 51.6, 39.8),
   or on these line segments;
the line segment PS is represented by coordinates (0.0064y²−0.7103y+40.1, y, −0.0064y²−0.2897y+59.9);
the line segment ST is represented by coordinates (0.0082y²−1.8683y+83.126, y, −0.0082y²+0.8683y+16.874); and
the line segment TP is a straight line.

The refrigeration cycle apparatus can perform a refrigeration cycle using a refrigerant having properties including a sufficiently small GWP, a refrigeration capacity (possibly referred to as cooling capacity or capacity) equivalent to that of R410A, and being classified with lower flammability (class 2L) according to the standard of the American Society of Heating, Refrigerating and Air-Conditioning Engineers (ASHRAE).
A refrigeration cycle apparatus according to a twentieth aspect is the refrigeration cycle apparatus according to the first or second aspect, wherein
the refrigerant comprises trans-1,2-difluoroethylene (HFO-1132(E)), trifluoroethylene (HFO-1123), and difluoromethane (R32),
   wherein
when the mass % of HFO-1132(E), HFO-1123, and R32 based on their sum in the refrigerant is respectively represented by x, y, and z, coordinates (x,y,z) in a ternary composition diagram in which the sum of HFO-1132(E), HFO-1123, and R32 is 100 mass % are within the range of a figure surrounded by line segments IK, KB′, B′H, HR, RG, and GI that connect the following 6 points:
   point I (72.0, 28.0, 0.0),
   point K (48.4, 33.2, 18.4),
   point B′ (0.0, 81.6, 18.4),
   point H (0.0, 84.2, 15.8),
   point R (23.1, 67.4, 9.5), and
   point G (38.5, 61.5, 0.0),
   or on these line segments (excluding the points on the line segments B′H and GI);
the line segment IK is represented by coordinates (0.025z²−1.7429z+72.00, −0.025z²+0.7429z+28.0, z),
the line segment HR is represented by coordinates (−0.3123z²+4.234z+11.06, 0.3123z²−5.234z+88.94, z),
the line segment RG is represented by coordinates (−0.0491z²−1.1544z+38.5, 0.0491z²+0.1544z+61.5, z), and
the line segments KB′ and GI are straight lines.

The refrigeration cycle apparatus can perform a refrigeration cycle using a refrigerant having properties including a sufficiently small GWP, and a coefficient of performance (COP) equivalent to that of R410A.
A refrigeration cycle apparatus according to a twenty first aspect is the refrigeration cycle apparatus according to the first or second aspect, wherein
the refrigerant comprises HFO-1132(E), HFO-1123, and R32,
   wherein
when the mass % of HFO-1132(E), HFO-1123, and R32 based on their sum in the refrigerant is respectively represented by x, y, and z, coordinates (x,y,z) in a ternary composition diagram in which the sum of HFO-1132(E), HFO-1123, and R32 is 100 mass % are within the range of a figure surrounded by line segments IJ, JR, RG, and GI that connect the following 4 points:
   point I (72.0, 28.0, 0.0),
   point J (57.7, 32.8, 9.5),
   point R (23.1, 67.4, 9.5), and
   point G (38.5, 61.5, 0.0),
   or on these line segments (excluding the points on the line segment GI);
the line segment IJ is represented by coordinates (0.025z²−1.7429z+72.0, −0.025z²+0.7429z+28.0, z),
the line segment RG is represented by coordinates (−0.0491z²−1.1544z+38.5, 0.0491z²+0.1544z+61.5, z), and
the line segments JR and GI are straight lines.

The refrigeration cycle apparatus can perform a refrigeration cycle using a refrigerant having properties including a sufficiently small GWP, and a coefficient of performance (COP) equivalent to that of R410A.
A refrigeration cycle apparatus according to a twenty second aspect is the refrigeration cycle apparatus according to the first or second aspect, wherein
the refrigerant comprises HFO-1132(E), HFO-1123, and R32,
   wherein
when the mass % of HFO-1132(E), HFO-1123, and R32 based on their sum in the refrigerant is respectively represented by x, y, and z, coordinates (x,y,z) in a ternary composition diagram in which the sum of HFO-1132(E), HFO-1123, and R32 is 100 mass % are within the range of a figure surrounded by line segments MP, PB′, B′H, HR, RG, and GM that connect the following 6 points:
   point M (47.1, 52.9, 0.0),
   point P (31.8, 49.8, 18.4),
   point B′ (0.0, 81.6, 18.4),
   point H (0.0, 84.2, 15.8),
   point R (23.1, 67.4, 9.5), and
   point G (38.5, 61.5, 0.0),
   or on these line segments (excluding the points on the line segments B′H and GM);
the line segment MP is represented by coordinates (0.0083z²−0.984z+47.1, −0.0083z²−0.016z+52.9, z),
the line segment HR is represented by coordinates (−0.3123z²+4.234z+11.06, 0.3123z²−5.234z+88.94, z),
the line segment RG is represented by coordinates (−0.0491z²−1.1544z+38.5, 0.0491z²+0.1544z+61.5, z), and
the line segments PB′ and GM are straight lines.

The refrigeration cycle apparatus can perform a refrigeration cycle using a refrigerant having properties including a sufficiently small GWP, and a coefficient of performance (COP) equivalent to that of R410A.
A refrigeration cycle apparatus according to a twenty third aspect is the refrigeration cycle apparatus according to the first or second aspect, wherein
the refrigerant comprises HFO-1132(E), HFO-1123, and R32, wherein
when the mass % of HFO-1132(E), HFO-1123, and R32 based on their sum in the refrigerant is respectively represented by x, y, and z, coordinates (x,y,z) in a ternary composition diagram in which the sum of HFO-1132(E), HFO-1123, and R32 is 100 mass % are within the range of a figure surrounded by line segments MN, NR, RG, and GM that connect the following 4 points:
   point M (47.1, 52.9, 0.0),
   point N (38.5, 52.1, 9.5),
   point R (23.1, 67.4, 9.5), and
   point G (38.5, 61.5, 0.0),
   or on these line segments (excluding the points on the line segment GM);
the line segment MN is represented by coordinates (0.0083z²−0.984z+47.1, −0.0083z²−0.016z+52.9, z),
the line segment RG is represented by coordinates (−0.0491z²−1.1544z+38.5, 0.0491z²+0.1544z+61.5, z), and
the line segments JR and GI are straight lines.

The refrigeration cycle apparatus can perform a refrigeration cycle using a refrigerant having properties including a sufficiently small GWP, and a coefficient of performance (COP) equivalent to that of R410A.
A refrigeration cycle apparatus according to a twenty fourth aspect is the refrigeration cycle apparatus according to the first or second aspect, wherein
the refrigerant comprises HFO-1132(E), HFO-1123, and R32, wherein
when the mass % of HFO-1132(E), HFO-1123, and R32 based on their sum in the refrigerant is respectively represented by x, y, and z, coordinates (x,y,z) in a ternary composition diagram in which the sum of HFO-1132(E), HFO-1123, and R32 is 100 mass % are within the range of a figure surrounded by line segments PS, ST, and TP that connect the following 3 points:
   point P (31.8, 49.8, 18.4),
   point S (25.4, 56.2, 18.4), and
   point T (34.8, 51.0, 14.2),
   or on these line segments;
the line segment ST is represented by coordinates (−0.0982z²+0.9622z+40.931, 0.0982z²−1.9622z+59.069, z),
the line segment TP is represented by coordinates (0.0083z²−0.984z+47.1, −0.0083z²−0.016z+52.9, z), and
the line segment PS is a straight line.

The refrigeration cycle apparatus can perform a refrigeration cycle using a refrigerant having properties including a sufficiently small GWP, and a coefficient of performance (COP) equivalent to that of R410A.
A refrigeration cycle apparatus according to a twenty fifth aspect is the refrigeration cycle apparatus according to the first or second aspect, wherein
the refrigerant comprises HFO-1132(E), HFO-1123, and R32,
   wherein
when the mass % of HFO-1132(E), HFO-1123, and R32 based on their sum in the refrigerant is respectively represented by x, y, and z, coordinates (x,y,z) in a ternary composition diagram in which the sum of HFO-1132(E), HFO-1123, and R32 is 100 mass % are within the range of a figure surrounded by line segments QB″, B″D, DU, and UQ that connect the following 4 points:
   point Q (28.6, 34.4, 37.0),
   point B″ (0.0, 63.0, 37.0),
   point D (0.0, 67.0, 33.0), and
   point U (28.7, 41.2, 30.1),
   or on these line segments (excluding the points on the line segment B″D);
the line segment DU is represented by coordinates (−3.4962z²+210.71z−3146.1, 3.4962z²−211.71z+3246.1, z),
the line segment UQ is represented by coordinates (0.0135z²−0.9181z+44.133, −0.0135z²−0.0819z+55.867, z), and
the line segments QB″ and B″D are straight lines.

The refrigeration cycle apparatus can perform a refrigeration cycle using a refrigerant having properties including a sufficiently small GWP, and a coefficient of performance (COP) equivalent to that of R410A.

A method of determining a refrigerant enclosure amount in a refrigeration cycle apparatus according to a twenty-sixth aspect, for a refrigeration cycle apparatus including a heat source unit including a compressor and a heat-source-side heat exchanger, a service unit including a service-side heat exchanger, and a refrigerant pipe that connects the heat source unit and the service unit to each other, and for a refrigerant containing at least 1,2-difluoroethylene being enclosed in a refrigerant circuit that is constituted by connecting the compressor, the heat-source-side heat exchanger, and the service-side heat exchanger to one another, sets an enclosure amount of the refrigerant in the refrigerant circuit per 1 kW of refrigeration capacity to 160 g or more and 560 g or less. The method of determining the refrigerant enclosure amount, for a refrigeration cycle apparatus including a heat source unit including a compressor and a heat-source-side heat exchanger, a first service unit including a first service-side heat exchanger, a second service unit including a second service-side heat exchanger, and a refrigerant pipe that connects the heat source unit, the first service unit, and the second service unit to one another, and for a refrigerant containing at least 1,2-difluoroethylene being enclosed in a refrigerant circuit that is constituted by connecting the first service-side heat exchanger and the second service-side heat exchanger in parallel to the compressor and the heat-source-side heat exchanger, sets an enclosure amount of the refrigerant in the refrigerant circuit per 1 kW of refrigeration capacity to 190 g or more and 1660 g or less.

With the method of determining the refrigerant enclosure amount, when a heat cycle is performed using a sufficiently small GWP, a refrigeration cycle apparatus having a LCCP kept low can be provided.

Note that, for the inner capacity (the volume of a fluid with which the inside can be filled) of the heat-source-side heat exchanger of the refrigeration cycle apparatus provided with one service unit, when the refrigerant circuit is not provided with a refrigerant container (for example, a low-pressure receiver or a high-pressure receiver, excluding an accumulator belonging to a compressor), the inner capacity is preferably 0.4 L or more and 2.5 L or less. When the refrigerant circuit is provided with a refrigerant container, the inner capacity is preferably 1.4 L or more and less than 5.0 L.

Moreover, regarding the refrigeration cycle apparatus provided with one service unit, for the inner capacity (the volume of a fluid with which the inside can be filled) of the heat-source-side heat exchanger included in the heat source unit provided with only one fan, when the heat source unit has a casing having a blow-out port for blowing out the air which has passed through the heat-source-side heat exchanger in a side surface in an installed state (when the heat source unit is trunk type or the like), the inner capacity is preferably 0.4 L or more and less than 3.5 L. For the inner capacity (the volume of a fluid with which the inside can be filled) of the heat-source-side heat exchanger included in the heat source unit provided with two fans, when the heat source unit has a casing having a blow-out port for blowing out the air which has passed through the heat-source-side heat exchanger in a side surface in an installed state (when the heat source unit is trunk type or the like), the inner capacity is preferably 3.5 L or more and less than 5.0 L.

Note that, for the inner capacity (the volume of a fluid with which the inside can be filled) of the heat-source-side heat exchanger of the refrigeration cycle apparatus provided with the first service unit and the second service unit, when the first service unit does not have an expansion valve on the liquid side of the first service-side heat exchanger and the second service unit also does not have an expansion valve on the liquid side of the second service-side heat exchanger, the inner capacity is preferably 1.4 L or more and less than 5.0 L. When the first service unit has an expansion valve on the liquid side of the first service-side heat exchanger and the second service unit also has an expansion valve on the liquid side of the second service-side heat exchanger, the inner capacity is preferably 5.0 L or more and 38 L or less.

Moreover, regarding the refrigeration cycle apparatus provided with the first service unit and the second service unit, for the inner capacity (the volume of a fluid with which the inside can be filled) of the heat-source-side heat exchanger included in the heat source unit provided with only one fan, when the heat source unit has a casing having a blow-out port for blowing out the air which has passed through the heat-source-side heat exchanger in a side surface in an installed state (when the heat source unit is trunk type or the like), the inner capacity is preferably 0.4 L or more and less than 3.5 L. For the inner capacity (the volume of a fluid with which the inside can be filled) of the heat-source-side heat exchanger included in the heat source unit provided with two fans, when the heat source unit has a casing having a blow-out port for blowing out the air which has passed through the heat-source-side heat exchanger in a side surface in an installed state (when the heat source unit is trunk type or the like), the inner capacity is preferably 3.5 L or more and 7.0 L or less. For the inner capacity (the volume of a fluid with which the inside can be filled) of the heat-source-side heat exchanger included in the heat source unit that blows out upward the air which has passed through the heat-source-side heat exchanger, the inner capacity is preferably 5.5 L or more and 38 L or less.

Note that the refrigerant for the method of determining the refrigerant enclosure amount in the refrigeration cycle apparatus according to the twenty-sixth aspect may be the same refrigerant as the refrigerant used for the refrigeration cycle apparatus according to any one of the third aspect to the twenty-fifth aspect.

### BRIEF DESCRIPTION OF THE DRAWINGS

FIG. 1 is a schematic view of an instrument used for a flammability test.

FIG. 2 is a diagram showing points A to T and line segments that connect these points in a ternary composition diagram in which the sum of HFO-1132(E), HFO-1123, and R1234yf is 100 mass %.

FIG. 3 is a diagram showing points A to C, D′, G, I, J, and K′, and line segments that connect these points to each other in a ternary composition diagram in which the sum of HFO-1132(E), HFO-1123, and R1234yf is (100−a) mass %.

FIG. 4 is a diagram showing points A to C, D′, G, I, J, and K′, and line segments that connect these points to each other in a ternary composition diagram in which the sum of HFO-1132(E), HFO-1123, and R1234yf is 92.9 mass % (the content of R32 is 7.1 mass %).

FIG. 5 is a diagram showing points A to C, D′, G, I, J, K′, and W, and line segments that connect these points to each other in a ternary composition diagram in which the sum of HFO-1132(E), HFO-1123, and R1234yf is 88.9 mass % (the content of R32 is 11.1 mass %).

FIG. 6 is a diagram showing points A, B, G, I, J, K′, and W, and line segments that connect these points to each other in a ternary composition diagram in which the sum of HFO-1132(E), HFO-1123, and R1234yf is 85.5 mass % (the content of R32 is 14.5 mass %).

FIG. 7 is a diagram showing points A, B, G, I, J, K′, and W, and line segments that connect these points to each other in a ternary composition diagram in which the sum of HFO-1132(E), HFO-1123, and R1234yf is 81.8 mass % (the content of R32 is 18.2 mass %).

FIG. 8 is a diagram showing points A, B, G, I, J, K′, and W, and line segments that connect these points to each other in a ternary composition diagram in which the sum of HFO-1132(E), HFO-1123, and R1234yf is 78.1 mass % (the content of R32 is 21.9 mass %).

FIG. 9 is a diagram showing points A, B, G, I, J, K′, and W, and line segments that connect these points to each other in a ternary composition diagram in which the sum of HFO-1132(E), HFO-1123, and R1234yf is 73.3 mass % (the content of R32 is 26.7 mass %).

FIG. 10 is a diagram showing points A, B, G, I, J, K′, and W, and line segments that connect these points to each other in a ternary composition diagram in which the sum of HFO-1132(E), HFO-1123, and R1234yf is 70.7 mass % (the content of R32 is 29.3 mass %).

FIG. 11 is a diagram showing points A, B, G, I, J, K′, and W, and line segments that connect these points to each other in a ternary composition diagram in which the sum of HFO-1132(E), HFO-1123, and R1234yf is 63.3 mass % (the content of R32 is 36.7 mass %).

FIG. 12 is a diagram showing points A, B, G, I, J, K′, and W, and line segments that connect these points to each other in a ternary composition diagram in which the sum of HFO-1132(E), HFO-1123, and R1234yf is 55.9 mass % (the content of R32 is 44.1 mass %).

FIG. 13 is a diagram showing points A, B, G, I, J, K′, and W, and line segments that connect these points to each other in a ternary composition diagram in which the sum of HFO-1132(E), HFO-1123, and R1234yf is 52.2 mass % (the content of R32 is 47.8 mass %).

FIG. 14 is a view showing points A to C, E, G, and I to W; and line segments that connect points A to C, E, G, and I to W in a ternary composition diagram in which the sum of HFO-1132(E), R32, and R1234yf is 100 mass %.

FIG. 15 is a view showing points A to U; and line segments that connect the points in a ternary composition diagram in which the sum of HFO-1132(E), HFO-1123, and R32 is 100 mass %.

FIG. 16 is a schematic configuration diagram of a refrigerant circuit according to a first embodiment.

FIG. 17 is a schematic control block configuration diagram of a refrigeration cycle apparatus according to the first embodiment.

FIG. 18 is a schematic configuration diagram of a refrigerant circuit according to a second embodiment.

FIG. 19 is a schematic control block configuration diagram of a refrigeration cycle apparatus according to the second embodiment.

FIG. 20 is a schematic configuration diagram of a refrigerant circuit according to a third embodiment.

FIG. 21 is a schematic control block configuration diagram of a refrigeration cycle apparatus according to the third embodiment.

### DESCRIPTION OF EMBODIMENTS

### (1) Definition of Terms

In the present specification, the term “refrigerant” includes at least compounds that are specified in ISO 817 (International Organization for Standardization), and that are given a refrigerant number (ASHRAE number) representing the type of refrigerant with “R” at the beginning; and further includes refrigerants that have properties equivalent to those of such refrigerants, even though a refrigerant number is not yet given. Refrigerants are broadly divided into fluorocarbon compounds and non-fluorocarbon compounds in terms of the structure of the compounds. Fluorocarbon compounds include chlorofluorocarbons (CFC), hydrochlorofluorocarbons (HCFC), and hydrofluorocarbons (HFC). Non-fluorocarbon compounds include propane (R290), propylene (R1270), butane (R600), isobutane (R600a), carbon dioxide (R744), ammonia (R717), and the like.

In the present specification, the phrase “composition comprising a refrigerant” at least includes (1) a refrigerant itself (including a mixture of refrigerants), (2) a composition that further comprises other components and that can be mixed with at least a refrigeration oil to obtain a working fluid for a refrigerating machine, and (3) a working fluid for a refrigerating machine containing a refrigeration oil. In the present specification, of these three embodiments, the composition (2) is referred to as a “refrigerant composition” so as to distinguish it from a refrigerant itself (including a mixture of refrigerants). Further, the working fluid for a refrigerating machine (3) is referred to as a “refrigeration oil-containing working fluid” so as to distinguish it from the “refrigerant composition.”

In the present specification, when the term “alternative” is used in a context in which the first refrigerant is replaced with the second refrigerant, the first type of “alternative” means that equipment designed for operation using the first refrigerant can be operated using the second refrigerant under optimum conditions, optionally with changes of only a few parts (at least one of the following: refrigeration oil, gasket, packing, expansion valve, dryer, and other parts) and equipment adjustment. In other words, this type of alternative means that the same equipment is operated with an alternative refrigerant. Embodiments of this type of “alternative” include “drop-in alternative,” “nearly drop-in alternative,” and “retrofit,” in the order in which the extent of changes and adjustment necessary for replacing the first refrigerant with the second refrigerant is smaller. The term “alternative” also includes a second type of “alternative,” which means that equipment designed for operation using the second refrigerant is operated for the same use as the existing use with the first refrigerant by using the second refrigerant. This type of alternative means that the same use is achieved with an alternative refrigerant.

In the present specification, the term “refrigerating machine” refers to machines in general that draw heat from an object or space to make its temperature lower than the temperature of ambient air, and maintain a low temperature. In other words, refrigerating machines refer to conversion machines that gain energy from the outside to do work, and that perform energy conversion, in order to transfer heat from where the temperature is lower to where the temperature is higher.

In the present specification, a refrigerant having a “WCF lower flammability” means that the most flammable composition (worst case of formulation for flammability: WCF) has a burning velocity of 10 cm/s or less according to the US ANSI/ASHRAE Standard 34-2013. Further, in the present specification, a refrigerant having “ASHRAE lower flammability” means that the burning velocity of WCF is 10 cm/s or less, that the most flammable fraction composition (worst case of fractionation for flammability: WCFF), which is specified by performing a leakage test during storage, shipping, or use based on ANSI/ASHRAE 34-2013 using WCF, has a burning velocity of 10 cm/s or less, and that flammability classification according to the US ANSI/ASHRAE Standard 34-2013 is determined to classified as be “Class 2L.”

In the present specification, a refrigerant having an “RCL of x % or more” means that the refrigerant has a refrigerant concentration limit (RCL), calculated in accordance with the US ANSI/ASHRAE Standard 34-2013, of x % or more. RCL refers to a concentration limit in the air in consideration of safety factors. RCL is an index for reducing the risk of acute toxicity, suffocation, and flammability in a closed space where humans are present. RCL is determined in accordance with the ASHRAE Standard. More specifically, RCL is the lowest concentration among the acute toxicity exposure limit (ATEL), the oxygen deprivation limit (ODL), and the flammable concentration limit (FCL), which are respectively calculated in accordance with sections 7.1.1, 7.1.2, and 7.1.3 of the ASHRAE Standard.

In the present specification, temperature glide refers to an absolute value of the difference between the initial temperature and the end temperature in the phase change process of a composition containing the refrigerant of the present disclosure in the heat exchanger of a refrigerant system.

### (2) Refrigerant

### (2-1) Refrigerant Component

Any one of various refrigerants such as refrigerant A, refrigerant B, refrigerant C, refrigerant D, and refrigerant E, details of these refrigerant are to be mentioned later, can be used as the refrigerant.

### (2-2) Use of Refrigerant

The refrigerant according to the present disclosure can be preferably used as a working fluid in a refrigerating machine.

The composition according to the present disclosure is suitable for use as an alternative refrigerant for HFC refrigerant such as R410A, R407C and R404 etc, or HCFC refrigerant such as R22 etc.

### (3) Refrigerant Composition

The refrigerant composition according to the present disclosure comprises at least the refrigerant according to the present disclosure, and can be used for the same use as the refrigerant according to the present disclosure. Moreover, the refrigerant composition according to the present disclosure can be further mixed with at least a refrigeration oil to thereby obtain a working fluid for a refrigerating machine.

The refrigerant composition according to the present disclosure further comprises at least one other component in addition to the refrigerant according to the present disclosure. The refrigerant composition according to the present disclosure may comprise at least one of the following other components, if necessary. As described above, when the refrigerant composition according to the present disclosure is used as a working fluid in a refrigerating machine, it is generally used as a mixture with at least a refrigeration oil. Therefore, it is preferable that the refrigerant composition according to the present disclosure does not substantially comprise a refrigeration oil. Specifically, in the refrigerant composition according to the present disclosure, the content of the refrigeration oil based on the entire refrigerant composition is preferably 0 to 1 mass %, and more preferably 0 to 0.1 mass %.

### (3-1) Water

The refrigerant composition according to the present disclosure may contain a small amount of water. The water content of the refrigerant composition is preferably 0.1 mass % or less based on the entire refrigerant. A small amount of water contained in the refrigerant composition stabilizes double bonds in the molecules of unsaturated fluorocarbon compounds that can be present in the refrigerant, and makes it less likely that the unsaturated fluorocarbon compounds will be oxidized, thus increasing the stability of the refrigerant composition.

### (3-2) Tracer

A tracer is added to the refrigerant composition according to the present disclosure at a detectable concentration such that when the refrigerant composition has been diluted, contaminated, or undergone other changes, the tracer can trace the changes.

The refrigerant composition according to the present disclosure may comprise a single tracer, or two or more tracers.

The tracer is not limited, and can be suitably selected from commonly used tracers. Preferably, a compound that cannot be an impurity inevitably mixed in the refrigerant of the present disclosure is selected as the tracer.

Examples of tracers include hydrofluorocarbons, hydrochlorofluorocarbons, chlorofluorocarbons, hydrochlorocarbons, fluorocarbons, deuterated hydrocarbons, deuterated hydrofluorocarbons, perfluorocarbons, fluoroethers, brominated compounds, iodinated compounds, alcohols, aldehydes, ketones, and nitrous oxide (N₂O). The tracer is particularly preferably a hydrofluorocarbon, a hydrochlorofluorocarbon, a chlorofluorocarbon, a fluorocarbon, a hydrochlorocarbon, a fluorocarbon, or a fluoroether.

The following compounds are preferable as the tracer.

FC-14 (tetrafluoromethane, CF₄)
HCC-40 (chloromethane, CH₃Cl)
HFC-23 (trifluoromethane, CHF₃)
HFC-41 (fluoromethane, CH₃Cl)
HFC-125 (pentafluoroethane, CF₃CHF₂)
HFC-134a (1,1,1,2-tetrafluoroethane, CF₃CH₂F)
HFC-134 (1,1,2,2-tetrafluoroethane, CHF₂CHF₂)
HFC-143a (1,1,1-trifluoroethane, CF₃CH₃)
HFC-143 (1,1,2-trifluoroethane, CHF₂CH₂F)
HFC-152a (1,1-difluoroethane, CHF₂CH₃)
HFC-152 (1,2-difluoroethane, CH₂FCH₂F)
HFC-161 (fluoroethane, CH₃CH₂F)
HFC-245fa (1,1,1,3,3-pentafluoropropane, CF₃CH₂CHF₂)
HFC-236fa (1,1,1,3,3,3-hexafluoropropane, CF₃CH₂CF₃)
HFC-236ea (1,1,1,2,3,3-hexafluoropropane, CF₃CHFCHF₂)
HFC-227ea (1,1,1,2,3,3,3-heptafluoropropane, CF₃CHFCF₃)
HCFC-22 (chlorodifluoromethane, CHClF₂)
HCFC-31 (chlorofluoromethane, CH₂ClF)
CFC-1113 (chlorotrifluoroethylene, CF₂═CClF)
HFE-125 (trifluoromethyl-difluoromethyl ether, CF₃OCHF₂)
HFE-134a (trifluoromethyl-fluoromethyl ether, CF₃OCH₂F)
HFE-143a (trifluoromethyl-methyl ether, CF₃OCH₃)
HFE-227ea (trifluoromethyl-tetrafluoroethyl ether, CF₃OCHFCF₃)
HFE-236fa (trifluoromethyl-trifluoroethyl ether, CF₃OCH₂CF₃)

The tracer compound may be present in the refrigerant composition at a total concentration of about 10 parts per million (ppm) to about 1000 ppm. Preferably, the tracer compound is present in the refrigerant composition at a total concentration of about 30 ppm to about 500 ppm, and most preferably, the tracer compound is present at a total concentration of about 50 ppm to about 300 ppm.

### (3-3) Ultraviolet Fluorescent Dye

The refrigerant composition according to the present disclosure may comprise a single ultraviolet fluorescent dye, or two or more ultraviolet fluorescent dyes.
The ultraviolet fluorescent dye is not limited, and can be suitably selected from commonly used ultraviolet fluorescent dyes.
Examples of ultraviolet fluorescent dyes include naphthalimide, coumarin, anthracene, phenanthrene, xanthene, thioxanthene, naphthoxanthene, fluorescein, and derivatives thereof. The ultraviolet fluorescent dye is particularly preferably either naphthalimide or coumarin, or both.

### (3-4) Stabilizer

The refrigerant composition according to the present disclosure may comprise a single stabilizer, or two or more stabilizers.
The stabilizer is not limited, and can be suitably selected from commonly used stabilizers.
Examples of stabilizers include nitro compounds, ethers, and amines.
Examples of nitro compounds include aliphatic nitro compounds, such as nitromethane and nitroethane; and aromatic nitro compounds, such as nitro benzene and nitro styrene.
Examples of ethers include 1,4-dioxane.
Examples of amines include 2,2,3,3,3-pentafluoropropylamine and diphenylamine.
Examples of stabilizers also include butylhydroxyxylene and benzotriazole.
The content of the stabilizer is not limited. Generally, the content of the stabilizer is preferably 0.01 to 5 mass %, and more preferably 0.05 to 2 mass %, based on the entire refrigerant.

### (3-5) Polymerization Inhibitor

The refrigerant composition according to the present disclosure may comprise a single polymerization inhibitor, or two or more polymerization inhibitors.
The polymerization inhibitor is not limited, and can be suitably selected from commonly used polymerization inhibitors.
Examples of polymerization inhibitors include 4-methoxy-1-naphthol, hydroquinone, hydroquinone methyl ether, dimethyl-t-butylphenol, 2,6-di-tert-butyl-p-cresol, and benzotriazole.
The content of the polymerization inhibitor is not limited. Generally, the content of the polymerization inhibitor is preferably 0.01 to 5 mass %, and more preferably 0.05 to 2 mass %, based on the entire refrigerant.

### (4) Refrigeration Oil-Containing Working Fluid

The refrigeration oil-containing working fluid according to the present disclosure comprises at least the refrigerant or refrigerant composition according to the present disclosure and a refrigeration oil, for use as a working fluid in a refrigerating machine. Specifically, the refrigeration oil-containing working fluid according to the present disclosure is obtained by mixing a refrigeration oil used in a compressor of a refrigerating machine with the refrigerant or the refrigerant composition. The refrigeration oil-containing working fluid generally comprises 10 to 50 mass % of refrigeration oil.

### (4-1) Refrigeration Oil

The refrigeration oil is not limited, and can be suitably selected from commonly used refrigeration oils. In this case, refrigeration oils that are superior in the action of increasing the miscibility with the mixture and the stability of the mixture, for example, are suitably selected as necessary.
The base oil of the refrigeration oil is preferably, for example, at least one member selected from the group consisting of polyalkylene glycols (PAG), polyol esters (POE), and polyvinyl ethers (PVE).
The refrigeration oil may further contain additives in addition to the base oil. The additive may be at least one member selected from the group consisting of antioxidants, extreme-pressure agents, acid scavengers, oxygen scavengers, copper deactivators, rust inhibitors, oil agents, and antifoaming agents.
A refrigeration oil with a kinematic viscosity of 5 to 400 cSt at 40° C. is preferable from the standpoint of lubrication.
The refrigeration oil-containing working fluid according to the present disclosure may further optionally contain at least one additive. Examples of additives include compatibilizing agents described below.

### (4-2) Compatibilizing Agent

The refrigeration oil-containing working fluid according to the present disclosure may comprise a single compatibilizing agent, or two or more compatibilizing agents.
The compatibilizing agent is not limited, and can be suitably selected from commonly used compatibilizing agents.
Examples of compatibilizing agents include polyoxyalkylene glycol ethers, amides, nitriles, ketones, chlorocarbons, esters, lactones, aryl ethers, fluoroethers, and 1,1,1-trifluoroalkanes. The compatibilizing agent is particularly preferably a polyoxyalkylene glycol ether.

### (5) Various Refrigerants

Hereinafter, the refrigerants A to E, which are the refrigerants used in the present embodiment, will be described in detail.

In addition, each description of the following refrigerant A, refrigerant B, refrigerant C, refrigerant D, and refrigerant E is each independent. The alphabet which shows a point or a line segment, the number of an Examples, and the number of a comparative examples are all independent of each other among the refrigerant A, the refrigerant B, the refrigerant C, the refrigerant D, and the refrigerant E. For example, the first embodiment of the refrigerant A and the first embodiment of the refrigerant B are different embodiment from each other.

### (5-1) Refrigerant A

The refrigerant A according to the present disclosure is a mixed refrigerant comprising trans-1,2-difluoroethylene (HFO-1132(E)), trifluoroethylene (HFO-1123), and 2,3,3,3-tetrafluoro-1-propene (R1234yf).
The refrigerant A according to the present disclosure has various properties that are desirable as an R410A-alternative refrigerant, i.e., a refrigerating capacity and a coefficient of performance that are equivalent to those of R410A, and a sufficiently low GWP.
The refrigerant A according to the present disclosure is a composition comprising HFO-1132(E) and R1234yf, and optionally further comprising HFO-1123, and may further satisfy the following requirements. This refrigerant also has various properties desirable as an alternative refrigerant for R410A; i.e., it has a refrigerating capacity and a coefficient of performance that are equivalent to those of R410A, and a sufficiently low GWP.

### Requirements

Preferable refrigerant A is as follows:
When the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments AA′, A′B, BD, DC′, C′C, CO, and OA that connect the following 7 points:
   point A (68.6, 0.0, 31.4),
   point A′ (30.6, 30.0, 39.4),
   point B (0.0, 58.7, 41.3),
   point D (0.0, 80.4, 19.6),
   point C′ (19.5, 70.5, 10.0),
   point C (32.9, 67.1, 0.0), and
   point O (100.0, 0.0, 0.0),
   or on the above line segments (excluding the points on the line CO);
the line segment AA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3,
the line segment DC′ is represented by coordinates (x, 0.0082x²−0.6671x+80.4, −0.0082x²−0.3329x+19.6),
the line segment C′C is represented by coordinates (x, 0.0067x²−0.6034x+79.729, −0.0067x²−0.3966x+20.271), and
the line segments BD, CO, and OA are straight lines.
When the requirements above are satisfied, the refrigerant according to the present disclosure has a refrigerating capacity ratio of 85% or more relative to that of R410A, and a COP of 92.5% or more relative to that of R410A.
When the mass % of HFO-1132(E), HFO-1123, and R1234yf, based on their sum in the refrigerant A according to the present disclosure is respectively represented by x, y, and z, the refrigerant is preferably a refrigerant wherein coordinates (x,y,z) in a ternary composition diagram in which the sum of HFO-1132(E), HFO-1123, and R1234yf is 100 mass % are within a figure surrounded by line segments GI, IA, AA′, A′B, BD, DC′, C′C, and CG that connect the following 8 points:
   point G (72.0, 28.0, 0.0),
   point I (72.0, 0.0, 28.0),
   point A (68.6, 0.0, 31.4),
   point A′ (30.6, 30.0, 39.4),
   point B (0.0, 58.7, 41.3),
   point D (0.0, 80.4, 19.6),
   point C′ (19.5, 70.5, 10.0), and
   point C (32.9, 67.1, 0.0),
   or on the above line segments (excluding the points on the line segment CG);
the line segment AA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment DC′ is represented by coordinates (x, 0.0082x²−0.6671x+80.4, −0.0082x²−0.3329x+19.6),
the line segment C′C is represented by coordinates (x, 0.0067x²−0.6034x+79.729, −0.0067x²−0.3966x+20.271), and
the line segments GI, IA, BD, and CG are straight lines.
When the requirements above are satisfied, the refrigerant A according to the present disclosure has a refrigerating capacity ratio of 85% or more relative to that of R410A, and a COP of 92.5% or more relative to that of R410A; furthermore, the refrigerant A has a WCF lower flammability according to the ASHRAE Standard (the WCF composition has a burning velocity of 10 cm/s or less).
When the mass % of HFO-1132(E), HFO-1123, and R1234yf based on their sum in the refrigerant according to the present disclosure is respectively represented by x, y, and z, the refrigerant is preferably a refrigerant wherein coordinates (x,y,z) in a ternary composition diagram in which the sum of HFO-1132(E), HFO-1123, and R1234yf is 100 mass % are within the range of a figure surrounded by line segments JP, PN, NK, KA′, A′B, BD, DC′, C′C, and CJ that connect the following 9 points:
   point J (47.1, 52.9, 0.0),
   point P (55.8, 42.0, 2.2),
   point N (68.6, 16.3, 15.1),
   point K (61.3, 5.4, 33.3),
   point A′ (30.6, 30.0, 39.4),
   point B (0.0, 58.7, 41.3),
   point D (0.0, 80.4, 19.6),
   point C′ (19.5, 70.5, 10.0), and
   point C (32.9, 67.1, 0.0),
   or on the above line segments (excluding the points on the line segment CJ);
the line segment PN is represented by coordinates (x, −0.1135x²+12.112x−280.43, 0.1135x²−13.112x+380.43),
the line segment NK is represented by coordinates (x, 0.2421x²−29.955x+931.91, −0.2421x²+28.955x−831.91),
the line segment KA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment DC′ is represented by coordinates (x, 0.0082x²−0.6671x+80.4, −0.0082x²−0.3329x+19.6),
the line segment C′C is represented by coordinates (x, 0.0067x²−0.6034x+79.729, −0.0067x²−0.3966x+20.271), and
the line segments JP, BD, and CG are straight lines.
When the requirements above are satisfied, the refrigerant A according to the present disclosure has a refrigerating capacity ratio of 85% or more relative to that of R410A, and a COP of 92.5% or more relative to that of R410A; furthermore, the refrigerant exhibits a lower flammability (Class 2L) according to the ASHRAE Standard (the WCF composition and the WCFF composition have a burning velocity of 10 cm/s or less).
When the mass % of HFO-1132(E), HFO-1123, and R1234yf based on their sum in the refrigerant according to the present disclosure is respectively represented by x, y, and z, the refrigerant is preferably a refrigerant wherein coordinates (x,y,z) in a ternary composition diagram in which the sum of HFO-1132(E), HFO-1123, and R1234yf is 100 mass % are within the range of a figure surrounded by line segments JP, PL, LM, MA′, A′B, BD, DC′, C′ C, and CJ that connect the following 9 points:
   point J (47.1, 52.9, 0.0),
   point P (55.8, 42.0, 2.2),
   point L (63.1, 31.9, 5.0),
   point M (60.3, 6.2, 33.5),
   point A′ (30.6, 30.0, 39.4),
   point B (0.0, 58.7, 41.3),
   point D (0.0, 80.4, 19.6),
   point C′ (19.5, 70.5, 10.0), and
   point (32.9, 67.1, 0.0),
   or on the above line segments (excluding the points on the line segment CJ);
the line segment PL is represented by coordinates (x, −0.1135x²+12.112x−280.43, 0.1135x²−13.112x+380.43),
the line segment MA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment DC′ is represented by coordinates (x, 0.0082x²−0.6671x+80.4, −0.0082x²−0.3329x+19.6),
the line segment C′C is represented by coordinates (x, 0.0067x²−0.6034x+79.729, −0.0067x²−0.3966x+20.271), and
the line segments JP, LM, BD, and CG are straight lines.

When the requirements above are satisfied, the refrigerant according to the present disclosure has a refrigerating capacity ratio of 85% or more relative to that of R410A, and a COP of 92.5% or more relative to that of R410A; furthermore, the refrigerant has an RCL of 40 g/m³ or more.
When the mass % of HFO-1132(E), HFO-1123, and R1234yf based on their sum in the refrigerant A according to the present disclosure is respectively represented by x, y, and z, the refrigerant is preferably a refrigerant wherein coordinates (x,y,z) in a ternary composition diagram in which the sum of HFO-1132(E), HFO-1123, and R1234yf is 100 mass % are within the range of a figure surrounded by line segments PL, LM, MA′, A′B, BF, FT, and TP that connect the following 7 points:
   point P (55.8, 42.0, 2.2),
   point L (63.1, 31.9, 5.0),
   point M (60.3, 6.2, 33.5),
   point A′ (30.6, 30.0, 39.4),
   point B (0.0, 58.7, 41.3),
   point F (0.0, 61.8, 38.2), and
   point T (35.8, 44.9, 19.3),
   or on the above line segments (excluding the points on the line segment BF);
the line segment PL is represented by coordinates (x, −0.1135x²+12.112x−280.43, 0.1135x²−13.112x+380.43),
the line segment MA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment FT is represented by coordinates (x, 0.0078x²−0.7501x+61.8, −0.0078x²−0.2499x+38.2),
the line segment TP is represented by coordinates (x, 0.00672x²−0.7607x+63.525, −0.00672x²−0.2393x+36.475), and
the line segments LM and BF are straight lines.
When the requirements above are satisfied, the refrigerant according to the present disclosure has a refrigerating capacity ratio of 85% or more relative to that of R410A, and a COP of 95% or more relative to that of R410A; furthermore, the refrigerant has an RCL of 40 g/m³ or more.
The refrigerant A according to the present disclosure is preferably a refrigerant wherein when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments PL, LQ, QR, and RP that connect the following 4 points:
   point P (55.8, 42.0, 2.2),
   point L (63.1, 31.9, 5.0),
   point Q (62.8, 29.6, 7.6), and
   point R (49.8, 42.3, 7.9),
   or on the above line segments;
the line segment PL is represented by coordinates (x, −0.1135x²+12.112x−280.43, 0.1135x²−13.112x+380.43),
the line segment RP is represented by coordinates (x, 0.00672x²−0.7607x+63.525, −0.00672x²−0.2393x+36.475), and
the line segments LQ and QR are straight lines.
When the requirements above are satisfied, the refrigerant according to the present disclosure has a COP of 95% or more relative to that of R410A, and an RCL of 40 g/m³ or more, furthermore, the refrigerant has a condensation temperature glide of 1° C. or less.
The refrigerant A according to the present disclosure is preferably a refrigerant wherein when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments SM, MA′, A′B, BF, FT, and TS that connect the following 6 points:
   point S (62.6, 28.3, 9.1),
   point M (60.3, 6.2, 33.5),
   point A′(30.6, 30.0, 39.4),
   point B (0.0, 58.7, 41.3),
   point F (0.0, 61.8, 38.2), and
   point T (35.8, 44.9, 19.3),
   or on the above line segments,
the line segment MA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment FT is represented by coordinates (x, 0.0078x²−0.7501x+61.8, −0.0078x²−0.2499x+38.2),
the line segment TS is represented by coordinates (x, −0.0017x²−0.7869x+70.888, −0.0017x²−0.2131x+29.112), and
the line segments SM and BF are straight lines.
When the requirements above are satisfied, the refrigerant according to the present disclosure has a refrigerating capacity ratio of 85% or more relative to that of R410A, a COP of 95% or more relative to that of R410A, and an RCL of 40 g/m³ or more furthermore, the refrigerant has a discharge pressure of 105% or more relative to that of R410A.
The refrigerant A according to the present disclosure is preferably a refrigerant wherein when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments Od, dg, gh, and hO that connect the following 4 points:
   point d (87.6, 0.0, 12.4),
   point g (18.2, 55.1, 26.7),
   point h (56.7, 43.3, 0.0), and
   point o (100.0, 0.0, 0.0),
   or on the line segments Od, dg, gh, and hO (excluding the points O and h);
the line segment dg is represented by coordinates (0.0047y²−1.5177y+87.598, y, −0.0047y²+0.5177y+12.402),
the line segment gh is represented by coordinates (−0.0134z²−1.0825z+56.692, 0.0134z²+0.0825z+43.308, z), and
the line segments hO and Od are straight lines.
When the requirements above are satisfied, the refrigerant according to the present disclosure has a refrigerating capacity ratio of 92.5% or more relative to that of R410A, and a COP ratio of 92.5% or more relative to that of R410A.
The refrigerant A according to the present disclosure is preferably a refrigerant wherein
when the mass % of HFO-1132(E), HFO-1123, and R1234yf, based on their sum is respectively represented by x, y, and z, coordinates (x,y,z) in a ternary composition diagram in which the sum of HFO-1132(E), HFO-1123, and R1234yf is 100 mass % are within the range of a figure surrounded by line segments lg, gh, hi, and it that connect the following 4 points:
   point l (72.5, 10.2, 17.3),
   point g (18.2, 55.1, 26.7),
   point h (56.7, 43.3, 0.0), and
   point i (72.5, 27.5, 0.0) or
   on the line segments lg, gh, and il (excluding the points h and i);
the line segment lg is represented by coordinates (0.0047y²−1.5177y+87.598, y, −0.0047y²+0.5177y+12.402),
the line gh is represented by coordinates (−0.0134z²−1.0825z+56.692, 0.0134z²+0.0825z+43.308, z), and
the line segments hi and il are straight lines.
When the requirements above are satisfied, the refrigerant according to the present disclosure has a refrigerating capacity ratio of 92.5% or more relative to that of R410A, and a COP ratio of 92.5% or more relative to that of R410A; furthermore, the refrigerant has a lower flammability (Class 2L) according to the ASHRAE Standard.
The refrigerant A according to the present disclosure is preferably a refrigerant wherein
when the mass % of HFO-1132(E), HFO-1123, and R1234yf based on their sum is respectively represented by x, y, and z, coordinates (x,y,z) in a ternary composition diagram in which the sum of HFO-1132(E), HFO-1123, and R1234yf is 100 mass % are within the range of a figure surrounded by line segments Od, de, ef, and fO that connect the following 4 points:
   point d (87.6, 0.0, 12.4),
   point e (31.1, 42.9, 26.0),
   point f (65.5, 34.5, 0.0), and
   point O (100.0, 0.0, 0.0),
   or on the line segments Od, de, and ef (excluding the points O and f);
the line segment de is represented by coordinates (0.0047y²−1.5177y+87.598, y, −0.0047y²+0.5177y+12.402),
the line segment ef is represented by coordinates (−0.0064z²−1.1565z+65.501, 0.0064z²+0.1565z+34.499, z), and
the line segments fO and Od are straight lines.
When the requirements above are satisfied, the refrigerant according to the present disclosure has a refrigerating capacity ratio of 93.5% or more relative to that of R410A, and a COP ratio of 93.5% or more relative to that of R410A.
The refrigerant A according to the present disclosure is preferably a refrigerant wherein
when the mass % of HFO-1132(E), HFO-1123, and R1234yf based on their sum is respectively represented by x, y, and z,
coordinates (x,y,z) in a ternary composition diagram in which the sum of HFO-1132(E), HFO-1123, and R1234yf is 100 mass % are within the range of a figure surrounded by line segments le, ef, fi, and il that connect the following 4 points:
   point l (72.5, 10.2, 17.3),
   point e (31.1, 42.9, 26.0),
   point f (65.5, 34.5, 0.0), and
   point i (72.5, 27.5, 0.0),
   or on the line segments le, ef, and il (excluding the points f and i);
the line segment le is represented by coordinates (0.0047y²−1.5177y+87.598, y, −0.0047y²+0.5177y+12.402),
the line segment of is represented by coordinates (−0.0134z²−1.0825z+56.692, 0.0134z²+0.0825z+43.308, z), and
the line segments fi and it are straight lines.
When the requirements above are satisfied, the refrigerant according to the present disclosure has a refrigerating capacity ratio of 93.5% or more relative to that of R410A, and a COP ratio of 93.5% or more relative to that of R410A; furthermore, the refrigerant has a lower flammability (Class 2L) according to the ASHRAE Standard.
The refrigerant A according to the present disclosure is preferably a refrigerant wherein
when the mass % of HFO-1132(E), HFO-1123, and R1234yf based on their sum is respectively represented by x, y, and z,
coordinates (x,y,z) in a ternary composition diagram in which the sum of HFO-1132(E), HFO-1123, and R1234yf is 100 mass % are within the range of a figure surrounded by line segments Oa, ab, bc, and cO that connect the following 4 points:
   point a (93.4, 0.0, 6.6),
   point b (55.6, 26.6, 17.8),
   point c (77.6, 22.4, 0.0), and
   point O (100.0, 0.0, 0.0),
   or on the line segments Oa, ab, and bc (excluding the points O and c);
the line segment ab is represented by coordinates (0.0052y²−1.5588y+93.385, y, −0.0052y²+0.5588y+6.615),
the line segment be is represented by coordinates (−0.0032z²−1.1791z+77.593, 0.0032z²+0.1791z+22.407, z), and
the line segments cO and Oa are straight lines.
When the requirements above are satisfied, the refrigerant according to the present disclosure has a refrigerating capacity ratio of 95% or more relative to that of R410A, and a COP ratio of 95% or more relative to that of R410A.
The refrigerant A according to the present disclosure is preferably a refrigerant wherein
when the mass % of HFO-1132(E), HFO-1123, and R1234yf based on their sum is respectively represented by x, y, and z,
coordinates (x,y,z) in a ternary composition diagram in which the sum of HFO-1132(E), HFO-1123, and R1234yf is 100 mass % are within the range of a figure surrounded by line segments kb, bj, and jk that connect the following 3 points:
   point k (72.5, 14.1, 13.4),
   point b (55.6, 26.6, 17.8), and
   point j (72.5, 23.2, 4.3),
   or on the line segments kb, bj, and jk;
the line segment kb is represented by coordinates (0.0052y²−1.5588y+93.385, y, and −0.0052y²+0.5588y+6.615),
the line segment bj is represented by coordinates (−0.0032z²−1.1791z+77.593, 0.0032z²+0.1791z+22.407, z), and
the line segment jk is a straight line.
When the requirements above are satisfied, the refrigerant according to the present disclosure has a refrigerating capacity ratio of 95% or more relative to that of R410A, and a COP ratio of 95% or more relative to that of R410A; furthermore, the refrigerant has a lower flammability (Class 2L) according to the ASHRAE Standard.
The refrigerant according to the present disclosure may further comprise other additional refrigerants in addition to HFO-1132(E), HFO-1123, and R1234yf, as long as the above properties and effects are not impaired. In this respect, the refrigerant according to the present disclosure preferably comprises HFO-1132(E), HFO-1123, and R1234yf in a total amount of 99.5 mass % or more, more preferably 99.75 mass % or more, and still more preferably 99.9 mass % or more, based on the entire refrigerant.
The refrigerant according to the present disclosure may comprise HFO-1132(E), HFO-1123, and R1234yf in a total amount of 99.5 mass % or more, 99.75 mass % or more, or 99.9 mass % or more, based on the entire refrigerant.
Additional refrigerants are not particularly limited and can be widely selected. The mixed refrigerant may contain one additional refrigerant, or two or more additional refrigerants.

### Examples of Refrigerant A

The present disclosure is described in more detail below with reference to Examples of refrigerant A. However, refrigerant A is not limited to the Examples.
The GWP of R1234yf and a composition consisting of a mixed refrigerant R410A (R32=50%/R125=50%) was evaluated based on the values stated in the Intergovernmental Panel on Climate Change (IPCC), fourth report. The GWP of HFO-1132(E), which was not stated therein, was assumed to be 1 from HFO-1132a (GWP=1 or less) and HFO-1123 (GWP=0.3, described in Patent Literature 1). The refrigerating capacity of R410A and compositions each comprising a mixture of HFO-1132(E), HFO-1123, and R1234yf was determined by performing theoretical refrigeration cycle calculations for the mixed refrigerants using the National Institute of Science and Technology (NIST) and Reference Fluid Thermodynamic and Transport Properties Database (Refprop 9.0) under the following conditions.
Further, the RCL of the mixture was calculated with the LFL of HFO-1132(E) being 4.7 vol. %, the LFL of HFO-1123 being 10 vol. %, and the LFL of R1234yf being 6.2 vol. %, in accordance with the ASHRAE Standard 34-2013.
   Evaporating temperature: 5° C.
   Condensation temperature: 45° C.
   Degree of superheating: 5 K
   Degree of subcooling: 5 K
   Compressor efficiency: 70%
Tables 1 to 34 show these values together with the GWP of each mixed refrigerant.

TABLE 1

| | | | Comp. | Comp. | | Example | | Comp. |
|---|---|---|---|---|---|---|---|---|
| | | Comp. | Ex. 2 | Ex. 3 | Example | 2 | Example | Ex. 4 |
| Item | Unit | Ex. 1 | O | A | 1 | A′ | 3 | B |
| HFO-1132(E) | mass % | R410A | 100.0 | 68.6 | 49.0 | 30.6 | 14.1 | 0.0 |
| HFO-1123 | mass % | | 0.0 | 0.0 | 14.9 | 30.0 | 44.8 | 58.7 |
| R1234yf | mass % | | 0.0 | 31.4 | 36.1 | 39.4 | 41.1 | 41.3 |
| GWP | — | 2088 | 1 | 2 | 2 | 2 | 2 | 2 |
| COP ratio | % (relative to | 100 | 99.7 | 100.0 | 98.6 | 97.3 | 96.3 | 95.5 |
| | 410A) | | | | | | | |
| Refrigerating | % (relative to | 100 | 98.3 | 85.0 | 85.0 | 85.0 | 85.0 | 85.0 |
| capacity ratio | 410A) | | | | | | | |
| Condensation | ° C. | 0.1 | 0.00 | 1.98 | 3.36 | 4.46 | 5.15 | 5.35 |
| glide | | | | | | | | |
| Discharge | % (relative to | 100.0 | 99.3 | 87.1 | 88.9 | 90.6 | 92.1 | 93.2 |
| pressure | 410A) | | | | | | | |
| RCL | g/m³ | — | 30.7 | 37.5 | 44.0 | 52.7 | 64.0 | 78.6 |

TABLE 2

| | | Comp. | | Example | | Comp. | Comp. | Example | Comp. |
|---|---|---|---|---|---|---|---|---|---|
| | | Ex. 5 | Example | 5 | Example | Ex. 6 | Ex. 7 | 7 | Ex. 8 |
| Item | Unit | C | 4 | C′ | 6 | D | E | E′ | F |
| HFO-1132(E) | mass % | 32.9 | 26.6 | 19.5 | 10.9 | 0.0 | 58.0 | 23.4 | 0.0 |
| HFO-1123 | mass % | 67.1 | 68.4 | 70.5 | 74.1 | 80.4 | 42.0 | 48.5 | 61.8 |
| R1234yf | mass % | 0.0 | 5.0 | 10.0 | 15.0 | 19.6 | 0.0 | 28.1 | 38.2 |
| GWP | — | 1 | 1 | 1 | 1 | 2 | 1 | 2 | 2 |
| COP ratio | % | 92.5 | 92.5 | 92.5 | 92.5 | 92.5 | 95.0 | 95.0 | 95.0 |
| | (relative | | | | | | | | |
| | to 410A) | | | | | | | | |
| Refrigerating | % | 107.4 | 105.2 | 102.9 | 100.5 | 97.9 | 105.0 | 92.5 | 86.9 |
| capacity ratio | (relative | | | | | | | | |
| | to 410A) | | | | | | | | |
| Condensation | ° C. | 0.16 | 0.52 | 0.94 | 1.42 | 1.90 | 0.42 | 3.16 | 4.80 |
| glide | | | | | | | | | |
| Discharge | (relative | 119.5 | 117.4 | 115.3 | 113.0 | 115.9 | 112.7 | 101.0 | 95.8 |
| pressure | to 410A) | | | | | | | | |
| RCL | g/m³ | 53.5 | 57.1 | 62.0 | 69.1 | 81.3 | 41.9 | 46.3 | 79.0 |

TABLE 3

| | | Comp. | Example | Example | Example | Example | Example |
|---|---|---|---|---|---|---|---|
| | | Ex. 9 | 8 | 9 | 10 | 11 | 12 |
| Item | Unit | J | P | L | N | N′ | K |
| HFO-1132(E) | mass % | 47.1 | 55.8 | 63.1 | 68.6 | 65.0 | 61.3 |
| HFO-1123 | mass % | 52.9 | 42.0 | 31.9 | 16.3 | 7.7 | 5.4 |
| R1234yf | mass % | 0.0 | 2.2 | 5.0 | 15.1 | 27.3 | 33.3 |
| GWP | — | 1 | 1 | 1 | 1 | 2 | 2 |
| COP ratio | % (relative to 410A) | 93.8 | 95.0 | 96.1 | 97.9 | 99.1 | 99.5 |
| Refrigerating | % (relative to 410A) | 106.2 | 104.1 | 101.6 | 95.0 | 88.2 | 85.0 |
| capacity ratio | | | | | | | |
| Condensation | ° C. | 0.31 | 0.57 | 0.81 | 1.41 | 2.11 | 2.51 |
| glide | | | | | | | |
| Discharge | % (relative to 410A) | 115.8 | 111.9 | 107.8 | 99.0 | 91.2 | 87.7 |
| pressure | | | | | | | |
| RCL | g/m³ | 46.2 | 42.6 | 40.0 | 38.0 | 38.7 | 39.7 |

TABLE 4

| | | Example | Example | Example | Example | Example | Example | Example |
|---|---|---|---|---|---|---|---|---|
| | | 13 | 14 | 15 | 16 | 17 | 18 | 19 |
| Item | Unit | L | M | Q | R | S | S′ | T |
| HFO-1132(E) | mass % | 63.1 | 60.3 | 62.8 | 49.8 | 62.6 | 50.0 | 35.8 |
| HFO-1123 | mass % | 31.9 | 6.2 | 29.6 | 42.3 | 28.3 | 35.8 | 44.9 |
| R1234yf | mass % | 5.0 | 33.5 | 7.6 | 7.9 | 9.1 | 14.2 | 19.3 |
| GWP | — | 1 | 2 | 1 | 1 | 1 | 1 | 2 |
| COP ratio | % (relative to | 96.1 | 99.4 | 96.4 | 95.0 | 96.6 | 95.8 | 95.0 |
| | 410A) | | | | | | | |
| Refrigerating | % (relative to | 101.6 | 85.0 | 100.2 | 101.7 | 99.4 | 98.1 | 96.7 |
| capacity ratio | 410A) | | | | | | | |
| Condensation | ° C. | 0.81 | 2.58 | 1.00 | 1.00 | 1.10 | 1.55 | 2.07 |
| glide | | | | | | | | |
| Discharge | % (relative to | 107.8 | 87.9 | 106.0 | 109.6 | 105.0 | 105.0 | 105.0 |
| pressure | 410A) | | | | | | | |
| RCL | g/m³ | 40.0 | 40.0 | 40.0 | 44.8 | 40.0 | 44.4 | 50.8 |

TABLE 5

| | | Comp. Ex. | Example | Example |
|---|---|---|---|---|
| | | 10 | 20 | 21 |
| Item | Unit | G | H | I |
| HFO-1132(E) | mass % | 72.0 | 72.0 | 72.0 |
| HFO-1123 | mass % | 28.0 | 14.0 | 0.0 |
| R1234yf | mass % | 0.0 | 14.0 | 28.0 |
| GWP | — | 1 | 1 | 2 |
| COP ratio | % (relative | 96.6 | 98.2 | 99.9 |
| | to 410A) | | | |
| Refrigerating | % (relative | 103.1 | 95.1 | 86.6 |
| capacity ratio | to 410A) | | | |
| Condensation glide | ° C. | 0.46 | 1.27 | 1.71 |
| Discharge pressure | % (relative | 108.4 | 98.7 | 88.6 |
| | to 410A) | | | |
| RCL | g/m³ | 37.4 | 37.0 | 36.6 |

TABLE 6

| | | Comp. | Comp. | Example | Example | Example | Example | Example | Comp. |
|---|---|---|---|---|---|---|---|---|---|
| Item | Unit | Ex. 11 | Ex. 12 | 22 | 23 | 24 | 25 | 26 | Ex. 13 |
| HFO-1132(E) | mass % | 10.0 | 20.0 | 30.0 | 40.0 | 50.0 | 60.0 | 70.0 | 80.0 |
| HFO-1123 | mass % | 85.0 | 75.0 | 65.0 | 55.0 | 45.0 | 35.0 | 25.0 | 15.0 |
| R1234yf | mass % | 5.0 | 5.0 | 5.0 | 5.0 | 5.0 | 5.0 | 5.0 | 5.0 |
| GWP | — | 1 | 1 | 1 | 1 | 1 | 1 | 1 | 1 |
| COP ratio | % (relative to | 91.4 | 92.0 | 92.8 | 93.7 | 94.7 | 95.8 | 96.9 | 98.0 |
| | 410A) | | | | | | | | |
| Refrigerating | % (relative to | 105.7 | 105.5 | 105.0 | 104.3 | 103.3 | 102.0 | 100.6 | 99.1 |
| capacity ratio | 410A) | | | | | | | | |
| Condensation | ° C. | 0.40 | 0.46 | 0.55 | 0.66 | 0.75 | 0.80 | 0.79 | 0.67 |
| glide | | | | | | | | | |
| Discharge | % (relative to | 120.1 | 118.7 | 116.7 | 114.3 | 111.6 | 108.7 | 105.6 | 102.5 |
| pressure | 410A) | | | | | | | | |
| RCL | g/m³ | 71.0 | 61.9 | 54.9 | 49.3 | 44.8 | 41.0 | 37.8 | 35.1 |

TABLE 7

| | | Comp. | Example | Example | Example | Example | Example | Example | Comp. |
|---|---|---|---|---|---|---|---|---|---|
| Item | Unit | Ex. 14 | 27 | 28 | 29 | 30 | 31 | 32 | Ex. 15 |
| HFO-1132(E) | mass % | 10.0 | 20.0 | 30.0 | 40.0 | 50.0 | 60.0 | 70.0 | 80.0 |
| HFO-1123 | mass % | 80.0 | 70.0 | 60.0 | 50.0 | 40.0 | 30.0 | 20.0 | 10.0 |
| R1234yf | mass % | 10.0 | 10.0 | 10.0 | 10.0 | 10.0 | 10.0 | 10.0 | 10.0 |
| GWP | — | 1 | 1 | 1 | 1 | 1 | 1 | 1 | 1 |
| COP ratio | % (relative to | 91.9 | 92.5 | 93.3 | 94.3 | 95.3 | 96.4 | 97.5 | 98.6 |
| | 410A) | | | | | | | | |
| Refrigerating | % (relative to | 103.2 | 102.9 | 102.4 | 101.5 | 100.5 | 99.2 | 97.8 | 96.2 |
| capacity ratio | 410A) | | | | | | | | |
| Condensation | ° C. | 0.87 | 0.94 | 1.03 | 1.12 | 1.18 | 1.18 | 1.09 | 0.88 |
| glide | | | | | | | | | |
| Discharge | % (relative to | 116.7 | 115.2 | 113.2 | 110.8 | 108.1 | 105.2 | 102.1 | 99.0 |
| pressure | 410A) | | | | | | | | |
| RCL | g/m³ | 70.5 | 61.6 | 54.6 | 49.1 | 44.6 | 40.8 | 37.7 | 35.0 |

TABLE 8

| | | Comp. | Example | Example | Example | Example | Example | Example | Comp. |
|---|---|---|---|---|---|---|---|---|---|
| Item | Unit | Ex. 16 | 33 | 34 | 35 | 36 | 37 | 38 | Ex. 17 |
| HFO-1132(E) | mass % | 10.0 | 20.0 | 30.0 | 40.0 | 50.0 | 60.0 | 70.0 | 80.0 |
| HFO-1123 | mass % | 75.0 | 65.0 | 55.0 | 45.0 | 35.0 | 25.0 | 15.0 | 5.0 |
| R1234yf | mass % | 15.0 | 15.0 | 15.0 | 15.0 | 15.0 | 15.0 | 15.0 | 15.0 |
| GWP | — | 1 | 1 | 1 | 1 | 1 | 1 | 1 | 1 |
| COP ratio | % (relative to | 92.4 | 93.1 | 93.9 | 94.8 | 95.9 | 97.0 | 98.1 | 99.2 |
| | 410A) | | | | | | | | |
| Refrigerating | % (relative to | 100.5 | 100.2 | 99.6 | 98.7 | 97.7 | 96.4 | 94.9 | 93.2 |
| capacity ratio | 410A) | | | | | | | | |
| Condensation | ° C. | 1.41 | 1.49 | 1.56 | 1.62 | 1.63 | 1.55 | 1.37 | 1.05 |
| glide | | | | | | | | | |
| Discharge | % (relative to | 113.1 | 111.6 | 109.6 | 107.2 | 104.5 | 101.6 | 98.6 | 95.5 |
| pressure | 410A) | | | | | | | | |
| RCL | g/m³ | 70.0 | 61.2 | 54.4 | 48.9 | 44.4 | 40.7 | 37.5 | 34.8 |

TABLE 9

| | | Example | Example | Example | Example | Example | Example | Example |
|---|---|---|---|---|---|---|---|---|
| Item | Unit | 39 | 40 | 41 | 42 | 43 | 44 | 45 |
| HFO-1132(E) | mass % | 10.0 | 20.0 | 30.0 | 40.0 | 50.0 | 60.0 | 70.0 |
| HFO-1123 | mass % | 70.0 | 60.0 | 50.0 | 40.0 | 30.0 | 20.0 | 10.0 |
| R1234yf | mass % | 20.0 | 20.0 | 20.0 | 20.0 | 20.0 | 20.0 | 20.0 |
| GWP | — | 2 | 2 | 2 | 2 | 2 | 2 | 2 |
| COP ratio | % (relative to | 93.0 | 93.7 | 94.5 | 95.5 | 96.5 | 97.6 | 98.7 |
| | 410A) | | | | | | | |
| Refrigerating | % (relative to | 97.7 | 97.4 | 96.8 | 95.9 | 94.7 | 93.4 | 91.9 |
| capacity ratio | 410A) | | | | | | | |
| Condensation | ° C. | 2.03 | 2.09 | 2.13 | 2.14 | 2.07 | 1.91 | 1.61 |
| glide | | | | | | | | |
| Discharge | % (relative to | 109.4 | 107.9 | 105.9 | 103.5 | 100.8 | 98.0 | 95.0 |
| pressure | 410A) | | | | | | | |
| RCL | g/m³ | 69.6 | 60.9 | 54.1 | 48.7 | 44.2 | 40.5 | 37.4 |

TABLE 10

| | | Example | Example | Example | Example | Example | Example | Example |
|---|---|---|---|---|---|---|---|---|
| Item | Unit | 46 | 47 | 48 | 49 | 50 | 51 | 52 |
| HFO-1132(E) | mass % | 10.0 | 20.0 | 30.0 | 40.0 | 50.0 | 60.0 | 70.0 |
| HFO-1123 | mass % | 65.0 | 55.0 | 45.0 | 35.0 | 25.0 | 15.0 | 5.0 |
| R1234yf | mass % | 25.0 | 25.0 | 25.0 | 25.0 | 25.0 | 25.0 | 25.0 |
| GWP | — | 2 | 2 | 2 | 2 | 2 | 2 | 2 |
| COP ratio | % (relative | 93.6 | 94.3 | 95.2 | 96.1 | 97.2 | 98.2 | 99.3 |
| | to 410A) | | | | | | | |
| Refrigerating | % (relative | 94.8 | 94.5 | 93.8 | 92.9 | 91.8 | 90.4 | 88.8 |
| capacity ratio | to 410A) | | | | | | | |
| Condensation | ° C. | 2.71 | 2.74 | 2.73 | 2.66 | 2.50 | 2.22 | 1.78 |
| glide | | | | | | | | |
| Discharge | % (relative | 105.5 | 104.0 | 102.1 | 99.7 | 97.1 | 94.3 | 91.4 |
| pressure | to 410A) | | | | | | | |
| RCL | g/m³ | 69.1 | 60.5 | 53.8 | 48.4 | 44.0 | 40.4 | 37.3 |

TABLE 11

| | | Example | Example | Example | Example | Example | Example |
|---|---|---|---|---|---|---|---|
| Item | Unit | 53 | 54 | 55 | 56 | 57 | 58 |
| HFO-1132(E) | mass % | 10.0 | 20.0 | 30.0 | 40.0 | 50.0 | 60.0 |
| HFO-1123 | mass % | 60.0 | 50.0 | 40.0 | 30.0 | 20.0 | 10.0 |
| R1234yf | mass % | 30.0 | 30.0 | 30.0 | 30.0 | 30.0 | 30.0 |
| GWP | — | 2 | 2 | 2 | 2 | 2 | 2 |
| COP ratio | % (relative to 410A) | 94.3 | 95.0 | 95.9 | 96.8 | 97.8 | 98.9 |
| Refrigerating | % (relative to 410A) | 91.9 | 91.5 | 90.8 | 89.9 | 88.7 | 87.3 |
| capacity ratio | | | | | | | |
| Condensation | ° C. | 3.46 | 3.43 | 3.35 | 3.18 | 2.90 | 2.47 |
| glide | | | | | | | |
| Discharge | % (relative to 410A) | 101.6 | 100.1 | 98.2 | 95.9 | 93.3 | 90.6 |
| pressure | | | | | | | |
| RCL | g/m³ | 68.7 | 60.2 | 53.5 | 48.2 | 43.9 | 40.2 |

TABLE 12

| | | Example | Example | Example | Example | Example | Comp. |
|---|---|---|---|---|---|---|---|
| Item | Unit | 59 | 60 | 61 | 62 | 63 | Ex. 18 |
| HFO-1132(E) | mass % | 10.0 | 20.0 | 30.0 | 40.0 | 50.0 | 60.0 |
| HFO-1123 | mass % | 55.0 | 45.0 | 35.0 | 25.0 | 15.0 | 5.0 |
| R1234yf | mass % | 35.0 | 35.0 | 35.0 | 35.0 | 35.0 | 35.0 |
| GWP | — | 2 | 2 | 2 | 2 | 2 | 2 |
| COP ratio | % (relative to 410A) | 95.0 | 95.8 | 96.6 | 97.5 | 98.5 | 99.6 |
| Refrigerating | % (relative to 410A) | 88.9 | 88.5 | 87.8 | 86.8 | 85.6 | 84.1 |
| capacity ratio | | | | | | | |
| Condensation | ° C. | 4.24 | 4.15 | 3.96 | 3.67 | 3.24 | 2.64 |
| glide | | | | | | | |
| Discharge | % (relative to 410A) | 97.6 | 96.1 | 94.2 | 92.0 | 89.5 | 86.8 |
| pressure | | | | | | | |
| RCL | g/m³ | 68.2 | 59.8 | 53.2 | 48.0 | 43.7 | 40.1 |

TABLE 13

| | | Example | Example | Comp. Ex. | Comp. Ex. | Comp. Ex. |
|---|---|---|---|---|---|---|
| Item | Unit | 64 | 65 | 19 | 20 | 21 |
| HFO-1132(E) | mass % | 10.0 | 20.0 | 30.0 | 40.0 | 50.0 |
| HFO-1123 | mass % | 50.0 | 40.0 | 30.0 | 20.0 | 10.0 |
| R1234yf | mass % | 40.0 | 40.0 | 40.0 | 40.0 | 40.0 |
| GWP | — | 2 | 2 | 2 | 2 | 2 |
| COP ratio | % (relative to 410A) | 95.9 | 96.6 | 97.4 | 98.3 | 99.2 |
| Refrigerating | % (relative to 410A) | 85.8 | 85.4 | 84.7 | 83.6 | 82.4 |
| capacity ratio | | | | | | |
| Condensation | ° C. | 5.05 | 4.85 | 4.55 | 4.10 | 3.50 |
| glide | | | | | | |
| Discharge | % (relative to 410A) | 93.5 | 92.1 | 90.3 | 88.1 | 85.6 |
| pressure | | | | | | |
| RCL | g/m³ | 67.8 | 59.5 | 53.0 | 47.8 | 43.5 |

TABLE 14

| | | Example | Example | Example | Example | Example | Example | Example | Example |
|---|---|---|---|---|---|---|---|---|---|
| Item | Unit | 66 | 67 | 68 | 69 | 70 | 71 | 72 | 73 |
| HFO-1132(E) | mass % | 54.0 | 56.0 | 58.0 | 62.0 | 52.0 | 54.0 | 56.0 | 58.0 |
| HFO-1123 | mass % | 41.0 | 39.0 | 37.0 | 33.0 | 41.0 | 39.0 | 37.0 | 35.0 |
| R1234yf | mass % | 5.0 | 5.0 | 5.0 | 5.0 | 7.0 | 7.0 | 7.0 | 7.0 |
| GWP | — | 1 | 1 | 1 | 1 | 1 | 1 | 1 | 1 |
| COP ratio | % (relative | 95.1 | 95.3 | 95.6 | 96.0 | 95.1 | 95.4 | 95.6 | 95.8 |
| | to 410A) | | | | | | | | |
| Refrigerating | % (relative | 102.8 | 102.6 | 102.3 | 101.8 | 101.9 | 101.7 | 101.5 | 101.2 |
| capacity ratio | to 410A) | | | | | | | | |
| Condensation | ° C. | 0.78 | 0.79 | 0.80 | 0.81 | 0.93 | 0.94 | 0.95 | 0.95 |
| glide | | | | | | | | | |
| Discharge | % (relative | 110.5 | 109.9 | 109.3 | 108.1 | 109.7 | 109.1 | 108.5 | 107.9 |
| pressure | to 410A) | | | | | | | | |
| RCL | g/m³ | 43.2 | 42.4 | 41.7 | 40.3 | 43.9 | 43.1 | 42.4 | 41.6 |

TABLE 15

| | | Example | Example | Example | Example | Example | Example | Example | Example |
|---|---|---|---|---|---|---|---|---|---|
| Item | Unit | 74 | 75 | 76 | 77 | 78 | 79 | 80 | 81 |
| HFO-1132(E) | mass % | 60.0 | 62.0 | 61.0 | 58.0 | 60.0 | 62.0 | 52.0 | 54.0 |
| HFO-1123 | mass % | 33.0 | 31.0 | 29.0 | 30.0 | 28.0 | 26.0 | 34.0 | 32.0 |
| R1234yf | mass % | 7.0 | 7.0 | 10.0 | 12.0 | 12.0 | 12.0 | 14.0 | 14.0 |
| GWP | — | 1 | 1 | 1 | 1 | 1 | 1 | 1 | 1 |
| COP ratio | % (relative | 96.0 | 96.2 | 96.5 | 96.4 | 96.6 | 96.8 | 96.0 | 96.2 |
| | to 410A) | | | | | | | | |
| Refrigerating | % (relative | 100.9 | 100.7 | 99.1 | 98.4 | 98.1 | 97.8 | 98.0 | 97.7 |
| capacity ratio | to 410A) | | | | | | | | |
| Condensation | ° C. | 0.95 | 0.95 | 1.18 | 1.34 | 1.33 | 1.32 | 1.53 | 1.53 |
| glide | | | | | | | | | |
| Discharge | % (relative | 107.3 | 106.7 | 104.9 | 104.4 | 103.8 | 103.2 | 104.7 | 104.1 |
| pressure | to 410A) | | | | | | | | |
| RCL | g/m³ | 40.9 | 40.3 | 40.5 | 41.5 | 40.8 | 40.1 | 43.6 | 42.9 |

TABLE 16

| | | Example | Example | Example | Example | Example | Example | Example | Example |
|---|---|---|---|---|---|---|---|---|---|
| Item | Unit | 82 | 83 | 84 | 85 | 86 | 87 | 88 | 89 |
| HFO-1132(E) | mass % | 56.0 | 58.0 | 60.0 | 48.0 | 50.0 | 52.0 | 54.0 | 56.0 |
| HFO-1123 | mass % | 30.0 | 28.0 | 26.0 | 36.0 | 34.0 | 32.0 | 30.0 | 28.0 |
| R1234yf | mass % | 14.0 | 14.0 | 14.0 | 16.0 | 16.0 | 16.0 | 16.0 | 16.0 |
| GWP | — | 1 | 1 | 1 | 1 | 1 | 1 | 1 | 1 |
| COP ratio | % (relative | 96.4 | 96.6 | 96.9 | 95.8 | 96.0 | 96.2 | 96.4 | 96.7 |
| | to 410A) | | | | | | | | |
| Refrigerating | % (relative | 97.5 | 97.2 | 96.9 | 97.3 | 97.1 | 96.8 | 96.6 | 96.3 |
| capacity ratio | to 410A) | | | | | | | | |
| Condensation | ° C. | 1.51 | 1.50 | 1.48 | 1.72 | 1.72 | 1.71 | 1.69 | 1.67 |
| glide | | | | | | | | | |
| Discharge | % (relative | 103.5 | 102.9 | 102.3 | 104.3 | 103.8 | 103.2 | 102.7 | 102.1 |
| pressure | to 410A) | | | | | | | | |
| RCL | g/m³ | 42.1 | 41.4 | 40.7 | 45.2 | 44.4 | 43.6 | 42.8 | 42.1 |

TABLE 17

| | | Example | Example | Example | Example | Example | Example | Example | Example |
|---|---|---|---|---|---|---|---|---|---|
| Item | Unit | 90 | 91 | 92 | 93 | 94 | 95 | 96 | 97 |
| HFO-1132(E) | mass % | 58.0 | 60.0 | 42.0 | 44.0 | 46.0 | 48.0 | 50.0 | 52.0 |
| HFO-1123 | mass % | 26.0 | 24.0 | 40.0 | 38.0 | 36.0 | 34.0 | 32.0 | 30.0 |
| R1234yf | mass % | 16.0 | 16.0 | 18.0 | 18.0 | 18.0 | 18.0 | 18.0 | 18.0 |
| GWP | — | 1 | 1 | 2 | 2 | 2 | 2 | 2 | 2 |
| COP ratio | % (relative | 96.9 | 97.1 | 95.4 | 95.6 | 95.8 | 96.0 | 96.3 | 96.5 |
| | to 410A) | | | | | | | | |
| Refrigerating | % (relative | 96.1 | 95.8 | 96.8 | 96.6 | 96.4 | 96.2 | 95.9 | 95.7 |
| capacity ratio | to 410A) | | | | | | | | |
| Condensation | ° C. | 1.65 | 1.63 | 1.93 | 1.92 | 1.92 | 1.91 | 1.89 | 1.88 |
| glide | | | | | | | | | |
| Discharge | % (relative | 101.5 | 100.9 | 104.5 | 103.9 | 103.4 | 102.9 | 102.3 | 101.8 |
| pressure | to 410A) | | | | | | | | |
| RCL | g/m³ | 41.4 | 40.7 | 47.8 | 46.9 | 46.0 | 45.1 | 44.3 | 43.5 |

TABLE 18

| | | Example | Example | Example | Example | Example | Example | Example | Example |
|---|---|---|---|---|---|---|---|---|---|
| Item | Unit | 98 | 99 | 100 | 101 | 102 | 103 | 104 | 105 |
| HFO-1132(E) | mass % | 54.0 | 56.0 | 58.0 | 60.0 | 36.0 | 38.0 | 42.0 | 44.0 |
| HFO-1123 | mass % | 28.0 | 26.0 | 24.0 | 22.0 | 44.0 | 42.0 | 38.0 | 36.0 |
| R1234yf | mass % | 18.0 | 18.0 | 18.0 | 18.0 | 20.0 | 20.0 | 20.0 | 20.0 |
| GWP | — | 2 | 2 | 2 | 2 | 2 | 2 | 2 | 2 |
| COP ratio | % (relative | 96.7 | 96.9 | 97.1 | 97.3 | 95.1 | 95.3 | 95.7 | 95.9 |
| | to 410A) | | | | | | | | |
| Refrigerating | % (relative | 95.4 | 95.2 | 94.9 | 94.6 | 96.3 | 96.1 | 95.7 | 95.4 |
| capacity ratio | to 410A) | | | | | | | | |
| Condensation | ° C. | 1.86 | 1.83 | 1.80 | 1.77 | 2.14 | 2.14 | 2.13 | 2.12 |
| glide | | | | | | | | | |
| Discharge | % (relative | 101.2 | 100.6 | 100.0 | 99.5 | 104.5 | 104.0 | 103.0 | 102.5 |
| pressure | to 410A) | | | | | | | | |
| RCL | g/m³ | 42.7 | 42.0 | 41.3 | 40.6 | 50.7 | 49.7 | 47.7 | 46.8 |

TABLE 19

| | | Example | Example | Example | Example | Example | Example | Example | Example |
|---|---|---|---|---|---|---|---|---|---|
| Item | Unit | 106 | 107 | 108 | 109 | 110 | 111 | 112 | 113 |
| HFO-1132(E) | mass % | 46.0 | 48.0 | 52.0 | 54.0 | 56.0 | 58.0 | 34.0 | 36.0 |
| HFO-1123 | mass % | 34.0 | 32.0 | 28.0 | 26.0 | 24.0 | 22.0 | 44.0 | 42.0 |
| R1234yf | mass % | 20.0 | 20.0 | 20.0 | 20.0 | 20.0 | 20.0 | 22.0 | 22.0 |
| GWP | — | 2 | 2 | 2 | 2 | 2 | 2 | 2 | 2 |
| COP ratio | % (relative | 96.1 | 96.3 | 96.7 | 96.9 | 97.2 | 97.4 | 95.1 | 95.3 |
| | to 410A) | | | | | | | | |
| Refrigerating | % (relative | 95.2 | 95.0 | 94.5 | 94.2 | 94.0 | 93.7 | 95.3 | 95.1 |
| capacity ratio | to 410A) | | | | | | | | |
| Condensation | ° C. | 2.11 | 2.09 | 2.05 | 2.02 | 1.99 | 1.95 | 2.37 | 2.36 |
| glide | | | | | | | | | |
| Discharge | % (relative | 101.9 | 101.4 | 100.3 | 99.7 | 99.2 | 98.6 | 103.4 | 103.0 |
| pressure | to 410A) | | | | | | | | |
| RCL | g/m³ | 45.9 | 45.0 | 43.4 | 42.7 | 41.9 | 41.2 | 51.7 | 50.6 |

TABLE 20

| | | Example | Example | Example | Example | Example | Example | Example | Example |
|---|---|---|---|---|---|---|---|---|---|
| Item | Unit | 114 | 115 | 116 | 117 | 118 | 119 | 120 | 121 |
| HFO-1132(E) | mass % | 38.0 | 40.0 | 42.0 | 44.0 | 46.0 | 48.0 | 50.0 | 52.0 |
| HFO-1123 | mass % | 40.0 | 38.0 | 36.0 | 34.0 | 32.0 | 30.0 | 28.0 | 26.0 |
| R1234yf | mass % | 22.0 | 22.0 | 22.0 | 22.0 | 22.0 | 22.0 | 22.0 | 22.0 |
| GWP | — | 2 | 2 | 2 | 2 | 2 | 2 | 2 | 2 |
| COP ratio | % (relative | 95.5 | 95.7 | 95.9 | 96.1 | 96.4 | 96.6 | 96.8 | 97.0 |
| | to 410A) | | | | | | | | |
| Refrigerating | % (relative | 94.9 | 94.7 | 94.5 | 94.3 | 94.0 | 93.8 | 93.6 | 93.3 |
| capacity ratio | to 410A) | | | | | | | | |
| Condensation | ° C. | 2.36 | 2.35 | 2.33 | 2.32 | 2.30 | 2.27 | 2.25 | 2.21 |
| glide | | | | | | | | | |
| Discharge | % (relative | 102.5 | 102.0 | 101.5 | 101.0 | 100.4 | 99.9 | 99.4 | 98.8 |
| pressure | to 410A) | | | | | | | | |
| RCL | g/m³ | 49.6 | 48.6 | 47.6 | 46.7 | 45.8 | 45.0 | 44.1 | 43.4 |

TABLE 21

| | | Example | Example | Example | Example | Example | Example | Example | Example |
|---|---|---|---|---|---|---|---|---|---|
| Item | Unit | 122 | 123 | 124 | 125 | 126 | 127 | 128 | 129 |
| HFO-1132(E) | mass % | 54.0 | 56.0 | 58.0 | 60.0 | 32.0 | 34.0 | 36.0 | 38.0 |
| HFO-1123 | mass % | 24.0 | 22.0 | 20.0 | 18.0 | 44.0 | 42.0 | 40.0 | 38.0 |
| R1234yf | mass % | 22.0 | 22.0 | 22.0 | 22.0 | 24.0 | 24.0 | 24.0 | 24.0 |
| GWP | — | 2 | 2 | 2 | 2 | 2 | 2 | 2 | 2 |
| COP ratio | % (relative | 97.2 | 97.4 | 97.6 | 97.9 | 95.2 | 95.4 | 95.6 | 95.8 |
| | to 410A) | | | | | | | | |
| Refrigerating | % (relative | 93.0 | 92.8 | 92.5 | 92.2 | 94.3 | 94.1 | 93.9 | 93.7 |
| capacity ratio | to 410A) | | | | | | | | |
| Condensation | ° C. | 2.18 | 2.14 | 2.09 | 2.04 | 2.61 | 2.60 | 2.59 | 2.58 |
| glide | | | | | | | | | |
| Discharge | % (relative | 98.2 | 97.7 | 97.1 | 96.5 | 102.4 | 101.9 | 101.5 | 101.0 |
| pressure | to 410A) | | | | | | | | |
| RCL | g/m³ | 42.6 | 41.9 | 41.2 | 40.5 | 52.7 | 51.6 | 50.5 | 49.5 |

TABLE 22

| | | Example | Example | Example | Example | Example | Example | Example | Example |
|---|---|---|---|---|---|---|---|---|---|
| Item | Unit | 130 | 131 | 132 | 133 | 134 | 135 | 136 | 137 |
| HFO-1132(E) | mass % | 40.0 | 42.0 | 44.0 | 46.0 | 48.0 | 50.0 | 52.0 | 54.0 |
| HFO-1123 | mass % | 36.0 | 34.0 | 32.0 | 30.0 | 28.0 | 26.0 | 24.0 | 22.0 |
| R1234yf | mass % | 24.0 | 24.0 | 24.0 | 24.0 | 24.0 | 24.0 | 24.0 | 24.0 |
| GWP | — | 2 | 2 | 2 | 2 | 2 | 2 | 2 | 2 |
| COP ratio | % (relative | 96.0 | 96.2 | 96.4 | 96.6 | 96.8 | 97.0 | 97.2 | 97.5 |
| | to 410A) | | | | | | | | |
| Refrigerating | % (relative | 93.5 | 93.3 | 93.1 | 92.8 | 92.6 | 92.4 | 92.1 | 91.8 |
| capacity ratio | to 410A) | | | | | | | | |
| Condensation | ° C. | 2.56 | 2.54 | 2.51 | 2.49 | 2.45 | 2.42 | 2.38 | 2.33 |
| glide | | | | | | | | | |
| Discharge | % (relative | 100.5 | 100.0 | 99.5 | 98.9 | 98.4 | 97.9 | 97.3 | 96.8 |
| pressure | to 410A) | | | | | | | | |
| RCL | g/m³ | 48.5 | 47.5 | 46.6 | 45.7 | 44.9 | 44.1 | 43.3 | 42.5 |

TABLE 23

| | | Example | Example | Example | Example | Example | Example | Example | Example |
|---|---|---|---|---|---|---|---|---|---|
| Item | Unit | 138 | 139 | 140 | 141 | 142 | 143 | 144 | 145 |
| HFO-1132(E) | mass % | 56.0 | 58.0 | 60.0 | 30.0 | 32.0 | 34.0 | 36.0 | 38.0 |
| HFO-1123 | mass % | 20.0 | 18.0 | 16.0 | 44.0 | 42.0 | 40.0 | 38.0 | 36.0 |
| R1234yf | mass % | 24.0 | 24.0 | 24.0 | 26.0 | 26.0 | 26.0 | 26.0 | 26.0 |
| GWP | — | 2 | 2 | 2 | 2 | 2 | 2 | 2 | 2 |
| COP ratio | % (relative | 97.7 | 97.9 | 98.1 | 95.3 | 95.5 | 95.7 | 95.9 | 96.1 |
| | to 410A) | | | | | | | | |
| Refrigerating | % (relative | 91.6 | 91.3 | 91.0 | 93.2 | 93.1 | 92.9 | 92.7 | 92.5 |
| capacity ratio | to 410A) | | | | | | | | |
| Condensation | ° C. | 2.28 | 2.22 | 2.16 | 2.86 | 2.85 | 2.83 | 2.81 | 2.79 |
| glide | | | | | | | | | |
| Discharge | % (relative | 96.2 | 95.6 | 95.1 | 101.3 | 100.8 | 100.4 | 99.9 | 99.4 |
| pressure | to 410A) | | | | | | | | |
| RCL | g/m³ | 41.8 | 41.1 | 40.4 | 53.7 | 52.6 | 51.5 | 50.4 | 49.4 |

TABLE 24

| | | Example | Example | Example | Example | Example | Example | Example | Example |
|---|---|---|---|---|---|---|---|---|---|
| Item | Unit | 146 | 147 | 148 | 149 | 150 | 151 | 152 | 153 |
| HFO-1132(E) | mass % | 40.0 | 42.0 | 44.0 | 46.0 | 48.0 | 50.0 | 52.0 | 54.0 |
| HFO-1123 | mass % | 34.0 | 32.0 | 30.0 | 28.0 | 26.0 | 24.0 | 22.0 | 20.0 |
| R1234yf | mass % | 26.0 | 26.0 | 26.0 | 26.0 | 26.0 | 26.0 | 26.0 | 26.0 |
| GWP | — | 2 | 2 | 2 | 2 | 2 | 2 | 2 | 2 |
| COP ratio | % (relative | 96.3 | 96.5 | 96.7 | 96.9 | 97.1 | 97.3 | 97.5 | 97.7 |
| | to 410A) | | | | | | | | |
| Refrigerating | % (relative | 92.3 | 92.1 | 91.9 | 91.6 | 91.4 | 91.2 | 90.9 | 90.6 |
| capacity ratio | to 410A) | | | | | | | | |
| Condensation | ° C. | 2.77 | 2.74 | 2.71 | 2.67 | 2.63 | 2.59 | 2.53 | 2.48 |
| glide | | | | | | | | | |
| Discharge | % (relative | 99.0 | 98.5 | 97.9 | 97.4 | 96.9 | 96.4 | 95.8 | 95.3 |
| pressure | to 410A) | | | | | | | | |
| RCL | g/m³ | 48.4 | 47.4 | 46.5 | 45.7 | 44.8 | 44.0 | 43.2 | 42.5 |

TABLE 25

| | | Example | Example | Example | Example | Example | Example | Example | Example |
|---|---|---|---|---|---|---|---|---|---|
| Item | Unit | 154 | 155 | 156 | 157 | 158 | 159 | 160 | 161 |
| HFO-1132(E) | mass % | 56.0 | 58.0 | 60.0 | 30.0 | 32.0 | 34.0 | 36.0 | 38.0 |
| HFO-1123 | mass % | 18.0 | 16.0 | 14.0 | 42.0 | 40.0 | 38.0 | 36.0 | 34.0 |
| R1234yf | mass % | 26.0 | 26.0 | 26.0 | 28.0 | 28.0 | 28.0 | 28.0 | 28.0 |
| GWP | — | 2 | 2 | 2 | 2 | 2 | 2 | 2 | 2 |
| COP ratio | % (relative | 97.9 | 98.2 | 98.4 | 95.6 | 95.8 | 96.0 | 96.2 | 96.3 |
| | to 410A) | | | | | | | | |
| Refrigerating | % (relative | 90.3 | 90.1 | 89.8 | 92.1 | 91.9 | 91.7 | 91.5 | 91.3 |
| capacity ratio | to 410A) | | | | | | | | |
| Condensation | ° C. | 2.42 | 2.35 | 2.27 | 3.10 | 3.09 | 3.06 | 3.04 | 3.01 |
| glide | | | | | | | | | |
| Discharge | % (relative | 94.7 | 94.1 | 93.6 | 99.7 | 99.3 | 98.8 | 98.4 | 97.9 |
| pressure | to 410A) | | | | | | | | |
| RCL | g/m³ | 41.7 | 41.0 | 40.3 | 53.6 | 52.5 | 51.4 | 50.3 | 49.3 |

TABLE 26

| | | Example | Example | Example | Example | Example | Example | Example | Example |
|---|---|---|---|---|---|---|---|---|---|
| Item | Unit | 162 | 163 | 164 | 165 | 166 | 167 | 168 | 169 |
| HFO-1132(E) | mass % | 40.0 | 42.0 | 44.0 | 46.0 | 48.0 | 50.0 | 52.0 | 54.0 |
| HFO-1123 | mass % | 32.0 | 30.0 | 28.0 | 26.0 | 24.0 | 22.0 | 20.0 | 18.0 |
| R1234yf | mass % | 28.0 | 28.0 | 28.0 | 28.0 | 28.0 | 28.0 | 28.0 | 28.0 |
| GWP | — | 2 | 2 | 2 | 2 | 2 | 2 | 2 | 2 |
| COP ratio | % (relative | 96.5 | 96.7 | 96.9 | 97.2 | 97.4 | 97.6 | 97.8 | 98.0 |
| | to 410A) | | | | | | | | |
| Refrigerating | % (relative | 91.1 | 90.9 | 90.7 | 90.4 | 90.2 | 89.9 | 89.7 | 89.4 |
| capacity ratio | to 410A) | | | | | | | | |
| Condensation | ° C. | 2.98 | 2.94 | 2.90 | 2.85 | 2.80 | 2.75 | 2.68 | 2.62 |
| glide | | | | | | | | | |
| Discharge | % (relative | 97.4 | 96.9 | 96.4 | 95.9 | 95.4 | 94.9 | 94.3 | 93.8 |
| pressure | to 410A) | | | | | | | | |
| RCL | g/m³ | 48.3 | 47.4 | 46.4 | 45.6 | 44.7 | 43.9 | 43.1 | 42.4 |

TABLE 27

| | | Example | Example | Example | Example | Example | Example | Example | Example |
|---|---|---|---|---|---|---|---|---|---|
| Item | Unit | 170 | 171 | 172 | 173 | 174 | 175 | 176 | 177 |
| HFO-1132(E) | mass % | 56.0 | 58.0 | 60.0 | 32.0 | 34.0 | 36.0 | 38.0 | 42.0 |
| HFO-1123 | mass % | 16.0 | 14.0 | 12.0 | 38.0 | 36.0 | 34.0 | 32.0 | 28.0 |
| R1234yf | mass % | 28.0 | 28.0 | 28.0 | 30.0 | 30.0 | 30.0 | 30.0 | 30.0 |
| GWP | — | 2 | 2 | 2 | 2 | 2 | 2 | 2 | 2 |
| COP ratio | % (relative | 98.2 | 98.4 | 98.6 | 96.1 | 96.2 | 96.4 | 96.6 | 97.0 |
| | to 410A) | | | | | | | | |
| Refrigerating | % (relative | 89.1 | 88.8 | 88.5 | 90.7 | 90.5 | 90.3 | 90.1 | 89.7 |
| capacity ratio | to 410A) | | | | | | | | |
| Condensation | ° C. | 2.54 | 2.46 | 2.38 | 3.32 | 3.30 | 3.26 | 3.22 | 3.14 |
| glide | | | | | | | | | |
| Discharge | % (relative | 93.2 | 92.6 | 92.1 | 97.7 | 97.3 | 96.8 | 96.4 | 95.4 |
| pressure | to 410A) | | | | | | | | |
| RCL | g/m³ | 41.7 | 41.0 | 40.3 | 52.4 | 51.3 | 50.2 | 49.2 | 47.3 |

TABLE 28

| | | Example | Example | Example | Example | Example | Example | Example | Example |
|---|---|---|---|---|---|---|---|---|---|
| Item | Unit | 178 | 179 | 180 | 181 | 182 | 183 | 184 | 185 |
| HFO-1132(E) | mass % | 44.0 | 46.0 | 48.0 | 50.0 | 52.0 | 54.0 | 56.0 | 58.0 |
| HFO-1123 | mass % | 26.0 | 24.0 | 22.0 | 20.0 | 18.0 | 16.0 | 14.0 | 12.0 |
| R1234yf | mass % | 30.0 | 30.0 | 30.0 | 30.0 | 30.0 | 30.0 | 30.0 | 30.0 |
| GWP | — | 2 | 2 | 2 | 2 | 2 | 2 | 2 | 2 |
| COP ratio | % (relative | 97.2 | 97.4 | 97.6 | 97.8 | 98.0 | 98.3 | 98.5 | 98.7 |
| | to 410A) | | | | | | | | |
| Refrigerating | % (relative | 89.4 | 89.2 | 89.0 | 88.7 | 88.4 | 88.2 | 87.9 | 87.6 |
| capacity ratio | to 410A) | | | | | | | | |
| Condensation | ° C. | 3.08 | 3.03 | 2.97 | 2.90 | 2.83 | 2.75 | 2.66 | 2.57 |
| glide | | | | | | | | | |
| Discharge | % (relative | 94.9 | 94.4 | 93.9 | 93.3 | 92.8 | 92.3 | 91.7 | 91.1 |
| pressure | to 410A) | | | | | | | | |
| RCL | g/m³ | 46.4 | 45.5 | 44.7 | 43.9 | 43.1 | 42.3 | 41.6 | 40.9 |

TABLE 29

| | | Example | Example | Example | Example | Example | Example | Example | Example |
|---|---|---|---|---|---|---|---|---|---|
| Item | Unit | 186 | 187 | 188 | 189 | 190 | 191 | 192 | 193 |
| HFO-1132(E) | mass % | 30.0 | 32.0 | 34.0 | 36.0 | 38.0 | 40.0 | 42.0 | 44.0 |
| HFO-1123 | mass % | 38.0 | 36.0 | 34.0 | 32.0 | 30.0 | 28.0 | 26.0 | 24.0 |
| R1234yf | mass % | 32.0 | 32.0 | 32.0 | 32.0 | 32.0 | 32.0 | 32.0 | 32.0 |
| GWP | — | 2 | 2 | 2 | 2 | 2 | 2 | 2 | 2 |
| COP ratio | % (relative | 96.2 | 96.3 | 96.5 | 96.7 | 96.9 | 97.1 | 97.3 | 97.5 |
| | to 410A) | | | | | | | | |
| Refrigerating | % (relative | 89.6 | 89.5 | 89.3 | 89.1 | 88.9 | 88.7 | 88.4 | 88.2 |
| capacity ratio | to 410A) | | | | | | | | |
| Condensation | ° C. | 3.60 | 3.56 | 3.52 | 3.48 | 3.43 | 3.38 | 3.33 | 3.26 |
| glide | | | | | | | | | |
| Discharge | % (relative | 96.6 | 96.2 | 95.7 | 95.3 | 94.8 | 94.3 | 93.9 | 93.4 |
| pressure | to 410A) | | | | | | | | |
| RCL | g/m³ | 53.4 | 52.3 | 51.2 | 50.1 | 49.1 | 48.1 | 47.2 | 46.3 |

TABLE 30

| | | Example | Example | Example | Example | Example | Example | Example | Example |
|---|---|---|---|---|---|---|---|---|---|
| Item | Unit | 194 | 195 | 196 | 197 | 198 | 199 | 200 | 201 |
| HFO-1132(E) | mass % | 46.0 | 48.0 | 50.0 | 52.0 | 54.0 | 56.0 | 58.0 | 60.0 |
| HFO-1123 | mass % | 22.0 | 20.0 | 18.0 | 16.0 | 14.0 | 12.0 | 10.0 | 8.0 |
| R1234yf | mass % | 32.0 | 32.0 | 32.0 | 32.0 | 32.0 | 32.0 | 32.0 | 32.0 |
| GWP | — | 2 | 2 | 2 | 2 | 2 | 2 | 2 | 2 |
| COP ratio | % (relative | 97.7 | 97.9 | 98.1 | 98.3 | 98.5 | 98.7 | 98.9 | 99.2 |
| | to 410A) | | | | | | | | |
| Refrigerating | % (relative | 88.0 | 87.7 | 87.5 | 87.2 | 86.9 | 86.6 | 86.3 | 86.0 |
| capacity ratio | to 410A) | | | | | | | | |
| Condensation | ° C. | 3.20 | 3.12 | 3.04 | 2.96 | 2.87 | 2.77 | 2.66 | 2.55 |
| glide | | | | | | | | | |
| Discharge | % (relative | 92.8 | 92.3 | 91.8 | 91.3 | 90.7 | 90.2 | 89.6 | 89.1 |
| pressure | to 410A) | | | | | | | | |
| RCL | g/m³ | 45.4 | 44.6 | 43.8 | 43.0 | 42.3 | 41.5 | 40.8 | 40.2 |

TABLE 31

| | | Example | Example | Example | Example | Example | Example | Example | Example |
|---|---|---|---|---|---|---|---|---|---|
| Item | Unit | 202 | 203 | 204 | 205 | 206 | 207 | 208 | 209 |
| HFO-1132(E) | mass % | 30.0 | 32.0 | 34.0 | 36.0 | 38.0 | 40.0 | 42.0 | 44.0 |
| HFO-1123 | mass % | 36.0 | 34.0 | 32.0 | 30.0 | 28.0 | 26.0 | 24.0 | 22.0 |
| R1234yf | mass % | 34.0 | 34.0 | 34.0 | 34.0 | 34.0 | 34.0 | 34.0 | 34.0 |
| GWP | — | 2 | 2 | 2 | 2 | 2 | 2 | 2 | 2 |
| COP ratio | % (relative | 96.5 | 96.6 | 96.8 | 97.0 | 97.2 | 97.4 | 97.6 | 97.8 |
| | to 410A) | | | | | | | | |
| Refrigerating | % (relative | 88.4 | 88.2 | 88.0 | 87.8 | 87.6 | 87.4 | 87.2 | 87.0 |
| capacity ratio | to 410A) | | | | | | | | |
| Condensation | ° C. | 3.84 | 3.80 | 3.75 | 3.70 | 3.64 | 3.58 | 3.51 | 3.43 |
| glide | | | | | | | | | |
| Discharge | % (relative | 95.0 | 94.6 | 94.2 | 93.7 | 93.3 | 92.8 | 92.3 | 91.8 |
| pressure | to 410A) | | | | | | | | |
| RCL | g/m³ | 53.3 | 52.2 | 51.1 | 50.0 | 49.0 | 48.0 | 47.1 | 46.2 |

TABLE 32

| | | Example | Example | Example | Example | Example | Example | Example | Example |
|---|---|---|---|---|---|---|---|---|---|
| Item | Unit | 210 | 211 | 212 | 213 | 214 | 215 | 216 | 217 |
| HFO-1132(E) | mass % | 46.0 | 48.0 | 50.0 | 52.0 | 54.0 | 30.0 | 32.0 | 34.0 |
| HFO-1123 | mass % | 20.0 | 18.0 | 16.0 | 14.0 | 12.0 | 34.0 | 32.0 | 30.0 |
| R1234yf | mass % | 34.0 | 34.0 | 34.0 | 34.0 | 34.0 | 36.0 | 36.0 | 36.0 |
| GWP | — | 2 | 2 | 2 | 2 | 2 | 2 | 2 | 2 |
| COP ratio | % (relative | 98.0 | 98.2 | 98.4 | 98.6 | 98.8 | 96.8 | 96.9 | 97.1 |
| | to 410A) | | | | | | | | |
| Refrigerating | % (relative | 86.7 | 86.5 | 86.2 | 85.9 | 85.6 | 87.2 | 87.0 | 86.8 |
| capacity ratio | to 410A) | | | | | | | | |
| Condensation | ° C. | 3.36 | 3.27 | 3.18 | 3.08 | 2.97 | 4.08 | 4.03 | 3.97 |
| glide | | | | | | | | | |
| Discharge | % (relative | 91.3 | 90.8 | 90.3 | 89.7 | 89.2 | 93.4 | 93.0 | 92.6 |
| pressure | to 410A) | | | | | | | | |
| RCL | g/m³ | 45.3 | 44.5 | 43.7 | 42.9 | 42.2 | 53.2 | 52.1 | 51.0 |

TABLE 33

| | | Example | Example | Example | Example | Example | Example | Example | Example |
|---|---|---|---|---|---|---|---|---|---|
| Item | Unit | 218 | 219 | 220 | 221 | 222 | 223 | 224 | 225 |
| HFO-1132(E) | mass % | 36.0 | 38.0 | 40.0 | 42.0 | 44.0 | 46.0 | 30.0 | 32.0 |
| HFO-1123 | mass % | 28.0 | 26.0 | 24.0 | 22.0 | 20.0 | 18.0 | 32.0 | 30.0 |
| R1234yf | mass % | 36.0 | 36.0 | 36.0 | 36.0 | 36.0 | 36.0 | 38.0 | 38.0 |
| GWP | — | 2 | 2 | 2 | 2 | 2 | 2 | 2 | 2 |
| COP ratio | % (relative | 97.3 | 97.5 | 97.7 | 97.9 | 98.1 | 98.3 | 97.1 | 97.2 |
| | to 410A) | | | | | | | | |
| Refrigerating | % (relative | 86.6 | 86.4 | 86.2 | 85.9 | 85.7 | 85.5 | 85.9 | 85.7 |
| capacity ratio | to 410A) | | | | | | | | |
| Condensation | ° C. | 3.91 | 3.84 | 3.76 | 3.68 | 3.60 | 3.50 | 4.32 | 4.25 |
| glide | | | | | | | | | |
| Discharge | % (relative | 92.1 | 91.7 | 91.2 | 90.7 | 90.3 | 89.8 | 91.9 | 91.4 |
| pressure | to 410A) | | | | | | | | |
| RCL | g/m³ | 49.9 | 48.9 | 47.9 | 47.0 | 46.1 | 45.3 | 53.1 | 52.0 |

TABLE 34

| | | Example | Example |
|---|---|---|---|
| Item | Unit | 226 | 227 |
| HFO-1132(E) | mass % | 34.0 | 36.0 |
| HFO-1123 | mass % | 28.0 | 26.0 |
| R1234yf | mass % | 38.0 | 38.0 |
| GWP | — | 2 | 2 |
| COP ratio | % (relative to | 97.4 | 97.6 |
| | 410A) | | |
| Refrigerating | % (relative to | 85.6 | 85.3 |
| capacity ratio | 410A) | | |
| Condensation glide | ° C. | 4.18 | 4.11 |
| Discharge pressure | % (relative to | 91.0 | 90.6 |
| | 410A) | | |
| RCL | g/m³ | 50.9 | 49.8 |

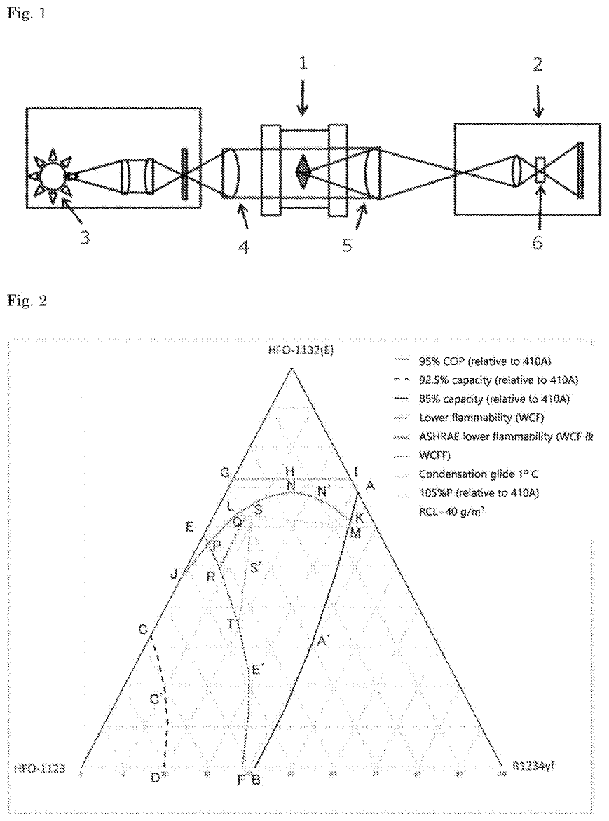

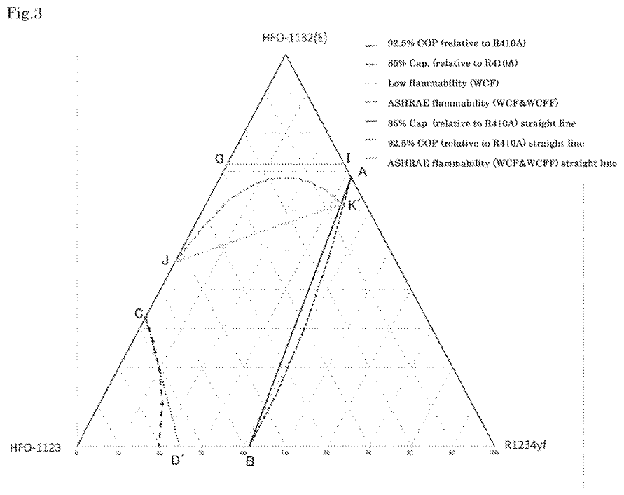

These results indicate that under the condition that the mass % of HFO-1132(E), HFO-1123, and R1234yf based on their sum is respectively represented by x, y, and z, when coordinates (x,y,z) in a ternary composition diagram in which the sum of HFO-1132(E), HFO-1123, and R1234yf is 100 mass % are within the range of a figure surrounded by line segments AA′, A′B, BD, DC′, C′C, CO, and OA that connect the following 7 points:
   point A (68.6, 0.0, 31.4),
   point A′(30.6, 30.0, 39.4),
   point B (0.0, 58.7, 41.3),
   point D (0.0, 80.4, 19.6),
   point C′ (19.5, 70.5, 10.0),
   point C (32.9, 67.1, 0.0), and
   point O (100.0, 0.0, 0.0),
   or on the above line segments (excluding the points on the line segment CO);
   the line segment AA′ is represented by coordinates (x, 0.0016x²−0.9473x+57.497, −0.0016x²−0.0527x+42.503),
   the line segment A′B is represented by coordinates (x, 0.0029x²−1.0268x+58.7, −0.0029x²+0.0268x+41.3,
   the line segment DC′ is represented by coordinates (x, 0.0082x²−0.6671x+80.4, −0.0082x²−0.3329x+19.6),
   the line segment C′C is represented by coordinates (x, 0.0067x²−0.6034x+79.729, −0.0067x²−0.3966x+20.271), and
   the line segments BD, CO, and OA are straight lines,
   the refrigerant has a refrigerating capacity ratio of 85% or more relative to that of R410A, and a COP of 92.5% or more relative to that of R410A.
The point on the line segment AA′ was determined by obtaining an approximate curve connecting point A, Example 1, and point A′ by the least square method. The point on the line segment A′B was determined by obtaining an approximate curve connecting point A′, Example 3, and point B by the least square method.
The point on the line segment DC′ was determined by obtaining an approximate curve connecting point D, Example 6, and point C′ by the least square method.
The point on the line segment C′C was determined by obtaining an approximate curve connecting point C′, Example 4, and point C by the least square method.
Likewise, the results indicate that when coordinates (x,y,z) are within the range of a figure surrounded by line segments AA′, A′B, BF, FT, TE, EO, and OA that connect the following 7 points:
   point A (68.6, 0.0, 31.4),
   point A′ (30.6, 30.0, 39.4),
   point B (0.0, 58.7, 41.3),
   point F (0.0, 61.8, 38.2),
   point T (35.8, 44.9, 19.3),
   point E (58.0, 42.0, 0.0) and
   point O (100.0, 0.0, 0.0),
   or on the above line segments (excluding the points on the line EO);
   the line segment AA′ is represented by coordinates (x, 0.0016x²−0.9473x+57.497, −0.0016x²−0.0527x+42.503),
   the line segment A′B is represented by coordinates (x, 0.0029x²−1.0268x+58.7, −0.0029x²+0.0268x+41.3),
   the line segment FT is represented by coordinates (x, 0.0078x²−0.7501x+61.8, −0.0078x²−0.2499x+38.2), and
   the line segment TE is represented by coordinates (x, 0.0067x²−0.7607x+63.525, −0.0067x²−0.2393x+36.475), and
   the line segments BF, FO, and OA are straight lines,
   the refrigerant has a refrigerating capacity ratio of 85% or more relative to that of R410A, and a COP of 95% or more relative to that of R410A.
The point on the line segment FT was determined by obtaining an approximate curve connecting three points, i.e., points T, E′, and F, by the least square method.
The point on the line segment TE was determined by obtaining an approximate curve connecting three points, i.e., points E, R, and T, by the least square method.
The results in Tables 1 to 34 clearly indicate that in a ternary composition diagram of the mixed refrigerant of HFO-1132(E), HFO-1123, and R1234yf in which the sum of these components is 100 mass %, a line segment connecting a point (0.0, 100.0, 0.0) and a point (0.0, 0.0, 100.0) is the base, the point (0.0, 100.0, 0.0) is on the left side, and the point (0.0, 0.0, 100.0) is on the right side, when coordinates (x,y,z) are on or below the line segment LM connecting point L (63.1, 31.9, 5.0) and point M (60.3, 6.2, 33.5), the refrigerant has an RCL of 40 g/m³ or more.
The results in Tables 1 to 34 clearly indicate that in a ternary composition diagram of the mixed refrigerant of HFO-1132(E), HFO-1123 and R1234yf in which their sum is 100 mass %, a line segment connecting a point (0.0, 100.0, 0.0) and a point (0.0, 0.0, 100.0) is the base, the point (0.0, 100.0, 0.0) is on the left side, and the point (0.0, 0.0, 100.0) is on the right side, when coordinates (x,y,z) are on the line segment QR connecting point Q (62.8, 29.6, 7.6) and point R (49.8, 42.3, 7.9) or on the left side of the line segment, the refrigerant has a temperature glide of 1° C. or less.
The results in Tables 1 to 34 clearly indicate that in a ternary composition diagram of the mixed refrigerant of HFO-1132(E), HFO-1123, and R1234yf in which their sum is 100 mass %, a line segment connecting a point (0.0, 100.0, 0.0) and a point (0.0, 0.0, 100.0) is the base, the point (0.0, 100.0, 0.0) is on the left side, and the point (0.0, 0.0, 100.0) is on the right side, when coordinates (x,y,z) are on the line segment ST connecting point S (62.6, 28.3, 9.1) and point T (35.8, 44.9, 19.3) or on the right side of the line segment, the refrigerant has a discharge pressure of 105% or less relative to that of 410A.
In these compositions, R1234yf contributes to reducing flammability, and suppressing deterioration of polymerization etc. Therefore, the composition preferably contains R1234yf.
Further, the burning velocity of these mixed refrigerants whose mixed formulations were adjusted to WCF concentrations was measured according to the ANSI/ASHRAE Standard 34-2013. Compositions having a burning velocity of 10 cm/s or less were determined to be classified as “Class 2L (lower flammability).”
A burning velocity test was performed using the apparatus shown in FIG. 1 in the following manner. In FIG. 1, reference numeral 901 refers to a sample cell, 902 refers to a high-speed camera, 903 refers to a xenon lamp, 904 refers to a collimating lens, 905 refers to a collimating lens, and 906 refers to a ring filter. First, the mixed refrigerants used had a purity of 99.5% or more, and were degassed by repeating a cycle of freezing, pumping, and thawing until no traces of air were observed on the vacuum gauge. The burning velocity was measured by the closed method. The initial temperature was ambient temperature. Ignition was performed by generating an electric spark between the electrodes in the center of a sample cell. The duration of the discharge was 1.0 to 9.9 ms, and the ignition energy was typically about 0.1 to 1.0 J. The spread of the flame was visualized using schlieren photographs. A cylindrical container (inner diameter: 155 mm, length: 198 mm) equipped with two light transmission acrylic windows was used as the sample cell, and a xenon lamp was used as the light source. Schlieren images of the flame were recorded by a high-speed digital video camera at a frame rate of 600 fps and stored on a PC.
Each WCFF concentration was obtained by using the WCF concentration as the initial concentration and performing a leak simulation using NIST Standard Reference Database REFLEAK Version 4.0.
Tables 35 and 36 show the results.

TABLE 35

| Item | | Unit | G | H | I |
|---|---|---|---|---|---|
| WCF | HFO-1132(E) | mass % | 72.0 | 72.0 | 72.0 |
| | HFO-1123 | mass % | 28.0 | 9.6 | 0.0 |
| | R1234yf | mass % | 0.0 | 18.4 | 28.0 |

| | | | | |
|---|---|---|---|---|
| Burning velocity (WCF) | cm/s | 10 | 10 | 10 |

TABLE 36

| Item | | Unit | J | P | L | N | N′ | K |
|---|---|---|---|---|---|---|---|---|
| WCF | HFO- | mass % | 47.1 | 55.8 | 63.1 | 68.6 | 65.0 | 61.3 |
| | 1132 | | | | | | | |
| | (E) | | | | | | | |
| | HFO- | mass % | 52.9 | 42.0 | 31.9 | 16.3 | 7.7 | 5.4 |
| | 1123 | | | | | | | |
| | R1234yf | mass % | 0.0 | 2.2 | 5.0 | 15.1 | 27.3 | 33.3 |
| Leak condition that results | | | Storage/ | Storage/ | Storage/ | Storage/ | Storage/ | Storage/ |
| in WCFF | | | Shipping | Shipping | Shipping | Shipping | Shipping | Shipping, |
| | | | −40° C., | −40° C., | −40° C., | −40° C., | −40° C., | −40° C., |
| | | | 92% | 90% | 90% | 66% | 12% | 0% |
| | | | release, | release, | release, | release, | release, | release, |
| | | | liquid | liquid | gas | gas | gas | gas |
| | | | phase | phase | phase | phase | phase | phase |
| | | | side | side | side | side | side | side |
| WCFF | HFO- | mass % | 72.0 | 72.0 | 72.0 | 72.0 | 72.0 | 72.0 |
| | 1132 | | | | | | | |
| | (E) | | | | | | | |
| | HFO- | mass % | 28.0 | 17.8 | 17.4 | 13.6 | 12.3 | 9.8 |
| | 1123 | | | | | | | |
| | R1234yf | mass % | 0.0 | 10.2 | 10.6 | 14.4 | 15.7 | 18.2 |

| | | | | | | | |
|---|---|---|---|---|---|---|---|
| Burning | cm/s | 8 or less | 8 or less | 8 or less | 9 | 9 | 8 or less |
| velocity (WCF) | | | | | | | |
| Burning | cm/s | 10 | 10 | 10 | 10 | 10 | 10 |
| velocity (WCFF) | | | | | | | |

The results in Table 35 clearly indicate that when a mixed refrigerant of HFO-1132(E), HFO-1123, and R1234yf contains HFO-1132(E) in a proportion of 72.0 mass % or less based on their sum, the refrigerant can be determined to have a WCF lower flammability.
The results in Tables 36 clearly indicate that in a ternary composition diagram of a mixed refrigerant of HFO-1132(E), HFO-1123, and R1234yf in which their sum is 100 mass %, and a line segment connecting a point (0.0, 100.0, 0.0) and a point (0.0, 0.0, 100.0) is the base, when coordinates (x,y,z) are on or below the line segments JP, PN, and NK connecting the following 6 points:
   point J (47.1, 52.9, 0.0),
   point P (55.8, 42.0, 2.2),
   point L (63.1, 31.9, 5.0)
   point N (68.6, 16.3, 15.1)
   point N′ (65.0, 7.7, 27.3) and
   point K (61.3, 5.4, 33.3),
   the refrigerant can be determined to have a WCF lower flammability, and a WCFF lower flammability.
   In the diagram, the line segment PN is represented by coordinates (x, −0.1135x²+12.112x−280.43, 0.1135x²−13.112x+380.43), and the line segment NK is represented by coordinates (x, 0.2421x²−29.955x+931.91, −0.2421x²+28.955x−831.91).
   The point on the line segment PN was determined by obtaining an approximate curve connecting three points, i.e., points P, L, and N, by the least square method.
The point on the line segment NK was determined by obtaining an approximate curve connecting three points, i.e., points N, N′, and K, by the least square method.

### (5-2) Refrigerant B

The refrigerant B according to the present disclosure is
a mixed refrigerant comprising trans-1,2-difluoroethylene (HFO-1132(E)) and trifluoroethylene (HFO-1123) in a total amount of 99.5 mass % or more based on the entire refrigerant, and the refrigerant comprising 62.0 mass % to 72.0 mass % or 45.1 mass % to 47.1 mass % of HFO-1132(E) based on the entire refrigerant, or
a mixed refrigerant comprising HFO-1132(E) and HFO-1123 in a total amount of 99.5 mass % or more based on the entire refrigerant, and the refrigerant comprising 45.1 mass % to 47.1 mass % of HFO-1132(E) based on the entire refrigerant.
The refrigerant B according to the present disclosure has various properties that are desirable as an R410A-alternative refrigerant, i.e., (1) a coefficient of performance equivalent to that of R410A, (2) a refrigerating capacity equivalent to that of R410A, (3) a sufficiently low GWP, and (4) a lower flammability (Class 2L) according to the ASHRAE standard.
When the refrigerant B according to the present disclosure is a mixed refrigerant comprising 72.0 mass % or less of HFO-1132(E), it has WCF lower flammability. When the refrigerant B according to the present disclosure is a composition comprising 47.1% or less of HFO-1132(E), it has WCF lower flammability and WCFF lower flammability, and is determined to be “Class 2L,” which is a lower flammable refrigerant according to the ASHRAE standard, and which is further easier to handle.
When the refrigerant B according to the present disclosure comprises 62.0 mass % or more of HFO-1132(E), it becomes superior with a coefficient of performance of 95% or more relative to that of R410A, the polymerization reaction of HFO-1132(E) and/or HFO-1123 is further suppressed, and the stability is further improved. When the refrigerant B according to the present disclosure comprises 45.1 mass % or more of HFO-1132(E), it becomes superior with a coefficient of performance of 93% or more relative to that of R410A, the polymerization reaction of HFO-1132(E) and/or HFO-1123 is further suppressed, and the stability is further improved.
The refrigerant B according to the present disclosure may further comprise other additional refrigerants in addition to HFO-1132(E) and HFO-1123, as long as the above properties and effects are not impaired. In this respect, the refrigerant according to the present disclosure preferably comprises HFO-1132(E) and HFO-1123 in a total amount of 99.75 mass % or more, and more preferably 99.9 mass % or more, based on the entire refrigerant.
Such additional refrigerants are not limited, and can be selected from a wide range of refrigerants. The mixed refrigerant may comprise a single additional refrigerant, or two or more additional refrigerants.

### (Examples of Refrigerant B)

The present disclosure is described in more detail below with reference to Examples of refrigerant B. However, the refrigerant B is not limited to the Examples.
Mixed refrigerants were prepared by mixing HFO-1132(E) and HFO-1123 at mass % based on their sum shown in Tables 37 and 38.
The GWP of compositions each comprising a mixture of R410A (R32=50%/R125=50%) was evaluated based on the values stated in the Intergovernmental Panel on Climate Change (IPCC), fourth report. The GWP of HFO-1132(E), which was not stated therein, was assumed to be 1 from HFO-1132a (GWP=1 or less) and HFO-1123 (GWP=0.3, described in Patent Literature 1). The refrigerating capacity of compositions each comprising R410A and a mixture of HFO-1132(E) and HFO-1123 was determined by performing theoretical refrigeration cycle calculations for the mixed refrigerants using the National Institute of Science and Technology (NIST) and Reference Fluid Thermodynamic and Transport Properties Database (Refprop 9.0) under the following conditions.
   Evaporating temperature: 5° C.
   Condensation temperature: 45° C.
   Superheating temperature: 5 K
   Subcooling temperature: 5 K
   Compressor efficiency: 70%
The composition of each mixture was defined as WCF. A leak simulation was performed using NIST Standard Reference Data Base Refleak Version 4.0 under the conditions of Equipment, Storage, Shipping, Leak, and Recharge according to the ASHRAE Standard 34-2013. The most flammable fraction was defined as WCFF.
Tables 1 and 2 show GWP, COP, and refrigerating capacity, which were calculated based on these results. The COP and refrigerating capacity are ratios relative to R410A.
The coefficient of performance (COP) was determined by the following formula.

COP=(refrigerating capacity or heating capacity)/power consumption
For the flammability, the burning velocity was measured according to the ANSI/ASHRAE Standard 34-2013. Both WCF and WCFF having a burning velocity of 10 cm/s or less were determined to be “Class 2L (lower flammability).”
A burning velocity test was performed using the apparatus shown in FIG. 1 in the following manner. First, the mixed refrigerants used had a purity of 99.5% or more, and were degassed by repeating a cycle of freezing, pumping, and thawing until no traces of air were observed on the vacuum gauge. The burning velocity was measured by the closed method. The initial temperature was ambient temperature. Ignition was performed by generating an electric spark between the electrodes in the center of a sample cell. The duration of the discharge was 1.0 to 9.9 ms, and the ignition energy was typically about 0.1 to 1.0 J. The spread of the flame was visualized using schlieren photographs. A cylindrical container (inner diameter: 155 mm, length: 198 mm) equipped with two light transmission acrylic windows was used as the sample cell, and a xenon lamp was used as the light source. Schlieren images of the flame were recorded by a high-speed digital video camera at a frame rate of 600 fps and stored on a PC.

TABLE 37

| | | | Comparative | | | | | | | |
|---|---|---|---|---|---|---|---|---|---|---|
| | | Comparative | Example | | | | | | | |
| | | Example | 2 | Comparative | | | | | | Comparative |
| | | 1 | HFO- | Example | Example | Example | Example | Example | Example | Example |
| Item | Unit | R410A | 1132E | 3 | 1 | 2 | 3 | 4 | 5 | 4 |
| HFO-1132E | mass % | — | 100 | 80 | 72 | 70 | 68 | 65 | 62 | 60 |
| (WCF) | | | | | | | | | | |
| HFO-1123 | mass % | — | 0 | 20 | 28 | 30 | 32 | 35 | 38 | 40 |
| (WCF) | | | | | | | | | | |
| GWP | — | 2088 | 1 | 1 | 1 | 1 | 1 | 1 | 1 | 1 |
| COP ratio | % | 100 | 99.7 | 97.5 | 96.6 | 96.3 | 96.1 | 95.8 | 95.4 | 95.2 |
| | (relative | | | | | | | | | |
| | to R410A) | | | | | | | | | |
| Refrigerating | % | 100 | 98.3 | 101.9 | 103.1 | 103.4 | 103.8 | 104.1 | 104.5 | 104.8 |
| capacity | (relative | | | | | | | | | |
| ratio | to R410A) | | | | | | | | | |
| Discharge | Mpa | 2.73 | 2.71 | 2.89 | 2.96 | 2.98 | 3.00 | 3.02 | 3.04 | 3.06 |
| pressure | | | | | | | | | | |
| Burning | cm/sec | Non- | 20 | 13 | 10 | 9 | 9 | 8 | 8 or | 8 or less |
| velocity | | flammable | | | | | | | less | |
| (WCF) | | | | | | | | | | |

TABLE 38

| | | | | | | | | | | Comparative |
|---|---|---|---|---|---|---|---|---|---|---|
| | | Comparative | Comparative | | | | Comparative | Comparative | Comparative | Example |
| | | Example | Example | Example | Example | Example | Example | Example | Example | 10 |
| Item | Unit | 5 | 6 | 7 | 8 | 9 | 7 | 8 | 9 | HFO-1123 |
| HFO- | mass % | 50 | 48 | 47.1 | 46.1 | 45.1 | 43 | 40 | 25 | 0 |
| 1132E | | | | | | | | | | |
| (WCF) | | | | | | | | | | |
| HFO-1123 | mass % | 50 | 52 | 52.9 | 53.9 | 54.9 | 57 | 60 | 75 | 100 |
| (WCF) | | | | | | | | | | |
| GWP | — | 1 | 1 | 1 | 1 | 1 | 1 | 1 | 1 | 1 |
| COP ratio | % | 94.1 | 93.9 | 93.8 | 93.7 | 93.6 | 93.4 | 93.1 | 91.9 | 90.6 |
| | (relative | | | | | | | | | |
| | to | | | | | | | | | |
| | R410A) | | | | | | | | | |
| Refrigerating | % | 105.9 | 106.1 | 106.2 | 106.3 | 106.4 | 106.6 | 106.9 | 107.9 | 108.0 |
| capacity | (relative | | | | | | | | | |
| ratio | to | | | | | | | | | |
| | R410A) | | | | | | | | | |
| Discharge | Mpa | 3.14 | 3.16 | 3.16 | 3.17 | 3.18 | 3.20 | 3.21 | 3.31 | 3.39 |
| pressure | | | | | | | | | | |
| Leakage test | | Storage/ | Storage/ | Storage/ | Storage/ | Storage/ | Storage/ | Storage/ | Storage/ | — |
| conditions (WCFF) | | Shipping | Shipping | Shipping | Shipping | Shipping | Shipping | Shipping | Shipping | |
| | | −40° C., | −40° C., | −40° C., | −40° C., | −40° C., | −40° C., | −40° C., | −40° C., | |
| | | 92% | 92% | 92% | 92% | 92% | 92% | 92% | 90% | |
| | | release, | release, | release, | release, | release, | release, | release, | release, | |
| | | liquid | liquid | liquid | liquid | liquid | liquid | liquid | liquid | |
| | | phase | phase | phase | phase | phase | phase | phase | phase | |
| | | side | side | side | side | side | side | side | side | |
| HFO- | mass % | 74 | 73 | 72 | 71 | 70 | 67 | 63 | 38 | — |
| 1132E | | | | | | | | | | |
| (WCFF) | | | | | | | | | | |
| HFO-1123 | mass % | 26 | 27 | 28 | 29 | 30 | 33 | 37 | 62 | |
| (WCFF) | | | | | | | | | | |
| Burning | cm/sec | 8 or less | 8 or less | 8 or | 8 or | 8 or | 8 or less | 8 or less | 8 or less | 5 |
| velocity | | | | less | less | less | | | | |
| (WCF) | | | | | | | | | | |
| Burning | cm/sec | 11 | 10.5 | 10.0 | 9.5 | 9.5 | 8.5 | 8 or less | 8 or less | |
| velocity | | | | | | | | | | |
| (WCFF) | | | | | | | | | | |

| | | | | | | | | | |
|---|---|---|---|---|---|---|---|---|---|
| ASHRAE flammability | 2 | 2 | 2 L | 2 L | 2 L | 2 L | 2 L | 2 L | 2 L |
| classification | | | | | | | | | |

The compositions each comprising 62.0 mass % to 72.0 mass % of HFO-1132(E) based on the entire composition are stable while having a low GWP (GWP=1), and they ensure WCF lower flammability. Further, surprisingly, they can ensure performance equivalent to that of R410A. Moreover, compositions each comprising 45.1 mass % to 47.1 mass % of HFO-1132(E) based on the entire composition are stable while having a low GWP (GWP=1), and they ensure WCFF lower flammability. Further, surprisingly, they can ensure performance equivalent to that of R410A.

### (5-3) Refrigerant C

The refrigerant C according to the present disclosure is a composition comprising trans-1,2-difluoroethylene (HFO-1132(E)), trifluoroethylene (HFO-1123), 2,3,3,3-tetrafluoro-1-propene (R1234yf), and difluoromethane (R32), and satisfies the following requirements. The refrigerant C according to the present disclosure has various properties that are desirable as an alternative refrigerant for R410A; i.e. it has a coefficient of performance and a refrigerating capacity that are equivalent to those of R410A, and a sufficiently low GWP.

### Requirements

Preferable refrigerant C is as follows:
When the mass % of HFO-1132(E), HFO-1123, R1234yf, and R32 based on their sum is respectively represented by x, y, z, and a,
if 0<a≤11.1, coordinates (x,y,z) in a ternary composition diagram in which the sum of HFO-1132(E), HFO-1123, and R1234yf is (100−a) mass % are within the range of a figure surrounded by straight lines GI, IA, AB, BD′, D′C, and CG that connect the following 6 points:
   point G (0.026a²−1.7478a+72.0, −0.026a²+0.7478a+28.0, 0.0),
   point I (0.026a²−1.7478a+72.0, 0.0, −0.026a²+0.7478a+28.0),
   point A (0.0134a²−1.9681a+68.6, 0.0, −0.0134a²+0.9681a+31.4),
   point B (0.0, 0.0144a²−1.6377a+58.7, −0.0144a²+0.6377a+41.3),
   point D′ (0.0, 0.0224a²+0.968a+75.4, −0.0224a²−1.968a+24.6), and
   point C (−0.2304a²−0.4062a+32.9, 0.2304a²−0.5938a+67.1, 0.0),
   or on the straight lines GI, AB, and D′C (excluding point G, point I, point A, point B, point D′, and point C);
if 11.1<a≤18.2, coordinates (x,y,z) in the ternary composition diagram are within the range of a figure surrounded by straight lines GI, IA, AB, BW, and WG that connect the following 5 points:
   point G (0.02a²−1.6013a+71.105, −0.02a²+0.6013a+28.895, 0.0),
   point I (0.02a²−1.6013a+71.105, 0.0, −0.02a²+0.6013a+28.895),
   point A (0.0112a²−1.9337a+68.484, 0.0, −0.0112a²+0.9337a+31.516),
   point B (0.0, 0.0075a²−1.5156a+58.199, −0.0075a²+0.5156a+41.801) and point W (0.0, 100.0−a, 0.0),
   or on the straight lines GI and AB (excluding point G, point I, point A, point B, and point W);
if 18.2<a≤26.7, coordinates (x,y,z) in the ternary composition diagram are within the range of a figure surrounded by straight lines GI, IA, AB, BW, and WG that connect the following 5 points:
   point G (0.0135a²−1.4068a+69.727, −0.0135a²+0.4068a+30.273, 0.0),
   point I (0.0135a²−1.4068a+69.727, 0.0, −0.0135a²+0.4068a+30.273),
   point A (0.0107a²−1.9142a+68.305, 0.0, −0.0107a²+0.9142a+31.695),
   point B (0.0, 0.009a²−1.6045a+59.318, −0.009a²+0.6045a+40.682) and point W (0.0, 100.0−a, 0.0),
   or on the straight lines GI and AB (excluding point G, point I, point A, point B, and point W);
if 26.7<a≤36.7, coordinates (x,y,z) in the ternary composition diagram are within the range of a figure surrounded by straight lines GI, IA, AB, BW, and WG that connect the following 5 points:
   point G (0.0111a²−1.3152a+68.986, −0.0111a²+0.3152a+31.014, 0.0),
   point I (0.0111a²−1.3152a+68.986, 0.0, −0.0111a²+0.3152a+31.014),
   point A (0.0103a²−1.9225a+68.793, 0.0, −0.0103a²+0.9225a+31.207),
   point B (0.0, 0.0046a²−1.41a+57.286, −0.0046a²+0.41a+42.714) and point W (0.0, 100.0−a, 0.0),
   or on the straight lines GI and AB (excluding point G, point I, point A, point B, and point W); and
if 36.7<a≤46.7, coordinates (x,y,z) in the ternary composition diagram are within the range of a figure surrounded by straight lines GI, IA, AB, BW, and WG that connect the following 5 points:
   point G (0.0061a²−0.9918a+63.902, −0.0061a²−0.0082a+36.098, 0.0),
   point I (0.0061a²−0.9918a+63.902, 0.0, −0.0061a²−0.0082a+36.098),
   point A (0.0085a²−1.8102a+67.1, 0.0, −0.0085a²+0.8102a+32.9),
   point B (0.0, 0.0012a²−1.1659a+52.95, −0.0012a²+0.1659a+47.05) and
   point W (0.0, 100.0−a, 0.0),
   or on the straight lines GI and AB (excluding point G, point I, point A, point B, and point W). When the refrigerant according to the present disclosure satisfies the above requirements, it has a refrigerating capacity ratio of 85% or more relative to that of R410A, and a COP ratio of 92.5% or more relative to that of R410A, and further ensures a WCF lower flammability.
The refrigerant C according to the present disclosure is preferably a refrigerant
   wherein
when the mass % of HFO-1132(E), HFO-1123, and R1234yf based on their sum is respectively represented by x, y, and z,
if 0<a≤11.1, coordinates (x,y,z) in a ternary composition diagram in which the sum of HFO-1132(E), HFO-1123, and R1234yf is (100−a) mass % are within the range of a figure surrounded by straight lines JK′, K′B, BD′, D′C, and CJ that connect the following 5 points:
   point J (0.0049a²−0.9645a+47.1, −0.0049a²−0.0355a+52.9, 0.0),
   point K′ (0.0514a²−2.4353a+61.7, −0.0323a²+0.4122a+5.9, −0.0191a²+1.0231a+32.4),
   point B (0.0, 0.0144a²−1.6377a+58.7, −0.0144a²+0.6377a+41.3),
   point D′ (0.0, 0.0224a²+0.968a+75.4, −0.0224a²−1.968a+24.6), and
   point C (−0.2304a²−0.4062a+32.9, 0.2304a²−0.5938a+67.1, 0.0),
   or on the straight lines JK′, K′B, and D′C (excluding point J, point B, point D′, and point C);
if 11.1<a≤18.2, coordinates (x,y,z) in the ternary composition diagram are within the range of a figure surrounded by straight lines JK′, K′B, BW, and WJ that connect the following 4 points:
   point J (0.0243a²−1.4161a+49.725, −0.0243a²+0.4161a+50.275, 0.0),
   point K′ (0.0341a²−2.1977a+61.187, −0.0236a²+0.34a+5.636,−0.0105a²+0.8577a+33.177),
   point B (0.0, 0.0075a²−1.5156a+58.199, −0.0075a²+0.5156a+41.801) and
   point W (0.0, 100.0−a, 0.0),
   or on the straight lines JK′ and K′B (excluding point J, point B, and point W);
if 18.2<a≤26.7, coordinates (x,y,z) in the ternary composition diagram are within the range of a figure surrounded by straight lines JK′, K′B, BW, and WJ that connect the following 4 points:
   point J (0.0246a²−1.4476a+50.184, −0.0246a²+0.4476a+49.816, 0.0),
   point K′ (0.0196a²−1.7863a+58.515, −0.0079a²−0.1136a+8.702, −0.0117a²+0.8999a+32.783),
   point B (0.0, 0.009a²−1.6045a+59.318, −0.009a²+0.6045a+40.682) and point W (0.0, 100.0−a, 0.0),
   or on the straight lines JK′ and K′B (excluding point J, point B, and point W);
if 26.7<a≤36.7, coordinates (x,y,z) in the ternary composition diagram are within the range of a figure surrounded by straight lines JK′, K′A, AB, BW, and WJ that connect the following 5 points:
   point J (0.0183a²−1.1399a+46.493, −0.0183a²+0.1399a+53.507, 0.0),
   point K′ (−0.0051a²+0.0929a+25.95, 0.0, 0.0051a²−1.0929a+74.05),
   point A (0.0103a²−1.9225a+68.793, 0.0, −0.0103a²+0.9225a+31.207),
   point B (0.0, 0.0046a²−1.41a+57.286, −0.0046a²+0.41a+42.714) and
   point W (0.0, 100.0−a, 0.0),
   or on the straight lines JK′, K′A, and AB (excluding point J, point B, and point W); and
if 36.7<a≤46.7, coordinates (x,y,z) in the ternary composition diagram are within the range of a figure surrounded by straight lines JK′, K′A, AB, BW, and WJ that connect the following 5 points:
   point J (−0.0134a²+1.0956a+7.13, 0.0134a²−2.0956a+92.87, 0.0),
   point K′ (−1.892a+29.443, 0.0, 0.892a+70.557),
   point A (0.0085a²−1.8102a+67.1, 0.0, −0.0085a²+0.8102a+32.9),
   point B (0.0, 0.0012a²−1.1659a+52.95, −0.0012a²+0.1659a+47.05) and
   point W (0.0, 100.0−a, 0.0),
   or on the straight lines JK′, K′A, and AB (excluding point J, point B, and point W). When the refrigerant according to the present disclosure satisfies the above requirements, it has a refrigerating capacity ratio of 85% or more relative to that of R410A, and a COP ratio of 92.5% or more relative to that of R410A. Additionally, the refrigerant has a WCF lower flammability and a WCFF lower flammability, and is classified as “Class 2L,” which is a lower flammable refrigerant according to the ASHRAE standard.
When the refrigerant C according to the present disclosure further contains R32 in addition to HFO-1132 (E), HFO-1123, and R1234yf, the refrigerant may be a refrigerant wherein when the mass % of HFO-1132(E), HFO-1123, R1234yf, and R32 based on their sum is respectively represented by x, y, z, and a,
if 0<a≤10.0, coordinates (x,y,z) in a ternary composition diagram in which the sum of HFO-1132(E), HFO-1123, and R1234yf is (100−a) mass % are within the range of a figure surrounded by straight lines that connect the following 4 points:
   point a (0.02a²−2.46a+93.4, 0, −0.02a²+2.46a+6.6),
   point b′ (−0.008a²−1.38a+56, 0.018a²−0.53a+26.3, −0.01a²+1.91a+17.7),
   point c (−0.016a²+1.02a+77.6, 0.016a²−1.02a+22.4, 0), and
   point o (100.0−a, 0.0, 0.0)
   or on the straight lines oa, ab′, and b′c (excluding point o and point c);
if 10.0<a≤16.5, coordinates (x,y,z) in the ternary composition diagram are within the range of a figure surrounded by straight lines that connect the following 4 points:
   point a (0.0244a²−2.5695a+94.056, 0, −0.0244a²+2.5695a+5.944),
   point b′ (0.1161a²−1.9959a+59.749, 0.014a²−0.3399a+24.8, −0.1301a²+2.3358a+15.451),
   point c (−0.0161a²+1.02a+77.6, 0.0161a²−1.02a+22.4, 0), and
   point o (100.0−a, 0.0, 0.0),
   or on the straight lines oa, ab′, and b′c (excluding point o and point c); or
if 16.5<a≤21.8, coordinates (x,y,z) in the ternary composition diagram are within the range of a figure surrounded by straight lines that connect the following 4 points:
   point a (0.0161a²−2.3535a+92.742, 0, −0.0161a²+2.3535a+7.258),
   point b′ (−0.0435a²−0.0435a+50.406, 0.0304a²+1.8991a−0.0661, 0.0739a²−1.8556a+49.6601),
   point c (−0.0161a²+0.9959a+77.851, 0.0161a²−0.9959a+22.149, 0), and
   point o (100.0−a, 0.0, 0.0),
   or on the straight lines oa, ab′, and b′c (excluding point o and point c). Note that when point b in the ternary composition diagram is defined as a point where a refrigerating capacity ratio of 95% relative to that of R410A and a COP ratio of 95% relative to that of R410A are both achieved, point b′ is the intersection of straight line ab and an approximate line formed by connecting the points where the COP ratio relative to that of R410A is 95%. When the refrigerant according to the present disclosure meets the above requirements, the refrigerant has a refrigerating capacity ratio of 95% or more relative to that of R410A, and a COP ratio of 95% or more relative to that of R410A.
The refrigerant C according to the present disclosure may further comprise other additional refrigerants in addition to HFO-1132(E), HFO-1123, R1234yf, and R32 as long as the above properties and effects are not impaired. In this respect, the refrigerant according to the present disclosure preferably comprises HFO-1132(E), HFO-1123, R1234yf, and R32 in a total amount of 99.5 mass % or more, more preferably 99.75 mass % or more, and still more preferably 99.9 mass % or more, based on the entire refrigerant.
The refrigerant C according to the present disclosure may comprise HFO-1132(E), HFO-1123, R1234yf, and R32 in a total amount of 99.5 mass % or more, 99.75 mass % or more, or 99.9 mass % or more, based on the entire refrigerant.
Additional refrigerants are not particularly limited and can be widely selected. The mixed refrigerant may contain one additional refrigerant, or two or more additional refrigerants.

### (Examples of Refrigerant C)

The present disclosure is described in more detail below with reference to Examples of refrigerant C. However, the refrigerant C is not limited to the Examples.
Mixed refrigerants were prepared by mixing HFO-1132(E), HFO-1123, R1234yf, and R32 at mass % based on their sum shown in Tables 39 to 96.
The GWP of compositions each comprising a mixture of R410A (R32=50%/R125=50%) was evaluated based on the values stated in the Intergovernmental Panel on Climate Change (IPCC), fourth report. The GWP of HFO-1132(E), which was not stated therein, was assumed to be 1 from HFO-1132a (GWP=1 or less) and HFO-1123 (GWP=0.3, described in Patent Literature 1). The refrigerating capacity of compositions each comprising R410A and a mixture of HFO-1132(E) and HFO-1123 was determined by performing theoretical refrigeration cycle calculations for the mixed refrigerants using the National Institute of Science and Technology (NIST) and Reference Fluid Thermodynamic and Transport Properties Database (Refprop 9.0) under the following conditions.
For each of these mixed refrigerants, the COP ratio and the refrigerating capacity ratio relative to those of R410 were obtained. Calculation was conducted under the following conditions.
Evaporating temperature: 5° C.
Condensation temperature: 45° C.
Superheating temperature: 5 K
Subcooling temperature: 5 K
Compressor efficiency: 70%
Tables 39 to 96 show the resulting values together with the GWP of each mixed refrigerant. The COP and refrigerating capacity are ratios relative to R410A.
The coefficient of performance (COP) was determined by the following formula.

COP=(refrigerating capacity or heating capacity)/power consumption

TABLE 39

| | | | Comp. | Comp. | Comp. | Comp. | Comp. | Comp. | Comp. | |
|---|---|---|---|---|---|---|---|---|---|---|
| | | Comp. | Ex. 2 | Ex. 3 | Ex. 4 | Ex. 5 | Ex. 6 | Ex. 7 | Ex. 8 | Ex. 1 |
| Item | Unit | Ex. 1 | A | B | C | D′ | G | I | J | K′ |
| HFO-1132(E) | Mass % | R410A | 68.6 | 0.0 | 32.9 | 0.0 | 72.0 | 72.0 | 47.1 | 61.7 |
| HFO-1123 | Mass % | | 0.0 | 58.7 | 67.1 | 75.4 | 28.0 | 0.0 | 52.9 | 5.9 |
| R1234yf | Mass % | | 31.4 | 41.3 | 0.0 | 24.6 | 0.0 | 28.0 | 0.0 | 32.4 |
| R32 | Mass % | | 0.0 | 0.0 | 0.0 | 0.0 | 0.0 | 0.0 | 0.0 | 0.0 |
| GWP | — | 2088 | 2 | 2 | 1 | 2 | 1 | 2 | 1 | 2 |
| COP ratio | % (relative to | 100 | 100.0 | 95.5 | 92.5 | 93.1 | 96.6 | 99.9 | 93.8 | 99.4 |
| | R410A) | | | | | | | | | |
| Refrigerating | % (relative to | 100 | 85.0 | 85.0 | 107.4 | 95.0 | 103.1 | 86.6 | 106.2 | 85.5 |
| capacity ratio | R410A) | | | | | | | | | |

TABLE 40

| | | Comp. | Comp. | Comp. | Comp. | Comp. | Comp. | Comp. | |
|---|---|---|---|---|---|---|---|---|---|
| | | Ex. 9 | Ex. 10 | Ex. 11 | Ex. 12 | Ex. 13 | Ex. 14 | Ex. 15 | Ex. 2 |
| Item | Unit | A | B | C | D′ | G | I | J | K′ |
| HFO-1132 | Mass % | 55.3 | 0.0 | 18.4 | 0.0 | 60.9 | 60.9 | 40.5 | 47.0 |
| (E) | | | | | | | | | |
| HFO-1123 | Mass % | 0.0 | 47.8 | 74.5 | 83.4 | 32.0 | 0.0 | 52.4 | 7.2 |
| R1234yf | Mass % | 37.6 | 45.1 | 0.0 | 9.5 | 0.0 | 32.0 | 0.0 | 38.7 |
| R32 | Mass % | 7.1 | 7.1 | 7.1 | 7.1 | 7.1 | 7.1 | 7.1 | 7.1 |
| GWP | — | 50 | 50 | 49 | 49 | 49 | 50 | 49 | 50 |
| COP ratio | % | 99.8 | 96.9 | 92.5 | 92.5 | 95.9 | 99.6 | 94.0 | 99.2 |
| | (relative | | | | | | | | |
| | to | | | | | | | | |
| | R410A) | | | | | | | | |
| Refrigerating | % | 85.0 | 85.0 | 110.5 | 106.0 | 106.5 | 87.7 | 108.9 | 85.5 |
| capacity ratio | (relative | | | | | | | | |
| | to | | | | | | | | |
| | R410A) | | | | | | | | |

TABLE 41

| | | Comp. Ex. | Comp. Ex. | Comp. Ex. | Comp. Ex. | Comp. Ex. | Comp. Ex. | |
|---|---|---|---|---|---|---|---|---|
| | | 16 | 17 | 18 | 19 | 20 | 21 | Ex. 3 |
| Item | Unit | A | B | C = D′ | G | I | J | K′ |
| HFO-1132(E) | Mass % | 48.4 | 0.0 | 0.0 | 55.8 | 55.8 | 37.0 | 41.0 |
| HFO-1123 | Mass % | 0.0 | 42.3 | 88.9 | 33.1 | 0.0 | 51.9 | 6.5 |
| R1234yf | Mass % | 40.5 | 46.6 | 0.0 | 0.0 | 33.1 | 0.0 | 41.4 |
| R32 | Mass % | 11.1 | 11.1 | 11.1 | 11.1 | 11.1 | 11.1 | 11.1 |
| GWP | — | 77 | 77 | 76 | 76 | 77 | 76 | 77 |
| COP ratio | % | 99.8 | 97.6 | 92.5 | 95.8 | 99.5 | 94.2 | 99.3 |
| | (relative | | | | | | | |
| | to R410A) | | | | | | | |
| Refrigerating | % | 85.0 | 85.0 | 112.0 | 108.0 | 88.6 | 110.2 | 85.4 |
| capacity ratio | (relative | | | | | | | |
| | to R410A) | | | | | | | |

TABLE 42

| | | | | | | Comp. Ex. | |
|---|---|---|---|---|---|---|---|
| | | Comp. Ex. 22 | Comp. Ex. 23 | Comp. Ex. 24 | Comp. Ex. 25 | 26 | Ex. 4 |
| Item | Unit | A | B | G | I | J | K' |
| HFO-1132(E) | Mass % | 42.8 | 0.0 | 52.1 | 52.1 | 34.3 | 36.5 |
| HFO-1123 | Mass % | 0.0 | 37.8 | 33.4 | 0.0 | 51.2 | 5.6 |
| R1234yf | Mass % | 42.7 | 47.7 | 0.0 | 33.4 | 0.0 | 43.4 |
| R32 | Mass % | 14.5 | 14.5 | 14.5 | 14.5 | 14.5 | 14.5 |
| GWP | — | 100 | 100 | 99 | 100 | 99 | 100 |
| COP ratio | % (relative to | 99.9 | 98.1 | 95.8 | 99.5 | 94.4 | 99.5 |
| | R410A) | | | | | | |
| Refrigerating | % (relative to | 85.0 | 85.0 | 109.1 | 89.6 | 111.1 | 85.3 |
| capacity ratio | R410A) | | | | | | |

TABLE 43

| | | | | | | Comp. Ex. | |
|---|---|---|---|---|---|---|---|
| | | Comp. Ex. 27 | Comp. Ex. 28 | Comp. Ex. 29 | Comp. Ex. 30 | 31 | Ex. 5 |
| Item | Unit | A | B | G | I | J | K' |
| HFO-1132(E) | Mass % | 37.0 | 0.0 | 48.6 | 48.6 | 32.0 | 32.5 |
| HFO-1123 | Mass % | 0.0 | 33.1 | 33.2 | 0.0 | 49.8 | 4.0 |
| R1234yf | Mass % | 44.8 | 48.7 | 0.0 | 33.2 | 0.0 | 45.3 |
| R32 | Mass % | 18.2 | 18.2 | 18.2 | 18.2 | 18.2 | 18.2 |
| GWP | — | 125 | 125 | 124 | 125 | 124 | 125 |
| COP ratio | % (relative to | 100.0 | 98.6 | 95.9 | 99.4 | 94.7 | 99.8 |
| | R410A) | | | | | | |
| Refrigerating | % (relative to | 85.0 | 85.0 | 110.1 | 90.8 | 111.9 | 85.2 |
| capacity ratio | R410A) | | | | | | |

TABLE 44

| | | | Comp. Ex. | | | | |
|---|---|---|---|---|---|---|---|
| | | Comp. Ex. 32 | 33 | Comp. Ex. 34 | Comp. Ex. 35 | Comp. Ex. 36 | Ex. 6 |
| Item | Unit | A | B | G | I | J | K′ |
| HFO-1132(E) | Mass % | 31.5 | 0.0 | 45.4 | 45.4 | 30.3 | 28.8 |
| HFO-1123 | Mass % | 0.0 | 28.5 | 32.7 | 0.0 | 47.8 | 2.4 |
| R1234yf | Mass % | 46.6 | 49.6 | 0.0 | 32.7 | 0.0 | 46.9 |
| R32 | Mass % | 21.9 | 21.9 | 21.9 | 21.9 | 21.9 | 21.9 |
| GWP | — | 150 | 150 | 149 | 150 | 149 | 150 |
| COP ratio | % (relative to | 100.2 | 99.1 | 96.0 | 99.4 | 95.1 | 100.0 |
| | R410A) | | | | | | |
| Refrigerating | % (relative to | 85.0 | 85.0 | 111.0 | 92.1 | 112.6 | 85.1 |
| capacity ratio | R410A) | | | | | | |

TABLE 45

| | | Comp. Ex. | Comp. Ex. | Comp. Ex. | Comp. Ex. | Comp. Ex. | Comp. Ex. |
|---|---|---|---|---|---|---|---|
| | | 37 | 38 | 39 | 40 | 41 | 42 |
| Item | Unit | A | B | G | I | J | K′ |
| HFO-1132(E) | Mass % | 24.8 | 0.0 | 41.8 | 41.8 | 29.1 | 24.8 |
| HFO-1123 | Mass % | 0.0 | 22.9 | 31.5 | 0.0 | 44.2 | 0.0 |
| R1234yf | Mass % | 48.5 | 50.4 | 0.0 | 31.5 | 0.0 | 48.5 |
| R32 | Mass % | 26.7 | 26.7 | 26.7 | 26.7 | 26.7 | 26.7 |
| GWP | — | 182 | 182 | 181 | 182 | 181 | 182 |
| COP ratio | % (relative to | 100.4 | 99.8 | 96.3 | 99.4 | 95.6 | 100.4 |
| | R410A) | | | | | | |
| Refrigerating capacity | % (relative to | 85.0 | 85.0 | 111.9 | 93.8 | 113.2 | 85.0 |
| ratio | R410A) | | | | | | |

TABLE 46

| | | Comp. Ex. | Comp. Ex. | Comp. Ex. | Comp. Ex. | Comp. Ex. | Comp. Ex. |
|---|---|---|---|---|---|---|---|
| | | 43 | 44 | 45 | 46 | 47 | 48 |
| Item | Unit | A | B | G | I | J | K′ |
| HFO-1132(E) | Mass % | 21.3 | 0.0 | 40.0 | 40.0 | 28.8 | 24.3 |
| HFO-1123 | Mass % | 0.0 | 19.9 | 30.7 | 0.0 | 41.9 | 0.0 |
| R1234yf | Mass % | 49.4 | 50.8 | 0.0 | 30.7 | 0.0 | 46.4 |
| R32 | Mass % | 29.3 | 29.3 | 29.3 | 29.3 | 29.3 | 29.3 |
| GWP | — | 200 | 200 | 198 | 199 | 198 | 200 |
| COP ratio | % (relative to | 100.6 | 100.1 | 96.6 | 99.5 | 96.1 | 100.4 |
| | R410A) | | | | | | |
| Refrigerating capacity | % (relative to | 85.0 | 85.0 | 112.4 | 94.8 | 113.6 | 86.7 |
| ratio | R410A) | | | | | | |

TABLE 47

| | | Comp. Ex. | Comp. Ex. | Comp. Ex. | Comp. Ex. | Comp. Ex. | Comp. Ex. |
|---|---|---|---|---|---|---|---|
| | | 49 | 50 | 51 | 52 | 53 | 54 |
| Item | Unit | A | B | G | I | J | K' |
| HFO-1132(E) | Mass % | 12.1 | 0.0 | 35.7 | 35.7 | 29.3 | 22.5 |
| HFO-1123 | Mass % | 0.0 | 11.7 | 27.6 | 0.0 | 34.0 | 0.0 |
| R1234yf | Mass % | 51.2 | 51.6 | 0.0 | 27.6 | 0.0 | 40.8 |
| R32 | Mass % | 36.7 | 36.7 | 36.7 | 36.7 | 36.7 | 36.7 |
| GWP | — | 250 | 250 | 248 | 249 | 248 | 250 |
| COP ratio | % (relative to | 101.2 | 101.0 | 96.4 | 99.6 | 97.0 | 100.4 |
| | R410A) | | | | | | |
| Refrigerating capacity | % (relative to | 85.0 | 85.0 | 113.2 | 97.6 | 113.9 | 90.9 |
| ratio | R410A) | | | | | | |

TABLE 48

| | | Comp. Ex. | Comp. Ex. | Comp. Ex. | Comp. Ex. | Comp. Ex. | Comp. Ex. |
|---|---|---|---|---|---|---|---|
| | | 55 | 56 | 57 | 58 | 59 | 60 |
| Item | Unit | A | B | G | I | J | K′ |
| HFO-1132(E) | Mass % | 3.8 | 0.0 | 32.0 | 32.0 | 29.4 | 21.1 |
| HFO-1123 | Mass % | 0.0 | 3.9 | 23.9 | 0.0 | 26.5 | 0.0 |
| R1234yf | Mass % | 52.1 | 52.0 | 0.0 | 23.9 | 0.0 | 34.8 |
| R32 | Mass % | 44.1 | 44.1 | 44.1 | 44.1 | 44.1 | 44.1 |
| GWP | — | 300 | 300 | 298 | 299 | 298 | 299 |
| COP ratio | % (relative to | 101.8 | 101.8 | 97.9 | 99.8 | 97.8 | 100.5 |
| | R410A) | | | | | | |
| Refrigerating capacity | % (relative to | 85.0 | 85.0 | 113.7 | 100.4 | 113.9 | 94.9 |
| ratio | R410A) | | | | | | |

TABLE 49

| | | Comp. Ex. | Comp. Ex. | Comp. Ex. | Comp. Ex. | Comp. Ex. |
|---|---|---|---|---|---|---|
| | | 61 | 62 | 63 | 64 | 65 |
| Item | Unit | A = B | G | I | J | K′ |
| HFO-1132(E) | Mass % | 0.0 | 30.4 | 30.4 | 28.9 | 20.4 |
| HFO-1123 | Mass % | 0.0 | 21.8 | 0.0 | 23.3 | 0.0 |
| R1234yf | Mass % | 52.2 | 0.0 | 21.8 | 0.0 | 31.8 |
| R32 | Mass % | 47.8 | 47.8 | 47.8 | 47.8 | 47.8 |
| GWP | — | 325 | 323 | 324 | 323 | 324 |
| COP ratio | % (relative to | 102.1 | 98.2 | 100.0 | 98.2 | 100.6 |
| | R410A) | | | | | |
| Refrigerating capacity | % (relative to | 85.0 | 113.8 | 101.8 | 113.9 | 96.8 |
| ratio | R410A) | | | | | |

TABLE 50

| | | Comp. Ex. | | | | Ex. | Ex. | Ex. | Ex. |
|---|---|---|---|---|---|---|---|---|---|
| Item | Unit | 66 | Ex. 7 | Ex. 8 | Ex. 9 | 10 | 11 | 12 | 13 |
| HFO-1132(E) | Mass % | 5.0 | 10.0 | 15.0 | 20.0 | 25.0 | 30.0 | 35.0 | 40.0 |
| HFO-1123 | Mass % | 82.9 | 77.9 | 72.9 | 67.9 | 62.9 | 57.9 | 52.9 | 47.9 |
| R1234yf | Mass % | 5.0 | 5.0 | 5.0 | 5.0 | 5.0 | 5.0 | 5.0 | 5.0 |
| R32 | Mass % | 7.1 | 7.1 | 7.1 | 7.1 | 7.1 | 7.1 | 7.1 | 7.1 |
| GWP | — | 49 | 49 | 49 | 49 | 49 | 49 | 49 | 49 |
| COP ratio | % (relative to | 92.4 | 92.6 | 92.8 | 93.1 | 93.4 | 93.7 | 94.1 | 94.5 |
| | R410A) | | | | | | | | |
| Refrigerating capacity | % (relative to | 108.4 | 108.3 | 108.2 | 107.9 | 107.6 | 107.2 | 106.8 | 106.3 |
| ratio | R410A) | | | | | | | | |

TABLE 51

| | | | | | | Comp. | | | |
|---|---|---|---|---|---|---|---|---|---|
| | | Ex. | Ex. | Ex. | Ex. | Ex. | Ex. | Ex. | Ex. |
| Item | Unit | 14 | 15 | 16 | 17 | 67 | 18 | 19 | 20 |
| HFO-1132(E) | Mass % | 45.0 | 50.0 | 55.0 | 60.0 | 65.0 | 10.0 | 15.0 | 20.0 |
| HFO-1123 | Mass % | 42.9 | 37.9 | 32.9 | 27.9 | 22.9 | 72.9 | 67.9 | 62.9 |
| R1234yf | Mass % | 5.0 | 5.0 | 5.0 | 5.0 | 5.0 | 10.0 | 10.0 | 10.0 |
| R32 | Mass % | 7.1 | 7.1 | 7.1 | 7.1 | 7.1 | 7.1 | 7.1 | 7.1 |
| GWP | — | 49 | 49 | 49 | 49 | 49 | 49 | 49 | 49 |
| COP ratio | % | 95.0 | 95.4 | 95.9 | 96.4 | 96.9 | 93.0 | 93.3 | 93.6 |
| | (relative to R410A) | | | | | | | | |
| Refrigerating | % | 105.8 | 105.2 | 104.5 | 103.9 | 103.1 | 105.7 | 105.5 | 105.2 |
| capacity ratio | (relative to R410A) | | | | | | | | |

TABLE 52

| | | Ex. | Ex. | Ex. | Ex. | Ex. | Ex. | Ex. | Ex. |
|---|---|---|---|---|---|---|---|---|---|
| Item | Unit | 21 | 22 | 23 | 24 | 25 | 26 | 27 | 28 |
| HFO- | Mass % | 25.0 | 30.0 | 35.0 | 40.0 | 45.0 | 50.0 | 55.0 | 60.0 |
| 1132(E) | | | | | | | | | |
| HFO- | Mass % | 57.9 | 52.9 | 47.9 | 42.9 | 37.9 | 32.9 | 27.9 | 22.9 |
| 1123 | | | | | | | | | |
| R1234yf | Mass % | 10.0 | 10.0 | 10.0 | 10.0 | 10.0 | 10.0 | 10.0 | 10.0 |
| R32 | Mass % | 7.1 | 7.1 | 7.1 | 7.1 | 7.1 | 7.1 | 7.1 | 7.1 |
| GWP | — | 49 | 49 | 49 | 49 | 49 | 49 | 49 | 49 |
| COP | % | 93.9 | 94.2 | 94.6 | 95.0 | 95.5 | 96.0 | 96.4 | 96.9 |
| ratio | (relative | | | | | | | | |
| | to | | | | | | | | |
| | R410A) | | | | | | | | |
| Refrig- | % | 104.9 | 104.5 | 104.1 | 103.6 | 103.0 | 102.4 | 101.7 | 101.0 |
| erating | (relative | | | | | | | | |
| capacity | to | | | | | | | | |
| ratio | R410A) | | | | | | | | |

TABLE 53

| | | Comp. | | | | | | | |
|---|---|---|---|---|---|---|---|---|---|
| | | Ex. | Ex. | Ex. | Ex. | Ex. | Ex. | Ex. | Ex. |
| Item | Unit | 68 | 29 | 30 | 31 | 32 | 33 | 34 | 35 |
| HFO-1132(E) | Mass % | 65.0 | 10.0 | 15.0 | 20.0 | 25.0 | 30.0 | 35.0 | 40.0 |
| HFO-1123 | Mass % | 17.9 | 67.9 | 62.9 | 57.9 | 52.9 | 47.9 | 42.9 | 37.9 |
| R1234yf | Mass % | 10.0 | 15.0 | 15.0 | 15.0 | 15.0 | 15.0 | 15.0 | 15.0 |
| R32 | Mass % | 7.1 | 7.1 | 7.1 | 7.1 | 7.1 | 7.1 | 7.1 | 7.1 |
| GWP | — | 49 | 49 | 49 | 49 | 49 | 49 | 49 | 49 |
| COP ratio | % (relative to R410A) | 97.4 | 93.5 | 93.8 | 94.1 | 94.4 | 94.8 | 95.2 | 95.6 |
| Refrigerating | % (relative to R410A) | 100.3 | 102.9 | 102.7 | 102.5 | 102.1 | 101.7 | 101.2 | 100.7 |
| capacity ratio | | | | | | | | | |

TABLE 54

| | | Ex. | Ex. | Ex. | Ex. | Comp. | Ex. | Ex. | Ex. |
|---|---|---|---|---|---|---|---|---|---|
| Item | Unit | 36 | 37 | 38 | 39 | Ex. 69 | 40 | 41 | 42 |
| HFO-1132(E) | Mass % | 45.0 | 50.0 | 55.0 | 60.0 | 65.0 | 10.0 | 15.0 | 20.0 |
| HFO-1123 | Mass % | 32.9 | 27.9 | 22.9 | 17.9 | 12.9 | 62.9 | 57.9 | 52.9 |
| R1234yf | Mass % | 15.0 | 15.0 | 15.0 | 15.0 | 15.0 | 20.0 | 20.0 | 20.0 |
| R32 | Mass % | 7.1 | 7.1 | 7.1 | 7.1 | 7.1 | 7.1 | 7.1 | 7.1 |
| GWP | — | 49 | 49 | 49 | 49 | 49 | 49 | 49 | 49 |
| COP ratio | % | 96.0 | 96.5 | 97.0 | 97.5 | 98.0 | 94.0 | 94.3 | 94.6 |
| | (relative to R410A) | | | | | | | | |
| Refrigerating | % | 100.1 | 99.5 | 98.9 | 98.1 | 97.4 | 100.1 | 99.9 | 99.6 |
| capacity ratio | (relative to R410A) | | | | | | | | |

TABLE 55

| | | Ex. | Ex. | Ex. | Ex. | Ex. | Ex. | Ex. | Ex. |
|---|---|---|---|---|---|---|---|---|---|
| Item | Unit | 43 | 44 | 45 | 46 | 47 | 48 | 49 | 50 |
| HFO- | Mass % | 25.0 | 30.0 | 35.0 | 40.0 | 45.0 | 50.0 | 55.0 | 60.0 |
| 1132(E) | | | | | | | | | |
| HFO- | Mass % | 47.9 | 42.9 | 37.9 | 32.9 | 27.9 | 22.9 | 17.9 | 12.9 |
| 1123 | | | | | | | | | |
| R1234yf | Mass % | 20.0 | 20.0 | 20.0 | 20.0 | 20.0 | 20.0 | 20.0 | 20.0 |
| R32 | Mass % | 7.1 | 7.1 | 7.1 | 7.1 | 7.1 | 7.1 | 7.1 | 7.1 |
| GWP | — | 49 | 49 | 49 | 49 | 49 | 49 | 49 | 49 |
| COP | % | 95.0 | 95.3 | 95.7 | 96.2 | 96.6 | 97.1 | 97.6 | 98.1 |
| ratio | (relative | | | | | | | | |
| | to | | | | | | | | |
| | R410A) | | | | | | | | |
| Refrig- | % | 99.2 | 98.8 | 98.3 | 97.8 | 97.2 | 96.6 | 95.9 | 95.2 |
| erating | (relative | | | | | | | | |
| capacity | to | | | | | | | | |
| ratio | R410A) | | | | | | | | |

TABLE 56

| | | Comp. | | | | | | | |
|---|---|---|---|---|---|---|---|---|---|
| | | Ex. | Ex. | Ex. | Ex. | Ex. | Ex. | Ex. | Ex. |
| Item | Unit | 70 | 51 | 52 | 53 | 54 | 55 | 56 | 57 |
| HFO-1132(E) | Mass % | 65.0 | 10.0 | 15.0 | 20.0 | 25.0 | 30.0 | 35.0 | 40.0 |
| HFO-1123 | Mass % | 7.9 | 57.9 | 52.9 | 47.9 | 42.9 | 37.9 | 32.9 | 27.9 |
| R1234yf | Mass % | 20.0 | 25.0 | 25.0 | 25.0 | 25.0 | 25.0 | 25.0 | 25.0 |
| R32 | Mass % | 7.1 | 7.1 | 7.1 | 7.1 | 7.1 | 7.1 | 7.1 | 7.1 |
| GWP | — | 49 | 50 | 50 | 50 | 50 | 50 | 50 | 50 |
| COP ratio | % | 98.6 | 94.6 | 94.9 | 95.2 | 95.5 | 95.9 | 96.3 | 96.8 |
| | (relative to R410A) | | | | | | | | |
| Refrigerating | % | 94.4 | 97.1 | 96.9 | 96.7 | 96.3 | 95.9 | 95.4 | 94.8 |
| capacity ratio | (relative to R410A) | | | | | | | | |

TABLE 57

| | | Ex. | Ex. | Ex. | Ex. | Comp. Ex. | Ex. | Ex. | Ex. |
|---|---|---|---|---|---|---|---|---|---|
| Item | Unit | 58 | 59 | 60 | 61 | 71 | 62 | 63 | 64 |
| HFO-1132(E) | Mass % | 45.0 | 50.0 | 55.0 | 60.0 | 65.0 | 10.0 | 15.0 | 20.0 |
| HFO-1123 | Mass % | 7.1 | 7.1 | 7.1 | 7.1 | 7.1 | 7.1 | 7.1 | 7.1 |
| R1234yf | Mass % | 25.0 | 25.0 | 25.0 | 25.0 | 25.0 | 30.0 | 30.0 | 30.0 |
| R32 | Mass % | 7.1 | 7.1 | 7.1 | 7.1 | 7.1 | 7.1 | 7.1 | 7.1 |
| GWP | — | 50 | 50 | 50 | 50 | 50 | 50 | 50 | 50 |
| COP ratio | % | 97.2 | 97.7 | 98.2 | 98.7 | 99.2 | 95.2 | 95.5 | 95.8 |
| | (relative to R410A) | | | | | | | | |
| Refrigerating | % | 94.2 | 93.6 | 92.9 | 92.2 | 91.4 | 94.2 | 93.9 | 93.7 |
| capacity ratio | (relative to R410A) | | | | | | | | |

TABLE 58

| | | Ex. | Ex. | Ex. | Ex. | Ex. | Ex. | Ex. | Ex. |
|---|---|---|---|---|---|---|---|---|---|
| Item | Unit | 65 | 66 | 67 | 68 | 69 | 70 | 71 | 72 |
| HFO- | Mass % | 25.0 | 30.0 | 35.0 | 40.0 | 45.0 | 50.0 | 55.0 | 60.0 |
| 1132(E) | | | | | | | | | |
| HFO- | Mass % | 37.9 | 32.9 | 27.9 | 22.9 | 17.9 | 12.9 | 7.9 | 2.9 |
| 1123 | | | | | | | | | |
| R1234yf | Mass % | 30.0 | 30.0 | 30.0 | 30.0 | 30.0 | 30.0 | 30.0 | 30.0 |
| R32 | Mass % | 7.1 | 7.1 | 7.1 | 7.1 | 7.1 | 7.1 | 7.1 | 7.1 |
| GWP | — | 50 | 50 | 50 | 50 | 50 | 50 | 50 | 50 |
| COP | % | 96.2 | 96.6 | 97.0 | 97.4 | 97.9 | 98.3 | 98.8 | 99.3 |
| ratio | (relative | | | | | | | | |
| | to | | | | | | | | |
| | R410A) | | | | | | | | |
| Refrig- | % | 93.3 | 92.9 | 92.4 | 91.8 | 91.2 | 90.5 | 89.8 | 89.1 |
| erating | (relative | | | | | | | | |
| capacity | to | | | | | | | | |
| ratio | R410A) | | | | | | | | |

TABLE 59

| | | Ex. | Ex. | Ex. | Ex. | Ex. | Ex. | Ex. | Ex. |
|---|---|---|---|---|---|---|---|---|---|
| Item | Unit | 73 | 74 | 75 | 76 | 77 | 78 | 79 | 80 |
| HFO- | Mass % | 10.0 | 15.0 | 20.0 | 25.0 | 30.0 | 35.0 | 40.0 | 45.0 |
| 1132(E) | | | | | | | | | |
| HFO- | Mass % | 47.9 | 42.9 | 37.9 | 32.9 | 27.9 | 22.9 | 17.9 | 12.9 |
| 1123 | | | | | | | | | |
| R1234yf | Mass % | 35.0 | 35.0 | 35.0 | 35.0 | 35.0 | 35.0 | 35.0 | 35.0 |
| R32 | Mass % | 7.1 | 7.1 | 7.1 | 7.1 | 7.1 | 7.1 | 7.1 | 7.1 |
| GWP | — | 50 | 50 | 50 | 50 | 50 | 50 | 50 | 50 |
| COP | % | 95.9 | 96.2 | 96.5 | 96.9 | 97.2 | 97.7 | 98.1 | 98.5 |
| ratio | (relative | | | | | | | | |
| | to | | | | | | | | |
| | R410A) | | | | | | | | |
| Refrig- | % | 91.1 | 90.9 | 90.6 | 90.2 | 89.8 | 89.3 | 88.7 | 88.1 |
| erating | (relativE | | | | | | | | |
| capacity | to | | | | | | | | |
| ratio | R410A) | | | | | | | | |

TABLE 60

| | | Ex. | Ex. | Ex. | Ex. | Ex. | Ex. | Ex. | Ex. |
|---|---|---|---|---|---|---|---|---|---|
| Item | Unit | 81 | 82 | 83 | 84 | 85 | 86 | 87 | 88 |
| HFO- | Mass % | 50.0 | 55.0 | 10.0 | 15.0 | 20.0 | 25.0 | 30.0 | 35.0 |
| 1132(E) | | | | | | | | | |
| HFO- | Mass % | 7.9 | 2.9 | 42.9 | 37.9 | 32.9 | 27.9 | 22.9 | 17.9 |
| 1123 | | | | | | | | | |
| R1234yf | Mass % | 35.0 | 35.0 | 40.0 | 40.0 | 40.0 | 40.0 | 40.0 | 40.0 |
| R32 | Mass % | 7.1 | 7.1 | 7.1 | 7.1 | 7.1 | 7.1 | 7.1 | 7.1 |
| GWP | — | 50 | 50 | 50 | 50 | 50 | 50 | 50 | 50 |
| COP | % | 99.0 | 99.4 | 96.6 | 96.9 | 97.2 | 97.6 | 98.0 | 98.4 |
| ratio | (relative | | | | | | | | |
| | to | | | | | | | | |
| | R410A) | | | | | | | | |
| Refrig- | % | 87.4 | 86.7 | 88.0 | 87.8 | 87.5 | 87.1 | 86.6 | 86.1 |
| erating | (relative | | | | | | | | |
| capacity | to | | | | | | | | |
| ratio | R410A) | | | | | | | | |

TABLE 61

| | | Comp. | Comp. | Comp. | Comp. | Comp. | Comp. | Comp. | Comp. |
|---|---|---|---|---|---|---|---|---|---|
| Item | Unit | Ex. 72 | Ex. 73 | Ex. 74 | Ex. 75 | Ex. 76 | Ex. 77 | Ex. 78 | Ex. 79 |
| HFO-1132(E) | Mass % | 40.0 | 45.0 | 50.0 | 10.0 | 15.0 | 20.0 | 25.0 | 30.0 |
| HFO-1123 | Mass % | 12.9 | 7.9 | 2.9 | 37.9 | 32.9 | 27.9 | 22.9 | 17.9 |
| R1234yf | Mass % | 40.0 | 40.0 | 40.0 | 45.0 | 45.0 | 45.0 | 45.0 | 45.0 |
| R32 | Mass % | 7.1 | 7.1 | 7.1 | 7.1 | 7.1 | 7.1 | 7.1 | 7.1 |
| GWP | — | 50 | 50 | 50 | 50 | 50 | 50 | 50 | 50 |
| COP ratio | % (relative to R410A) | 98.8 | 99.2 | 99.6 | 97.4 | 97.7 | 98.0 | 98.3 | 98.7 |
| Refrigerating | % (relative to R410A) | 85.5 | 84.9 | 84.2 | 84.9 | 84.6 | 84.3 | 83.9 | 83.5 |
| capacity ratio | | | | | | | | | |

TABLE 62

| | | Comp. | Comp. | Comp. |
|---|---|---|---|---|
| Item | Unit | Ex. 80 | Ex. 81 | Ex. 82 |
| HFO-1132(E) | Mass % | 35.0 | 40.0 | 45.0 |
| HFO-1123 | Mass % | 12.9 | 7.9 | 2.9 |
| R1234yf | Mass % | 45.0 | 45.0 | 45.0 |
| R32 | Mass % | 7.1 | 7.1 | 7.1 |
| GWP | — | 50 | 50 | 50 |
| COP ratio | % (relative | 99.1 | 99.5 | 99.9 |
| | to R410A) | | | |
| Refrigerating | % (relative | 82.9 | 82.3 | 81.7 |
| capacity ratio | to R410A) | | | |

TABLE 63

| | | Ex. | Ex. | Ex. | Ex. | Ex. | Ex. | Ex. | Ex. |
|---|---|---|---|---|---|---|---|---|---|
| Item | Unit | 89 | 90 | 91 | 92 | 93 | 94 | 95 | 96 |
| HFO-1132(E) | Mass % | 10.0 | 15.0 | 20.0 | 25.0 | 30.0 | 35.0 | 40.0 | 45.0 |
| HFO-1123 | Mass % | 70.5 | 65.5 | 60.5 | 55.5 | 50.5 | 45.5 | 40.5 | 35.5 |
| R1234yf | Mass % | 5.0 | 5.0 | 5.0 | 5.0 | 5.0 | 5.0 | 5.0 | 5.0 |
| R32 | Mass % | 14.5 | 14.5 | 14.5 | 14.5 | 14.5 | 14.5 | 14.5 | 14.5 |
| GWP | — | 99 | 99 | 99 | 99 | 99 | 99 | 99 | 99 |
| COP ratio | % (relative to R410A) | 93.7 | 93.9 | 94.1 | 94.4 | 94.7 | 95.0 | 95.4 | 95.8 |
| Refrigerating | % (relative to R410A) | 110.2 | 110.0 | 109.7 | 109.3 | 108.9 | 108.4 | 107.9 | 107.3 |
| capacity ratio | | | | | | | | | |

TABLE 64

| | | Ex. | Comp. Ex. | Ex. | Ex. | Ex. | Ex. | Ex. | Ex. |
|---|---|---|---|---|---|---|---|---|---|
| Item | Unit | 97 | 83 | 98 | 99 | 100 | 101 | 102 | 103 |
| HFO-1132(E) | Mass % | 50.0 | 55.0 | 10.0 | 15.0 | 20.0 | 25.0 | 30.0 | 35.0 |
| HFO-1123 | Mass % | 30.5 | 25.5 | 65.5 | 60.5 | 55.5 | 50.5 | 45.5 | 40.5 |
| R1234yf | Mass % | 5.0 | 5.0 | 10.0 | 10.0 | 10.0 | 10.0 | 10.0 | 10.0 |
| R32 | Mass % | 14.5 | 14.5 | 14.5 | 14.5 | 14.5 | 14.5 | 14.5 | 14.5 |
| GWP | — | 99 | 99 | 99 | 99 | 99 | 99 | 99 | 99 |
| COP ratio | % | 96.2 | 96.6 | 94.2 | 94.4 | 94.6 | 94.9 | 95.2 | 95.5 |
| | (relative to R410A) | | | | | | | | |
| Refrigerating | % | 106.6 | 106.0 | 107.5 | 107.3 | 107.0 | 106.6 | 106.1 | 105.6 |
| capacity ratio | (relative to R410A) | | | | | | | | |

TABLE 65

| | | Ex. | Ex. | Ex. | Comp. Ex. | Ex. | Ex. | Ex. | Ex. |
|---|---|---|---|---|---|---|---|---|---|
| Item | Unit | 104 | 105 | 106 | 84 | 107 | 108 | 109 | 110 |
| HFO-1132(E) | Mass % | 40.0 | 45.0 | 50.0 | 55.0 | 10.0 | 15.0 | 20.0 | 25.0 |
| HFO-1123 | Mass % | 35.5 | 30.5 | 25.5 | 20.5 | 60.5 | 55.5 | 50.5 | 45.5 |
| R1234yf | Mass % | 10.0 | 10.0 | 10.0 | 10.0 | 15.0 | 15.0 | 15.0 | 15.0 |
| R32 | Mass % | 14.5 | 14.5 | 14.5 | 14.5 | 14.5 | 14.5 | 14.5 | 14.5 |
| GWP | — | 99 | 99 | 99 | 99 | 99 | 99 | 99 | 99 |
| COP ratio | % | 95.9 | 96.3 | 96.7 | 97.1 | 94.6 | 94.8 | 95.1 | 95.4 |
| | (relative to R410A) | | | | | | | | |
| Refrigerating | % | 105.1 | 104.5 | 103.8 | 103.1 | 104.7 | 104.5 | 104.1 | 103.7 |
| capacity ratio | (relative to R410A) | | | | | | | | |

TABLE 66

| | | Ex. | Ex. | Ex. | Ex. | Ex. | Comp. Ex. | Ex. | Ex. |
|---|---|---|---|---|---|---|---|---|---|
| Item | Unit | 111 | 112 | 113 | 114 | 115 | 85 | 116 | 117 |
| HFO-1132(E) | Mass % | 30.0 | 35.0 | 40.0 | 45.0 | 50.0 | 55.0 | 10.0 | 15.0 |
| HFO-1123 | Mass % | 40.5 | 35.5 | 30.5 | 25.5 | 20.5 | 15.5 | 55.5 | 50.5 |
| R1234yf | Mass % | 15.0 | 15.0 | 15.0 | 15.0 | 15.0 | 15.0 | 20.0 | 20.0 |
| R32 | Mass % | 14.5 | 14.5 | 14.5 | 14.5 | 14.5 | 14.5 | 14.5 | 14.5 |
| GWP | — | 99 | 99 | 99 | 99 | 99 | 99 | 99 | 99 |
| COP ratio | % | 95.7 | 96.0 | 96.4 | 96.8 | 97.2 | 97.6 | 95.1 | 95.3 |
| | (relative to R410A) | | | | | | | | |
| Refrigerating | % | 103.3 | 102.8 | 102.2 | 101.6 | 101.0 | 100.3 | 101.8 | 101.6 |
| capacity ratio | (relative to R410A) | | | | | | | | |

TABLE 67

| Item | Unit | Ex. 118 | Ex. 119 | Ex. 120 | Ex. 121 | Ex. 122 | Ex. 123 | Ex. 124 | Comp. Ex. 86 |
|---|---|---|---|---|---|---|---|---|---|
| HFO-1132(E) | Mass % | 20.0 | 25.0 | 30.0 | 35.0 | 40.0 | 45.0 | 50.0 | 55.0 |
| HFO-1123 | Mass % | 45.5 | 40.5 | 35.5 | 30.5 | 25.5 | 20.5 | 15.5 | 10.5 |
| R1234yf | Mass % | 20.0 | 20.0 | 20.0 | 20.0 | 20.0 | 20.0 | 20.0 | 20.0 |
| R32 | Mass % | 14.5 | 14.5 | 14.5 | 14.5 | 14.5 | 14.5 | 14.5 | 14.5 |
| GWP | — | 99 | 99 | 99 | 99 | 99 | 99 | 99 | 99 |
| COP ratio | % (relative | 95.6 | 95.9 | 96.2 | 96.5 | 96.9 | 97.3 | 97.7 | 98.2 |
| | to R410A) | | | | | | | | |
| Refrigerating | % (relative | 101.2 | 100.8 | 100.4 | 99.9 | 99.3 | 98.7 | 98.0 | 97.3 |
| capacity ratio | to R410A) | | | | | | | | |

TABLE 68

| Item | Unit | Ex. 125 | Ex. 126 | Ex. 127 | Ex. 128 | Ex. 129 | Ex. 130 | Ex. 131 | Ex. 132 |
|---|---|---|---|---|---|---|---|---|---|
| HFO-1132(E) | Mass % | 10.0 | 15.0 | 20.0 | 25.0 | 30.0 | 35.0 | 40.0 | 45.0 |
| HFO-1123 | Mass % | 50.5 | 45.5 | 40.5 | 35.5 | 30.5 | 25.5 | 20.5 | 15.5 |
| R1234yf | Mass % | 25.0 | 25.0 | 25.0 | 25.0 | 25.0 | 25.0 | 25.0 | 25.0 |
| R32 | Mass % | 14.5 | 14.5 | 14.5 | 14.5 | 14.5 | 14.5 | 14.5 | 14.5 |
| GWP | — | 99 | 99 | 99 | 99 | 99 | 99 | 99 | 99 |
| COP ratio | % (relative | 95.6 | 95.9 | 96.1 | 96.4 | 96.7 | 97.1 | 97.5 | 97.9 |
| | to R410A) | | | | | | | | |
| Refrigerating | % (relative | 98.9 | 98.6 | 98.3 | 97.9 | 97.4 | 96.9 | 96.3 | 95.7 |
| capacity ratio | to R410A) | | | | | | | | |

TABLE 69

| Item | Unit | Ex. 133 | Comp. Ex. 87 | Ex. 134 | Ex. 135 | Ex. 136 | Ex. 137 | Ex. 138 | Ex. 139 |
|---|---|---|---|---|---|---|---|---|---|
| HFO-1132(E) | Mass % | 50.0 | 55.0 | 10.0 | 15.0 | 20.0 | 25.0 | 30.0 | 35.0 |
| HFO-1123 | Mass % | 10.5 | 5.5 | 45.5 | 40.5 | 35.5 | 30.5 | 25.5 | 20.5 |
| R1234yf | Mass % | 25.0 | 25.0 | 30.0 | 30.0 | 30.0 | 30.0 | 30.0 | 30.0 |
| R32 | Mass % | 14.5 | 14.5 | 14.5 | 14.5 | 14.5 | 14.5 | 14.5 | 14.5 |
| GWP | — | 99 | 99 | 100 | 100 | 100 | 100 | 100 | 100 |
| COP ratio | % (relative | 98.3 | 98.7 | 96.2 | 96.4 | 96.7 | 97.0 | 97.3 | 97.7 |
| | to R410A) | | | | | | | | |
| Refrigerating | % (relative | 95.0 | 94.3 | 95.8 | 95.6 | 95.2 | 94.8 | 94.4 | 93.8 |
| capacity ratio | to R410A) | | | | | | | | |

TABLE 70

| Item | Unit | Ex. 140 | Ex. 141 | Ex. 142 | Ex. 143 | Ex. 144 | Ex. 145 | Ex. 146 | Ex. 147 |
|---|---|---|---|---|---|---|---|---|---|
| HFO-1132(E) | Mass % | 40.0 | 45.0 | 50.0 | 10.0 | 15.0 | 20.0 | 25.0 | 30.0 |
| HFO-1123 | Mass % | 15.5 | 10.5 | 5.5 | 40.5 | 35.5 | 30.5 | 25.5 | 20.5 |
| R1234yf | Mass % | 30.0 | 30.0 | 30.0 | 35.0 | 35.0 | 35.0 | 35.0 | 35.0 |
| R32 | Mass % | 14.5 | 14.5 | 14.5 | 14.5 | 14.5 | 14.5 | 14.5 | 14.5 |
| GWP | — | 100 | 100 | 100 | 100 | 100 | 100 | 100 | 100 |
| COP ratio | % (relative | 98.1 | 98.5 | 98.9 | 96.8 | 97.0 | 97.3 | 97.6 | 97.9 |
| | to R410A) | | | | | | | | |
| Refrigerating | % (relative | 93.3 | 92.6 | 92.0 | 92.8 | 92.5 | 92.2 | 91.8 | 91.3 |
| capacity ratio | to R410A) | | | | | | | | |

TABLE 71

| Item | Unit | Ex. 148 | Ex. 149 | Ex. 150 | Ex. 151 | Ex. 152 | Ex. 153 | Ex. 154 | Ex. 155 |
|---|---|---|---|---|---|---|---|---|---|
| HFO-1132(E) | Mass % | 35.0 | 40.0 | 45.0 | 10.0 | 15.0 | 20.0 | 25.0 | 30.0 |
| HFO-1123 | Mass % | 15.5 | 10.5 | 5.5 | 35.5 | 30.5 | 25.5 | 20.5 | 15.5 |
| R1234yf | Mass % | 35.0 | 35.0 | 35.0 | 40.0 | 40.0 | 40.0 | 40.0 | 40.0 |
| R32 | Mass % | 14.5 | 14.5 | 14.5 | 14.5 | 14.5 | 14.5 | 14.5 | 14.5 |
| GWP | — | 100 | 100 | 100 | 100 | 100 | 100 | 100 | 100 |
| COP ratio | % (relative | 98.3 | 98.7 | 99.1 | 97.4 | 97.7 | 98.0 | 98.3 | 98.6 |
| | to R410A) | | | | | | | | |
| Refrigerating | % (relative | 90.8 | 90.2 | 89.6 | 89.6 | 89.4 | 89.0 | 88.6 | 88.2 |
| capacity ratio | to R410A) | | | | | | | | |

TABLE 72

| Item | Unit | Ex. 156 | Ex. 157 | Ex. 158 | Ex. 159 | Ex. 160 | Comp. Ex. 88 | Comp. Ex. 89 | Comp. Ex. 90 |
|---|---|---|---|---|---|---|---|---|---|
| HFO-1132(E) | Mass % | 35.0 | 40.0 | 10.0 | 15.0 | 20.0 | 25.0 | 30.0 | 35.0 |
| HFO-1123 | Mass % | 10.5 | 5.5 | 30.5 | 25.5 | 20.5 | 15.5 | 10.5 | 5.5 |
| R1234yf | Mass % | 40.0 | 40.0 | 45.0 | 45.0 | 45.0 | 45.0 | 45.0 | 45.0 |
| R32 | Mass % | 14.5 | 14.5 | 14.5 | 14.5 | 14.5 | 14.5 | 14.5 | 14.5 |
| GWP | - | 100 | 100 | 100 | 100 | 100 | 100 | 100 | 100 |
| COP ratio | % (relative | 98.9 | 99.3 | 98.1 | 98.4 | 98.7 | 98.9 | 99.3 | 99.6 |
| | to R410A) | | | | | | | | |
| Refrigerating | % (relative | 87.6 | 87.1 | 86.5 | 86.2 | 85.9 | 85.5 | 85.0 | 84.5 |
| capacity ratio | to R410A) | | | | | | | | |

TABLE 73

| Item | Unit | Comp. Ex. 91 | Comp. Ex. 92 | Comp. Ex. 93 | Comp. Ex. 94 | Comp. Ex. 95 |
|---|---|---|---|---|---|---|
| HFO-1132(E) | Mass % | 10.0 | 15.0 | 20.0 | 25.0 | 30.0 |
| HFO-1123 | Mass % | 25.5 | 20.5 | 15.5 | 10.5 | 5.5 |
| R1234yf | Mass % | 50.0 | 50.0 | 50.0 | 50.0 | 50.0 |
| R32 | Mass % | 14.5 | 14.5 | 14.5 | 14.5 | 14.5 |
| GWP | — | 100 | 100 | 100 | 100 | 100 |
| COP ratio | % (relative | 98.9 | 99.1 | 99.4 | 99.7 | 100.0 |
| | to R410A) | | | | | |
| Refrigerating | % (relative | 83.3 | 83.0 | 82.7 | 82.2 | 81.8 |
| capacity ratio | to R410A) | | | | | |

TABLE 74

| Item | Unit | Ex. 161 | Ex. 162 | Ex. 163 | Ex. 164 | Ex. 165 | Ex. 166 | Ex. 167 | Ex. 168 |
|---|---|---|---|---|---|---|---|---|---|
| HFO-1132(E) | Mass % | 10.0 | 15.0 | 20.0 | 25.0 | 30.0 | 35.0 | 40.0 | 45.0 |
| HFO-1123 | Mass % | 63.1 | 58.1 | 53.1 | 48.1 | 43.1 | 38.1 | 33.1 | 28.1 |
| R1234yf | Mass % | 5.0 | 5.0 | 5.0 | 5.0 | 5.0 | 5.0 | 5.0 | 5.0 |
| R32 | Mass % | 21.9 | 21.9 | 21.9 | 21.9 | 21.9 | 21.9 | 21.9 | 21.9 |
| GWP | — | 149 | 149 | 149 | 149 | 149 | 149 | 149 | 149 |
| COP ratio | % (relative | 94.8 | 95.0 | 95.2 | 95.4 | 95.7 | 95.9 | 96.2 | 96.6 |
| | to R410A) | | | | | | | | |
| Refrigerating | % (relative | 111.5 | 111.2 | 110.9 | 110.5 | 110.0 | 109.5 | 108.9 | 108.3 |
| capacity ratio | to R410A) | | | | | | | | |

TABLE 75

| Item | Unit | Comp. Ex. 96 | Ex. 169 | Ex. 170 | Ex. 171 | Ex. 172 | Ex. 173 | Ex. 174 | Ex. 175 |
|---|---|---|---|---|---|---|---|---|---|
| HFO-1132(E) | Mass % | 50.0 | 10.0 | 15.0 | 20.0 | 25.0 | 30.0 | 35.0 | 40.0 |
| HFO-1123 | Mass % | 23.1 | 58.1 | 53.1 | 48.1 | 43.1 | 38.1 | 33.1 | 28.1 |
| R1234yf | Mass % | 5.0 | 10.0 | 10.0 | 10.0 | 10.0 | 10.0 | 10.0 | 10.0 |
| R32 | Mass % | 21.9 | 21.9 | 21.9 | 21.9 | 21.9 | 21.9 | 21.9 | 21.9 |
| GWP | — | 149 | 149 | 149 | 149 | 149 | 149 | 149 | 149 |
| COP ratio | % (relative | 96.9 | 95.3 | 95.4 | 95.6 | 95.8 | 96.1 | 96.4 | 96.7 |
| | to R410A) | | | | | | | | |
| Refrigerating | % (relative | 107.7 | 108.7 | 108.5 | 108.1 | 107.7 | 107.2 | 106.7 | 106.1 |
| capacity ratio | to R410A) | | | | | | | | |

TABLE 76

| Item | Unit | Ex.176 | Comp. Ex. 97 | Ex. 177 | Ex. 178 | Ex. 179 | Ex. 180 | Ex. 181 | Ex. 182 |
|---|---|---|---|---|---|---|---|---|---|
| HFO-1132(E) | Mass % | 45.0 | 50.0 | 10.0 | 15.0 | 20.0 | 25.0 | 30.0 | 35.0 |
| HFO-1123 | Mass % | 23.1 | 18.1 | 53.1 | 48.1 | 43.1 | 38.1 | 33.1 | 28.1 |
| R1234yf | Mass % | 10.0 | 10.0 | 15.0 | 15.0 | 15.0 | 15.0 | 15.0 | 15.0 |
| R32 | Mass % | 21.9 | 21.9 | 21.9 | 21.9 | 21.9 | 21.9 | 21.9 | 21.9 |
| GWP | — | 149 | 149 | 149 | 149 | 149 | 149 | 149 | 149 |
| COP ratio | % (relative | 97.0 | 97.4 | 95.7 | 95.9 | 96.1 | 96.3 | 96.6 | 96.9 |
| | to R410A) | | | | | | | | |
| Refrigerating | % (relative | 105.5 | 104.9 | 105.9 | 105.6 | 105.3 | 104.8 | 104.4 | 103.8 |
| capacity ratio | to R410A) | | | | | | | | |

TABLE 77

| Item | Unit | Ex. 183 | Ex. 184 | Comp. Ex. 98 | Ex. 185 | Ex. 186 | Ex. 187 | Ex. 188 | Ex. 189 |
|---|---|---|---|---|---|---|---|---|---|
| HFO-1132(E) | Mass % | 40.0 | 45.0 | 50.0 | 10.0 | 15.0 | 20.0 | 25.0 | 30.0 |
| HFO-1123 | Mass % | 23.1 | 18.1 | 13.1 | 48.1 | 43.1 | 38.1 | 33.1 | 28.1 |
| R1234yf | Mass % | 15.0 | 15.0 | 15.0 | 20.0 | 20.0 | 20.0 | 20.0 | 20.0 |
| R32 | Mass % | 21.9 | 21.9 | 21.9 | 21.9 | 21.9 | 21.9 | 21.9 | 21.9 |
| GWP | — | 149 | 149 | 149 | 149 | 149 | 149 | 149 | 149 |
| COP ratio | % (relative | 97.2 | 97.5 | 97.9 | 96.1 | 96.3 | 96.5 | 96.8 | 97.1 |
| | to R410A) | | | | | | | | |
| Refrigerating | % (relative | 103.3 | 102.6 | 102.0 | 103.0 | 102.7 | 102.3 | 101.9 | 101.4 |
| capacity ratio | to R410A) | | | | | | | | |

TABLE 78

| Item | Unit | Ex. 190 | Ex. 191 | Ex. 192 | Comp. Ex. 99 | Ex. 193 | Ex. 194 | Ex. 195 | Ex. 196 |
|---|---|---|---|---|---|---|---|---|---|
| HFO-1132(E) | Mass % | 35.0 | 40.0 | 45.0 | 50.0 | 10.0 | 15.0 | 20.0 | 25.0 |
| HFO-1123 | Mass % | 23.1 | 18.1 | 13.1 | 8.1 | 43.1 | 38.1 | 33.1 | 28.1 |
| R1234yf | Mass % | 20.0 | 20.0 | 20.0 | 20.0 | 25.0 | 25.0 | 25.0 | 25.0 |
| R32 | Mass % | 21.9 | 21.9 | 21.9 | 21.9 | 21.9 | 21.9 | 21.9 | 21.9 |
| GWP | — | 149 | 149 | 149 | 149 | 149 | 149 | 149 | 149 |
| COP ratio | % (relative | 97.4 | 97.7 | 98.0 | 98.4 | 96.6 | 96.8 | 97.0 | 97.3 |
| | to R410A) | | | | | | | | |
| Refrigerating | % (relative | 100.9 | 100.3 | 99.7 | 99.1 | 100.0 | 99.7 | 99.4 | 98.9 |
| capacity ratio | to R410A) | | | | | | | | |

TABLE 79

| Item | Unit | Ex. 197 | Ex. 198 | Ex. 199 | Ex. 200 | Comp. Ex. 100 | Ex. 201 | Ex. 202 | Ex. 203 |
|---|---|---|---|---|---|---|---|---|---|
| HFO-1132(E) | Mass % | 30.0 | 35.0 | 40.0 | 45.0 | 50.0 | 10.0 | 15.0 | 20.0 |
| HFO-1123 | Mass % | 23.1 | 18.1 | 13.1 | 8.1 | 3.1 | 38.1 | 33.1 | 28.1 |
| R1234yf | Mass % | 25.0 | 25.0 | 25.0 | 25.0 | 25.0 | 30.0 | 30.0 | 30.0 |
| R32 | Mass % | 21.9 | 21.9 | 21.9 | 21.9 | 21.9 | 21.9 | 21.9 | 21.9 |
| GWP | — | 149 | 149 | 149 | 149 | 149 | 150 | 150 | 150 |
| COP ratio | % (relative | 97.6 | 97.9 | 98.2 | 98.5 | 98.9 | 97.1 | 97.3 | 97.6 |
| | to R410A) | | | | | | | | |
| Refrigerating | % (relative | 98.5 | 97.9 | 97.4 | 96.8 | 96.1 | 97.0 | 96.7 | 96.3 |
| capacity ratio | to R410A) | | | | | | | | |

TABLE 80

| Item | Unit | Ex. 204 | Ex. 205 | Ex. 206 | Ex. 207 | Ex. 208 | Ex. 209 | Ex. 210 | Ex. 211 |
|---|---|---|---|---|---|---|---|---|---|
| HFO-1132(E) | Mass % | 25.0 | 30.0 | 35.0 | 40.0 | 45.0 | 10.0 | 15.0 | 20.0 |
| HFO-1123 | Mass % | 23.1 | 18.1 | 13.1 | 8.1 | 3.1 | 33.1 | 28.1 | 23.1 |
| R1234yf | Mass % | 30.0 | 30.0 | 30.0 | 30.0 | 30.0 | 35.0 | 35.0 | 35.0 |
| R32 | Mass % | 21.9 | 21.9 | 21.9 | 21.9 | 21.9 | 21.9 | 21.9 | 21.9 |
| GWP | — | 150 | 150 | 150 | 150 | 150 | 150 | 150 | 150 |
| COP ratio | % (relative | 97.8 | 98.1 | 98.4 | 98.7 | 99.1 | 97.7 | 97.9 | 98.1 |
| | to R410A) | | | | | | | | |
| Refrigerating | % (relative | 95.9 | 95.4 | 94.9 | 94.4 | 93.8 | 93.9 | 93.6 | 93.3 |
| capacity ratio | to R410A) | | | | | | | | |

TABLE 81

| Item | Unit | Ex. 212 | Ex. 213 | Ex. 214 | Ex. 215 | Ex. 216 | Ex. 217 | Ex. 218 | Ex. 219 |
|---|---|---|---|---|---|---|---|---|---|
| HFO-1132(E) | Mass % | 25.0 | 30.0 | 35.0 | 40.0 | 10.0 | 15.0 | 20.0 | 25.0 |
| HFO-1123 | Mass % | 18.1 | 13.1 | 8.1 | 3.1 | 28.1 | 23.1 | 18.1 | 13.1 |
| R1234yf | Mass % | 35.0 | 35.0 | 35.0 | 35.0 | 40.0 | 40.0 | 40.0 | 40.0 |
| R32 | Mass % | 21.9 | 21.9 | 21.9 | 21.9 | 21.9 | 21.9 | 21.9 | 21.9 |
| GWP | — | 150 | 150 | 150 | 150 | 150 | 150 | 150 | 150 |
| COP ratio | % (relative | 98.4 | 98.7 | 99.0 | 99.3 | 98.3 | 98.5 | 98.7 | 99.0 |
| | to R410A) | | | | | | | | |
| Refrigerating | % (relative | 92.9 | 92.4 | 91.9 | 91.3 | 90.8 | 90.5 | 90.2 | 89.7 |
| capacity ratio | to R410A) | | | | | | | | |

TABLE 82

| Item | Unit | Ex. 220 | Ex. 221 | Ex. 222 | Ex. 223 | Ex. 224 | Ex. 225 | Ex. 226 | Comp. Ex. 101 |
|---|---|---|---|---|---|---|---|---|---|
| HFO-1132(E) | Mass % | 30.0 | 35.0 | 10.0 | 15.0 | 20.0 | 25.0 | 30.0 | 10.0 |
| HFO-1123 | Mass % | 8.1 | 3.1 | 23.1 | 18.1 | 13.1 | 8.1 | 3.1 | 18.1 |
| R1234yf | Mass % | 40.0 | 40.0 | 45.0 | 45.0 | 45.0 | 45.0 | 45.0 | 50.0 |
| R32 | Mass % | 21.9 | 21.9 | 21.9 | 21.9 | 21.9 | 21.9 | 21.9 | 21.9 |
| GWP | — | 150 | 150 | 150 | 150 | 150 | 150 | 150 | 150 |
| COP ratio | % (relative | 99.3 | 99.6 | 98.9 | 99.1 | 99.3 | 99.6 | 99.9 | 99.6 |
| | to R410A) | | | | | | | | |
| Refrigerating | % (relative | 89.3 | 88.8 | 87.6 | 87.3 | 87.0 | 86.6 | 86.2 | 84.4 |
| capacity ratio | to R410A) | | | | | | | | |

TABLE 83

| | | Comp. | Comp. | Comp. |
|---|---|---|---|---|
| Item | Unit | Ex. 102 | Ex. 103 | Ex. 104 |
| HFO-1132(E) | Mass % | 15.0 | 20.0 | 25.0 |
| HFO-1123 | Mass % | 13.1 | 8.1 | 3.1 |
| R1234yf | Mass % | 50.0 | 50.0 | 50.0 |
| R32 | Mass % | 21.9 | 21.9 | 21.9 |
| GWP | — | 150 | 150 | 150 |
| COP ratio | % (relative | 99.8 | 100.0 | 100.2 |
| | to R410A) | | | |
| Refrigerating | % (relative | 84.1 | 83.8 | 83.4 |
| capacity ratio | to R410A) | | | |

TABLE 84

| Item | Unit | Ex. 227 | Ex. 228 | Ex. 229 | Ex. 230 | Ex. 231 | Ex. 232 | Ex. 233 | Comp. Ex. 105 |
|---|---|---|---|---|---|---|---|---|---|
| HFO-1132(E) | Mass % | 10.0 | 15.0 | 20.0 | 25.0 | 30.0 | 35.0 | 40.0 | 45.0 |
| HFO-1123 | Mass % | 55.7 | 50.7 | 45.7 | 40.7 | 35.7 | 30.7 | 25.7 | 20.7 |
| R1234yf | Mass % | 5.0 | 5.0 | 5.0 | 5.0 | 5.0 | 5.0 | 5.0 | 5.0 |
| R32 | Mass % | 29.3 | 29.3 | 29.3 | 29.3 | 29.3 | 29.3 | 29.3 | 29.3 |
| GWP | — | 199 | 199 | 199 | 199 | 199 | 199 | 199 | 199 |
| COP ratio | % (relative | 95.9 | 96.0 | 96.2 | 96.3 | 96.6 | 96.8 | 97.1 | 97.3 |
| | to R410A) | | | | | | | | |
| Refrigerating | % (relative | 112.2 | 111.9 | 111.6 | 111.2 | 110.7 | 110.2 | 109.6 | 109.0 |
| capacity ratio | to R410A) | | | | | | | | |

TABLE 85

| Item | Unit | Ex. 234 | Ex. 235 | Ex. 236 | Ex. 237 | Ex. 238 | Ex. 239 | Ex. 240 | Comp. Ex. 106 |
|---|---|---|---|---|---|---|---|---|---|
| HFO-1132(E) | Mass % | 10.0 | 15.0 | 20.0 | 25.0 | 30.0 | 35.0 | 40.0 | 45.0 |
| HFO-1123 | Mass % | 50.7 | 45.7 | 40.7 | 35.7 | 30.7 | 25.7 | 20.7 | 15.7 |
| R1234yf | Mass % | 10.0 | 10.0 | 10.0 | 10.0 | 10.0 | 10.0 | 10.0 | 10.0 |
| R32 | Mass % | 29.3 | 29.3 | 29.3 | 29.3 | 29.3 | 29.3 | 29.3 | 29.3 |
| GWP | — | 199 | 199 | 199 | 199 | 199 | 199 | 199 | 199 |
| COP ratio | % (relative | 96.3 | 96.4 | 96.6 | 96.8 | 97.0 | 97.2 | 97.5 | 97.8 |
| | to R410A) | | | | | | | | |
| Refrigerating | % (relative to | 109.4 | 109.2 | 108.8 | 108.4 | 107.9 | 107.4 | 106.8 | 106.2 |
| capacity ratio | R410A) | | | | | | | | |

TABLE 86

| Item | Unit | Ex. 241 | Ex. 242 | Ex. 243 | Ex. 244 | Ex. 245 | Ex. 246 | Ex. 247 | Comp. Ex. 107 |
|---|---|---|---|---|---|---|---|---|---|
| HFO-1132(E) | Mass % | 10.0 | 15.0 | 20.0 | 25.0 | 30.0 | 35.0 | 40.0 | 45.0 |
| HFO-1123 | Mass % | 45.7 | 40.7 | 35.7 | 30.7 | 25.7 | 20.7 | 15.7 | 10.7 |
| R1234yf | Mass % | 15.0 | 15.0 | 15.0 | 15.0 | 15.0 | 15.0 | 15.0 | 15.0 |
| R32 | Mass % | 29.3 | 29.3 | 29.3 | 29.3 | 29.3 | 29.3 | 29.3 | 29.3 |
| GWP | — | 199 | 199 | 199 | 199 | 199 | 199 | 199 | 199 |
| COP ratio | % (relative | 96.7 | 96.8 | 97.0 | 97.2 | 97.4 | 97.7 | 97.9 | 98.2 |
| | to R410A) | | | | | | | | |
| Refrigerating | % (relative | 106.6 | 106.3 | 106.0 | 105.5 | 105.1 | 104.5 | 104.0 | 103.4 |
| capacity ratio | to R410A) | | | | | | | | |

TABLE 87

| Item | Unit | Ex. 248 | Ex. 249 | Ex. 250 | Ex. 251 | Ex. 252 | Ex. 253 | Ex. 254 | Comp. Ex. 108 |
|---|---|---|---|---|---|---|---|---|---|
| HFO-1132(E) | Mass % | 10.0 | 15.0 | 20.0 | 25.0 | 30.0 | 35.0 | 40.0 | 45.0 |
| HFO-1123 | Mass % | 40.7 | 35.7 | 30.7 | 25.7 | 20.7 | 15.7 | 10.7 | 5.7 |
| R1234yf | Mass % | 20.0 | 20.0 | 20.0 | 20.0 | 20.0 | 20.0 | 20.0 | 20.0 |
| R32 | Mass % | 29.3 | 29.3 | 29.3 | 29.3 | 29.3 | 29.3 | 29.3 | 29.3 |
| GWP | — | 199 | 199 | 199 | 199 | 199 | 199 | 199 | 199 |
| COP ratio | % (relative | 97.1 | 97.3 | 97.5 | 97.7 | 97.9 | 98.1 | 98.4 | 98.7 |
| | to R410A) | | | | | | | | |
| Refrigerating | % (relative | 103.7 | 103.4 | 103.0 | 102.6 | 102.2 | 101.6 | 101.1 | 100.5 |
| capacity ratio | to R410A) | | | | | | | | |

TABLE 88

| Item | Unit | Ex. 255 | Ex. 256 | Ex. 257 | Ex. 258 | Ex. 259 | Ex. 260 | Ex. 261 | Ex. 262 |
|---|---|---|---|---|---|---|---|---|---|
| HFO-1132(E) | Mass % | 10.0 | 15.0 | 20.0 | 25.0 | 30.0 | 35.0 | 40.0 | 10.0 |
| HFO-1123 | Mass % | 35.7 | 30.7 | 25.7 | 20.7 | 15.7 | 10.7 | 5.7 | 30.7 |
| R1234yf | Mass % | 25.0 | 25.0 | 25.0 | 25.0 | 25.0 | 25.0 | 25.0 | 30.0 |
| R32 | Mass % | 29.3 | 29.3 | 29.3 | 29.3 | 29.3 | 29.3 | 29.3 | 29.3 |
| GWP | — | 199 | 199 | 199 | 199 | 199 | 199 | 199 | 199 |
| COP ratio | % (relative | 97.6 | 97.7 | 97.9 | 98.1 | 98.4 | 98.6 | 98.9 | 98.1 |
| | to R410A) | | | | | | | | |
| Refrigerating | % (relative | 100.7 | 100.4 | 100.1 | 99.7 | 99.2 | 98.7 | 98.2 | 97.7 |
| capacity ratio | to R410A) | | | | | | | | |

TABLE 89

| Item | Unit | Ex. 263 | Ex. 264 | Ex. 265 | Ex. 266 | Ex. 267 | Ex. 268 | Ex. 269 | Ex. 270 |
|---|---|---|---|---|---|---|---|---|---|
| HFO-1132(E) | Mass % | 15.0 | 20.0 | 25.0 | 30.0 | 35.0 | 10.0 | 15.0 | 20.0 |
| HFO-1123 | Mass % | 25.7 | 20.7 | 15.7 | 10.7 | 5.7 | 25.7 | 20.7 | 15.7 |
| R1234yf | Mass % | 30.0 | 30.0 | 30.0 | 30.0 | 30.0 | 35.0 | 35.0 | 35.0 |
| R32 | Mass % | 29.3 | 29.3 | 29.3 | 29.3 | 29.3 | 29.3 | 29.3 | 29.3 |
| GWP | — | 199 | 199 | 199 | 199 | 199 | 200 | 200 | 200 |
| COP ratio | % (relative | 98.2 | 98.4 | 98.6 | 98.9 | 99.1 | 98.6 | 98.7 | 98.9 |
| | to R410A) | | | | | | | | |
| Refrigerating | % (relative | 97.4 | 97.1 | 96.7 | 96.2 | 95.7 | 94.7 | 94.4 | 94.0 |
| capacity ratio | to R410A) | | | | | | | | |

TABLE 90

| Item | Unit | Ex. 271 | Ex. 272 | Ex. 273 | Ex. 274 | Ex. 275 | Ex. 276 | Ex. 277 | Ex. 278 |
|---|---|---|---|---|---|---|---|---|---|
| HFO-1132(E) | Mass % | 25.0 | 30.0 | 10.0 | 15.0 | 20.0 | 25.0 | 10.0 | 15.0 |
| HFO-1123 | Mass % | 10.7 | 5.7 | 20.7 | 15.7 | 10.7 | 5.7 | 15.7 | 10.7 |
| R1234yf | Mass % | 35.0 | 35.0 | 40.0 | 40.0 | 40.0 | 40.0 | 45.0 | 45.0 |
| R32 | Mass % | 29.3 | 29.3 | 29.3 | 29.3 | 29.3 | 29.3 | 29.3 | 29.3 |
| GWP | — | 200 | 200 | 200 | 200 | 200 | 200 | 200 | 200 |
| COP ratio | % (relative | 99.2 | 99.4 | 99.1 | 99.3 | 99.5 | 99.7 | 99.7 | 99.8 |
| | to R410A) | | | | | | | | |
| Refrigerating | % (relative | 93.6 | 93.2 | 91.5 | 91.3 | 90.9 | 90.6 | 88.4 | 88.1 |
| capacity ratio | to R410A) | | | | | | | | |

TABLE 91

| | | | | Comp. | Comp. |
|---|---|---|---|---|---|
| Item | Unit | Ex. 279 | Ex. 280 | Ex. 109 | Ex. 110 |
| HFO-1132(E) | Mass % | 20.0 | 10.0 | 15.0 | 10.0 |
| HFO-1123 | Mass % | 5.7 | 10.7 | 5.7 | 5.7 |
| R1234yf | Mass % | 45.0 | 50.0 | 50.0 | 55.0 |
| R32 | Mass % | 29.3 | 29.3 | 29.3 | 29.3 |
| GWP | — | 200 | 200 | 200 | 200 |
| COP ratio | % (relative | 100.0 | 100.3 | 100.4 | 100.9 |
| | to R410A) | | | | |
| Refrigerating | % (relative | 87.8 | 85.2 | 85.0 | 82.0 |
| capacity ratio | to R410A) | | | | |

TABLE 92

| Item | Unit | Ex. 281 | Ex. 282 | Ex. 283 | Ex. 284 | Ex. 285 | Comp. Ex. 111 | Ex. 286 | Ex. 287 |
|---|---|---|---|---|---|---|---|---|---|
| HFO-1132(E) | Mass % | 10.0 | 15.0 | 20.0 | 25.0 | 30.0 | 35.0 | 10.0 | 15.0 |
| HFO-1123 | Mass % | 40.9 | 35.9 | 30.9 | 25.9 | 20.9 | 15.9 | 35.9 | 30.9 |
| R1234yf | Mass % | 5.0 | 5.0 | 5.0 | 5.0 | 5.0 | 5.0 | 10.0 | 10.0 |
| R32 | Mass % | 44.1 | 44.1 | 44.1 | 44.1 | 44.1 | 44.1 | 44.1 | 44.1 |
| GWP | — | 298 | 298 | 298 | 298 | 298 | 298 | 299 | 299 |
| COP ratio | % (relative | 97.8 | 97.9 | 97.9 | 98.1 | 98.2 | 98.4 | 98.2 | 98.2 |
| | to R410A) | | | | | | | | |
| Refrigerating | % (relative | 112.5 | 112.3 | 111.9 | 111.6 | 111.2 | 110.7 | 109.8 | 109.5 |
| capacity ratio | to R410A) | | | | | | | | |

TABLE 93

| Item | Unit | Ex. 288 | Ex. 289 | Ex. 290 | Comp. Ex. 112 | Ex. 291 | Ex. 292 | Ex. 293 | Ex. 294 |
|---|---|---|---|---|---|---|---|---|---|
| HFO-1132(E) | Mass % | 20.0 | 25.0 | 30.0 | 35.0 | 10.0 | 15.0 | 20.0 | 25.0 |
| HFO-1123 | Mass % | 25.9 | 20.9 | 15.9 | 10.9 | 30.9 | 25.9 | 20.9 | 15.9 |
| R1234yf | Mass % | 10.0 | 10.0 | 10.0 | 10.0 | 15.0 | 15.0 | 15.0 | 15.0 |
| R32 | Mass % | 44.1 | 44.1 | 44.1 | 44.1 | 44.1 | 44.1 | 44.1 | 44.1 |
| GWP | — | 299 | 299 | 299 | 299 | 299 | 299 | 299 | 299 |
| COP ratio | % (relative | 98.3 | 98.5 | 98.6 | 98.8 | 98.6 | 98.6 | 98.7 | 98.9 |
| | to R410A) | | | | | | | | |
| Refrigerating | % (relative | 109.2 | 108.8 | 108.4 | 108.0 | 107.0 | 106.7 | 106.4 | 106.0 |
| capacity ratio | to R410A) | | | | | | | | |

TABLE 94

| Item | Unit | Ex. 295 | Comp. Ex. 113 | Ex. 296 | Ex. 297 | Ex. 298 | Ex. 299 | Ex. 300 | Ex. 301 |
|---|---|---|---|---|---|---|---|---|---|
| HFO-1132(E) | Mass % | 30.0 | 35.0 | 10.0 | 15.0 | 20.0 | 25.0 | 30.0 | 10.0 |
| HFO-1123 | Mass % | 10.9 | 5.9 | 25.9 | 20.9 | 15.9 | 10.9 | 5.9 | 20.9 |
| R1234yf | Mass % | 15.0 | 15.0 | 20.0 | 20.0 | 20.0 | 20.0 | 20.0 | 25.0 |
| R32 | Mass % | 44.1 | 44.1 | 44.1 | 44.1 | 44.1 | 44.1 | 44.1 | 44.1 |
| GWP | — | 299 | 299 | 299 | 299 | 299 | 299 | 299 | 299 |
| COP ratio | % (relative | 99.0 | 99.2 | 99.0 | 99.0 | 99.2 | 99.3 | 99.4 | 99.4 |
| | to R410A) | | | | | | | | |
| Refrigerating | % (relative | 105.6 | 105.2 | 104.1 | 103.9 | 103.6 | 103.2 | 102.8 | 101.2 |
| capacity ratio | to R410A) | | | | | | | | |

TABLE 95

| Item | Unit | Ex. 302 | Ex. 303 | Ex. 304 | Ex. 305 | Ex. 306 | Ex. 307 | Ex. 308 | Ex. 309 |
|---|---|---|---|---|---|---|---|---|---|
| HFO-1132(E) | Mass % | 15.0 | 20.0 | 25.0 | 10.0 | 15.0 | 20.0 | 10.0 | 15.0 |
| HFO-1123 | Mass % | 15.9 | 10.9 | 5.9 | 15.9 | 10.9 | 5.9 | 10.9 | 5.9 |
| R1234yf | Mass % | 25.0 | 25.0 | 25.0 | 30.0 | 30.0 | 30.0 | 35.0 | 35.0 |
| R32 | Mass % | 44.1 | 44.1 | 44.1 | 44.1 | 44.1 | 44.1 | 44.1 | 44.1 |
| GWP | — | 299 | 299 | 299 | 299 | 299 | 299 | 299 | 299 |
| COP ratio | % (relative | 99.5 | 99.6 | 99.7 | 99.8 | 99.9 | 100.0 | 100.3 | 100.4 |
| | to R410A) | | | | | | | | |
| Refrigerating | % (relative | 101.0 | 100.7 | 100.3 | 98.3 | 98.0 | 97.8 | 95.3 | 95.1 |
| capacity ratio | to R410A) | | | | | | | | |

TABLE 96

| Item | Unit | Ex. 400 |
|---|---|---|
| HFO-1132(E) | Mass % | 10.0 |
| HFO-1123 | Mass % | 5.9 |
| R1234yf | Mass % | 40.0 |
| R32 | Mass % | 44.1 |
| GWP | — | 299 |
| COP ratio | % (relative to R410A) | 100.7 |
| Refrigerating capacity ratio | % (relative to R410A) | 92.3 |

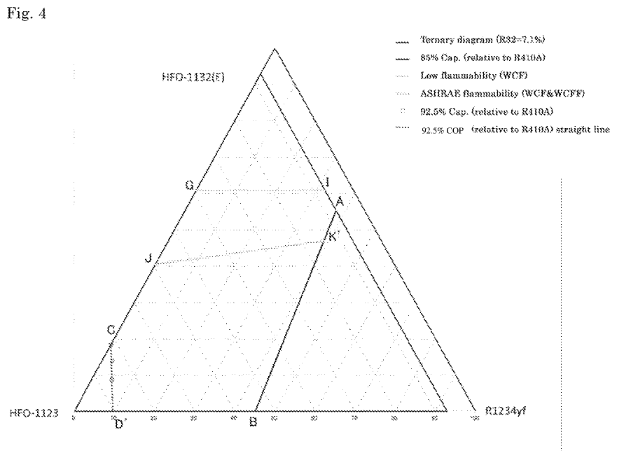

The above results indicate that the refrigerating capacity ratio relative to R410A is 85% or more in the following cases:
When the mass % of HFO-1132(E), HFO-1123, R1234yf, and R32 based on their sum is respectively represented by x, y, z, and a, in a ternary composition diagram in which the sum of HFO-1132(E), HFO-1123, and R1234yf is (100−a) mass %, a straight line connecting a point (0.0, 100.0−a, 0.0) and a point (0.0, 0.0, 100.0−a) is the base, and the point (0.0, 100.0−a, 0.0) is on the left side, if 0<a≤11.1, coordinates (x,y,z) in the ternary composition diagram are on, or on the left side of, a straight line AB that connects point A (0.0134a²−1.9681a+68.6, 0.0, −0.0134a²+0.9681a+31.4) and point B (0.0, 0.0144a²−1.6377a+58.7, −0.0144a²+0.6377a+41.3);
if 11.1<a≤18.2, coordinates (x,y,z) in the ternary composition diagram are on, or on the left side of, a straight line AB that connects point A (0.0112a²−1.9337a+68.484, 0.0, −0.0112a²+0.9337a+31.516) and point B (0.0, 0.0075a²−1.5156a+58.199, −0.0075a²+0.5156a+41.801);
if 18.2a<a≤26.7, coordinates (x,y,z) in the ternary composition diagram are on, or on the left side of, a straight line AB that connects point A (0.0107a²−1.9142a+68.305, 0.0, −0.0107a²+0.9142a+31.695) and point B (0.0, 0.009a²−1.6045a+59.318, −0.009a²+0.6045a+40.682);
if 26.7<a≤36.7, coordinates (x,y,z) in the ternary composition diagram are on, or on the left side of, a straight line AB that connects point A (0.0103a²−1.9225a+68.793, 0.0, −0.0103a²+0.9225a+31.207) and point B (0.0, 0.0046a²−1.41a+57.286, −0.0046a²+0.41a+42.714); and
if 36.7<a≤46.7, coordinates (x,y,z) in the ternary composition diagram are on, or on the left side of, a straight line AB that connects point A (0.0085a²−1.8102a+67.1, 0.0, −0.0085a²+0.8102a+32.9) and point B (0.0, 0.0012a²−1.1659a+52.95, −0.0012a²+0.1659a+47.05).
Actual points having a refrigerating capacity ratio of 85% or more form a curved line that connects point A and point B in FIG. 3, and that extends toward the 1234yf side. Accordingly, when coordinates are on, or on the left side of, the straight line AB, the refrigerating capacity ratio relative to R410A is 85% or more.
Similarly, it was also found that in the ternary composition diagram, if 0<a≤11.1, when coordinates (x,y,z) are on, or on the left side of, a straight line D′C that connects point D′ (0.0, 0.0224a²+0.968a+75.4, −0.0224a²−1.968a+24.6) and point C (−0.2304a²−0.4062a+32.9, 0.2304a²−0.5938a+67.1, 0.0); or if 11.1<a≤46.7, when coordinates are in the entire region, the COP ratio relative to that of R410A is 92.5% or more.
In FIG. 3, the COP ratio of 92.5% or more forms a curved line CD. In FIG. 3, an approximate line formed by connecting three points: point C (32.9, 67.1, 0.0) and points (26.6, 68.4, 5) (19.5, 70.5, 10) where the COP ratio is 92.5% when the concentration of R1234yf is 5 mass % and 10 mass was obtained, and a straight line that connects point C and point D′ (0, 75.4, 24.6), which is the intersection of the approximate line and a point where the concentration of HFO-1132(E) is 0.0 mass % was defined as a line segment D′C. In FIG. 4, point D′(0, 83.4, 9.5) was similarly obtained from an approximate curve formed by connecting point C (18.4, 74.5, 0) and points (13.9, 76.5, 2.5) (8.7, 79.2, 5) where the COP ratio is 92.5%, and a straight line that connects point C and point D′ was defined as the straight line D′C.
The composition of each mixture was defined as WCF. A leak simulation was performed using NIST Standard Reference Database REFLEAK Version 4.0 under the conditions of Equipment, Storage, Shipping, Leak, and Recharge according to the ASHRAE Standard 34-2013. The most flammable fraction was defined as WCFF.
For the flammability, the burning velocity was measured according to the ANSI/ASHRAE Standard 34-2013. Both WCF and WCFF having a burning velocity of 10 cm/s or less were determined to be classified as “Class 2L (lower flammability).”
A burning velocity test was performed using the apparatus shown in FIG. 1 in the following manner. First, the mixed refrigerants used had a purity of 99.5% or more, and were degassed by repeating a cycle of freezing, pumping, and thawing until no traces of air were observed on the vacuum gauge. The burning velocity was measured by the closed method. The initial temperature was ambient temperature. Ignition was performed by generating an electric spark between the electrodes in the center of a sample cell. The duration of the discharge was 1.0 to 9.9 ms, and the ignition energy was typically about 0.1 to 1.0 J. The spread of the flame was visualized using schlieren photographs. A cylindrical container (inner diameter: 155 mm, length: 198 mm) equipped with two light transmission acrylic windows was used as the sample cell, and a xenon lamp was used as the light source. Schlieren images of the flame were recorded by a high-speed digital video camera at a frame rate of 600 fps and stored on a PC.
The results are shown in Tables 97 to 104.

TABLE 97

| Item | | | Comp. Ex. 6 | Comp. Ex. 13 | Comp. Ex. 19 | Comp. Ex. 24 | Comp. Ex. 29 | Comp. Ex. 34 |
|---|---|---|---|---|---|---|---|---|
| WCF | HFO-1132(E) | Mass % | 72.0 | 60.9 | 55.8 | 52.1 | 48.6 | 45.4 |
| | HFO-1123 | Mass % | 28.0 | 32.0 | 33.1 | 33.4 | 33.2 | 32.7 |
| | R1234yf | Mass % | 0.0 | 0.0 | 0.0 | 0 | 0 | 0 |
| | R32 | Mass % | 0.0 | 7.1 | 11.1 | 14.5 | 18.2 | 21.9 |

| | | | | | | | |
|---|---|---|---|---|---|---|---|
| Burning velocity (WCF) | cm/s | 10 | 10 | 10 | 10 | 10 | 10 |

TABLE 98

| Item | | | Comp. Ex. 39 | Comp. Ex. 45 | Comp. Ex. 51 | Comp. Ex. 57 | Comp. Ex. 62 |
|---|---|---|---|---|---|---|---|
| WCF | HFO-1132(E) | Mass % | 41.8 | 40 | 35.7 | 32 | 30.4 |
| | HFO-1123 | Mass % | 31.5 | 30.7 | 23.6 | 23.9 | 21.8 |
| | R1234yf | Mass % | 0 | 0 | 0 | 0 | 0 |
| | R32 | Mass % | 26.7 | 29.3 | 36.7 | 44.1 | 47.8 |

| | | | | | | |
|---|---|---|---|---|---|---|
| Burning velocity (WCF) | cm/s | 10 | 10 | 10 | 10 | 10 |

TABLE 99

| Item | | | Comp. Ex. 7 | Comp. Ex. 14 | Comp. Ex. 20 | Comp. Ex. 25 | Comp. Ex. 30 | Comp. Ex. 35 |
|---|---|---|---|---|---|---|---|---|
| WCF | HFO-1132(E) | Mass % | 72.0 | 60.9 | 55.8 | 52.1 | 48.6 | 45.4 |
| | HFO-1123 | Mass % | 0.0 | 0.0 | 0.0 | 0 | 0 | 0 |
| | R1234yf | Mass % | 28.0 | 32.0 | 33.1 | 33.4 | 33.2 | 32.7 |
| | R32 | Mass % | 0.0 | 7.1 | 11.1 | 14.5 | 18.2 | 21.9 |

| | | | | | | | |
|---|---|---|---|---|---|---|---|
| Burning velocity (WCF) | cm/s | 10 | 10 | 10 | 10 | 10 | 10 |

TABLE 100

| | | | Comp. | Comp. | Comp. | Comp. | Comp. |
|---|---|---|---|---|---|---|---|
| Item | | | Ex. 40 | Ex. 46 | Ex. 52 | Ex. 58 | Ex. 63 |
| WCF | HFO-1132 | Mass % | 41.8 | 40 | 35.7 | 32 | 30.4 |
| | (E) | | | | | | |
| | HFO-1123 | Mass % | 0 | 0 | 0 | 0 | 0 |
| | R1234yf | Mass % | 31.5 | 30.7 | 23.6 | 23.9 | 21.8 |
| | R32 | Mass % | 26.7 | 29.3 | 36.7 | 44.1 | 47.8 |

| | | | | | | |
|---|---|---|---|---|---|---|
| Burning velocity | cm/s | 10 | 10 | 10 | 10 | 10 |
| (WCF) | | | | | | |

TABLE 101

| | | | Comp. | Comp. | Comp. | Comp. | Comp. | Comp. |
|---|---|---|---|---|---|---|---|---|
| Item | | | Ex. 8 | Ex. 15 | Ex. 21 | Ex. 26 | Ex. 31 | Ex. 36 |
| WCF | HFO-1132(E) | Mass % | 47.1 | 40.5 | 37.0 | 34.3 | 32.0 | 30.3 |
| | HFO-1123 | Mass % | 52.9 | 52.4 | 51.9 | 51.2 | 49.8 | 47.8 |
| | R1234yf | Mass % | 0.0 | 0.0 | 0.0 | 0.0 | 0.0 | 0.0 |
| | R32 | Mass % | 0.0 | 7.1 | 11.1 | 14.5 | 18.2 | 21.9 |
| Leak condition that results | | | Storage/ | Storage/ | Storage/ | Storage/ | Storage/ | Storage/ |
| in WCFF | | | Shipping | Shipping | Shipping | Shipping | Shipping | Shipping |
| | | | −40° C. | −40° C. | −40° C. | −40° C. | −40° C. | −40° C. |
| | | | 92% | 92% | 92% | 92% | 92% | 92% |
| | | | release, | release, | release, | release, | release, | release, |
| | | | liquid | liquid | liquid | liquid | liquid | liquid |
| | | | phase side | phase side | phase side | phase side | phase side | phase side |
| WCFF | HFO-1132(E) | Mass % | 72.0 | 62.4 | 56.2 | 50.6 | 45.1 | 40.0 |
| | HFO-1123 | Mass % | 28.0 | 31.6 | 33.0 | 33.4 | 32.5 | 30.5 |
| | R1234yf | Mass % | 0.0 | 0.0 | 0.0 | 20.4 | 0.0 | 0.0 |
| | R32 | Mass % | 0.0 | 50.9 | 10.8 | 16.0 | 22.4 | 29.5 |

| | | | | | | | |
|---|---|---|---|---|---|---|---|
| Burning velocity (WCF) | cm/s | 8 or less | 8 or less | 8 or less | 8 or less | 8 or less | 8 or less |
| Burning velocity (WCFF) | cm/s | 10 | 10 | 10 | 10 | 10 | 10 |

TABLE 102

| | | | Comp. | Comp. | Comp. | Comp. | Comp. |
|---|---|---|---|---|---|---|---|
| Item | | | Ex. 41 | Ex. 47 | Ex. 53 | Ex. 59 | Ex. 64 |
| WCF | HFO-1132(E) | Mass % | 29.1 | 28.8 | 29.3 | 29.4 | 28.9 |
| | HFO-1123 | Mass % | 44.2 | 41.9 | 34.0 | 26.5 | 23.3 |
| | R1234yf | Mass % | 0.0 | 0.0 | 0.0 | 0.0 | 0.0 |
| | R32 | Mass % | 26.7 | 29.3 | 36.7 | 44.1 | 47.8 |
| Leak condition that results in | | | Storage/ | Storage/ | Storage/ | Storage/ | Storage/ |
| WCFF | | | Shipping | Shipping | Shipping | Shipping | Shipping |
| | | | −40° C. | −40° C. | −40° C. | −40° C. | −40° C. |
| | | | 92% | 92% | 92% | 90% | 86% |
| | | | release, | release, | release, | release, | release, |
| | | | liquid | liquid | liquid | gas | gas |
| | | | phase side | phase side | phase side | phase side | phase side |
| WCFF | HFO-1132(E) | Mass % | 34.6 | 32.2 | 27.7 | 28.3 | 27.5 |
| | HFO-1123 | Mass % | 26.5 | 23.9 | 17.5 | 18.2 | 16.7 |
| | R1234yf | Mass % | 0.0 | 0.0 | 0.0 | 0.0 | 0.0 |
| | R32 | Mass % | 38.9 | 43.9 | 54.8 | 53.5 | 55.8 |

| | | | | | | |
|---|---|---|---|---|---|---|
| Burning velocity (WCF) | cm/s | 8 or less | 8 or less | 8.3 | 9.3 | 9.6 |
| Burning velocity (WCFF) | cm/s | 10 | 10 | 10 | 10 | 10 |

TABLE 103

| | | | Comp. | Comp. | Comp. | Comp. | Comp. | Comp. |
|---|---|---|---|---|---|---|---|---|
| Item | | | Ex. 9 | Ex. 16 | Ex. 22 | Ex. 27 | Ex. 32 | Ex. 37 |
| WCF | HFO-1132(E) | Mass % | 61.7 | 47.0 | 41.0 | 36.5 | 32.5 | 28.8 |
| | HFO-1123 | Mass % | 5.9 | 7.2 | 6.5 | 5.6 | 4.0 | 2.4 |
| | R1234yf | Mass % | 32.4 | 38.7 | 41.4 | 43.4 | 45.3 | 46.9 |
| | R32 | Mass % | 0.0 | 7.1 | 11.1 | 14.5 | 18.2 | 21.9 |
| Leak condition that results in | | | Storage/ | Storage/ | Storage/ | Storage/ | Storage/ | Storage/ |
| WCFF | | | Shipping | Shipping | Shipping | Shipping | Shipping | Shipping |
| | | | −40° C. | −40° C. | −40° C. | −40° C. | −40° C. | −40° C. |
| | | | 0% | 0% | 0% | 92% | 0% | 0% |
| | | | release, | release, | release, | release, | release, | release, |
| | | | gas | gas | gas | liquid | gas | gas |
| | | | phase side | phase side | phase side | phase side | phase side | phase side |
| WCFF | HFO-1132(E) | Mass % | 72.0 | 56.2 | 50.4 | 46.0 | 42.4 | 39.1 |
| | HFO-1123 | Mass % | 10.5 | 12.6 | 11.4 | 10.1 | 7.4 | 4.4 |
| | R1234yf | Mass % | 17.5 | 20.4 | 21.8 | 22.9 | 24.3 | 25.7 |
| | R32 | Mass % | 0.0 | 10.8 | 16.3 | 21.0 | 25.9 | 30.8 |

| | | | | | | | |
|---|---|---|---|---|---|---|---|
| Burning velocity (WCF) | cm/s | 8 or less | 8 or less | 8 or less | 8 or less | 8 or less | 8 or less |
| Burning velocity (WCFF) | cm/s | 10 | 10 | 10 | 10 | 10 | 10 |

TABLE 104

| | | | Comp. | Comp. | Comp. | Comp. | Comp. |
|---|---|---|---|---|---|---|---|
| Item | | | Ex. 42 | Ex. 48 | Ex. 54 | Ex. 60 | Ex. 65 |
| WCF | HFO-1132(E) | Mass % | 24.8 | 24.3 | 22.5 | 21.1 | 20.4 |
| | HFO-1123 | Mass % | 0.0 | 0.0 | 0.0 | 0.0 | 0.0 |
| | R1234yf | Mass % | 48.5 | 46.4 | 40.8 | 34.8 | 31.8 |
| | R32 | Mass % | 26.7 | 29.3 | 36.7 | 44.1 | 47.8 |
| Leak condition that results in | | | Storage/ | Storage/ | Storage/ | Storage/ | Storage/ |
| WCFF | | | Shipping | Shipping | Shipping | Shipping | Shipping |
| | | | −40° C. | −40° C. | −40° C. | −40° C. | −40° C. |
| | | | 0% | 0% | 0% | 0% | 0% |
| | | | release, | release, | release, | release, | release, |
| | | | gas | gas | gas | gas | gas |
| | | | phase side | phase side | phase side | phase side | phase side |
| WCFF | HFO-1132(E) | Mass % | 35.3 | 34.3 | 31.3 | 29.1 | 28.1 |
| | HFO-1123 | Mass % | 0.0 | 0.0 | 0.0 | 0.0 | 0.0 |
| | R1234yf | Mass % | 27.4 | 26.2 | 23.1 | 19.8 | 18.2 |
| | R32 | Mass % | 37.3 | 39.6 | 45.6 | 51.1 | 53.7 |

| | | | | | | |
|---|---|---|---|---|---|---|
| Burning velocity (WCF) | cm/s | 8 or less | 8 or less | 8 or less | 8 or less | 8 or less |
| Burning velocity (WCFF) | cm/s | 10 | 10 | 10 | 10 | 10 |

The results in Tables 97 to 100 indicate that the refrigerant has a WCF lower flammability in the following cases:
When the mass % of HFO-1132(E), HFO-1123, R1234yf, and R32 based on their sum in the mixed refrigerant of HFO-1132(E), HFO-1123, R1234yf, and R32 is respectively represented by x, y, z, and a, coordinates (x,y,z) in a ternary composition diagram in which the sum of HFO-1132(E), HFO-1123, and R1234yf is (100−a) mass % and a straight line connecting a point (0.0, 100.0−a, 0.0) and a point (0.0, 0.0, 100.0−a) is the base, if 0<a≤11.1, coordinates (x,y,z) in the ternary composition diagram are on or below a straight line GI that connects point G (0.026a²−1.7478a+72.0, −0.026a²+0.7478a+28.0, 0.0) and point I (0.026a²−1.7478a+72.0, 0.0, −0.026a²+0.7478a+28.0);
   if 11.1<a≤18.2, coordinates (x,y,z) in the ternary composition diagram are on or below a straight line GI that connects point G (0.02a²−1.6013a+71.105, −0.02a²+0.6013a+28.895, 0.0) and point I (0.02a²−1.6013a+71.105, 0.0, −0.02a²+0.6013a+28.895); if 18.2<a≤26.7, coordinates (x,y,z) in the ternary composition diagram are on or below a straight line GI that connects point G (0.0135a²−1.4068a+69.727, −0.0135a²+0.4068a+30.273, 0.0) and point I (0.0135a²−1.4068a+69.727, 0.0, −0.0135a²+0.4068a+30.273); if 26.7<a≤36.7, coordinates (x,y,z) in the ternary composition diagram are on or below a straight line GI that connects point G (0.0111a²−1.3152a+68.986, −0.0111a²+0.3152a+31.014, 0.0) and point I (0.0111a²−1.3152a+68.986, 0.0, −0.0111a²+0.3152a+31.014); and if 36.7<a≤46.7, coordinates (x,y,z) in the ternary composition diagram are on or below a straight line GI that connects point G (0.0061a²−0.9918a+63.902, −0.0061a²−0.0082a+36.098,0.0) and point I (0.0061a²−0.9918a+63.902, 0.0, −0.0061a²−0.0082a+36.098).
Three points corresponding to point G (Table 105) and point I (Table 106) were individually obtained in each of the following five ranges by calculation, and their approximate expressions were obtained.

TABLE 105

| Item | 11.1 ≥ R32 > 0 | | | 18.2 ≥ R32 ≥ 11.1 | | | 26.7 ≥ R32 ≥ 18.2 | | |
|---|---|---|---|---|---|---|---|---|---|
| R32 | 0 | 7.1 | 11.1 | 11.1 | 14.5 | 18.2 | 18.2 | 21.9 | 26.7 |
| HFO-1132(E) | 72.0 | 60.9 | 55.8 | 55.8 | 52.1 | 48.6 | 48.6 | 45.4 | 41.8 |
| HFO-1123 | 28.0 | 32.0 | 33.1 | 33.1 | 33.4 | 33.2 | 33.2 | 32.7 | 31.5 |
| R1234yf | 0 | 0 | 0 | 0 | 0 | 0 | 0 | 0 | 0 |

| | | | |
|---|---|---|---|
| R32 | a | a | a |
| HFO-1132(E) | 0.026a² − 1.7478a + 72.0 | 0.02a² − 1.6013a + 71.105 | 0.0135a² − 1.4068a + 69.727 |
| Approximate | | | |
| expression | | | |
| HFO-1123 | −0.026a² + 0..7478a + 28.0 | −0.02a² + 0..6013a + 28.895 | −0.0135a² + 0.4068a + 30.273 |
| Approximate | | | |
| expression | | | |
| R1234yf | 0 | 0 | 0 |
| Approximate | | | |
| expression | | | |

| Item | 36.7 ≥ R32 ≥ 26.7 | | | 46.7 ≥ R32 ≥ 36.7 | | |
|---|---|---|---|---|---|---|
| R32 | 26.7 | 29.3 | 36.7 | 36.7 | 44.1 | 47.8 |
| HFO-1132(E) | 41.8 | 40.0 | 35.7 | 35.7 | 32.0 | 30.4 |
| HFO-1123 | 31.5 | 30.7 | 27.6 | 27.6 | 23.9 | 21.8 |
| R1234yf | 0 | 0 | 0 | 0 | 0 | 0 |

| | | |
|---|---|---|
| R32 | a | a |
| HFO-1132(E) | 0.0111a2 − 1.3152a + 68.986 | 0.0061a² − 0.9918a + 63.902 |
| Approximate | | |
| expression | | |
| HFO-1123 | −0.0111a2 + 0.3152a + 31.014 | −0.0061a² − 0.0082a + 36.098 |
| Approximate | | |
| expression | | |
| R1234yf | 0 | 0 |
| Approximate | | |
| expression | | |

TABLE 106

| Item | 11.1 ≥ R32 > 0 | | | 18.2 ≥ R32 ≥ 11.1 | | | 26.7 ≥ R32 ≥ 18.2 | | |
|---|---|---|---|---|---|---|---|---|---|
| R32 | 0 | 7.1 | 11.1 | 11.1 | 14.5 | 18.2 | 18.2 | 21.9 | 26.7 |
| HFO-1132(E) | 72.0 | 60.9 | 55.8 | 55.8 | 52.1 | 48.6 | 48.6 | 45.4 | 41.8 |
| HFO-1123 | 0 | 0 | 0 | 0 | 0 | 0 | 0 | 0 | 0 |
| R1234yf | 28.0 | 32.0 | 33.1 | 33.1 | 33.4 | 33.2 | 33.2 | 32.7 | 31.5 |

| | | | |
|---|---|---|---|
| R32 | a | a | a |
| HFO-1132(E) | 0.026a² − 1.7478a + 72.0 | 0.02a² − 1.6013a + 71.105 | 0.0135a² − 1.4068a + 69.727 |
| Approximate | | | |
| expression | | | |
| HFO-1123 | 0 | 0 | 0 |
| Approximate | | | |
| expression | | | |
| R1234yf | −0.026a² + 0.7478a + 28.0 | −0.02a² + 0.6013a + 28.895 | −0.0135a² + 0.4068a + 30.273 |
| Approximate | | | |
| expression | | | |

| Item | 36.7 ≥ R32 ≥ 26.7 | | | 46.7 ≥ R32 ≥ 36.7 | | |
|---|---|---|---|---|---|---|
| R32 | 26.7 | 29.3 | 36.7 | 36.7 | 44.1 | 47.8 |
| HFO-1132(E) | 41.8 | 40.0 | 35.7 | 35.7 | 32.0 | 30.4 |
| HFO-1123 | 0 | 0 | 0 | 0 | 0 | 0 |
| R1234yf | 31.5 | 30.7 | 23.6 | 23.6 | 23.5 | 21.8 |

| | | |
|---|---|---|
| R32 | x | x |
| HFO-1132(E) | 0.0111a² − 1.3152a + 68.986 | 0.0061a² − 0.9918a + 63.902 |
| Approximate | | |
| expression | | |
| HFO-1123 | 0 | 0 |
| Approximate | | |
| expression | | |
| R1234yf | −0.0111a² + 0.3152a + 31.014 | −0.0061a² − 0.0082a + 36.098 |
| Approximate | | |
| expression | | |

The results in Tables 101 to 104 indicate that the refrigerant is determined to have a WCFF lower flammability, and the flammability classification according to the ASHRAE Standard is “2L (flammability)” in the following cases:
When the mass % of HFO-1132(E), HFO-1123, R1234yf, and R32 based on their sum in the mixed refrigerant of HFO-1132(E), HFO-1123, R1234yf, and R32 is respectively represented by x, y, z, and a, in a ternary composition diagram in which the sum of HFO-1132(E), HFO-1123, and R1234yf is (100−a) mass % and a straight line connecting a point (0.0, 100.0−a, 0.0) and a point (0.0, 0.0, 100.0−a) is the base, if 0<a≤11.1, coordinates (x,y,z) in the ternary composition diagram are on or below a straight line JK′ that connects point J (0.0049a²−0.9645a+47.1, −0.0049a²−0.0355a+52.9, 0.0) and point K′(0.0514a²−2.4353a+61.7, −0.0323a²+0.4122a+5.9, −0.0191a²+1.0231a+32.4); if 11.1<a≤18.2, coordinates are on a straight line JK′ that connects point J (0.0243a²−1.4161a+49.725, −0.0243a²+0.4161a+50.275, 0.0) and point K′(0.0341a²−2.1977a+61.187, −0.0236a²+0.34a+5.636, −0.0105a²+0.8577a+33.177); if 18.2<a≤26.7, coordinates are on or below a straight line JK′ that connects point J (0.0246a²−1.4476a+50.184, −0.0246a²+0.4476a+49.816, 0.0) and point K′ (0.0196a²−1.7863a+58.515, −0.0079a²−0.1136a+8.702, −0.0117a²+0.8999a+32.783); if 26.7<a≤36.7, coordinates are on or below a straight line JK′ that connects point J (0.0183a²−1.1399a+46.493, −0.0183a²+0.1399a+53.507, 0.0) and point K′ (−0.0051a²+0.0929a+25.95, 0.0, 0.0051a²−1.0929a+74.05); and if 36.7<a≤46.7, coordinates are on or below a straight line JK′ that connects point J (−0.0134a²+1.0956a+7.13, 0.0134a²−2.0956a+92.87, 0.0) and point K′(−1.892a+29.443, 0.0, 0.892a+70.557).
Actual points having a WCFF lower flammability form a curved line that connects point J and point K′ (on the straight line AB) in FIG. 3 and extends toward the HFO-1132(E) side. Accordingly, when coordinates are on or below the straight line JK′, WCFF lower flammability is achieved.
Three points corresponding to point J (Table 107) and point K′ (Table 108) were individually obtained in each of the following five ranges by calculation, and their approximate expressions were obtained.

TABLE 107

| Item | 11.1 ≥ R32 > 0 | | | 18.2 ≥ R32 ≥ 11.1 | | | 26.7 ≥ R32 ≥ 18.2 | | |
|---|---|---|---|---|---|---|---|---|---|
| R32 | 0 | 7.1 | 11.1 | 11.1 | 14.5 | 18.2 | 18.2 | 21.9 | 26.7 |
| HFO-1132(E) | 47.1 | 40.5 | 37 | 37.0 | 34.3 | 32.0 | 32.0 | 30.3 | 29.1 |
| HFO-1123 | 52.9 | 52.4 | 51.9 | 51.9 | 51.2 | 49.8 | 49.8 | 47.8 | 44.2 |
| R1234yf | 0 | 0 | 0 | 0 | 0 | 0 | 0 | 0 | 0 |

| | | | |
|---|---|---|---|
| R32 | a | a | a |
| HFO-1132(E) | 0.0049a² − 0.9645a + 47.1 | 0.0243a² − 1.4161a + 49.725 | 0.0246a² − 1.4476a + 50.184 |
| Approximate | | | |
| expression | | | |
| HFO-1123 | −0.0049a² − 0.0355a + 52.9 | −0.0243a² + 0.4161a + 50.275 | −0.0246a² + 0.4476a + 49.816 |
| Approximate | | | |
| expression | | | |
| R1234yf | 0 | 0 | 0 |
| Approximate | | | |
| expression | | | |

| Item | 36.7 ≥ R32 ≥ 26.7 | | | 47.8 ≥ R32 ≥ 36.7 | | |
|---|---|---|---|---|---|---|
| R32 | 26.7 | 29.3 | 36.7 | 36.7 | 44.1 | 47.8 |
| HFO-1132(E) | 29.1 | 28.8 | 29.3 | 29.3 | 29.4 | 28.9 |
| HFO-1123 | 44.2 | 41.9 | 34.0 | 34.0 | 26.5 | 23.3 |
| R1234yf | 0 | 0 | 0 | 0 | 0 | 0 |

| | | |
|---|---|---|
| R32 | a | a |
| HFO-1132(E) | 0.0183a² − 1.1399a + 46.493 | −0.0134a² + 1.0956a + 7.13 |
| Approximate | | |
| expression | | |
| HFO-1123 | −0.0183a² + 0.1399a + 53.507 | 0.0134a² − 2.0956a + 92.87 |
| Approximate | | |
| expression | | |
| R1234yf | 0 | 0 |
| Approximate | | |
| expression | | |

TABLE 108

| Item | 11.1 ≥ R32 > 0 | | | 18.2 ≥ R32 ≥ 11.1 | | | 26.7 ≥ R32 ≥ 18.2 | | |
|---|---|---|---|---|---|---|---|---|---|
| R32 | 0 | 7.1 | 11.1 | 11.1 | 14.5 | 18.2 | 18.2 | 21.9 | 26.7 |
| HFO-1132(E) | 61.7 | 47.0 | 41.0 | 41.0 | 36.5 | 32.5 | 32.5 | 28.8 | 24.8 |
| HFO-1123 | 5.9 | 7.2 | 6.5 | 6.5 | 5.6 | 4.0 | 4.0 | 2.4 | 0 |
| R1234yf | 32.4 | 38.7 | 41.4 | 41.4 | 43.4 | 45.3 | 45.3 | 46.9 | 48.5 |

| | | | |
|---|---|---|---|
| R32 | x | x | x |
| HFO-1132(E) | 0.0514a² − 2.4353a + 61.7 | 0.0341a² − 2.1977a + 61.187 | 0.0196a² − 1.7863a + 58.515 |
| Approximate | | | |
| expression | | | |
| HFO-1123 | −0.0323a² + 0.41 22a + 5.9 | −0.0236a² + 0.34a + 5.636 | −0.0079a² − 0.1136a + 8.702 |
| Approximate | | | |
| expression | | | |
| R1234yf | −0.0191a² + 1.0231a + 32.4 | −0.0105a² + 0.8577a + 33.177 | −0.0117a² + 0.8999a + 32.783 |
| Approximate | | | |
| expression | | | |

| Item | 36.7 ≥ R32 ≥ 26.7 | | | 46.7 ≥ R32 ≥ 36.7 | | |
|---|---|---|---|---|---|---|
| R32 | 26.7 | 29.3 | 36.7 | 36.7 | 44.1 | 47.8 |
| HFO-1132(E) | 24.8 | 24.3 | 22.5 | 22.5 | 21.1 | 20.4 |
| HFO-1123 | 0 | 0 | 0 | 0 | 0 | 0 |
| R1234yf | 48.5 | 46.4 | 40.8 | 40.8 | 34.8 | 31.8 |

| | | |
|---|---|---|
| R32 | x | x |
| HFO-1132(E) | −0.0051a² + 0.0929a + 25.95 | −1.892a + 29.443 |
| Approximate | | |
| expression | | |
| HFO-1123 | 0 | 0 |
| Approximate | | |
| expression | | |
| R1234yf | 0.0051a² − 1.0929a + 74.05 | 0.892a + 70.557 |
| Approximate | | |
| expression | | |

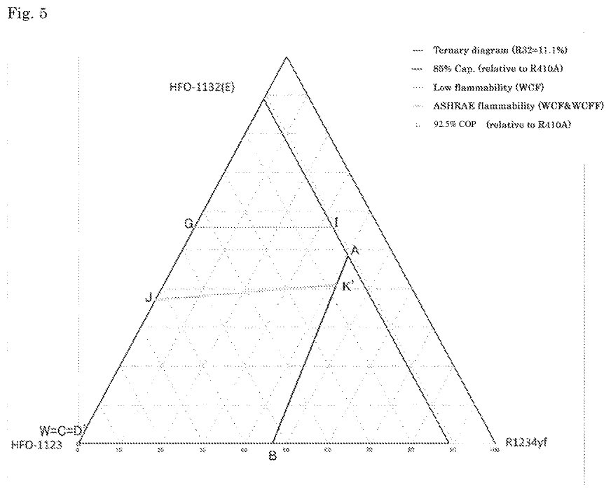

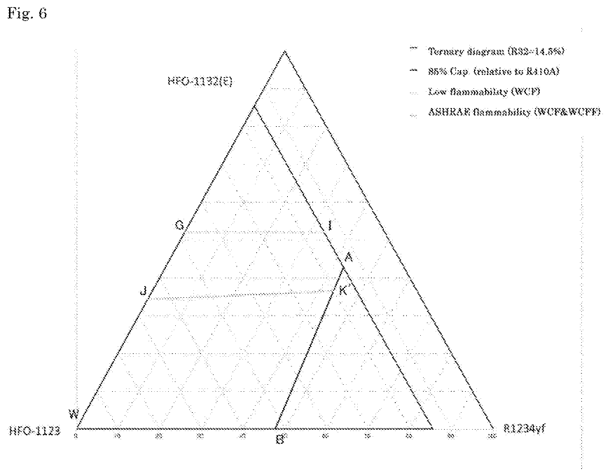

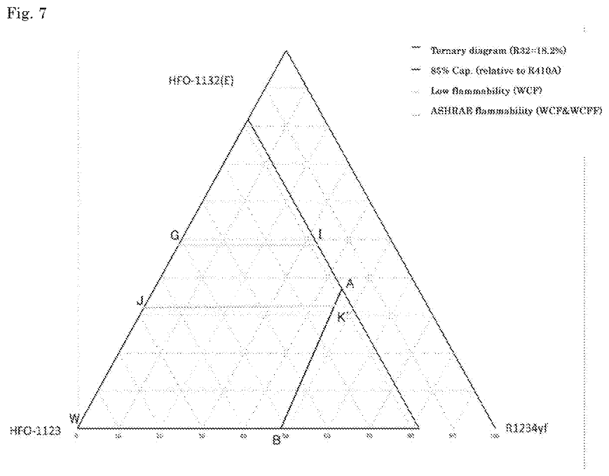

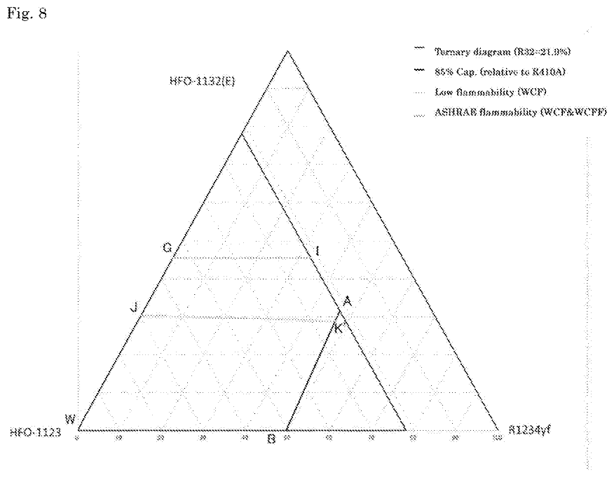

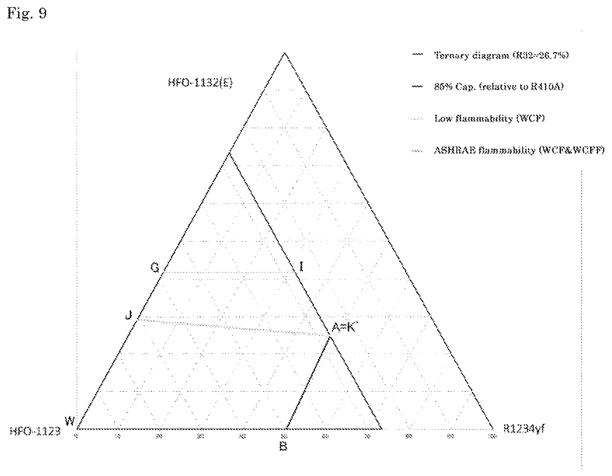

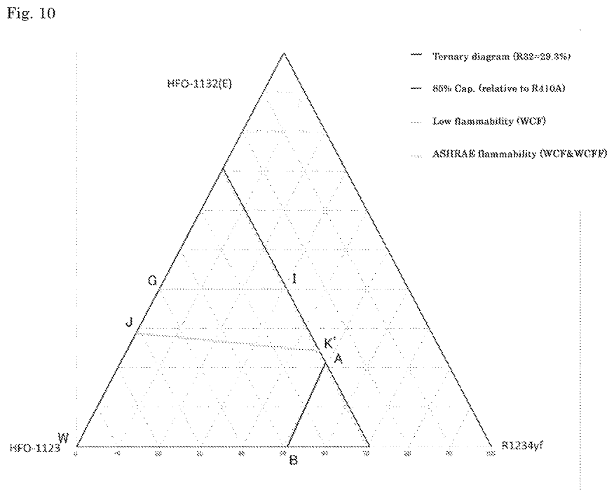

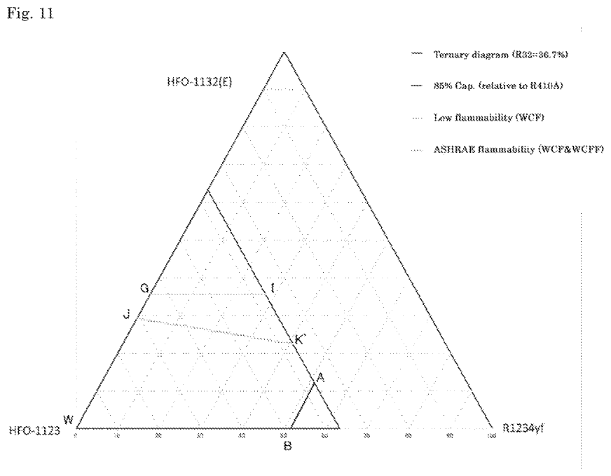

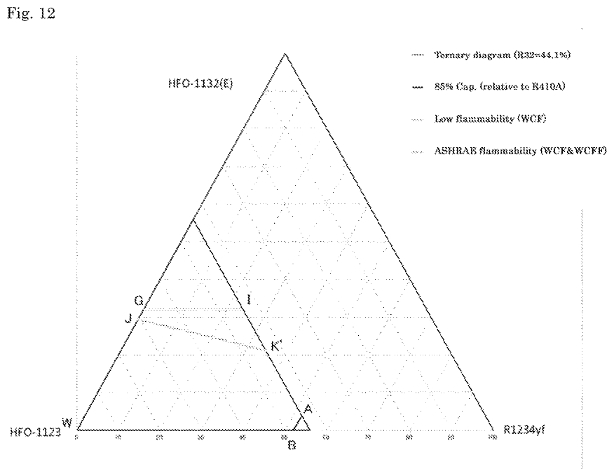

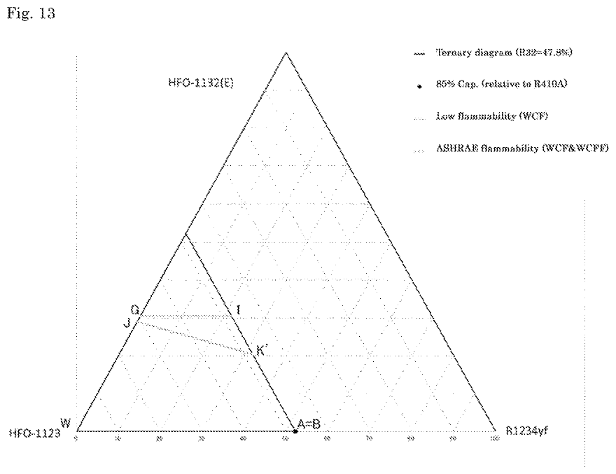

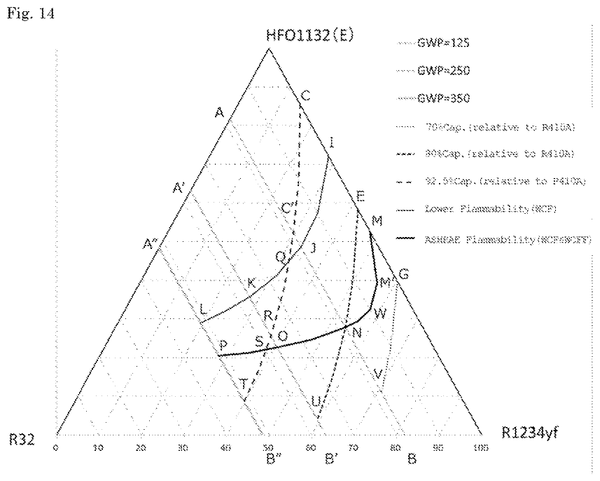

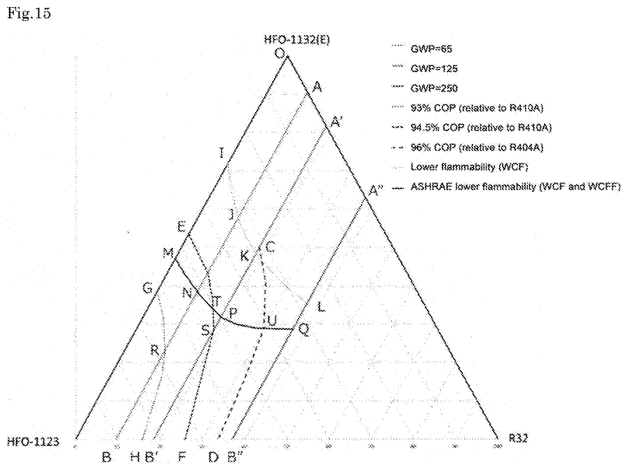

FIGS. 3 to 13 show compositions whose R32 content a (mass %) is 0 mass %, 7.1 mass %, 11.1 mass %, 14.5 mass %, 18.2 mass %, 21.9 mass %, 26.7 mass %, 29.3 mass %, 36.7 mass %, 44.1 mass %, and 47.8 mass %, respectively.
Points A, B, C, and D′ were obtained in the following manner according to approximate calculation.
Point A is a point where the content of HFO-1123 is 0 mass %, and a refrigerating capacity ratio of 85% relative to that of R410A is achieved. Three points corresponding to point A were obtained in each of the following five ranges by calculation, and their approximate expressions were obtained (Table 109).

TABLE 109

| Item | 11.1 ≥ R32 > 0 | | | 18.2 ≥ R32 ≥ 11.1 | | | 26.7 ≥ R32 ≥ 18.2 | | |
|---|---|---|---|---|---|---|---|---|---|
| R32 | 0 | 7.1 | 11.1 | 11.1 | 14.5 | 18.2 | 18.2 | 21.9 | 26.7 |
| HFO-1132(E) | 68.6 | 55.3 | 48.4 | 48.4 | 42.8 | 37 | 37 | 31.5 | 24.8 |
| HFO-1123 | 0 | 0 | 0 | 0 | 0 | 0 | 0 | 0 | 0 |
| R1234yf | 31.4 | 37.6 | 40.5 | 40.5 | 42.7 | 44.8 | 44.8 | 46.6 | 48.5 |

| | | | |
|---|---|---|---|
| R32 | a | a | a |
| HFO-1132(E) | 0.0134a² − 1.9681a + 68.6 | 0.0112a² − 1.9337a + 68.484 | 0.0107a² − 1.9142a + 68.305 |
| Approximate | | | |
| expression | | | |
| HFO-1123 | 0 | 0 | 0 |
| Approximate | | | |
| expression | | | |
| R1234yf | −0.0134a² + 0.9681a + 31.4 | −0.0112a² + 0.9337a + 31.516 | −0.0107a² + 0.9142a + 31.695 |
| Approximate | | | |
| expression | | | |

| Item | 36.7 ≥ R32 ≥ 26.7 | | | 46.7 ≥ R32 ≥ 36.7 | | |
|---|---|---|---|---|---|---|
| R32 | 26.7 | 29.3 | 36.7 | 36.7 | 44.1 | 47.8 |
| HFO-1132(E) | 24.8 | 21.3 | 12.1 | 12.1 | 3.8 | 0 |
| HFO-1123 | 0 | 0 | 0 | 0 | 0 | 0 |
| R1234yf | 48.5 | 49.4 | 51.2 | 51.2 | 52.1 | 52.2 |

| | | |
|---|---|---|
| R32 | a | a |
| HFO-1132(E) | 0.0103a² − 1.9225a + 68.793 | 0.0085a² − 1.8102a + 67.1 |
| Approximate | | |
| expression | | |
| HFO-1123 | 0 | 0 |
| Approximate | | |
| expression | | |
| R1234yf | −0.0103a² + 0.9225a + 31..207 | −0.0085a² + 0.8102a + 32.9 |
| Approximate | | |
| expression | | |

Point B is a point where the content of HFO-1132(E) is 0 mass %, and a refrigerating capacity ratio of 85% relative to that of R410A is achieved.
Three points corresponding to point B were obtained in each of the following five ranges by calculation, and their approximate expressions were obtained (Table 110).

TABLE 110

| Item | 11.1 ≥ R32 > 0 | | | 18.2 ≥ R32 ≥ 11.1 | | | 26.7 ≥ R32 ≥ 18.2 | | |
|---|---|---|---|---|---|---|---|---|---|
| R32 | 0 | 7.1 | 11.1 | 11.1 | 14.5 | 18.2 | 18.2 | 21.9 | 26.7 |
| HFO-1132(E) | 0 | 0 | 0 | 0 | 0 | 0 | 0 | 0 | 0 |
| HFO-1123 | 58.7 | 47.8 | 42.3 | 42.3 | 37.8 | 33.1 | 33.1 | 28.5 | 22.9 |
| R1234yf | 41.3 | 45.1 | 46.6 | 46.6 | 47.7 | 48.7 | 48.7 | 49.6 | 50.4 |

| | | | |
|---|---|---|---|
| R32 | a | a | a |
| HFO-1132(E) | 0 | 0 | 0 |
| Approximate | | | |
| expression | | | |
| HFO-1123 | 0.0144a² − 1.6377a + 58.7 | 0.0075a² − 1.5156a + 58.199 | 0.009a² − 1.6045a + 59.318 |
| Approximate | | | |
| expression | | | |
| R1234yf | −0.0144a² + 0.6377a + 41.3 | −0.0075a² + 0.5156a + 41.801 | −0.009a² + 0.6045a + 40.682 |
| Approximate | | | |
| expression | | | |

| Item | 36.7 ≥ R32 ≥ 26.7 | | | 46.7 ≥ R32 ≥ 36.7 | | |
|---|---|---|---|---|---|---|
| R32 | 26.7 | 29.3 | 36.7 | 36.7 | 44.1 | 47.8 |
| HFO-1132(E) | 0 | 0 | 0 | 0 | 0 | 0 |
| HFO-1123 | 22.9 | 19.9 | 11.7 | 11.8 | 3.9 | 0 |
| R1234yf | 50.4 | 50.8 | 51.6 | 51.5 | 52.0 | 52.2 |

| | | |
|---|---|---|
| R32 | a | a |
| HFO-1132(E) | 0 | 0 |
| Approximate | | |
| expression | | |
| HFO-1123 | 0.0046a² − 1.41a + 57.286 | 0.0012a² − 1.1659a + 52.95 |
| Approximate | | |
| expression | | |
| R1234yf | −0.0046a² + 0.41a + 42.714 | −0.0012a² + 0.1659a + 47.05 |
| Approximate | | |
| expression | | |

Point D′ is a point where the content of HFO-1132(E) is 0 mass %, and a COP ratio of 95.5% relative to that of R410A is achieved.
Three points corresponding to point D′ were obtained in each of the following by calculation, and their approximate expressions were obtained (Table 111).

TABLE 111

| Item | 11.1 ≥ R32 > 0 | | |
|---|---|---|---|
| R32 | 0 | 7.1 | 11.1 |
| HFO-1132(E) | 0 | 0 | 0 |
| HFO-1123 | 75.4 | 83.4 | 88.9 |
| R1234yf | 24.6 | 9.5 | 0 |

| | |
|---|---|
| R32 | a |
| HFO-1132(E) | 0 |
| Approximate | |
| expression | |
| HFO-1123 | 0.0224a² + 0.968a + 75.4 |
| Approximate | |
| expression | |
| R1234yf | −0.0224a² − 1.968a + 24.6 |
| Approximate | |
| expression | |

Point C is a point where the content of R1234yf is 0 mass %, and a COP ratio of 95.5% relative to that of R410A is achieved.
Three points corresponding to point C were obtained in each of the following by calculation, and their approximate expressions were obtained (Table 112).

TABLE 112

| Item | 11.1 ≥ R32 > 0 | | |
|---|---|---|---|
| R32 | 0 | 7.1 | 11.1 |
| HFO-1132(E) | 32.9 | 18.4 | 0 |
| HFO-1123 | 67.1 | 74.5 | 88.9 |
| R1234yf | 0 | 0 | 0 |

| | |
|---|---|
| R32 | a |
| HFO-1132(E) | −0.2304a² − 0.4062a + 32.9 |
| Approximate | |
| expression | |
| HFO-1123 | 0.2304a² − 0.5938a + 67.1 |
| Approximate | |
| expression | |
| R1234yf | 0 |
| Approximate | |
| expression | |

### (5-4) Refrigerant D

The refrigerant D according to the present disclosure is a mixed refrigerant comprising trans-1,2-difluoroethylene (HFO-1132(E)), difluoromethane (R32), and 2,3,3,3-tetrafluoro-1-propene (R1234yf).
The refrigerant D according to the present disclosure has various properties that are desirable as an R410A-alternative refrigerant; i.e., a refrigerating capacity equivalent to that of R410A, a sufficiently low GWP, and a lower flammability (Class 2L) according to the ASHRAE standard.
The refrigerant D according to the present disclosure is preferably a refrigerant
   wherein
when the mass % of HFO-1132(E), R32, and R1234yf based on their sum is respectively represented by x, y, and z, coordinates (x,y,z) in a ternary composition diagram in which the sum of HFO-1132(E), R32, and R1234yf is 100 mass % are within the range of a figure surrounded by line segments IJ, JN, NE, and EI that connect the following 4 points:
   point I (72.0, 0.0, 28.0),
   point J (48.5, 18.3, 33.2),
   point N (27.7, 18.2, 54.1), and
   point E (58.3, 0.0, 41.7),
   or on these line segments (excluding the points on the line segment EI);
the line segment IJ is represented by coordinates (0.0236y²−1.7616y+72.0, y, −0.0236y²+0.7616y+28.0);
the line segment NE is represented by coordinates (0.012y²−1.9003y+58.3, y, −0.012y²+0.9003y+41.7); and
the line segments JN and EI are straight lines. When the requirements above are satisfied, the refrigerant according to the present disclosure has a refrigerating capacity ratio of 80% or more relative to R410A, a GWP of 125 or less, and a WCF lower flammability.
The refrigerant D according to the present disclosure is preferably a refrigerant wherein
when the mass % of HFO-1132(E), R32, and R1234yf based on their sum is respectively represented by x, y, and z, coordinates (x,y,z) in a ternary composition diagram in which the sum of HFO-1132(E), R32, and R1234yf is 100 mass % are within the range of a figure surrounded by line segments MM′, M′N, NV, VG, and GM that connect the following 5 points:
   point M (52.6, 0.0, 47.4),
   point M′ (39.2, 5.0, 55.8),
   point N (27.7, 18.2, 54.1),
   point V (11.0, 18.1, 70.9), and
   point G (39.6, 0.0, 60.4),
   or on these line segments (excluding the points on the line segment GM);
the line segment MM′ is represented by coordinates (0.132y²−3.34y+52.6, y, −0.132y²+2.34y+47.4);
the line segment M′N is represented by coordinates (0.0596y²−2.2541y+48.98, y, −0.0596y²+1.2541y+51.02);
the line segment VG is represented by coordinates (0.0123y²−1.8033y+39.6, y, −0.0123y²+0.8033y+60.4); and
the line segments NV and GM are straight lines. When the requirements above are satisfied, the refrigerant according to the present disclosure has a refrigerating capacity ratio of 70% or more relative to R410A, a GWP of 125 or less, and an ASHRAE lower flammability.
The refrigerant D according to the present disclosure is preferably a refrigerant wherein
when the mass % of HFO-1132(E), R32, and R1234yf based on their sum is respectively represented by x, y, and z, coordinates (x,y,z) in a ternary composition diagram in which the sum of HFO-1132(E), R32, and R1234yf is 100 mass % are within the range of a figure surrounded by line segments ON, NU, and UO that connect the following 3 points:
   point O (22.6, 36.8, 40.6),
   point N (27.7, 18.2, 54.1), and
   point U (3.9, 36.7, 59.4),
   or on these line segments;
the line segment ON is represented by coordinates (0.0072y²−0.6701y+37.512, y, −0.0072y²−0.3299y+62.488);
the line segment NU is represented by coordinates (0.0083y²−1.7403y+56.635, y, −0.0083y²+0.7403y+43.365); and
the line segment UO is a straight line. When the requirements above are satisfied, the refrigerant according to the present disclosure has a refrigerating capacity ratio of 80% or more relative to R410A, a GWP of 250 or less, and an ASHRAE lower flammability.
The refrigerant D according to the present disclosure is preferably a refrigerant wherein
when the mass % of HFO-1132(E), R32, and R1234yf based on their sum is respectively represented by x, y, and z, coordinates (x,y,z) in a ternary composition diagram in which the sum of HFO-1132(E), R32, and R1234yf is 100 mass % are within the range of a figure surrounded by line segments QR, RT, TL, LK, and KQ that connect the following 5 points:
   point Q (44.6, 23.0, 32.4),
   point R (25.5, 36.8, 37.7),
   point T (8.6, 51.6, 39.8),
   point L (28.9, 51.7, 19.4), and
   point K (35.6, 36.8, 27.6),
   or on these line segments;
the line segment QR is represented by coordinates (0.0099y²−1.975y+84.765, y, −0.0099y²+0.975y+15.235);
the line segment RT is represented by coordinates (0.0082y²−1.8683y+83.126, y, −0.0082y²+0.8683y+16.874);
the line segment LK is represented by coordinates (0.0049y²−0.8842y+61.488, y, −0.0049y²−0.1158y+38.512);
the line segment KQ is represented by coordinates (0.0095y²−1.2222y+67.676, y, −0.0095y²+0.2222y+32.324); and
the line segment TL is a straight line. When the requirements above are satisfied, the refrigerant according to the present disclosure has a refrigerating capacity ratio of 92.5% or more relative to R410A, a GWP of 350 or less, and a WCF lower flammability.
The refrigerant D according to the present disclosure is preferably a refrigerant wherein
when the mass % of HFO-1132(E), R32, and R1234yf based on their sum is respectively represented by x, y, and z, coordinates (x,y,z) in a ternary composition diagram in which the sum of HFO-1132(E), R32, and R1234yf is 100 mass % are within the range of a figure surrounded by line segments PS, ST, and TP that connect the following 3 points: point P (20.5, 51.7, 27.8),
   point S (21.9, 39.7, 38.4), and
   point T (8.6, 51.6, 39.8),
   or on these line segments;
the line segment PS is represented by coordinates (0.0064y²−0.7103y+40.1, y, −0.0064y²−0.2897y+59.9);
the line segment ST is represented by coordinates (0.0082y²−1.8683y+83.126, y, −0.0082y²+0.8683y+16.874); and
the line segment TP is a straight line. When the requirements above are satisfied, the refrigerant according to the present disclosure has a refrigerating capacity ratio of 92.5% or more relative to R410A, a GWP of 350 or less, and an ASHRAE lower flammability.
The refrigerant D according to the present disclosure is preferably a refrigerant wherein
when the mass % of HFO-1132(E), R32, and R1234yf based on their sum is respectively represented by x, y, and z, coordinates (x,y,z) in a ternary composition diagram in which the sum of HFO-1132(E), R32, and R1234yf is 100 mass % are within the range of a figure surrounded by line segments ac, cf, fd, and da that connect the following 4 points:
   point a (71.1, 0.0, 28.9),
   point c (36.5, 18.2, 45.3),
   point f (47.6, 18.3, 34.1), and
   point d (72.0, 0.0, 28.0),
   or on these line segments;
the line segment ac is represented by coordinates (0.0181y²−2.2288y+71.096, y, −0.0181y²+1.2288y+28.904);
the line segment fd is represented by coordinates (0.02y²−1.7y+72, y, −0.02y²+0.7y+28); and
the line segments cf and da are straight lines. When the requirements above are satisfied, the refrigerant according to the present disclosure has a refrigerating capacity ratio of 85% or more relative to R410A, a GWP of 125 or less, and a lower flammability (Class 2L) according to the ASHRAE standard.
The refrigerant D according to the present disclosure is preferably a refrigerant wherein
when the mass % of HFO-1132(E), R32, and R1234yf based on their sum is respectively represented by x, y, and z, coordinates (x,y,z) in a ternary composition diagram in which the sum of HFO-1132(E), R32, and R1234yf is 100 mass % are within the range of a figure surrounded by line segments ab, be, ed, and da that connect the following 4 points:
   point a (71.1, 0.0, 28.9),
   point b (42.6, 14.5, 42.9),
   point e (51.4, 14.6, 34.0), and
   point d (72.0, 0.0, 28.0),
   or on these line segments;
the line segment ab is represented by coordinates (0.0181y²−2.2288y+71.096, y, −0.0181y²+1.2288y+28.904);
the line segment ed is represented by coordinates (0.02y²−1.7y+72, y, −0.02y²+0.7y+28); and
the line segments be and da are straight lines. When the requirements above are satisfied, the refrigerant according to the present disclosure has a refrigerating capacity ratio of 85% or more relative to R410A, a GWP of 100 or less, and a lower flammability (Class 2L) according to the ASHRAE standard.
The refrigerant D according to the present disclosure is preferably a refrigerant wherein
when the mass % of HFO-1132(E), R32, and R1234yf based on their sum is respectively represented by x, y, and z, coordinates (x,y,z) in a ternary composition diagram in which the sum of HFO-1132(E), R32, and R1234yf is 100 mass % are within the range of a figure surrounded by line segments gi, ij, and jg that connect the following 3 points:
   point g (77.5, 6.9, 15.6),
   point i (55.1, 18.3, 26.6), and
   point j (77.5. 18.4, 4.1),
   or on these line segments;
the line segment gi is represented by coordinates (0.02y²−2.4583y+93.396, y, −0.02y²+1.4583y+6.604); and
the line segments ij and jg are straight lines. When the requirements above are satisfied, the refrigerant according to the present disclosure has a refrigerating capacity ratio of 95% or more relative to R410A and a GWP of 100 or less, undergoes fewer or no changes such as polymerization or decomposition, and also has excellent stability.
The refrigerant D according to the present disclosure is preferably a refrigerant wherein
when the mass % of HFO-1132(E), R32, and R1234yf based on their sum is respectively represented by x, y, and z, coordinates (x,y,z) in a ternary composition diagram in which the sum of HFO-1132(E), R32, and R1234yf is 100 mass % are within the range of a figure surrounded by line segments gh, hk, and kg that connect the following 3 points:
   point g (77.5, 6.9, 15.6),
   point h (61.8, 14.6, 23.6), and
   point k (77.5, 14.6, 7.9),
   or on these line segments;
the line segment gh is represented by coordinates (0.02y²−2.4583y+93.396, y, −0.02y²+1.4583y+6.604); and
the line segments hk and kg are straight lines. When the requirements above are satisfied, the refrigerant according to the present disclosure has a refrigerating capacity ratio of 95% or more relative to R410A and a GWP of 100 or less, undergoes fewer or no changes such as polymerization or decomposition, and also has excellent stability.
The refrigerant D according to the present disclosure may further comprise other additional refrigerants in addition to HFO-1132(E), R32, and R1234yf, as long as the above properties and effects are not impaired. In this respect, the refrigerant according to the present disclosure preferably comprises HFO-1132(E), R32, and R1234yf in a total amount of 99.5 mass % or more, more preferably 99.75 mass % or more, and still more preferably 99.9 mass % or more based on the entire refrigerant.
Such additional refrigerants are not limited, and can be selected from a wide range of refrigerants. The mixed refrigerant may comprise a single additional refrigerant, or two or more additional refrigerants.

### (Examples of Refrigerant D)

The present disclosure is described in more detail below with reference to Examples of refrigerant D. However, the refrigerant D is not limited to the Examples.
The composition of each mixed refrigerant of HFO-1132(E), R32, and R1234yf was defined as WCF. A leak simulation was performed using the NIST Standard Reference Database REFLEAK Version 4.0 under the conditions of Equipment, Storage, Shipping, Leak, and Recharge according to the ASHRAE Standard 34-2013. The most flammable fraction was defined as WCFF.
A burning velocity test was performed using the apparatus shown in FIG. 1 in the following manner. First, the mixed refrigerants used had a purity of 99.5% or more, and were degassed by repeating a cycle of freezing, pumping, and thawing until no traces of air were observed on the vacuum gauge. The burning velocity was measured by the closed method. The initial temperature was ambient temperature. Ignition was performed by generating an electric spark between the electrodes in the center of a sample cell. The duration of the discharge was 1.0 to 9.9 ms, and the ignition energy was typically about 0.1 to 1.0 J. The spread of the flame was visualized using schlieren photographs. A cylindrical container (inner diameter: 155 mm, length: 198 mm) equipped with two light transmission acrylic windows was used as the sample cell, and a xenon lamp was used as the light source. Schlieren images of the flame were recorded by a high-speed digital video camera at a frame rate of 600 fps and stored on a PC. Tables 113 to 115 show the results.

TABLE 113

| | | | Comparative | | Example | | Example | | Example |
|---|---|---|---|---|---|---|---|---|---|
| | | | Example 13 | Example | 12 | Example | 14 | Example | 16 |
| Item | | Unit | I | 11 | J | 13 | K | 15 | L |
| WCF | HFO-1132(E) | Mass % | 72 | 57.2 | 48.5 | 41.2 | 35.6 | 32 | 28.9 |
| | R32 | Mass % | 0 | 10 | 18.3 | 27.6 | 36.8 | 44.2 | 51.7 |
| | R1234yf | Mass % | 28 | 32.8 | 33.2 | 31.2 | 27.6 | 23.8 | 19.4 |

| | | | | | | | | |
|---|---|---|---|---|---|---|---|---|
| Burning Velocity (WCF) | cm/s | 10 | 10 | 10 | 10 | 10 | 10 | 10 |

TABLE 114

| | | | Comparative | | Example | | Example | |
|---|---|---|---|---|---|---|---|---|
| | | | Example 14 | Example | 19 | Example | 21 | Example |
| Item | | Unit | M | 18 | W | 20 | N | 22 |
| WCF | HFO-1132(E) | Mass % | 52.6 | 39.2 | 32.4 | 29.3 | 27.7 | 24.6 |
| | R32 | Mass % | 0.0 | 5.0 | 10.0 | 14.5 | 18.2 | 27.6 |
| | R1234yf | Mass % | 47.4 | 55.8 | 57.6 | 56.2 | 54.1 | 47.8 |
| Leak condition that results in | | | Storage, | Storage, | Storage, | Storage, | Storage, | Storage, |
| WCFF | | | Shipping, | Shipping, | Shipping, | Shipping, | Shipping, | Shipping, |
| | | | −40° C. | −40° C. | −40° C. | −40° C. | −40° C. | −40° C. |
| | | | 0% | 0% | 0% | 0% | 0% | 0% |
| | | | release, | release, | release, | release, | release, | release, |
| | | | on the gas | on the gas | on the gas | on the gas | on the gas | on the gas |
| | | | phase side | phase side | phase side | phase side | phase side | phase side |
| WCF | HFO-1132(E) | Mass % | 72.0 | 57.8 | 48.7 | 43.6 | 40.6 | 34.9 |
| | R32 | Mass % | 0.0 | 9.5 | 17.9 | 24.2 | 28.7 | 38.1 |
| | R1234yf | Mass % | 28.0 | 32.7 | 33.4 | 32.2 | 30.7 | 27.0 |

| | | | | | | | |
|---|---|---|---|---|---|---|---|
| Burning Velocity (WCF) | cm/s | 8 or less | 8 or less | 8 or less | 8 or less | 8 or less | 8 or less |
| Burning Velocity (WCFF) | cm/s | 10 | 10 | 10 | 10 | 10 | 10 |

TABLE 115

| | | | Example | | Example |
|---|---|---|---|---|---|
| | | | 23 | Example | 25 |
| Item | | Unit | O | 24 | P |
| WCF | HFO-1132 | Mass % | 22.6 | 21.2 | 20.5 |
| | (E) | | | | |
| | HFO-1123 | Mass % | 36.8 | 44.2 | 51.7 |
| | R1234yf | Mass % | 40.6 | 34.6 | 27.8 |
| Leak condition | | | Storage, | Storage, | Storage, |
| that results | | | Shipping, | Shipping, | Shipping, |
| in WCFF | | | −40° C., | −40° C., | −40° C., |
| | | | 0% release, | 0% release, | 0% release, |
| | | | on the gas | on the gas | on the gas |
| | | | phase side | phase side | phase side |
| WCFF | HFO-1132 | Mass % | 31.4 | 29.2 | 27.1 |
| | (E) | | | | |
| | HFO-1123 | Mass % | 45.7 | 51.1 | 56.4 |
| | R1234yf | Mass % | 23.0 | 19.7 | 16.5 |

| | | | | |
|---|---|---|---|---|
| Burning | cm/s | 8 or less | 8 or less | 8 or less |
| Velocity (WCF) | | | | |
| Burning | cm/s | 10 | 10 | 10 |
| Velocity (WCFF) | | | | |

The results indicate that under the condition that the mass % of HFO-1132(E), R32, and R1234yf based on their sum is respectively represented by x, y, and z, when coordinates (x,y,z) in the ternary composition diagram shown in FIG. 14 in which the sum of HFO-1132(E), R32, and R1234yf is 100 mass % are on the line segment that connects point I, point J, point K, and point L, or below these line segments, the refrigerant has a WCF lower flammability.
The results also indicate that when coordinates (x,y,z) in the ternary composition diagram shown in FIG. 14 are on the line segments that connect point M, point M′, point W, point J, point N, and point P, or below these line segments, the refrigerant has an ASHRAE lower flammability.
Mixed refrigerants were prepared by mixing HFO-1132(E), R32, and R1234yf in amounts (mass %) shown in Tables 116 to 144 based on the sum of HFO-1132(E), R32, and R1234yf. The coefficient of performance (COP) ratio and the refrigerating capacity ratio relative to R410 of the mixed refrigerants shown in Tables 116 to 144 were determined. The conditions for calculation were as described below.
Evaporating temperature: 5° C.
Condensation temperature: 45° C.
Degree of superheating: 5 K
Degree of subcooling: 5 K
Compressor efficiency: 70%
Tables 116 to 144 show these values together with the GWP of each mixed refrigerant.

TABLE 116

| | | | Comparative | Comparative | Comparative | Comparative | Comparative | Comparative |
|---|---|---|---|---|---|---|---|---|
| | | Comparative | Example 2 | Example 3 | Example 4 | Example 5 | Example 6 | Example 7 |
| Item | Unit | Example 1 | A | B | A′ | B′ | A″ | B″ |
| HFO-1132(E) | Mass % | R410A | 81.6 | 0.0 | 63.1 | 0.0 | 48.2 | 0.0 |
| R32 | Mass % | | 18.4 | 18.1 | 36.9 | 36.7 | 51.8 | 51.5 |
| R1234yf | Mass % | | 0.0 | 81.9 | 0.0 | 63.3 | 0.0 | 48.5 |
| GWP | — | 2088 | 125 | 125 | 250 | 250 | 350 | 350 |
| COP Ratio | % (relative | 100 | 98.7 | 103.6 | 98.7 | 102.3 | 99.2 | 102.2 |
| | to R410A) | | | | | | | |
| Refrigerating | % (relative | 100 | 105.3 | 62.5 | 109.9 | 77.5 | 112.1 | 87.3 |
| Capacity | to R410A) | | | | | | | |
| Ratio | | | | | | | | |

TABLE 117

| | | Comparative | | Comparative | | Example | | Example |
|---|---|---|---|---|---|---|---|---|
| | | Example 8 | Comparative | Example 10 | Example | 2 | Example | 4 |
| Item | Unit | C | Example 9 | C′ | 1 | R | 3 | T |
| HFO-1132(E) | Mass % | 85.5 | 66.1 | 52.1 | 37.8 | 25.5 | 16.6 | 8.6 |
| R32 | Mass % | 0.0 | 10.0 | 18.2 | 27.6 | 36.8 | 44.2 | 51.6 |
| R1234yf | Mass % | 14.5 | 23.9 | 29.7 | 34.6 | 37.7 | 39.2 | 39.8 |
| GWP | — | 1 | 69 | 125 | 188 | 250 | 300 | 350 |
| COP Ratio | % (relative | 99.8 | 99.3 | 99.3 | 99.6 | 100.2 | 100.8 | 101.4 |
| | to R410A) | | | | | | | |
| Refrigerating | % (relative | 92.5 | 92.5 | 92.5 | 92.5 | 92.5 | 92.5 | 92.5 |
| Capacity | to R410A) | | | | | | | |
| Ratio | | | | | | | | |

TABLE 118

| | | Comparative | | Example | | Example | Comparative | | Example |
|---|---|---|---|---|---|---|---|---|---|
| | | Example 11 | Example | 6 | Example | 8 | Example 12 | Example | 10 |
| Item | Unit | E | 5 | N | 7 | U | G | 9 | V |
| HFO-1132(E) | Mass % | 58.3 | 40.5 | 27.7 | 14.9 | 3.9 | 39.6 | 22.8 | 11.0 |
| R32 | Mass % | 0.0 | 10.0 | 18.2 | 27.6 | 36.7 | 0.0 | 10.0 | 18.1 |
| R1234yf | Mass % | 41.7 | 49.5 | 54.1 | 57.5 | 59.4 | 60.4 | 67.2 | 70.9 |
| GWP | — | 2 | 70 | 125 | 189 | 250 | 3 | 70 | 125 |
| COP Ratio | % (relative to | 100.3 | 100.3 | 100.7 | 101.2 | 101.9 | 101.4 | 101.8 | 102.3 |
| | R410A) | | | | | | | | |
| Refrigerating | % (relative to | 80.0 | 80.0 | 80.0 | 80.0 | 80.0 | 70.0 | 70.0 | 70.0 |
| Capacity Ratio | R410A) | | | | | | | | |

TABLE 119

| | | Comparative | | Example | | Example | | Example | Example |
|---|---|---|---|---|---|---|---|---|---|
| | | Example 13 | Example | 12 | Example | 14 | Example | 16 | 17 |
| Item | Unit | I | 11 | J | 13 | K | 15 | L | Q |
| HFO-1132(E) | Mass % | 72.0 | 57.2 | 48.5 | 41.2 | 35.6 | 32.0 | 28.9 | 44.6 |
| R32 | Mass % | 0.0 | 10.0 | 18.3 | 27.6 | 36.8 | 44.2 | 51.7 | 23.0 |
| R1234yf | Mass % | 28.0 | 32.8 | 33.2 | 31.2 | 27.6 | 23.8 | 19.4 | 32.4 |
| GWP | — | 2 | 69 | 125 | 188 | 250 | 300 | 350 | 157 |
| COP Ratio | % (relative to | 99.9 | 99.5 | 99.4 | 99.5 | 99.6 | 99.8 | 100.1 | 99.4 |
| | R410A) | | | | | | | | |
| Refrigerating | % (relative to | 86.6 | 88.4 | 90.9 | 94.2 | 97.7 | 100.5 | 103.3 | 92.5 |
| Capacity Ratio | R410A) | | | | | | | | |

TABLE 120

| | | Comparative | | Example | | Example | |
|---|---|---|---|---|---|---|---|
| | | Example 14 | Example | 19 | Example | 21 | Example |
| Item | Unit | M | 18 | W | 20 | N | 22 |
| HFO-1132(E) | Mass % | 52.6 | 39.2 | 32.4 | 29.3 | 27.7 | 24.5 |
| R32 | Mass % | 0.0 | 5.0 | 10.0 | 14.5 | 18.2 | 27.6 |
| R1234yf | Mass % | 47.4 | 55.8 | 57.6 | 56.2 | 54.1 | 47.9 |
| GWP | — | 2 | 36 | 70 | 100 | 125 | 188 |
| COP Ratio | % (relative to | 100.5 | 100.9 | 100.9 | 100.8 | 100.7 | 100.4 |
| | R410A) | | | | | | |
| Refrigerating | % (relative to | 77.1 | 74.8 | 75.6 | 77.8 | 80.0 | 85.5 |
| Capacity Ratio | R410A) | | | | | | |

TABLE 121

| | | Exam- | | Exam- | Exam- |
|---|---|---|---|---|---|
| | | ple | Exam- | ple | ple |
| | | 23 | ple | 25 | 26 |
| Item | Unit | O | 24 | P | S |
| HFO-1132(E) | Mass % | 22.6 | 21.2 | 20.5 | 21.9 |
| R32 | Mass % | 36.8 | 44.2 | 51.7 | 39.7 |
| R1234yf | Mass % | 40.6 | 34.6 | 27.8 | 38.4 |
| GWP | — | 250 | 300 | 350 | 270 |
| COP Ratio | % (relative | 100.4 | 100.5 | 100.6 | 100.4 |
| | to R410A) | | | | |
| Refrigerating | % (relative | 91.0 | 95.0 | 99.1 | 92.5 |
| Capacity | to R410A) | | | | |
| Ratio | | | | | |

TABLE 122

| | | Comparative | Comparative | Comparative | Comparative | | | Comparative | Comparative |
|---|---|---|---|---|---|---|---|---|---|
| Item | Unit | Example 15 | Example 16 | Example 17 | Example 18 | Example 27 | Example 28 | Example 19 | Example 20 |
| HFO-1132(E) | Mass % | 10.0 | 20.0 | 30.0 | 40.0 | 50.0 | 60.0 | 70.0 | 80.0 |
| R32 | Mass % | 5.0 | 5.0 | 5.0 | 5.0 | 5.0 | 5.0 | 5.0 | 5.0 |
| R1234yf | Mass % | 85.0 | 75.0 | 65.0 | 55.0 | 45.0 | 35.0 | 25.0 | 15.0 |
| GWP | — | 37 | 37 | 37 | 36 | 36 | 36 | 35 | 35 |
| COP Ratio | % (relative to | 103.4 | 102.6 | 101.6 | 100.8 | 100.2 | 99.8 | 99.6 | 99.4 |
| | R410A) | | | | | | | | |
| Refrigerating | % (relative to | 56.4 | 63.3 | 69.5 | 75.2 | 80.5 | 85.4 | 90.1 | 94.4 |
| Capacity Ratio | R410A) | | | | | | | | |

TABLE 123

| | | Comparative | Comparative | | Comparative | | Comparative | Comparative | Comparative |
|---|---|---|---|---|---|---|---|---|---|
| Item | Unit | Example 21 | Example 22 | Example 29 | Example 23 | Example 30 | Example 24 | Example 25 | Example 26 |
| HFO-1132(E) | Mass % | 10.0 | 20.0 | 30.0 | 40.0 | 50.0 | 60.0 | 70.0 | 80.0 |
| R32 | Mass % | 10.0 | 10.0 | 10.0 | 10.0 | 10.0 | 10.0 | 10.0 | 10.0 |
| R1234yf | Mass % | 80.0 | 70.0 | 60.0 | 50.0 | 40.0 | 30.0 | 20.0 | 10.0 |
| GWP | — | 71 | 71 | 70 | 70 | 70 | 69 | 69 | 69 |
| COP Ratio | % (relative to | 103.1 | 102.1 | 101.1 | 100.4 | 99.8 | 99.5 | 99.2 | 99.1 |
| | R410A) | | | | | | | | |
| Refrigerating | % (relative to | 61.8 | 68.3 | 74.3 | 79.7 | 84.9 | 89.7 | 94.2 | 98.4 |
| Capacity Ratio | R410A) | | | | | | | | |

TABLE 124

| | | Comparative | | Comparative | | | Comparative | Comparative | Comparative |
|---|---|---|---|---|---|---|---|---|---|
| Item | Unit | Example 27 | Example 31 | Example 28 | Example 32 | Example 33 | Example 29 | Example 30 | Example 31 |
| HFO-1132(E) | Mass % | 10.0 | 20.0 | 30.0 | 40.0 | 50.0 | 60.0 | 70.0 | 80.0 |
| R32 | Mass % | 15.0 | 15.0 | 15.0 | 15.0 | 15.0 | 15.0 | 15.0 | 15.0 |
| R1234yf | Mass % | 75.0 | 65.0 | 55.0 | 45.0 | 35.0 | 25.0 | 15.0 | 5.0 |
| GWP | — | 104 | 104 | 104 | 103 | 103 | 103 | 103 | 102 |
| COP Ratio | % (relative to | 102.7 | 101.6 | 100.7 | 100.0 | 99.5 | 99.2 | 99.0 | 98.9 |
| | R410A) | | | | | | | | |
| Refrigerating | % (relative to | 66.6 | 72.9 | 78.6 | 84.0 | 89.0 | 93.7 | 98.1 | 102.2 |
| Capacity Ratio | R410A) | | | | | | | | |

TABLE 125

| | | Comparative | Comparative | Comparative | Comparative | Comparative | Comparative | Comparative | Comparative |
|---|---|---|---|---|---|---|---|---|---|
| Item | Unit | Example 32 | Example 33 | Example 34 | Example 35 | Example 36 | Example 37 | Example 38 | Example 39 |
| HFO-1132(E) | Mass % | 10.0 | 20.0 | 30.0 | 40.0 | 50.0 | 60.0 | 70.0 | 10.0 |
| R32 | Mass % | 20.0 | 20.0 | 20.0 | 20.0 | 20.0 | 20.0 | 20.0 | 25.0 |
| R1234yf | Mass % | 70.0 | 60.0 | 50.0 | 40.0 | 30.0 | 20.0 | 10.0 | 65.0 |
| GWP | — | 138 | 138 | 137 | 137 | 137 | 136 | 136 | 171 |
| COP Ratio | % (relative to | 102.3 | 101.2 | 100.4 | 99.7 | 99.3 | 99.0 | 98.8 | 101.9 |
| | R410A) | | | | | | | | |
| Refrigerating | % (relative to | 71.0 | 77.1 | 82.7 | 88.0 | 92.9 | 97.5 | 101.7 | 75.0 |
| Capacity Ratio | R410A) | | | | | | | | |

TABLE 126

| | | Example | Comparative | Comparative | Comparative | Comparative | Comparative | Comparative | Example |
|---|---|---|---|---|---|---|---|---|---|
| Item | Unit | 34 | Example 40 | Example 41 | Example 42 | Example 43 | Example 44 | Example 45 | 35 |
| HFO-1132(E) | Mass % | 20.0 | 30.0 | 40.0 | 50.0 | 60.0 | 70.0 | 10.0 | 20.0 |
| R32 | Mass % | 25.0 | 25.0 | 25.0 | 25.0 | 25.0 | 25.0 | 30.0 | 30.0 |
| R1234yf | Mass % | 55.0 | 45.0 | 35.0 | 25.0 | 15.0 | 5.0 | 60.0 | 50.0 |
| GWP | — | 171 | 171 | 171 | 170 | 170 | 170 | 205 | 205 |
| COP Ratio | % (relative to | 100.9 | 100.1 | 99.6 | 99.2 | 98.9 | 98.7 | 101.6 | 100.7 |
| | R410A) | | | | | | | | |
| Refrigerating | % (relative to | 81.0 | 86.6 | 91.7 | 96.5 | 101.0 | 105.2 | 78.9 | 84.8 |
| Capacity Ratio | R410A) | | | | | | | | |

TABLE 127

| | | Comparative | Comparative | Comparative | Comparative | | | | Comparative |
|---|---|---|---|---|---|---|---|---|---|
| Item | Unit | Example 46 | Example 47 | Example 48 | Example 49 | Example 36 | Example 37 | Example 38 | Example 50 |
| HFO-1132(E) | Mass % | 30.0 | 40.0 | 50.0 | 60.0 | 10.0 | 20.0 | 30.0 | 40.0 |
| R32 | Mass % | 30.0 | 30.0 | 30.0 | 30.0 | 35.0 | 35.0 | 35.0 | 35.0 |
| R1234yf | Mass % | 40.0 | 30.0 | 20.0 | 10.0 | 55.0 | 45.0 | 35.0 | 25.0 |
| GWP | — | 204 | 204 | 204 | 204 | 239 | 238 | 238 | 238 |
| COP Ratio | % (relative to | 100.0 | 99.5 | 99.1 | 98.8 | 101.4 | 100.6 | 99.9 | 99.4 |
| | R410A) | | | | | | | | |
| Refrigerating | % (relative to | 90.2 | 95.3 | 100.0 | 104.4 | 82.5 | 88.3 | 93.7 | 98.6 |
| Capacity Ratio | R410A) | | | | | | | | |

TABLE 128

| | | Comparative | Comparative | Comparative | Comparative | | Comparative | Comparative | Comparative |
|---|---|---|---|---|---|---|---|---|---|
| Item | Unit | Example 51 | Example 52 | Example 53 | Example 54 | Example 39 | Example 55 | Example 56 | Example 57 |
| HFO-1132(E) | Mass % | 50.0 | 60.0 | 10.0 | 20.0 | 30.0 | 40.0 | 50.0 | 10.0 |
| R32 | Mass % | 35.0 | 35.0 | 40.0 | 40.0 | 40.0 | 40.0 | 40.0 | 45.0 |
| R1234yf | Mass % | 15.0 | 5.0 | 50.0 | 40.0 | 30.0 | 20.0 | 10.0 | 45.0 |
| GWP | — | 237 | 237 | 272 | 272 | 272 | 271 | 271 | 306 |
| COP Ratio | % (relative to | 99.0 | 98.8 | 101.3 | 100.6 | 99.9 | 99.4 | 99.0 | 101.3 |
| | R410A) | | | | | | | | |
| Refrigerating | % (relative to | 103.2 | 107.5 | 86.0 | 91.7 | 96.9 | 101.8 | 106.3 | 89.3 |
| Capacity Ratio | R410A) | | | | | | | | |

TABLE 129

| | | Example | Example | Comparative | Comparative | Comparative | Example | Comparative | Comparative |
|---|---|---|---|---|---|---|---|---|---|
| Item | Unit | 40 | 41 | Example 58 | Example 59 | Example 60 | 42 | Example 61 | Example 62 |
| HFO-1132(E) | Mass % | 20.0 | 30.0 | 40.0 | 50.0 | 10.0 | 20.0 | 30.0 | 40.0 |
| R32 | Mass % | 45.0 | 45.0 | 45.0 | 45.0 | 50.0 | 50.0 | 50.0 | 50.0 |
| R1234yf | Mass % | 35.0 | 25.0 | 15.0 | 5.0 | 40.0 | 30.0 | 20.0 | 10.0 |
| GWP | — | 305 | 305 | 305 | 304 | 339 | 339 | 339 | 338 |
| COP Ratio | % (relative to | 100.6 | 100.0 | 99.5 | 99.1 | 101.3 | 100.6 | 100.0 | 99.5 |
| | R410A) | | | | | | | | |
| Refrigerating | % (relative to | 94.9 | 100.0 | 104.7 | 109.2 | 92.4 | 97.8 | 102.9 | 107.5 |
| Capacity Ratio | R410A) | | | | | | | | |

TABLE 130

| | | Comparative | Comparative | Comparative | Comparative | | | | |
|---|---|---|---|---|---|---|---|---|---|
| Item | Unit | Example 63 | Example 64 | Example 65 | Example 66 | Example 43 | Example 44 | Example 45 | Example 46 |
| HFO-1132(E) | Mass % | 10.0 | 20.0 | 30.0 | 40.0 | 56.0 | 59.0 | 62.0 | 65.0 |
| R32 | Mass % | 55.0 | 55.0 | 55.0 | 55.0 | 3.0 | 3.0 | 3.0 | 3.0 |
| R1234yf | Mass % | 35.0 | 25.0 | 15.0 | 5.0 | 41.0 | 38.0 | 35.0 | 32.0 |
| GWP | — | 373 | 372 | 372 | 372 | 22 | 22 | 22 | 22 |
| COP Ratio | % (relative to | 101.4 | 100.7 | 100.1 | 99.6 | 100.1 | 100.0 | 99.9 | 99.8 |
| | R410A) | | | | | | | | |
| Refrigerating | % (relative to | 95.3 | 100.6 | 105.6 | 110.2 | 81.7 | 83.2 | 84.6 | 86.0 |
| Capacity Ratio | R410A) | | | | | | | | |

TABLE 131

| Item | Unit | Example 47 | Example 48 | Example 49 | Example 50 | Example 51 | Example 52 | Example 53 | Example 54 |
|---|---|---|---|---|---|---|---|---|---|
| HFO-1132(E) | Mass % | 49.0 | 52.0 | 55.0 | 58.0 | 61.0 | 43.0 | 46.0 | 49.0 |
| R32 | Mass % | 6.0 | 6.0 | 6.0 | 6.0 | 6.0 | 9.0 | 9.0 | 9.0 |
| R1234yf | Mass % | 45.0 | 42.0 | 39.0 | 36.0 | 33.0 | 48.0 | 45.0 | 42.0 |
| GWP | — | 43 | 43 | 43 | 43 | 42 | 63 | 63 | 63 |
| COP Ratio | % (relative to | 100.2 | 100.0 | 99.9 | 99.8 | 99.7 | 100.3 | 100.1 | 99.9 |
| | R410A) | | | | | | | | |
| Refrigerating | % (relative to | 80.9 | 82.4 | 83.9 | 85.4 | 86.8 | 80.4 | 82.0 | 83.5 |
| Capacity Ratio | R410A) | | | | | | | | |

TABLE 132

| Item | Unit | Example 55 | Example 56 | Example 57 | Example 58 | Example 59 | Example 60 | Example 61 | Example 62 |
|---|---|---|---|---|---|---|---|---|---|
| HFO-1132(E) | Mass % | 52.0 | 55.0 | 58.0 | 38.0 | 41.0 | 44.0 | 47.0 | 50.0 |
| R32 | Mass % | 9.0 | 9.0 | 9.0 | 12.0 | 12.0 | 12.0 | 12.0 | 12.0 |
| R1234yf | Mass % | 39.0 | 36.0 | 33.0 | 50.0 | 47.0 | 44.0 | 41.0 | 38.0 |
| GWP | — | 63 | 63 | 63 | 83 | 83 | 83 | 83 | 83 |
| COP Ratio | % (relative to | 99.8 | 99.7 | 99.6 | 100.3 | 100.1 | 100.0 | 99.8 | 99.7 |
| | R410A) | | | | | | | | |
| Refrigerating | % (relative to | 85.0 | 86.5 | 87.9 | 80.4 | 82.0 | 83.5 | 85.1 | 86.6 |
| Capacity Ratio | R410A) | | | | | | | | |

TABLE 133

| Item | Unit | Example 63 | Example 64 | Example 65 | Example 66 | Example 67 | Example 68 | Example 69 | Example 70 |
|---|---|---|---|---|---|---|---|---|---|
| HFO-1132(E) | M.s% | 53.0 | 33.0 | 36.0 | 39.0 | 42.0 | 45.0 | 48.0 | 51.0 |
| R32 | M.s% | 12.0 | 15.0 | 15.0 | 15.0 | 15.0 | 15.0 | 15.0 | 15.0 |
| R1234yf | M.s% | 35.0 | 52.0 | 49.0 | 46.0 | 43.0 | 40.0 | 37.0 | 34.0 |
| GWP | — | 83 | 104 | 104 | 103 | 103 | 103 | 103 | 103 |
| COP Ratio | % (relative to | 99.6 | 100.5 | 100.3 | 100.1 | 99.9 | 99.7 | 99.6 | 99.5 |
| | R410A) | | | | | | | | |
| Refrigerating | % (relative to | 88.0 | 80.3 | 81.9 | 83.5 | 85.0 | 86.5 | 88.0 | 89.5 |
| Capacity Ratio | R410A) | | | | | | | | |

TABLE 134

| | | Example | Example | Example | Example | Example | Example | Example | Example |
|---|---|---|---|---|---|---|---|---|---|
| Item | Unit | 71 | 72 | 73 | 74 | 75 | 76 | 77 | 78 |
| HFO-1132(E) | Mass % | 29.0 | 32.0 | 35.0 | 38.0 | 41.0 | 44.0 | 47.0 | 36.0 |
| R32 | Mass % | 18.0 | 18.0 | 18.0 | 18.0 | 18.0 | 18.0 | 18.0 | 3.0 |
| R1234yf | Mass % | 53.0 | 50.0 | 47.0 | 44.0 | 41.0 | 38.0 | 35.0 | 61.0 |
| GWP | — | 124 | 124 | 124 | 124 | 124 | 123 | 123 | 23 |
| COP Ratio | % (relative | 100.6 | 100.3 | 100.1 | 99.9 | 99.8 | 99.6 | 99.5 | 101.3 |
| | to R410A) | | | | | | | | |
| Refrigerating | % (relative | 80.6 | 82.2 | 83.8 | 85.4 | 86.9 | 88.4 | 89.9 | 71.0 |
| Capacity | to R410A) | | | | | | | | |
| Ratio | | | | | | | | | |

TABLE 135

| | | Example | Example | Example | Example | Example | Example | Example | Example |
|---|---|---|---|---|---|---|---|---|---|
| Item | Unit | 79 | 80 | 81 | 82 | 83 | 84 | 85 | 86 |
| HFO-1132(E) | Mass % | 39.0 | 42.0 | 30.0 | 33.0 | 36.0 | 26.0 | 29.0 | 32.0 |
| R32 | Mass % | 3.0 | 3.0 | 6.0 | 6.0 | 6.0 | 9.0 | 9.0 | 9.0 |
| R1234yf | Mass % | 58.0 | 55.0 | 64.0 | 61.0 | 58.0 | 65.0 | 62.0 | 59.0 |
| GWP | — | 23 | 23 | 43 | 43 | 43 | 64 | 64 | 63 |
| COP Ratio | % (relative | 101.1 | 100.9 | 101.5 | 101.3 | 101.0 | 101.6 | 101.3 | 101.1 |
| | to R410A) | | | | | | | | |
| Refrigerating | % (relative | 72.7 | 74.4 | 70.5 | 72.2 | 73.9 | 71.0 | 72.8 | 74.5 |
| Capacity | to | | | | | | | | |
| Ratio | R410A) | | | | | | | | |

TABLE 136

| | | Example | Example | Example | Example | Example | Example | Example | Example |
|---|---|---|---|---|---|---|---|---|---|
| Item | Unit | 87 | 88 | 89 | 90 | 91 | 92 | 93 | 94 |
| HFO-1132(E) | Mass % | 21.0 | 24.0 | 27.0 | 30.0 | 16.0 | 19.0 | 22.0 | 25.0 |
| R32 | Mass % | 12.0 | 12.0 | 12.0 | 12.0 | 15.0 | 15.0 | 15.0 | 15.0 |
| R1234yf | Mass % | 67.0 | 64.0 | 61.0 | 58.0 | 69.0 | 66.0 | 63.0 | 60.0 |
| GWP | — | 84 | 84 | 84 | 84 | 104 | 104 | 104 | 104 |
| COP Ratio | % (relative | 101.8 | 101.5 | 101.2 | 101.0 | 102.1 | 101.8 | 101.4 | 101.2 |
| | to R410A) | | | | | | | | |
| Refrigerating | % (relative | 70.8 | 72.6 | 74.3 | 76.0 | 70.4 | 72.3 | 74.0 | 75.8 |
| Capacity | to | | | | | | | | |
| Ratio | R410A) | | | | | | | | |

TABLE 137

| | | Example | Example | Example | Example | Example | Example | Example | Example |
|---|---|---|---|---|---|---|---|---|---|
| Item | Unit | 95 | 96 | 97 | 98 | 99 | 100 | 101 | 102 |
| HFO-1132(E) | Mass % | 28.0 | 12.0 | 15.0 | 18.0 | 21.0 | 24.0 | 27.0 | 25.0 |
| R32 | Mass % | 15.0 | 18.0 | 18.0 | 18.0 | 18.0 | 18.0 | 18.0 | 21.0 |
| R1234yf | Mass % | 57.0 | 70.0 | 67.0 | 64.0 | 61.0 | 58.0 | 55.0 | 54.0 |
| GWP | — | 104 | 124 | 124 | 124 | 124 | 124 | 124 | 144 |
| COP Ratio | % (relative | 100.9 | 102.2 | 101.9 | 101.6 | 101.3 | 101.0 | 100.7 | 100.7 |
| | to R410A) | | | | | | | | |
| Refrigerating | % (relative | 77.5 | 70.5 | 72.4 | 74.2 | 76.0 | 77.7 | 79.4 | 80.7 |
| Capacity | to | | | | | | | | |
| Ratio | R410A) | | | | | | | | |

TABLE 138

| | | Example | Example | Example | Example | Example | Example | Example | Example |
|---|---|---|---|---|---|---|---|---|---|
| Item | Unit | 103 | 104 | 105 | 106 | 107 | 108 | 109 | 110 |
| HFO-1132(E) | Mass % | 21.0 | 24.0 | 17.0 | 20.0 | 23.0 | 13.0 | 16.0 | 19.0 |
| R32 | Mass % | 24.0 | 24.0 | 27.0 | 27.0 | 27.0 | 30.0 | 30.0 | 30.0 |
| R1234yf | Mass % | 55.0 | 52.0 | 56.0 | 53.0 | 50.0 | 57.0 | 54.0 | 51.0 |
| GWP | — | 164 | 164 | 185 | 185 | 184 | 205 | 205 | 205 |
| COP Ratio | % (relative | 100.9 | 100.6 | 101.1 | 100.8 | 100.6 | 101.3 | 101.0 | 100.8 |
| | to R410A) | | | | | | | | |
| Refrigerating | % (relative | 80.8 | 82.5 | 80.8 | 82.5 | 84.2 | 80.7 | 82.5 | 84.2 |
| Capacity | to | | | | | | | | |
| Ratio | R410A) | | | | | | | | |

TABLE 139

| | | Example | Example | Example | Example | Example | Example | Example | Example |
|---|---|---|---|---|---|---|---|---|---|
| Item | Unit | 111 | 112 | 113 | 114 | 115 | 116 | 117 | 118 |
| HFO-1132(E) | Mass % | 22.0 | 9.0 | 12.0 | 15.0 | 18.0 | 21.0 | 8.0 | 12.0 |
| R32 | Mass % | 30.0 | 33.0 | 33.0 | 33.0 | 33.0 | 33.0 | 36.0 | 36.0 |
| R1234yf | Mass % | 48.0 | 58.0 | 55.0 | 52.0 | 49.0 | 46.0 | 56.0 | 52.0 |
| GWP | — | 205 | 225 | 225 | 225 | 225 | 225 | 245 | 245 |
| COP Ratio | % (relative | 100.5 | 101.6 | 101.3 | 101.0 | 100.8 | 100.5 | 101.6 | 101.2 |
| | to R410A) | | | | | | | | |
| Refrigerating | % (relative | 85.9 | 80.5 | 82.3 | 84.1 | 85.8 | 87.5 | 82.0 | 84.4 |
| Capacity | to R410A) | | | | | | | | |
| Ratio | | | | | | | | | |

TABLE 140

| | | Example | Example | Example | Example | Example | Example | Example | Example |
|---|---|---|---|---|---|---|---|---|---|
| Item | Unit | 119 | 120 | 121 | 122 | 123 | 124 | 125 | 126 |
| HFO-1132(E) | Mass % | 15.0 | 18.0 | 21.0 | 42.0 | 39.0 | 34.0 | 37.0 | 30.0 |
| R32 | Mass % | 36.0 | 36.0 | 36.0 | 25.0 | 28.0 | 31.0 | 31.0 | 34.0 |
| R1234yf | Mass % | 49.0 | 46.0 | 43.0 | 33.0 | 33.0 | 35.0 | 32.0 | 36.0 |
| GWP | — | 245 | 245 | 245 | 170 | 191 | 211 | 211 | 231 |
| COP Ratio | % (relative | 101.0 | 100.7 | 100.5 | 99.5 | 99.5 | 99.8 | 99.6 | 99.9 |
| | to R410A) | | | | | | | | |
| Refrigerating | % (relative | 86.2 | 87.9 | 89.6 | 92.7 | 93.4 | 93.0 | 94.5 | 93.0 |
| Capacity | to | | | | | | | | |
| Ratio | R410A) | | | | | | | | |

TABLE 141

| | | Example | Example | Example | Example | Example | Example | Example | Example |
|---|---|---|---|---|---|---|---|---|---|
| Item | Unit | 127 | 128 | 129 | 130 | 131 | 132 | 133 | 134 |
| HFO-1132(E) | Mass % | 33.0 | 36.0 | 24.0 | 27.0 | 30.0 | 33.0 | 23.0 | 26.0 |
| R32 | Mass % | 34.0 | 34.0 | 37.0 | 37.0 | 37.0 | 37.0 | 40.0 | 40.0 |
| R1234yf | Mass % | 33.0 | 30.0 | 39.0 | 36.0 | 33.0 | 30.0 | 37.0 | 34.0 |
| GWP | — | 231 | 231 | 252 | 251 | 251 | 251 | 272 | 272 |
| COP Ratio | % (relative | 99.8 | 99.6 | 100.3 | 100.1 | 99.9 | 99.8 | 100.4 | 100.2 |
| | to R410A) | | | | | | | | |
| Refrigerating | % (relative | 94.5 | 96.0 | 91.9 | 93.4 | 95.0 | 96.5 | 93.3 | 94.9 |
| Capacity | to | | | | | | | | |
| Ratio | R410A) | | | | | | | | |

TABLE 142

| | | Example | Example | Example | Example | Example | Example | Example | Example |
|---|---|---|---|---|---|---|---|---|---|
| Item | Unit | 135 | 136 | 137 | 138 | 139 | 140 | 141 | 142 |
| HFO-1132(E) | Mass % | 29.0 | 32.0 | 19.0 | 22.0 | 25.0 | 28.0 | 31.0 | 18.0 |
| R32 | Mass % | 40.0 | 40.0 | 43.0 | 43.0 | 43.0 | 43.0 | 43.0 | 46.0 |
| R1234yf | Mass % | 31.0 | 28.0 | 38.0 | 35.0 | 32.0 | 29.0 | 26.0 | 36.0 |
| GWP | — | 272 | 271 | 292 | 292 | 292 | 292 | 292 | 312 |
| COP Ratio | % (relative | 100.0 | 99.8 | 100.6 | 100.4 | 100.2 | 100.1 | 99.9 | 100.7 |
| | to R410A) | | | | | | | | |
| Refrigerating | % (relative | 96.4 | 97.9 | 93.1 | 94.7 | 96.2 | 97.8 | 99.3 | 94.4 |
| Capacity | to | | | | | | | | |
| Ratio | R410A) | | | | | | | | |

TABLE 143

| | | Example | Example | Example | Example | Example | Example | Example | Example |
|---|---|---|---|---|---|---|---|---|---|
| Item | Unit | 143 | 144 | 145 | 146 | 147 | 148 | 149 | 150 |
| HFO-1132(E) | Mass % | 21.0 | 23.0 | 26.0 | 29.0 | 13.0 | 16.0 | 19.0 | 22.0 |
| R32 | Mass % | 46.0 | 46.0 | 46.0 | 46.0 | 49.0 | 49.0 | 49.0 | 49.0 |
| R1234yf | Mass % | 33.0 | 31.0 | 28.0 | 25.0 | 38.0 | 35.0 | 32.0 | 29.0 |
| GWP | — | 312 | 312 | 312 | 312 | 332 | 332 | 332 | 332 |
| COP Ratio | % (relative | 100.5 | 100.4 | 100.2 | 100.0 | 101.1 | 100.9 | 100.7 | 100.5 |
| | to R410A) | | | | | | | | |
| Refrigerating | % (relative | 96.0 | 97.0 | 98.6 | 100.1 | 93.5 | 95.1 | 96.7 | 98.3 |
| Capacity | to | | | | | | | | |
| Ratio | R410A) | | | | | | | | |

TABLE 144

| Item | Unit | Example 151 | Example 152 |
|---|---|---|---|
| HFO-1132(E) | Mass % | 25.0 | 28.0 |
| R32 | Mass % | 49.0 | 49.0 |
| R1234yf | Mass % | 26.0 | 23.0 |
| GWP | — | 332 | 332 |
| COP Ratio | % (relative to | 100.3 | 100.1 |
| | R410A) | | |
| Refrigerating Capacity | % (relative to | 99.8 | 101.3 |
| Ratio | R410A) | | |

The results also indicate that under the condition that the mass % of HFO-1132(E), R32, and R1234yf based on their sum is respectively represented by x, y, and z, when coordinates (x,y,z) in a ternary composition diagram in which the sum of HFO-1132(E), R32, and R1234yf is 100 mass % are within the range of a figure surrounded by line segments IJ, JN, NE, and EI that connect the following 4 points:

point I (72.0, 0.0, 28.0),
point J (48.5, 18.3, 33.2),
point N (27.7, 18.2, 54.1), and
point E (58.3, 0.0, 41.7),
or on these line segments (excluding the points on the line segment EI),
the line segment IJ is represented by coordinates (0.0236y²−1.7616y+72.0, y, −0.0236y²+0.7616y+28.0),
the line segment NE is represented by coordinates (0.012y²−1.9003y+58.3, y, −0.012y²+0.9003y+41.7), and
the line segments JN and EI are straight lines, the refrigerant D has a refrigerating capacity ratio of 80% or more relative to R410A, a GWP of 125 or less, and a WCF lower flammability.
The results also indicate that under the condition that the mass % of HFO-1132(E), R32, and R1234yf based on their sum is respectively represented by x, y, and z, when coordinates (x,y,z) in a ternary composition diagram in which the sum of HFO-1132(E), R32, and R1234yf is 100 mass % are within the range of a figure surrounded by line segments MM′, M′N, NV, VG, and GM that connect the following 5 points:
   point M (52.6, 0.0, 47.4),
   point M′ (39.2, 5.0, 55.8),
   point N (27.7, 18.2, 54.1),
   point V (11.0, 18.1, 70.9), and
   point G (39.6, 0.0, 60.4),
   or on these line segments (excluding the points on the line segment GM),
the line segment MM′ is represented by coordinates (0.132y²−3.34y+52.6, y, −0.132y²+2.34y+47.4),
the line segment M′N is represented by coordinates (0.0596y²−2.2541y+48.98, y, −0.0596y²+1.2541y+51.02),
the line segment VG is represented by coordinates (0.0123y²−1.8033y+39.6, y, −0.0123y²+0.8033y+60.4), and
the line segments NV and GM are straight lines, the refrigerant D according to the present disclosure has a refrigerating capacity ratio of 70% or more relative to R410A, a GWP of 125 or less, and an ASHRAE lower flammability.
The results also indicate that under the condition that the mass % of HFO-1132(E), R32, and R1234yf based on their sum is respectively represented by x, y, and z, when coordinates (x,y,z) in a ternary composition diagram in which the sum of HFO-1132(E), R32, and R1234yf is 100 mass % are within the range of a figure surrounded by line segments ON, NU, and UO that connect the following 3 points:
   point O (22.6, 36.8, 40.6),
   point N (27.7, 18.2, 54.1), and
   point U (3.9, 36.7, 59.4),
   or on these line segments,
the line segment ON is represented by coordinates (0.0072y²−0.6701y+37.512, y, −0.0072y²−0.3299y+62.488),
the line segment NU is represented by coordinates (0.0083y²−1.7403y+56.635, y, −0.0083y²+0.7403y+43.365), and
the line segment UO is a straight line, the refrigerant D according to the present disclosure has a refrigerating capacity ratio of 80% or more relative to R410A, a GWP of 250 or less, and an ASHRAE lower flammability.
The results also indicate that under the condition that the mass % of HFO-1132(E), R32, and R1234yf based on their sum is respectively represented by x, y, and z, when coordinates (x,y,z) in a ternary composition diagram in which the sum of HFO-1132(E), R32, and R1234yf is 100 mass % are within the range of a figure surrounded by line segments QR, RT, TL, LK, and KQ that connect the following 5 points:
   point Q (44.6, 23.0, 32.4),
   point R (25.5, 36.8, 37.7),
   point T (8.6, 51.6, 39.8),
   point L (28.9, 51.7, 19.4), and
   point K (35.6, 36.8, 27.6),
   or on these line segments,
the line segment QR is represented by coordinates (0.0099y²−1.975y+84.765, y, −0.0099y²+0.975y+15.235),
the line segment RT is represented by coordinates (0.0082y²−1.8683y+83.126, y, −0.0082y²+0.8683y+16.874),
the line segment LK is represented by coordinates (0.0049y²−0.8842y+61.488, y, −0.0049y²−0.1158y+38.512),
the line segment KQ is represented by coordinates (0.0095y²−1.2222y+67.676, y, −0.0095y²+0.2222y+32.324), and
the line segment TL is a straight line, the refrigerant D according to the present disclosure has a refrigerating capacity ratio of 92.5% or more relative to R410A, a GWP of 350 or less, and a WCF lower flammability.
The results further indicate that under the condition that the mass % of HFO-1132(E), R32, and R1234yf based on their sum is respectively represented by x, y, and z, when coordinates (x,y,z) in a ternary composition diagram in which the sum of HFO-1132(E), R32, and R1234yf is 100 mass % are within the range of a figure surrounded by line segments PS, ST, and TP that connect the following 3 points:
   point P (20.5, 51.7, 27.8),
   point S (21.9, 39.7, 38.4), and
   point T (8.6, 51.6, 39.8),
   or on these line segments,
the line segment PS is represented by coordinates (0.0064y²−0.7103y+40.1, y, −0.0064y²−0.2897y+59.9),
the line segment ST is represented by coordinates (0.0082y²−1.8683y+83.126, y, −0.0082y²+0.8683y+16.874), and
the line segment TP is a straight line, the refrigerant D according to the present disclosure has a refrigerating capacity ratio of 92.5% or more relative to R410A, a GWP of 350 or less, and an ASHRAE lower flammability.

### (5-5) Refrigerant E

The refrigerant E according to the present disclosure is a mixed refrigerant comprising trans-1,2-difluoroethylene (HFO-1132(E)), trifluoroethylene (HFO-1123), and difluoromethane (R32).
The refrigerant E according to the present disclosure has various properties that are desirable as an R410A-alternative refrigerant, i.e., a coefficient of performance equivalent to that of R410A and a sufficiently low GWP.
The refrigerant E according to the present disclosure is preferably a refrigerant wherein
when the mass % of HFO-1132(E), HFO-1123, and R32 based on their sum is respectively represented by x, y, and z, coordinates (x,y,z) in a ternary composition diagram in which the sum of HFO-1132(E), HFO-1123, and R32 is 100 mass % are within the range of a figure surrounded by line segments IK, KB′, B′H, HR, RG, and GI that connect the following 6 points:
   point I (72.0, 28.0, 0.0),
   point K (48.4, 33.2, 18.4),
   point B′ (0.0, 81.6, 18.4),
   point H (0.0, 84.2, 15.8),
   point R (23.1, 67.4, 9.5), and
   point G (38.5, 61.5, 0.0),
   or on these line segments (excluding the points on the line segments B′H and GI);
the line segment IK is represented by coordinates (0.025z²−1.7429z+72.00, −0.025z²+0.7429z+28.0, z),
the line segment HR is represented by coordinates (−0.3123z²+4.234z+11.06, 0.3123z²−5.234z+88.94, z),
the line segment RG is represented by coordinates (−0.0491z²−1.1544z+38.5, 0.0491z²+0.1544z+61.5, z), and
the line segments KB′ and GI are straight lines. When the requirements above are satisfied, the refrigerant according to the present disclosure has WCF lower flammability, a COP ratio of 93% or more relative to that of R410A, and a GWP of 125 or less.
The refrigerant E according to the present disclosure is preferably a refrigerant wherein
when the mass % of HFO-1132(E), HFO-1123, and R32 based on their sum is respectively represented by x, y, and z, coordinates (x,y,z) in a ternary composition diagram in which the sum of HFO-1132(E), HFO-1123, and R32 is 100 mass % are within the range of a figure surrounded by line segments IJ, JR, RG, and GI that connect the following 4 points:
   point I (72.0, 28.0, 0.0),
   point J (57.7, 32.8, 9.5),
   point R (23.1, 67.4, 9.5), and
   point G (38.5, 61.5, 0.0),
   or on these line segments (excluding the points on the line segment GI);
the line segment IJ is represented by coordinates (0.025z²−1.7429z+72.0, −0.025z²+0.7429z+28.0, z),
the line segment RG is represented by coordinates (−0.0491z²−1.1544z+38.5, 0.0491z²+0.1544z+61.5, z), and
the line segments JR and GI are straight lines. When the requirements above are satisfied, the refrigerant according to the present disclosure has WCF lower flammability, a COP ratio of 93% or more relative to that of R410A, and a GWP of 125 or less.
The refrigerant E according to the present disclosure is preferably a refrigerant wherein
when the mass % of HFO-1132(E), HFO-1123, and R32 based on their sum is respectively represented by x, y, and z, coordinates (x,y,z) in a ternary composition diagram in which the sum of HFO-1132(E), HFO-1123, and R32 is 100 mass % are within the range of a figure surrounded by line segments MP, PB′, B′H, HR, RG, and GM that connect the following 6 points:
   point M (47.1, 52.9, 0.0),
   point P (31.8, 49.8, 18.4),
   point B′ (0.0, 81.6, 18.4),
   point H (0.0, 84.2, 15.8),
   point R (23.1, 67.4, 9.5), and
   point G (38.5, 61.5, 0.0),
   or on these line segments (excluding the points on the line segments B′H and GM);
the line segment MP is represented by coordinates (0.0083z²−0.984z+47.1, −0.0083z²−0.016z+52.9, z),
the line segment HR is represented by coordinates (−0.3123z²+4.234z+11.06, 0.3123z²−5.234z+88.94, z),
the line segment RG is represented by coordinates (−0.0491z²−1.1544z+38.5, 0.0491z²+0.1544z+61.5, z), and
the line segments PB′ and GM are straight lines. When the requirements above are satisfied, the refrigerant according to the present disclosure has ASHRAE lower flammability, a COP ratio of 93% or more relative to that of R410A, and a GWP of 125 or less.
The refrigerant E according to the present disclosure is preferably a refrigerant wherein
when the mass % of HFO-1132(E), HFO-1123, and R32 based on their sum is respectively represented by x, y, and z, coordinates (x,y,z) in a ternary composition diagram in which the sum of HFO-1132(E), HFO-1123, and R32 is 100 mass % are within the range of a figure surrounded by line segments MN, NR, RG, and GM that connect the following 4 points:
   point M (47.1, 52.9, 0.0),
   point N (38.5, 52.1, 9.5),
   point R (23.1, 67.4, 9.5), and
   point G (38.5, 61.5, 0.0),
   or on these line segments (excluding the points on the line segment GM);
the line segment MN is represented by coordinates (0.0083z²−0.984z+47.1, −0.0083z²−0.016z+52.9, z),
the line segment RG is represented by coordinates (−0.0491z²−1.1544z+38.5, 0.0491z²+0.1544z+61.5, z),
the line segments NR and GM are straight lines. When the requirements above are satisfied, the refrigerant according to the present disclosure has ASHRAE lower flammability, a COP ratio of 93% or more relative to that of R410A, and a GWP of 65 or less.
The refrigerant E according to the present disclosure is preferably a refrigerant wherein
when the mass % of HFO-1132(E), HFO-1123, and R32 based on their sum is respectively represented by x, y, and z, coordinates (x,y,z) in a ternary composition diagram in which the sum of HFO-1132(E), HFO-1123, and R32 is 100 mass % are within the range of a figure surrounded by line segments PS, ST, and TP that connect the following 3 points:
   point P (31.8, 49.8, 18.4),
   point S (25.4, 56.2, 18.4), and
   point T (34.8, 51.0, 14.2),
   or on these line segments;
the line segment ST is represented by coordinates (−0.0982z²+0.9622z+40.931, 0.0982z²−1.9622z+59.069, z),
the line segment TP is represented by coordinates (0.0083z²−0.984z+47.1, −0.0083z²−0.016z+52.9, z), and
the line segment PS is a straight line. When the requirements above are satisfied, the refrigerant according to the present disclosure has ASHRAE lower flammability, a COP ratio of 94.5% or more relative to that of R410A, and a GWP of 125 or less.
The refrigerant E according to the present disclosure is preferably a refrigerant wherein
when the mass % of HFO-1132(E), HFO-1123, and R32 based on their sum is respectively represented by x, y, and z, coordinates (x,y,z) in a ternary composition diagram in which the sum of HFO-1132(E), HFO-1123, and R32 is 100 mass % are within the range of a figure surrounded by line segments QB″, B″D, DU, and UQ that connect the following 4 points:
   point Q (28.6, 34.4, 37.0),
   point B″ (0.0, 63.0, 37.0),
   point D (0.0, 67.0, 33.0), and
   point U (28.7, 41.2, 30.1),
   or on these line segments (excluding the points on the line segment B″D);
the line segment DU is represented by coordinates (−3.4962z²+210.71z−3146.1, 3.4962z²−211.71z+3246.1, z),
the line segment UQ is represented by coordinates (0.0135z²−0.9181z+44.133, −0.0135z²−0.0819z+55.867, z), and
the line segments QB″ and B″D are straight lines. When the requirements above are satisfied, the refrigerant according to the present disclosure has ASHRAE lower flammability, a COP ratio of 96% or more relative to that of R410A, and a GWP of 250 or less.
The refrigerant E according to the present disclosure is preferably a refrigerant wherein
when the mass % of HFO-1132(E), HFO-1123, and R32 based on their sum is respectively represented by x, y, and z, coordinates (x,y,z) in a ternary composition diagram in which the sum of HFO-1132(E), HFO-1123, and R32 is 100 mass % are within the range of a figure surrounded by line segments Oc′, c′d′, d′e′, e′a′, and a′O that connect the following 5 points:
   point O (100.0, 0.0, 0.0),
   point c′ (56.7, 43.3, 0.0),
   point d′ (52.2, 38.3, 9.5),
   point e′ (41.8, 39.8, 18.4), and
   point a′ (81.6, 0.0, 18.4),
   or on the line segments c′d′, d′e′, and e′a′ (excluding the points c′ and a′);
the line segment c′d′ is represented by coordinates (−0.0297z²−0.1915z+56.7, 0.0297z²+1.1915z+43.3, z),
the line segment d′e′ is represented by coordinates (−0.0535z²+0.3229z+53.957, 0.0535z²+0.6771z+46.043, z), and
the line segments Oc′, e′a′, and a′0 are straight lines. When the requirements above are satisfied, the refrigerant according to the present disclosure has a COP ratio of 92.5% or more relative to that of R410A, and a GWP of 125 or less.
The refrigerant E according to the present disclosure is preferably a refrigerant wherein
when the mass % of HFO-1132(E), HFO-1123, and R32 based on their sum is respectively represented by x, y, and z, coordinates (x,y,z) in a ternary composition diagram in which the sum of HFO-1132(E), HFO-1123, and R32 is 100 mass % are within the range of a figure surrounded by line segments Oc, cd, de, ea′, and a′0 that connect the following 5 points:
   point O (100.0, 0.0, 0.0),
   point c (77.7, 22.3, 0.0),
   point d (76.3, 14.2, 9.5),
   point e (72.2, 9.4, 18.4), and
   point a′ (81.6, 0.0, 18.4),
   or on the line segments cd, de, and ea′ (excluding the points c and a′);
the line segment cde is represented by coordinates (−0.017z²+0.0148z+77.684, 0.017z²+0.9852z+22.316, z), and
the line segments Oc, ea′, and a′O are straight lines. When the requirements above are satisfied, the refrigerant according to the present disclosure has a COP ratio of 95% or more relative to that of R410A, and a GWP of 125 or less.
The refrigerant E according to the present disclosure is preferably a refrigerant wherein
when the mass % of HFO-1132(E), HFO-1123, and R32 based on their sum is respectively represented by x, y, and z, coordinates (x,y,z) in a ternary composition diagram in which the sum of HFO-1132(E), HFO-1123, and R32 is 100 mass % are within the range of a figure surrounded by line segments Oc′, c′d′, d′a, and aO that connect the following 5 points:
   point O (100.0, 0.0, 0.0),
   point c′ (56.7, 43.3, 0.0),
   point d′ (52.2, 38.3, 9.5), and
   point a (90.5, 0.0, 9.5),
   or on the line segments c′d′ and d′a (excluding the points c′ and a);
the line segment c′d′ is represented by coordinates (−0.0297z²−0.1915z+56.7, 0.0297z²+1.1915z+43.3, z), and
the line segments Oc′, d′a, and aO are straight lines. When the requirements above are satisfied, the refrigerant according to the present disclosure has a COP ratio of 93.5% or more relative to that of R410A, and a GWP of 65 or less.
The refrigerant E according to the present disclosure is preferably a refrigerant wherein
when the mass % of HFO-1132(E), HFO-1123, and R32 based on their sum is respectively represented by x, y, and z, coordinates (x,y,z) in a ternary composition diagram in which the sum of HFO-1132(E), HFO-1123, and R32 is 100 mass % are within the range of a figure surrounded by line segments Oc, cd, da, and aO that connect the following 4 points:
   point O (100.0, 0.0, 0.0),
   point c (77.7, 22.3, 0.0),
   point d (76.3, 14.2, 9.5), and
   point a (90.5, 0.0, 9.5),
   or on the line segments cd and da (excluding the points c and a);
the line segment cd is represented by coordinates (−0.017z²+0.0148z+77.684, 0.017z²+0.9852z+22.316, z), and
the line segments Oc, da, and aO are straight lines. When the requirements above are satisfied, the refrigerant according to the present disclosure has a COP ratio of 95% or more relative to that of R410A, and a GWP of 65 or less.
The refrigerant E according to the present disclosure may further comprise other additional refrigerants in addition to HFO-1132(E), HFO-1123, and R32, as long as the above properties and effects are not impaired. In this respect, the refrigerant according to the present disclosure preferably comprises HFO-1132(E), HFO-1123, and R32 in a total amount of 99.5 mass % or more, more preferably 99.75 mass % or more, and even more preferably 99.9 mass % or more, based on the entire refrigerant.
Such additional refrigerants are not limited, and can be selected from a wide range of refrigerants. The mixed refrigerant may comprise a single additional refrigerant, or two or more additional refrigerants.

### (Examples of Refrigerant E)

The present disclosure is described in more detail below with reference to Examples of refrigerant E. However, the refrigerant E is not limited to the Examples.
Mixed refrigerants were prepared by mixing HFO-1132(E), HFO-1123, and R32 at mass % based on their sum shown in Tables 145 and 146.
The composition of each mixture was defined as WCF. A leak simulation was performed using National Institute of Science and Technology (NIST) Standard Reference Data Base Refleak Version 4.0 under the conditions for equipment, storage, shipping, leak, and recharge according to the ASHRAE Standard 34-2013. The most flammable fraction was defined as WCFF.
For each mixed refrigerant, the burning velocity was measured according to the ANSI/ASHRAE Standard 34-2013. When the burning velocities of the WCF composition and the WCFF composition are 10 cm/s or less, the flammability of such a refrigerant is classified as Class 2L (lower flammability) in the ASHRAE flammability classification.
A burning velocity test was performed using the apparatus shown in FIG. 1 in the following manner. First, the mixed refrigerants used had a purity of 99.5% or more, and were degassed by repeating a cycle of freezing, pumping, and thawing until no traces of air were observed on the vacuum gauge. The burning velocity was measured by the closed method. The initial temperature was ambient temperature. Ignition was performed by generating an electric spark between the electrodes in the center of a sample cell. The duration of the discharge was 1.0 to 9.9 ms, and the ignition energy was typically about 0.1 to 1.0 J. The spread of the flame was visualized using schlieren photographs. A cylindrical container (inner diameter: 155 mm, length: 198 mm) equipped with two light transmission acrylic windows was used as the sample cell, and a xenon lamp was used as the light source. Schlieren images of the flame were recorded by a high-speed digital video camera at a frame rate of 600 fps and stored on a PC.
Tables 145 and 146 show the results.

TABLE 145

| Item | | Unit | I | J | K | L |
|---|---|---|---|---|---|---|
| WCF | HFO-1132(E) | mass % | 72.0 | 57.7 | 48.4 | 35.5 |
| | HFO-1123 | mass % | 28.0 | 32.8 | 33.2 | 27.5 |
| | R32 | mass % | 0.0 | 9.5 | 18.4 | 37.0 |

| | | | | | |
|---|---|---|---|---|---|
| Burning velocity (WCF) | cm/s | 10 | 10 | 10 | 10 |

TABLE 146

| Item | | Unit | M | N | T | P | U | Q |
|---|---|---|---|---|---|---|---|---|
| WCF | HFO- | mass | 47.1 | 38.5 | 34.8 | 31.8 | 28.7 | 28.6 |
| | 1132(E) | % | | | | | | |
| | HFO-1123 | mass | 52.9 | 52.1 | 51.0 | 49.8 | 41.2 | 34.4 |
| | | % | | | | | | |
| | R32 | mass | 0.0 | 9.5 | 14.2 | 18.4 | 30.1 | 37.0 |
| | | % | | | | | | |
| | | | | | | Storage, | Storage, | |
| | | | Storage, | Storage, | Storage, | Shipping, | Shipping, | Storage, |
| | | | Shipping, | Shipping, | Shipping, | −40° C., | −40° C., | Shipping, |
| | | | −40° C., | −40° C., | −40° C., | 92%, | 92%, | −40° C., |
| | | | 92%, | 92%, | 92%, | release, | release, | 92%, |
| | | | release, | release, | release, | on the | on the | release, on |
| Leak condition that | | | on the liquid | on the liquid | on the liquid | liquid | liquid | the liquid |
| results in WCFF | | | phase side | phase side | phase side | phase side | phase side | phase side |
| WCF | HFO- | mass | 72.0 | 58.9 | 51.5 | 44.6 | 31.4 | 27.1 |
| F | 1132(E) | % | | | | | | |
| | HFO-1123 | mass | 28.0 | 32.4 | 33.1 | 32.6 | 23.2 | 18.3 |
| | | % | | | | | | |
| | R32 | mass | 0.0 | 8.7 | 15.4 | 22.8 | 45.4 | 54.6 |
| | | % | | | | | | |

| | | | | | | | |
|---|---|---|---|---|---|---|---|
| Burning velocity | cm/s | 8 or less | 8 or less | 8 or less | 8 or less | 8 or less | 8 or less |
| (WCF) | | | | | | | |
| Burning velocity | cm/s | 10 | 10 | 10 | 10 | 10 | 10 |
| (WCFF) | | | | | | | |

The results in Table 1 indicate that in a ternary composition diagram of a mixed refrigerant of HFO-1132(E), HFO-1123, and R32 in which their sum is 100 mass %, a line segment connecting a point (0.0, 100.0, 0.0) and a point (0.0, 0.0, 100.0) is the base, the point (0.0, 100.0, 0.0) is on the left side, and the point (0.0, 0.0, 100.0) is on the right side, when coordinates (x,y,z) are on or below line segments IK and KL that connect the following 3 points:
   point I (72.0, 28.0, 0.0),
   point K (48.4, 33.2, 18.4), and
   point L (35.5, 27.5, 37.0);
   the line segment IK is represented by coordinates (0.025z²−1.7429z+72.00, −0.025z²+0.7429z+28.00, z), and
   the line segment KL is represented by coordinates (0.0098z²−1.238z+67.852, −0.0098z²+0.238z+32.148, z), it can be determined that the refrigerant has WCF lower flammability.
For the points on the line segment IK, an approximate curve (x=0.025z²−1.7429z+72.00) was obtained from three points, i.e., I (72.0, 28.0, 0.0), J (57.7, 32.8, 9.5), and K (48.4, 33.2, 18.4) by using the least-square method to determine coordinates (x=0.025z²−1.7429z+72.00, y=100−z−x=−0.00922z²+0.2114z+32.443, z).
Likewise, for the points on the line segment KL, an approximate curve was determined from three points, i.e., K (48.4, 33.2, 18.4), Example 10 (41.1, 31.2, 27.7), and L (35.5, 27.5, 37.0) by using the least-square method to determine coordinates.
The results in Table 146 indicate that in a ternary composition diagram of a mixed refrigerant of HFO-1132(E), HFO-1123, and R32 in which their sum is 100 mass %, a line segment connecting a point (0.0, 100.0, 0.0) and a point (0.0, 0.0, 100.0) is the base, the point (0.0, 100.0, 0.0) is on the left side, and the point (0.0, 0.0, 100.0) is on the right side, when coordinates (x,y,z) are on or below line segments MP and PQ that connect the following 3 points:
   point M (47.1, 52.9, 0.0),
   point P (31.8, 49.8, 18.4), and
   point Q (28.6, 34.4, 37.0), it can be determined that the refrigerant has ASHRAE lower flammability.
In the above, the line segment MP is represented by coordinates (0.0083z²−0.984z+47.1, −0.0083z²−0.016z+52.9, z), and the line segment PQ is represented by coordinates (0.0135z²−0.9181z+44.133, −0.0135z²−0.0819z+55.867, z).
For the points on the line segment MP, an approximate curve was obtained from three points, i.e., points M, N, and P, by using the least-square method to determine coordinates. For the points on the line segment PQ, an approximate curve was obtained from three points, i.e., points P, U, and Q, by using the least-square method to determine coordinates.
The GWP of compositions each comprising a mixture of R410A (R32=50%/R125=50%) was evaluated based on the values stated in the Intergovernmental Panel on Climate Change (IPCC), fourth report. The GWP of HFO-1132(E), which was not stated therein, was assumed to be 1 from HFO-1132a (GWP=1 or less) and HFO-1123 (GWP=0.3, described in Patent Literature 1). The refrigerating capacity of compositions each comprising R410A and a mixture of HFO-1132(E) and HFO-1123 was determined by performing theoretical refrigeration cycle calculations for the mixed refrigerants using the National Institute of Science and Technology (NIST) and Reference Fluid Thermodynamic and Transport Properties Database (Refprop 9.0) under the following conditions.
The COP ratio and the refrigerating capacity (which may be referred to as “cooling capacity” or “capacity”) ratio relative to those of R410 of the mixed refrigerants were determined. The conditions for calculation were as described below.
   Evaporating temperature: 5° C.
   Condensation temperature: 45° C.
   Degree of superheating: 5K
   Degree of subcooling: 5K
   Compressor efficiency: 70%
Tables 147 to 166 show these values together with the GWP of each mixed refrigerant.

TABLE 147

| | | | | | Comparative | Comparative | Comparative | Comparative |
|---|---|---|---|---|---|---|---|---|
| | | Comparative | Comparative | Comparative | Example | Example | Example | Example |
| | | Example | Example 2 | Example 3 | 4 | 5 | 6 | 7 |
| Item | Unit | 1 | A | B | A′ | B′ | A″ | B″ |
| HFO-1132(E) | mass % | R410A | 90.5 | 0.0 | 81.6 | 0.0 | 63.0 | 0.0 |
| HFO-1123 | mass % | | 0.0 | 90.5 | 0.0 | 81.6 | 0.0 | 63.0 |
| R32 | mass % | | 9.5 | 9.5 | 18.4 | 18.4 | 37.0 | 37.0 |
| GWP | — | 2088 | 65 | 65 | 125 | 125 | 250 | 250 |
| COP ratio | % | 100 | 99.1 | 92.0 | 98.7 | 93.4 | 98.7 | 96.1 |
| | (relative | | | | | | | |
| | to | | | | | | | |
| | R410A) | | | | | | | |
| Refrigerating | % | 100 | 102.2 | 111.6 | 105.3 | 113.7 | 110.0 | 115.4 |
| capacity | (relative | | | | | | | |
| ratio | to | | | | | | | |
| | R410A) | | | | | | | |

TABLE 148

| | | | Comparative | | | | Comparative |
|---|---|---|---|---|---|---|---|
| | | Comparative | Example | Comparative | | | Example |
| | | Example 8 | 9 | Example | Example 1 | | 11 |
| Item | Unit | O | C | 10 | U | Example 2 | D |
| HFO-1132(E) | mass % | 100.0 | 50.0 | 41.1 | 28.7 | 15.2 | 0.0 |
| HFO-1123 | mass % | 0.0 | 31.6 | 34.6 | 41.2 | 52.7 | 67.0 |
| R32 | mass % | 0.0 | 18.4 | 24.3 | 30.1 | 32.1 | 33.0 |
| GWP | — | 1 | 125 | 165 | 204 | 217 | 228 |
| COP ratio | % (relative | 99.7 | 96.0 | 96.0 | 96.0 | 96.0 | 96.0 |
| | to R410A) | | | | | | |
| Refrigerating | % (relative | 98.3 | 109.9 | 111.7 | 113.5 | 114.8 | 115.4 |
| capacity ratio | to R410A) | | | | | | |

TABLE 149

| | | Com- | Com- | | | Com- |
|---|---|---|---|---|---|---|
| | | parative | par- | Ex- | Ex- | parative |
| | | Example | ative | am- | am- | Exam- |
| | | 12 | Exam- | ple 3 | ple 4 | ple 14 |
| Item | Unit | E | ple 13 | T | S | F |
| HFO-1132(E) | mass % | 53.4 | 43.4 | 34.8 | 25.4 | 0.0 |
| HFO-1123 | mass % | 46.6 | 47.1 | 51.0 | 56.2 | 74.1 |
| R32 | mass % | 0.0 | 9.5 | 14.2 | 18.4 | 25.9 |
| GWP | — | 1 | 65 | 97 | 125 | 176 |
| COP ratio | % (relative | 94.5 | 94.5 | 94.5 | 94.5 | 94.5 |
| | to R410A) | | | | | |
| Refrigerating | % (relative | 105.6 | 109.2 | 110.8 | 112.3 | 114.8 |
| capacity ratio | to R410A) | | | | | |

TABLE 150

| | | Com | | | | Com- |
|---|---|---|---|---|---|---|
| | | parative | | Ex- | | parative |
| | | Exam- | Ex- | am- | Ex- | Exam- |
| | | ple 15 | am- | ple 6 | am- | ple 16 |
| Item | Unit | G | ple 5 | R | ple 7 | H |
| HFO-1132(E) | mass % | 38.5 | 31.5 | 23.1 | 16.9 | 0.0 |
| HFO-1123 | mass % | 61.5 | 63.5 | 67.4 | 71.1 | 84.2 |
| R32 | mass % | 0.0 | 5.0 | 9.5 | 12.0 | 15.8 |
| GWP | — | 1 | 35 | 65 | 82 | 107 |
| COP ratio | % (relative | 93.0 | 93.0 | 93.0 | 93.0 | 93.0 |
| | to | | | | | |
| | R410A) | | | | | |
| Refrigerating | % (relative | 107.0 | 109.1 | 110.9 | 111.9 | 113.2 |
| capacity ratio | to R410A) | | | | | |

TABLE 151

| | | Comparative | | | | Comparative |
|---|---|---|---|---|---|---|
| | | Example 17 | Example 8 | Example 9 | Comparative | Example 19 |
| Item | Unit | I | J | K | Example 18 | L |
| HFO-1132(E) | mass % | 72.0 | 57.7 | 48.4 | 41.1 | 35.5 |
| HFO-1123 | mass % | 28.0 | 32.8 | 33.2 | 31.2 | 27.5 |
| R32 | mass % | 0.0 | 9.5 | 18.4 | 27.7 | 37.0 |
| GWP | — | 1 | 65 | 125 | 188 | 250 |
| COP ratio | % (relative to | 96.6 | 95.8 | 95.9 | 96.4 | 97.1 |
| | R410A) | | | | | |
| Refrigerating | % (relative to | 103.1 | 107.4 | 110.1 | 112.1 | 113.2 |
| capacity ratio | R410A) | | | | | |

TABLE 152

| | | Compar- | | | |
|---|---|---|---|---|---|
| | | ative | | | |
| | | Example | Example | Example | Example |
| | | 20 | 10 | 11 | 12 |
| Item | Unit | M | N | P | Q |
| HFO- | mass % | 47.1 | 38.5 | 31.8 | 28.6 |
| 1132(E) | | | | | |
| HFO- | mass % | 52.9 | 52.1 | 49.8 | 34.4 |
| 1123 | | | | | |
| R32 | mass % | 0.0 | 9.5 | 18.4 | 37.0 |
| GWP | — | 1 | 65 | 125 | 250 |
| COP ratio | % (relative | 93.9 | 94.1 | 94.7 | 96.9 |
| | to R410A) | | | | |
| Refrig- | % (relative | 106.2 | 109.7 | 112.0 | 114.1 |
| erating | to R410A) | | | | |
| capacity | | | | | |
| ratio | | | | | |

TABLE 153

| | | Comparative | Comparative | Comparative | | | | Comparative | Comparative |
|---|---|---|---|---|---|---|---|---|---|
| | | Example | Example | Example | Example | Example | Example | Example | Example |
| Item | Unit | 22 | 23 | 24 | 14 | 15 | 16 | 25 | 26 |
| HFO-1132(E) | mass % | 10.0 | 20.0 | 30.0 | 40.0 | 50.0 | 60.0 | 70.0 | 80.0 |
| HFO-1123 | mass % | 85.0 | 75.0 | 65.0 | 55.0 | 45.0 | 35.0 | 25.0 | 15.0 |
| R32 | mass % | 5.0 | 5.0 | 5.0 | 5.0 | 5.0 | 5.0 | 5.0 | 5.0 |
| GWP | — | 35 | 35 | 35 | 35 | 35 | 35 | 35 | 35 |
| COP ratio | % | 91.7 | 92.2 | 92.9 | 93.7 | 94.6 | 95.6 | 96.7 | 97.7 |
| | (relative | | | | | | | | |
| | to | | | | | | | | |
| | R410A) | | | | | | | | |
| Refrigerating | % | 110.1 | 109.8 | 109.2 | 108.4 | 107.4 | 106.1 | 104.7 | 103.1 |
| capacity | (relative | | | | | | | | |
| ratio | to | | | | | | | | |
| | R410A) | | | | | | | | |

TABLE 154

| | | Comparative | Comparative | Comparative | | | | Comparative | Comparative |
|---|---|---|---|---|---|---|---|---|---|
| | | Example | Example | Example | Example | Example | Example | Example | Example |
| Item | Unit | 27 | 28 | 29 | 17 | 18 | 19 | 30 | 31 |
| HFO-1132(E) | mass % | 90.0 | 10.0 | 20.0 | 30.0 | 40.0 | 50.0 | 60.0 | 70.0 |
| HFO-1123 | mass % | 5.0 | 80.0 | 70.0 | 60.0 | 50.0 | 40.0 | 30.0 | 20.0 |
| R32 | mass % | 5.0 | 10.0 | 10.0 | 10.0 | 10.0 | 10.0 | 10.0 | 10.0 |
| GWP | — | 35 | 68 | 68 | 68 | 68 | 68 | 68 | 68 |
| COP ratio | % | 98.8 | 92.4 | 92.9 | 93.5 | 94.3 | 95.1 | 96.1 | 97.0 |
| | (relative | | | | | | | | |
| | to | | | | | | | | |
| | R410A) | | | | | | | | |
| Refrigerating | % | 101.4 | 111.7 | 111.3 | 110.6 | 109.6 | 108.5 | 107.2 | 105.7 |
| capacity | (relative | | | | | | | | |
| ratio | to | | | | | | | | |
| | R410A) | | | | | | | | |

TABLE 155

| | | Comparative | | | | | | Comparative | Comparative |
|---|---|---|---|---|---|---|---|---|---|
| | | Example | Example | Example | Example | Example | Example | Example | Example |
| Item | Unit | 32 | 20 | 21 | 22 | 23 | 24 | 33 | 34 |

| | | | | | | | | | |
|---|---|---|---|---|---|---|---|---|---|
| HFO-1132(E) | mass % | 80.0 | 10.0 | 20.0 | 30.0 | 40.0 | 50.0 | 60.0 | 70.0 |
| HFO-1123 | mass % | 10.0 | 75.0 | 65.0 | 55.0 | 45.0 | 35.0 | 25.0 | 15.0 |
| R32 | mass% | 10.0 | 15.0 | 15.0 | 15.0 | 15.0 | 15.0 | 15.0 | 15.0 |
| GWP | — | 68 | 102 | 102 | 102 | 102 | 102 | 102 | 102 |
| COP ratio | % (relative | 98.0 | 93.1 | 93.6 | 94.2 | 94.9 | 95.6 | 96.5 | 97.4 |
| | to R410A) | | | | | | | | |
| Refrigerating | % (relative | 104.1 | 112.9 | 112.4 | 111.6 | 110.6 | 109.4 | 108.1 | 106.6 |
| capacity ratio | to R410A) | | | | | | | | |

TABLE 156

| | | Comparative | Comparative | Comparative | Comparative | Comparative | Comparative | Comparative | Comparative |
|---|---|---|---|---|---|---|---|---|---|
| | | Example | Example | Example | Example | Example | Example | Example | Example |
| Item | Unit | 35 | 36 | 37 | 38 | 39 | 40 | 41 | 42 |
| HFO-1132(E) | mass % | 80.0 | 10.0 | 20.0 | 30.0 | 40.0 | 50.0 | 60.0 | 70.0 |
| HFO-1123 | mass % | 5.0 | 70.0 | 60.0 | 50.0 | 40.0 | 30.0 | 20.0 | 10.0 |
| R32 | mass % | 15.0 | 20.0 | 20.0 | 20.0 | 20.0 | 20.0 | 20.0 | 20.0 |
| GWP | — | 102 | 136 | 136 | 136 | 136 | 136 | 136 | 136 |
| COP ratio | % (relative | 98.3 | 93.9 | 94.3 | 94.8 | 95.4 | 96.2 | 97.0 | 97.8 |
| | to R410A) | | | | | | | | |
| Refrigerating | % (relative | 105.0 | 113.8 | 113.2 | 112.4 | 111.4 | 110.2 | 108.8 | 107.3 |
| capacity | to R410A) | | | | | | | | |
| ratio | | | | | | | | | |

TABLE 157

| | | Comparative | Comparative | Comparative | Comparative | Comparative | Comparative | Comparative | Comparative |
|---|---|---|---|---|---|---|---|---|---|
| | | Example | Example | Example | Example | Example | Example | Example | Example |
| Item | Unit | 43 | 44 | 45 | 46 | 47 | 48 | 49 | 50 |
| HFO-1132(E) | mass % | 10.0 | 20.0 | 30.0 | 40.0 | 50.0 | 60.0 | 70.0 | 10.0 |
| HFO-1123 | mass % | 65.0 | 55.0 | 45.0 | 35.0 | 25.0 | 15.0 | 5.0 | 60.0 |
| R32 | mass % | 25.0 | 25.0 | 25.0 | 25.0 | 25.0 | 25.0 | 25.0 | 30.0 |
| GWP | — | 170 | 170 | 170 | 170 | 170 | 170 | 170 | 203 |
| COP ratio | % (relative | 94.6 | 94.9 | 95.4 | 96.0 | 96.7 | 97.4 | 98.2 | 95.3 |
| | to R410A) | | | | | | | | |
| Refrigerating | % | | | | | | | | |
| capacity | (relative | 114.4 | 113.8 | 113.0 | 111.9 | 110.7 | 109.4 | 107.9 | 114.8 |
| ratio | to R410A) | | | | | | | | |

TABLE 158

| | | Comparative | Comparative | Comparative | Comparative | Comparative | | | Comparative |
|---|---|---|---|---|---|---|---|---|---|
| | | Example | Example | Example | Example | Example | Example | Example | Example |
| Item | Unit | 51 | 52 | 53 | 54 | 55 | 25 | 26 | 56 |
| HFO-1132(E) | mass % | 20.0 | 30.0 | 40.0 | 50.0 | 60.0 | 10.0 | 20.0 | 30.0 |
| HFO-1123 | mass % | 50.0 | 40.0 | 30.0 | 20.0 | 10.0 | 55.0 | 45.0 | 35.0 |
| R32 | mass % | 30.0 | 30.0 | 30.0 | 30.0 | 30.0 | 35.0 | 35.0 | 35.0 |
| GWP | — | 203 | 203 | 203 | 203 | 203 | 237 | 237 | 237 |
| COP ratio | % (relative | 95.6 | 96.0 | 96.6 | 97.2 | 97.9 | 96.0 | 96.3 | 96.6 |
| | to R410A) | | | | | | | | |
| Refrigerating | % (relative | 114.2 | 113.4 | 112.4 | 111.2 | 109.8 | 115.1 | 114.5 | 113.6 |
| capacity ratio | to R410A) | | | | | | | | |

TABLE 159

| | | Comparative | Comparative | Comparative | Comparative | Comparative | Comparative | Comparative | Comparative |
|---|---|---|---|---|---|---|---|---|---|
| | | Example | Example | Example | Example | Example | Example | Example | Example |
| Item | Unit | 57 | 58 | 59 | 60 | 61 | 62 | 63 | 64 |
| HFO-1132(E) | mass % | 40.0 | 50.0 | 60.0 | 10.0 | 20.0 | 30.0 | 40.0 | 50.0 |
| HFO-1123 | mass % | 25.0 | 15.0 | 5.0 | 50.0 | 40.0 | 30.0 | 20.0 | 10.0 |
| R32 | mass % | 35.0 | 35.0 | 35.0 | 40.0 | 40.0 | 40.0 | 40.0 | 40.0 |
| GWP | — | 237 | 237 | 237 | 271 | 271 | 271 | 271 | 271 |
| COP ratio | % (relative | 97.1 | 97.7 | 98.3 | 96.6 | 96.9 | 97.2 | 97.7 | 98.2 |
| | to R410A) | | | | | | | | |
| Refrigerating | % (relative | 112.6 | 111.5 | 110.2 | 115.1 | 114.6 | 113.8 | 112.8 | 111.7 |
| capacity ratio | to R410A) | | | | | | | | |

TABLE 160

| | | Example | Example | Example | Example | Example | Example | Example | Example |
|---|---|---|---|---|---|---|---|---|---|
| Item | Unit | 27 | 28 | 29 | 30 | 31 | 32 | 33 | 34 |
| HFO-1132(E) | mass % | 38.0 | 40.0 | 42.0 | 44.0 | 35.0 | 37.0 | 39.0 | 41.0 |
| HFO-1123 | mass % | 60.0 | 58.0 | 56.0 | 54.0 | 61.0 | 59.0 | 57.0 | 55.0 |
| R32 | mass % | 2.0 | 2.0 | 2.0 | 2.0 | 4.0 | 4.0 | 4.0 | 4.0 |
| GWP | — | 14 | 14 | 14 | 14 | 28 | 28 | 28 | 28 |
| COP ratio | % (relative | 93.2 | 93.4 | 93.6 | 93.7 | 93.2 | 93.3 | 93.5 | 93.7 |
| | to R410A) | | | | | | | | |
| Refrigerating | % (relative | 107.7 | 107.5 | 107.3 | 107.2 | 108.6 | 108.4 | 108.2 | 108.0 |
| capacity ratio | to R410A) | | | | | | | | |

TABLE 161

| | | Example | Example | Example | Example | Example | Example | Example | Example |
|---|---|---|---|---|---|---|---|---|---|
| Item | Unit | 35 | 36 | 37 | 38 | 39 | 40 | 41 | 42 |
| HFO-1132(E) | mass % | 43.0 | 31.0 | 33.0 | 35.0 | 37.0 | 39.0 | 41.0 | 27.0 |
| HFO-1123 | mass % | 53.0 | 63.0 | 61.0 | 59.0 | 57.0 | 55.0 | 53.0 | 65.0 |
| R32 | mass % | 4.0 | 6.0 | 6.0 | 6.0 | 6.0 | 6.0 | 6.0 | 8.0 |
| GWP | — | 28 | 41 | 41 | 41 | 41 | 41 | 41 | 55 |
| COP ratio | % (relative | 93.9 | 93.1 | 93.2 | 93.4 | 93.6 | 93.7 | 93.9 | 93.0 |
| | to R410A) | | | | | | | | |
| Refrigerating | % (relative | 107.8 | 109.5 | 109.3 | 109.1 | 109.0 | 108.8 | 108.6 | 110.3 |
| capacity ratio | to R410A) | | | | | | | | |

TABLE 162

| | | Example | Example | Example | Example | Example | Example | Example | Example |
|---|---|---|---|---|---|---|---|---|---|
| Item | Unit | 43 | 44 | 45 | 46 | 47 | 48 | 49 | 50 |
| HFO-1132(E) | mass % | 29.0 | 31.0 | 33.0 | 35.0 | 37.0 | 39.0 | 32.0 | 32.0 |
| HFO-1123 | mass % | 63.0 | 61.0 | 59.0 | 57.0 | 55.0 | 53.0 | 51.0 | 50.0 |
| R32 | mass % | 8.0 | 8.0 | 8.0 | 8.0 | 8.0 | 8.0 | 17.0 | 18.0 |
| GWP | — | 55 | 55 | 55 | 55 | 55 | 55 | 116 | 122 |
| COP ratio | % (relative | 93.2 | 93.3 | 93.5 | 93.6 | 93.8 | 94.0 | 94.5 | 94.7 |
| | to R410A) | | | | | | | | |
| Refrigerating | % (relative | 110.1 | 110.0 | 109.8 | 109.6 | 109.5 | 109.3 | 111.8 | 111.9 |
| capacity ratio | to R410A) | | | | | | | | |

TABLE 163

| | | Example | Example | Example | Example | Example | Example | Example | Example |
|---|---|---|---|---|---|---|---|---|---|
| Item | Unit | 51 | 52 | 53 | 54 | 55 | 56 | 57 | 58 |
| HFO-1132(E) | mass % | 30.0 | 27.0 | 21.0 | 23.0 | 25.0 | 27.0 | 11.0 | 13.0 |
| HFO-1123 | mass % | 52.0 | 42.0 | 46.0 | 44.0 | 42.0 | 40.0 | 54.0 | 52.0 |
| R32 | mass % | 18.0 | 31.0 | 33.0 | 33.0 | 33.0 | 33.0 | 35.0 | 35.0 |
| GWP | — | 122 | 210 | 223 | 223 | 223 | 223 | 237 | 237 |
| COP ratio | % (relative | 94.5 | 96.0 | 96.0 | 96.1 | 96.2 | 96.3 | 96.0 | 96.0 |
| | to R410A) | | | | | | | | |
| Refrigerating | % (relative | 112.1 | 113.7 | 114.3 | 114.2 | 114.0 | 113.8 | 115.0 | 114.9 |
| capacity ratio | to R410A) | | | | | | | | |

TABLE 164

| | | Example | Example | Example | Example | Example | Example | Example | Example |
|---|---|---|---|---|---|---|---|---|---|
| Item | Unit | 59 | 60 | 61 | 62 | 63 | 64 | 65 | 66 |
| HFO-1132(E) | mass % | 15.0 | 17.0 | 19.0 | 21.0 | 23.0 | 25.0 | 27.0 | 11.0 |
| HFO-1123 | mass % | 50.0 | 48.0 | 46.0 | 44.0 | 42.0 | 40.0 | 38.0 | 52.0 |
| R32 | mass % | 35.0 | 35.0 | 35.0 | 35.0 | 35.0 | 35.0 | 35.0 | 37.0 |
| GWP | — | 237 | 237 | 237 | 237 | 237 | 237 | 237 | 250 |
| COP ratio | % (relative | 96.1 | 96.2 | 96.2 | 96.3 | 96.4 | 96.4 | 96.5 | 96.2 |
| | to R410A) | | | | | | | | |
| Refrigerating | % (relative | 114.8 | 114.7 | 114.5 | 114.4 | 114.2 | 114.1 | 113.9 | 115.1 |
| capacity ratio | to R410A) | | | | | | | | |

TABLE 165

| | | Example | Example | Example | Example | Example | Example | Example | Example |
|---|---|---|---|---|---|---|---|---|---|
| Item | Unit | 67 | 68 | 69 | 70 | 71 | 72 | 73 | 74 |
| HFO-1132(E) | mass % | 13.0 | 15.0 | 17.0 | 15.0 | 17.0 | 19.0 | 21.0 | 23.0 |
| HFO-1123 | mass % | 50.0 | 48.0 | 46.0 | 50.0 | 48.0 | 46.0 | 44.0 | 42.0 |
| R32 | mass % | 37.0 | 37.0 | 37.0 | 0.0 | 0.0 | 0.0 | 0.0 | 0.0 |
| GWP | — | 250 | 250 | 250 | 237 | 237 | 237 | 237 | 237 |
| COP ratio | % (relative | 96.3 | 96.4 | 96.4 | 96.1 | 96.2 | 96.2 | 96.3 | 96.4 |
| | to R410A) | | | | | | | | |
| Refrigerating | % (relative | 115.0 | 114.9 | 114.7 | 114.8 | 114.7 | 114.5 | 114.4 | 114.2 |
| capacity ratio | to R410A) | | | | | | | | |

TABLE 166

| | | Example | Example | Example | Example | Example | Example | Example | Example |
|---|---|---|---|---|---|---|---|---|---|
| Item | Unit | 75 | 76 | 77 | 78 | 79 | 80 | 81 | 82 |
| HFO-1132(E) | mass % | 25.0 | 27.0 | 11.0 | 19.0 | 21.0 | 23.0 | 25.0 | 27.0 |
| HFO-1123 | mass % | 40.0 | 38.0 | 52.0 | 44.0 | 42.0 | 40.0 | 38.0 | 36.0 |
| R32 | mass % | 0.0 | 0.0 | 0.0 | 37.0 | 37.0 | 37.0 | 37.0 | 37.0 |
| GWP | — | 237 | 237 | 250 | 250 | 250 | 250 | 250 | 250 |
| COP ratio | % (relative | 96.4 | 96.5 | 96.2 | 96.5 | 96.5 | 96.6 | 96.7 | 96.8 |
| | to R410A) | | | | | | | | |
| Refrigerating | % (relative | 114.1 | 113.9 | 115.1 | 114.6 | 114.5 | 114.3 | 114.1 | 114.0 |
| capacity ratio | to R410A) | | | | | | | | |

The above results indicate that under the condition that the mass % of HFO-1132(E), HFO-1123, and R32 based on their sum is respectively represented by x, y, and z, when coordinates (x,y,z) in a ternary composition diagram in which the sum of HFO-1132(E), HFO-1123, and R32 is 100 mass %, a line segment connecting a point (0.0, 100.0, 0.0) and a point (0.0, 0.0, 100.0) is the base, and the point (0.0, 100.0, 0.0) is on the left side are within the range of a figure surrounded by line segments that connect the following 4 points:
   point O (100.0, 0.0, 0.0),
   point A″ (63.0, 0.0, 37.0),
   point B″ (0.0, 63.0, 37.0), and
   point (0.0, 100.0, 0.0),
   or on these line segments,
   the refrigerant has a GWP of 250 or less.
The results also indicate that when coordinates (x,y,z) are within the range of a figure surrounded by line segments that connect the following 4 points:
   point O (100.0, 0.0, 0.0),
   point A′ (81.6, 0.0, 18.4),
   point B′ (0.0, 81.6, 18.4), and
   point (0.0, 100.0, 0.0),
   or on these line segments,
   the refrigerant has a GWP of 125 or less.
The results also indicate that when coordinates (x,y,z) are within the range of a figure surrounded by line segments that connect the following 4 points:
   point O (100.0, 0.0, 0.0),
   point A (90.5, 0.0, 9.5),
   point B (0.0, 90.5, 9.5), and
   point (0.0, 100.0, 0.0),
   or on these line segments,
   the refrigerant has a GWP of 65 or less.
The results also indicate that when coordinates (x,y,z) are on the left side of line segments that connect the following 3 points:
   point C (50.0, 31.6, 18.4),
   point U (28.7, 41.2, 30.1), and
   point D (52.2, 38.3, 9.5),
   or on these line segments,
   the refrigerant has a COP ratio of 96% or more relative to that of R410A.
In the above, the line segment CU is represented by coordinates (−0.0538z²+0.7888z+53.701, 0.0538z²−1.7888z+46.299, z), and the line segment UD is represented by coordinates (−3.4962z²+210.71z−3146.1, 3.4962z²−211.71z+3246.1, z).
The points on the line segment CU are determined from three points, i.e., point C, Comparative Example 10, and point U, by using the least-square method.
The points on the line segment UD are determined from three points, i.e., point U, Example 2, and point D, by using the least-square method.
The results also indicate that when coordinates (x,y,z) are on the left side of line segments that connect the following 3 points:
   point E (55.2, 44.8, 0.0),
   point T (34.8, 51.0, 14.2), and
   point F (0.0, 76.7, 23.3),
   or on these line segments,
   the refrigerant has a COP ratio of 94.5% or more relative to that of R410A.
In the above, the line segment ET is represented by coordinates (−0.0547z²−0.5327z+53.4, 0.0547z²−0.4673z+46.6, z), and the line segment TF is represented by coordinates (−0.0982z²+0.9622z+40.931, 0.0982z²−1.9622z+59.069, z).
The points on the line segment ET are determined from three points, i.e., point E, Example 2, and point T, by using the least-square method.
The points on the line segment TF are determined from three points, i.e., points T, S, and F, by using the least-square method.
The results also indicate that when coordinates (x,y,z) are on the left side of line segments that connect the following 3 points:
   point G (0.0, 76.7, 23.3),
   point R (21.0, 69.5, 9.5), and
   point H (0.0, 85.9, 14.1),
   or on these line segments,
   the refrigerant has a COP ratio of 93% or more relative to that of R410A.
In the above, the line segment GR is represented by coordinates (−0.0491z²−1.1544z+38.5, 0.0491z²+0.1544z+61.5, z), and the line segment RH is represented by coordinates (−0.3123z²+4.234z+11.06, 0.3123z²−5.234z+88.94, z).
The points on the line segment GR are determined from three points, i.e., point G, Example 5, and point R, by using the least-square method.
The points on the line segment RH are determined from three points, i.e., point R, Example 7, and point H, by using the least-square method.
In contrast, as shown in, for example, Comparative Examples 8, 9, 13, 15, 17, and 18, when R32 is not contained, the concentrations of HFO-1132(E) and HFO-1123, which have a double bond, become relatively high; this undesirably leads to deterioration, such as decomposition, or polymerization in the refrigerant compound.

The embodiments of the present disclosure have been described above, and it is understood that the embodiments and details can be modified in various ways without departing from the idea and scope of the present disclosure described in the claims.

### (6) First Embodiment

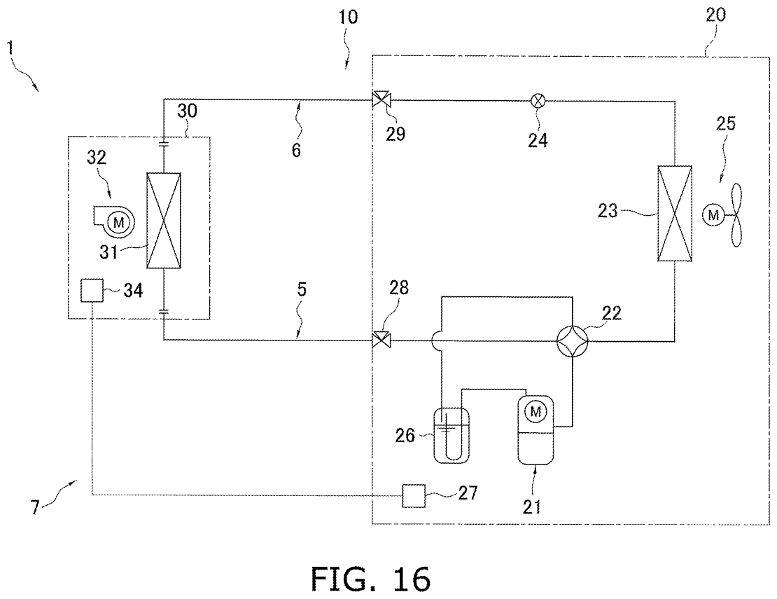

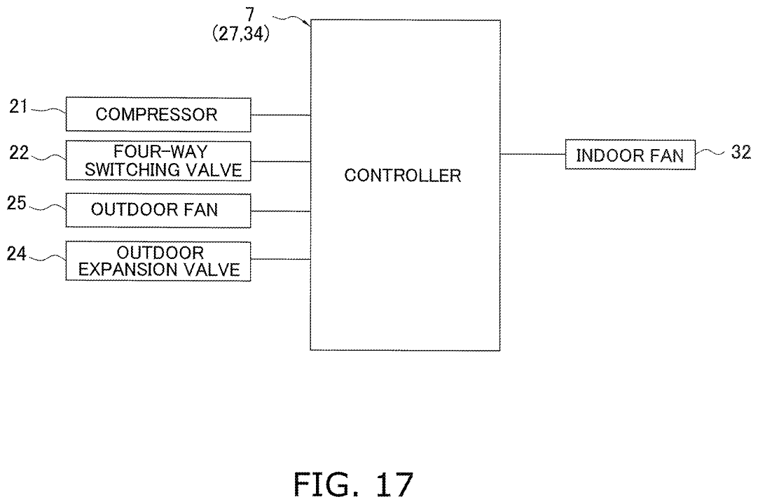

An air conditioning apparatus 1 serving as a refrigeration cycle apparatus according to a first embodiment is described below with reference to FIG. 16 which is a schematic configuration diagram of a refrigerant circuit and FIG. 17 which is a schematic control block configuration diagram.

The air conditioning apparatus 1 is an apparatus that controls the condition of air in a subject space by performing a vapor compression refrigeration cycle.

The air conditioning apparatus 1 mainly includes an outdoor unit 20, an indoor unit 30, a liquid-side connection pipe 6 and a gas-side connection pipe 5 that connect the outdoor unit 20 and the indoor unit 30 to each other, a remote controller (not illustrated) serving as an input device and an output device, and a controller 7 that controls operations of the air conditioning apparatus 1.

The air conditioning apparatus 1 performs a refrigeration cycle in which a refrigerant enclosed in a refrigerant circuit 10 is compressed, cooled or condensed, decompressed, heated or evaporated, and then compressed again. In the present embodiment, the refrigerant circuit 10 is filled with a refrigerant for performing a vapor compression refrigeration cycle. The refrigerant is a refrigerant containing 1,2-difluoroethylene, and can use any one of the above-described refrigerants A to E. The air conditioning apparatus 1 provided with only one indoor unit 30 may have, for example, a rated cooling capacity of 2.0 kW or more and 17.0 kW or less. In particular, in the present embodiment provided with a low-pressure receiver 26 being a refrigerant container, the rated cooling capacity is preferably 4.0 kW or more and 17.0 kW or less.

### (6-1) Outdoor Unit 20

The outdoor unit 20 is connected to the indoor unit 30 via the liquid-side connection pipe 6 and the gas-side connection pipe 5, and constitutes a part of the refrigerant circuit 10. The outdoor unit 20 mainly includes a compressor 21, a four-way switching valve 22, an outdoor heat exchanger 23, an outdoor expansion valve 24, an outdoor fan 25, the low-pressure receiver 26, a liquid-side shutoff valve 29, and a gas-side shutoff valve 28.

The compressor 21 is a device that compresses the refrigerant with a low pressure in the refrigeration cycle until the refrigerant becomes a high-pressure refrigerant. In this case, a compressor having a hermetically sealed structure in which a compression element (not illustrated) of positive-displacement type, such as rotary type or scroll type, is rotationally driven by a compressor motor is used as the compressor 21. The compressor motor is for changing the capacity, and has an operational frequency that can be controlled by an inverter. Note that the compressor 21 is provided with an additional accumulator (not illustrated) on the suction side.

The four-way switching valve 22, by switching the connection state, can switch the state between a cooling operation connection state in which the discharge side of the compressor 21 is connected to the outdoor heat exchanger 23 and the suction side of the compressor 21 is connected to the gas-side shutoff valve 28, and a heating operation connection state in which the discharge side of the compressor 21 is connected to the gas-side shutoff valve 28 and the suction side of the compressor 21 is connected to the outdoor heat exchanger 23.

The outdoor heat exchanger 23 is a heat exchanger that functions as a condenser for the high-pressure refrigerant in the refrigeration cycle during cooling operation and that functions as an evaporator for the low-pressure refrigerant in the refrigeration cycle during heating operation. Note that, for the inner capacity (the volume of a fluid with which the inside can be filled) of the outdoor heat exchanger 23, when the refrigerant circuit 10 is provided with a refrigerant container (for example, a low-pressure receiver or a high-pressure receiver, excluding the accumulator belonging to the compressor) like the present embodiment, the inner capacity is preferably 1.4 L or more and less than 5.0 L. Moreover, like the present embodiment, for the inner capacity (the volume of a fluid with which the inside can be filled) of the outdoor heat exchanger 23 included in a trunk outdoor unit 20 provided with only one outdoor fan 25, the inner capacity is preferably 0.4 L or more and less than 3.5 L.

The outdoor fan 25 sucks outdoor air into the outdoor unit 20, causes the outdoor air to exchange heat with the refrigerant in the outdoor heat exchanger 23, and then generates an air flow to be discharged to the outside. The outdoor fan 25 is rotationally driven by an outdoor fan motor.

The valve opening degree of the outdoor expansion valve 24 is controllable and the outdoor expansion valve 24 is provided between a liquid-side end portion of the outdoor heat exchanger 23 and the liquid-side shutoff valve 29.

The low-pressure receiver 26 is a container that is provided between one of the connecting ports of the four-way switching valve 22 and the suction side of the compressor 21 and that can store the refrigerant.

The liquid-side shutoff valve 29 is a manual valve disposed in a connection portion of the outdoor unit 20 with respect to the liquid-side connection pipe 6.

The gas-side shutoff valve 28 is a manual valve disposed in a connection portion of the outdoor unit 20 with respect to the gas-side connection pipe 5.

The outdoor unit 20 includes an outdoor-unit control unit 27 that controls operations of respective sections constituting the outdoor unit 20. The outdoor-unit control unit 27 includes a microcomputer including a CPU, a memory, and so forth. The outdoor-unit control unit 27 is connected to an indoor-unit control unit 34 of each indoor unit 30 via a communication line, and transmits and receives a control signal and so forth. The outdoor-unit control unit 27 is electrically connected to various sensors (not illustrated) and receives signals from the respective sensors.

### (6-2) Indoor Unit 30

The indoor unit 30 is installed on a wall surface or a ceiling in a room that is a subject space. The indoor unit 30 is connected to the outdoor unit 20 via the liquid-side connection pipe 6 and the gas-side connection pipe 5, and constitutes a part of the refrigerant circuit 10.

The indoor unit 30 includes an indoor heat exchanger 31 and an indoor fan 32. The liquid side of the indoor heat exchanger 31 is connected to the liquid-side connection pipe 6, and the gas-side end thereof is connected to the gas-side connection pipe 5. The indoor heat exchanger 31 is a heat exchanger that functions as an evaporator for the low-pressure refrigerant in the refrigeration cycle during cooling operation and that functions as a condenser for the high-pressure refrigerant in the refrigeration cycle during heating operation. The indoor fan 32 sucks indoor air into the indoor unit 30, causes the indoor air to exchange heat with the refrigerant in the indoor heat exchanger 31, and then generates an air flow to be discharged to the outside. The indoor fan 32 is rotationally driven by an indoor fan motor.

The indoor unit 30 includes an indoor-unit control unit 34 that controls operations of respective sections constituting the indoor unit 30. The indoor-unit control unit 34 includes a microcomputer including a CPU, a memory, and so forth. The indoor-unit control unit 34 is connected to the outdoor-unit control unit 27 via a communication line, and transmits and receives a control signal and so forth.

The indoor-unit control unit 34 is electrically connected to various sensors (not illustrated) provided in the indoor unit 30 and receives signals from the respective sensors.

### (6-3) Details of Controller 7

In the air conditioning apparatus 1, the outdoor-unit control unit 27 is connected to the indoor-unit control unit 34 via the communication line, thereby constituting the controller 7 that controls operations of the air conditioning apparatus 1.

The controller 7 mainly includes a CPU (central processing unit) and a memory, such as a ROM or a RAM. Various processing and control by the controller 7 are provided when respective sections included in the outdoor-unit control unit 27 and/or the indoor-unit control unit 34 function together.

### (6-4) Operating Modes

Operating modes are described below.

The operating modes include a cooling operating mode and a heating operating mode.

The controller 7 determines whether the operating mode is the cooling operating mode or the heating operating mode and executes the determined mode based on an instruction received from the remote controller or the like.

### (6-4-1) Cooling Operating Mode

In the air conditioning apparatus 1, in the cooling operating mode, the connection state of the four-way switching valve 22 is in the cooling operation connection state in which the discharge side of the compressor 21 is connected to the outdoor heat exchanger 23 and the suction side of the compressor 21 is connected to the gas-side shutoff valve 28, and the refrigerant filled in the refrigerant circuit 10 is circulated mainly sequentially in the compressor 21, the outdoor heat exchanger 23, the outdoor expansion valve 24, and the indoor heat exchanger 31.

More specifically, in the refrigerant circuit 10, when the cooling operating mode is started, the refrigerant is sucked into the compressor 21, compressed, and then discharged.

The compressor 21 performs capacity control in accordance with a cooling load required for the indoor unit 30. The capacity control is not limited and may be, for example, control in which a target value of suction pressure is set in accordance with the cooling load required for the indoor unit 30, and the operating frequency of the compressor 21 is controlled such that the suction pressure becomes the target value.

The gas refrigerant discharged from the compressor 21 passes through the four-way switching valve 22 and flows into the gas-side end of the outdoor heat exchanger 23.

The gas refrigerant which has flowed into the gas-side end of the outdoor heat exchanger 23 exchanges heat with outdoor-side air supplied by the outdoor fan 25, hence is condensed and turns into a liquid refrigerant in the outdoor heat exchanger 23, and flows out from the liquid-side end of the outdoor heat exchanger 23.

The refrigerant which has flowed out from the liquid-side end of the outdoor heat exchanger 23 is decompressed when passing through the outdoor expansion valve 24. Note that the outdoor expansion valve 24 is controlled such that the degree of subcooling of the refrigerant flowing through the liquid-side outlet of the outdoor heat exchanger 23 satisfies a predetermined condition. The method of controlling the valve opening degree of the outdoor expansion valve 24 is not limited, and, for example, control may be performed such that the discharge temperature of the refrigerant discharged from the compressor 21 becomes a predetermined temperature, or the degree of superheating of the refrigerant discharged from the compressor 21 satisfies a predetermined condition.

The refrigerant decompressed at the outdoor expansion valve 24 passes through the liquid-side shutoff valve 29 and the liquid-side connection pipe 6, and flows into the indoor unit 30.

The refrigerant which has flowed into the indoor unit 30 flows into the indoor heat exchanger 31; exchanges heat with the indoor air supplied by the indoor fan 32, hence is evaporated, and turns into a gas refrigerant in the indoor heat exchanger 31; and flows out from the gas-side end of the indoor heat exchanger 31. The gas refrigerant which has flowed out from the gas-side end of the indoor heat exchanger 31 flows to the gas-side connection pipe 5.

The refrigerant which has flowed through the gas-side connection pipe 5 passes through the gas-side shutoff valve 28 and the four-way switching valve 22, and is sucked into the compressor 21 again.

### (6-4-2) Heating Operating Mode

In the air conditioning apparatus 1, in the heating operating mode, the connection state of the four-way switching valve 22 is in the heating operation connection state in which the discharge side of the compressor 21 is connected to the gas-side shutoff valve 28 and the suction side of the compressor 21 is connected to the outdoor heat exchanger 23, and the refrigerant filled in the refrigerant circuit 10 is circulated mainly sequentially in the compressor 21, the indoor heat exchanger 31, the outdoor expansion valve 24, and the outdoor heat exchanger 23.

More specifically, in the refrigerant circuit 10, when the heating operating mode is started, the refrigerant is sucked into the compressor 21, compressed, and then discharged.

The compressor 21 performs capacity control in accordance with a heating load required for the indoor unit 30. The capacity control is not limited and may be, for example, control in which a target value of discharge pressure is set in accordance with the heating load required for the indoor unit 30, and the operating frequency of the compressor 21 is controlled such that the discharge pressure becomes the target value.

The gas refrigerant discharged from the compressor 21 flows through the four-way switching valve 22 and the gas-side connection pipe 5, and then flows into the indoor unit 30.

The refrigerant which has flowed into the indoor unit 30 flows into the gas-side end of the indoor heat exchanger 31; exchanges heat with the indoor air supplied by the indoor fan 32, hence is condensed, and turns into a refrigerant in a gas-liquid two-phase state or a liquid refrigerant in the indoor heat exchanger 31; and flows out from the liquid-side end of the indoor heat exchanger 31. The refrigerant which has flowed out from the liquid-side end of the indoor heat exchanger 31 flows to the liquid-side connection pipe 6.

The refrigerant which has flowed through the liquid-side connection pipe 6 is decompressed to a low pressure in the refrigeration cycle at the liquid-side shutoff valve 29 and the outdoor expansion valve 24. Note that the outdoor expansion valve 24 is controlled such that the degree of subcooling of the refrigerant flowing through the liquid-side outlet of the indoor heat exchanger 31 satisfies a predetermined condition. The method of controlling the valve opening degree of the outdoor expansion valve 24 is not limited, and, for example, control may be performed such that the discharge temperature of the refrigerant discharged from the compressor 21 becomes a predetermined temperature, or the degree of superheating of the refrigerant discharged from the compressor 21 satisfies a predetermined condition.

The refrigerant decompressed at the outdoor expansion valve 24 flows into the liquid-side end of the outdoor heat exchanger 23.

The refrigerant which has flowed in from the liquid-side end of the outdoor heat exchanger 23 exchanges heat with the outdoor air supplied by the outdoor fan 25, hence is evaporated and turns into a gas refrigerant in the outdoor heat exchanger 23, and flows out from the gas-side end of the outdoor heat exchanger 23.

The refrigerant which has flowed out from the gas-side end of the outdoor heat exchanger 23 passes through the four-way switching valve 22 and is sucked into the compressor 21 again.

### (6-5) Refrigerant Enclosure Amount

In the air conditioning apparatus 1 provided with only the above-described one indoor unit 30, the refrigerant circuit 10 is filled with the refrigerant by an enclosure amount of 160 g or more and 560 g or less per 1 kW of refrigeration capacity. In particular, in the air conditioning apparatus 1 provided with the low-pressure receiver 26 as a refrigerant container, the refrigerant circuit 10 is filled with the refrigerant by an enclosure amount of 260 g or more and 560 g or less per 1 kW of refrigeration capacity.

### (6-6) Characteristics of First Embodiment

For example, in a refrigeration cycle apparatus using a R32 refrigerant which has been frequently used, when the filling amount of R32 is too small, an insufficiency of the refrigerant tends to decrease cycle efficiency, resulting in an increase in the LCCP; and when the filling amount of R32 is too large, the impact of the GWP tends to increase, resulting in an increase in the LCCP.

In contrast, the air conditioning apparatus 1 provided with only one indoor unit 30 according to the present embodiment uses any one of the above-described refrigerants A to E containing 1,2-difluoroethylene as the refrigerant, and the refrigerant enclosure amount is set such that the enclosure amount per 1 kW of refrigeration capacity is 160 g or more and 560 g or less (in particular, 260 g or more and 560 g or less as the low-pressure receiver 26 is provided).

Accordingly, since a refrigerant having a GWP sufficiently smaller than R32 is used and the enclosure amount per 1 kW of refrigeration capacity is not more than 560 g, the LCCP can be kept low. Moreover, even when a refrigerant having a heat-transfer capacity lower than R32 is used, since the enclosure amount per 1 kW of refrigeration capacity is 160 g or more (in particular, 260 g or more as the low-pressure receiver 26 is provided), a decrease in cycle efficiency due to an insufficiency of the refrigerant is suppressed, thereby suppressing an increase in the LCCP. As described above, when a heat cycle is performed using a sufficiently small GWP, the LCCP can be kept low.

### (6-7) Modification A of First Embodiment

In the above-described first embodiment, the example of the air conditioning apparatus provided with the low-pressure receiver on the suction side of the compressor 21 has been described; however, the air conditioning apparatus may be one not be provided with a refrigerant container (a low-pressure receiver, a high-pressure receiver, or the like, excluding an accumulator belonging to a compressor) in a refrigerant circuit.

In this case, the refrigerant circuit 10 is filled with the refrigerant such that the refrigerant enclosure amount per 1 kW of refrigeration capacity is 160 g or more and 400 g or less. Moreover, in this case, the inner capacity (the volume of a fluid with which the inside can be filled) of the outdoor heat exchanger 23 is preferably 0.4 L or more and 2.5 L or less.

### (6-8) Modification B of First Embodiment

In the above-described first embodiment, the example of the air conditioning apparatus provided with only one indoor unit has been described; however, the air conditioning apparatus may be one provided with a plurality of indoor units (without an indoor expansion valve) connected in parallel to one another.

In this case, the refrigerant circuit 10 is filled with the refrigerant such that the refrigerant enclosure amount per 1 kW of refrigeration capacity is 260 g or more and 560 g or less. Moreover, in this case, the inner capacity (the volume of a fluid with which the inside can be filled) of the outdoor heat exchanger 23 is preferably 1.4 L or more and less than 5.0 L.

### (6-9) Modification C of First Embodiment

In the above-described first embodiment, the example of the air conditioning apparatus having the trunk outdoor unit 20 provided with only one outdoor fan 25 has been described; however, the air conditioning apparatus may be one having the trunk outdoor unit 20 provided with two outdoor fans 25.

In this case, the refrigerant circuit 10 is filled with the refrigerant such that the refrigerant enclosure amount per 1 kW of refrigeration capacity is 350 g or more and 540 g or less. Moreover, in this case, the inner capacity (the volume of a fluid with which the inside can be filled) of the outdoor heat exchanger 23 is preferably 3.5 L or more and 7.0 L or less.

### (7) Second Embodiment

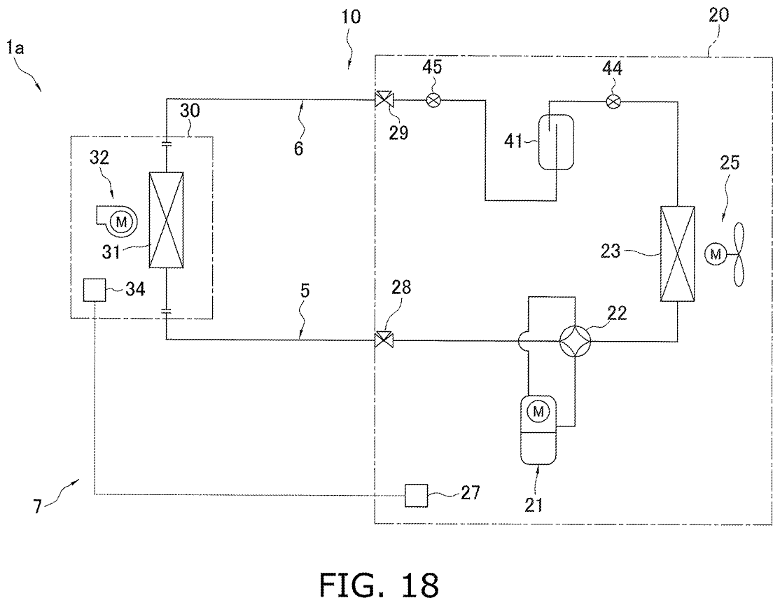

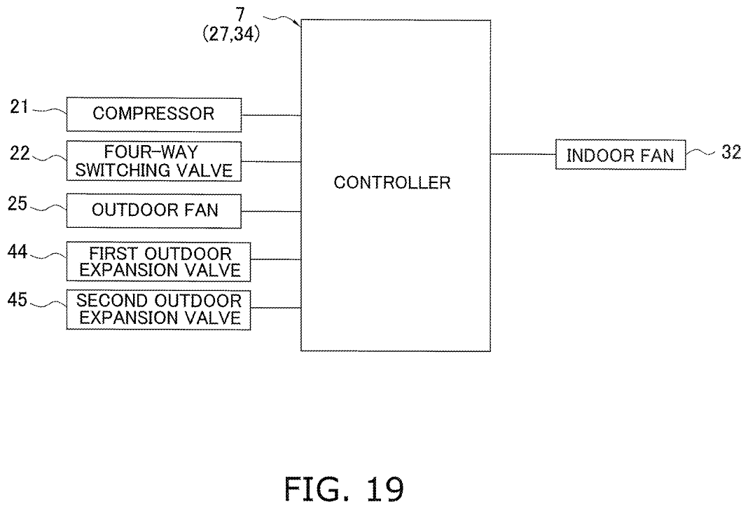

An air conditioning apparatus 1a serving as a refrigeration cycle apparatus according to a second embodiment is described below with reference to FIG. 18 which is a schematic configuration diagram of a refrigerant circuit and FIG. 19 which is a schematic control block configuration diagram.

The air conditioning apparatus 1a according to the second embodiment is mainly described below, and portions different from the air conditioning apparatus 1 according to the first embodiment are mainly described.

Also in the air conditioning apparatus 1a, the refrigerant circuit 10 is filled with, as a refrigerant for performing a vapor compression refrigeration cycle, a refrigerant which contains 1,2-difluoroethylene, and which is any one of the above-described refrigerants A to E.

In the outdoor unit 20 of the air conditioning apparatus 1a, a first outdoor expansion valve 44, an intermediate-pressure receiver 41, and a second outdoor expansion valve 45 are sequentially provided between the liquid side of the outdoor heat exchanger 23 and the liquid-side shutoff valve 29, instead of the outdoor expansion valve 24 of the outdoor unit 20 according to the above-described first embodiment. Moreover, the low-pressure receiver 26 of the outdoor unit 20 according to the first embodiment is not provided in the outdoor unit 20 according to the second embodiment.

The valve opening degrees of the first outdoor expansion valve 44 and the second outdoor expansion valve 45 are controllable.

The intermediate-pressure receiver 41 is a container in which both an end portion of a pipe extending from the first outdoor expansion valve 44 side and an end portion of a pipe extending from the second outdoor expansion valve 45 side are located in the inner space thereof and that can store the refrigerant.

Note that, since the air conditioning apparatus 1a according to the second embodiment is provided with the intermediate-pressure receiver 41 that is a refrigerant container in the refrigerant circuit 10, the inner capacity (the volume of a fluid with which the inside can be filled) of the outdoor heat exchanger 23 included in the outdoor unit 20 is preferably 1.4 L or more and less than 5.0 L. Moreover, like the present embodiment, the inner capacity (the volume of a fluid with which the inside can be filled) of the outdoor heat exchanger 23 included in a trunk outdoor unit 20 provided with only one outdoor fan 25 is preferably 0.4 L or more and less than 3.5 L.

In the air conditioning apparatus 1a, in the cooling operating mode, the first outdoor expansion valve 44 is controlled such that the degree of subcooling of the refrigerant flowing through the liquid-side outlet of the outdoor heat exchanger 23 satisfies a predetermined condition. Also, in the cooling operating mode, the second outdoor expansion valve 45 is controlled such that the degree of superheating of the refrigerant to be sucked by the compressor 21 satisfies a predetermined condition. Note that, in the cooling operating mode, the second outdoor expansion valve 45 may be controlled such that the temperature of the refrigerant discharged from the compressor 21 becomes a predetermined temperature, or may be controlled such that the degree of superheating of the refrigerant discharged from the compressor 21 satisfies a predetermined condition.

Also, in the heating operating mode, the second outdoor expansion valve 45 is controlled such that the degree of subcooling of the refrigerant passing through the liquid-side outlet of the indoor heat exchanger 31 satisfies a predetermined condition. Also, in the cooling operating mode, the first outdoor expansion valve 44 is controlled such that the degree of superheating of the refrigerant to be sucked by the compressor 21 satisfies a predetermined condition. Note that, in the heating operating mode, the first outdoor expansion valve 44 may be controlled such that the temperature of the refrigerant discharged from the compressor 21 becomes a predetermined temperature, or may be controlled such that the degree of superheating of the refrigerant discharged from the compressor 21 satisfies a predetermined condition.

In the air conditioning apparatus 1a provided with only the above-described one indoor unit 30, the refrigerant circuit 10 is filled with the refrigerant by an enclosure amount of 160 g or more and 560 g or less per 1 kW of refrigeration capacity. In particular, in the air conditioning apparatus 1 provided with the intermediate-pressure receiver 41 as a refrigerant container, the refrigerant circuit 10 is filled with the refrigerant by an enclosure amount of 260 g or more and 560 g or less per 1 kW of refrigeration capacity.

The air conditioning apparatus 1 provided with only one indoor unit 30 may have a rated cooling capacity of 2.2 kW or more and 16.0 kW or less, or more preferably 4.0 kW or more and 16.0 kW or less.

Even in the air conditioning apparatus 1a according to the second embodiment, like the air conditioning apparatus 1 according to the first embodiment, when a heat cycle is performed using a sufficiently small GWP, the LCCP can be kept low.

### (7-1) Modification A of Second Embodiment

In the above-described second embodiment, the example of the air conditioning apparatus provided with only one indoor unit has been described; however, the air conditioning apparatus may be one provided with a plurality of indoor units (without an indoor expansion valve) connected in parallel to one another.

In this case, the refrigerant circuit 10 is filled with the refrigerant such that the refrigerant enclosure amount per 1 kW of refrigeration capacity is 260 g or more and 560 g or less. Moreover, in this case, the inner capacity (the volume of a fluid with which the inside can be filled) of the outdoor heat exchanger 23 is preferably 1.4 L or more and less than 5.0 L.

### (7-2) Modification B of Second Embodiment

In the above-described second embodiment, the example of the air conditioning apparatus having the trunk outdoor unit 20 provided with only one outdoor fan 25 has been described; however, the air conditioning apparatus may be one having the trunk outdoor unit 20 provided with two outdoor fans 25.

In this case, the refrigerant circuit 10 is filled with the refrigerant such that the refrigerant enclosure amount per 1 kW of refrigeration capacity is 350 g or more and 540 g or less. Moreover, in this case, the inner capacity (the volume of a fluid with which the inside can be filled) of the outdoor heat exchanger 23 is preferably 3.5 L or more and 7.0 L or less.

### (8) Third Embodiment

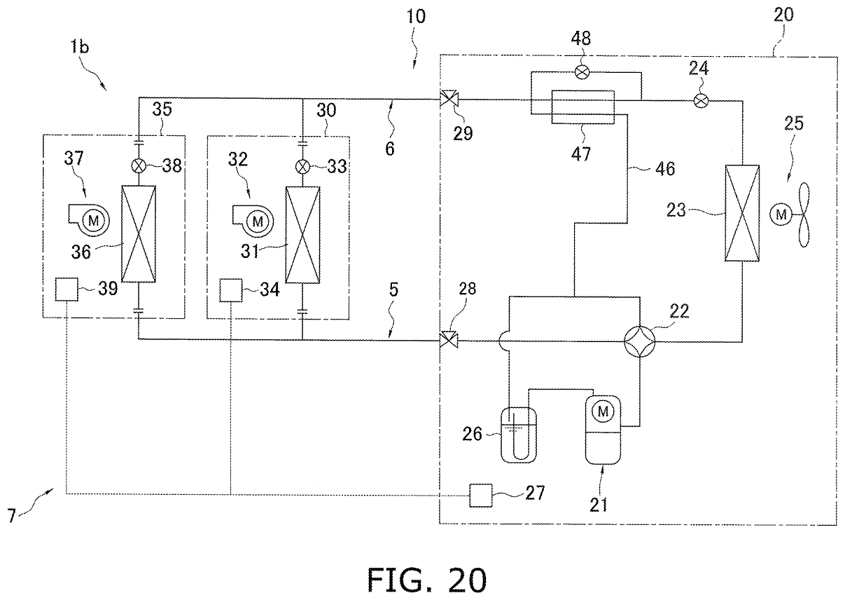

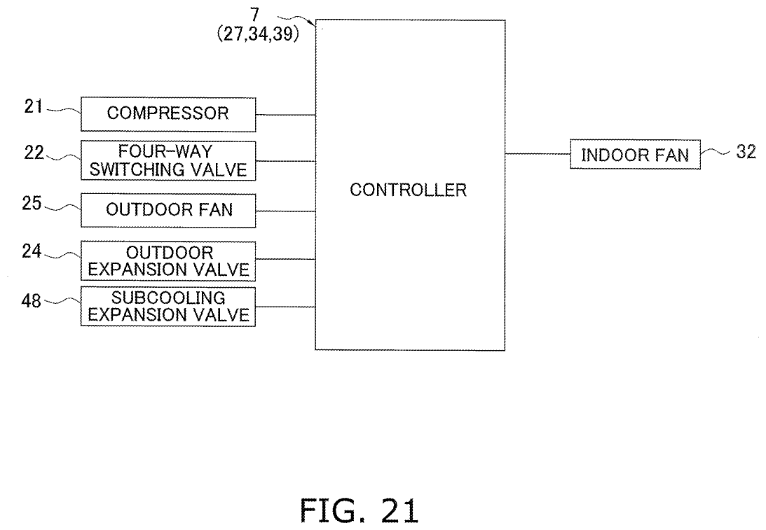

An air conditioning apparatus 1b serving as a refrigeration cycle apparatus according to a third embodiment is described below with reference to FIG. 20 which is a schematic configuration diagram of a refrigerant circuit and FIG. 21 which is a schematic control block configuration diagram.

The air conditioning apparatus 1b according to the third embodiment is mainly described below, and portions different from the air conditioning apparatus 1 according to the first embodiment are mainly described.

In the air conditioning apparatus 1b, the refrigerant circuit 10 is filled with, as a refrigerant for performing a vapor compression refrigeration cycle, a refrigerant which contains 1,2-difluoroethylene, and which is any one of the above-described refrigerants A to E.

The outdoor unit 20 of the air conditioning apparatus 1b according to the third embodiment is obtained by providing a subcooling heat exchanger 47 and a subcooling circuit 46 in the outdoor unit 20 according to the first embodiment.

The subcooling heat exchanger 47 is provided between the outdoor expansion valve 24 and the liquid-side shutoff valve 29.

The subcooling circuit 46 is a circuit that is branched from a main circuit between the outdoor expansion valve 24 and the subcooling heat exchanger 47 and that extends to be joined to a midway portion extending from one of the connecting ports of the four-way switching valve 22 to the low-pressure receiver 26. The subcooling circuit 46 is provided with a subcooling expansion valve 48 that is located midway in the subcooling circuit 46 and that decompresses the refrigerant passing therethrough. The refrigerant flowing through the subcooling circuit 46 and decompressed at the subcooling expansion valve 48 exchanges heat with the refrigerant flowing through the main-circuit side in the subcooling heat exchanger 47. Thus, the refrigerant flowing through the main-circuit side is further cooled and the refrigerant flowing through the subcooling circuit 46 is evaporated.

Note that, in the air conditioning apparatus 1b according to the third embodiment including a plurality of indoor units each having an indoor expansion valve, the inner capacity (the volume of a fluid with which the inside can be filled) of the outdoor heat exchanger 23 included in the outdoor unit 20 is preferably 5.0 L or more and 38 L or less. In particular, when the outdoor unit 20 has a blow-out port facing a lateral side for the air which has passed through the outdoor heat exchanger 23 and is provided with two outdoor fans 25, the inner capacity (the volume of a fluid with which the inside can be filled) of the outdoor heat exchanger 23 is preferably 7.0 L or less. When the outdoor unit 20 blows out the air which has passed through the outdoor heat exchanger 23 upward, the inner capacity is preferably 5.5 L or more.

The air conditioning apparatus 1b according to the third embodiment includes a first indoor unit 30 and a second indoor unit 35 connected in parallel to each other, instead of the indoor unit 30 according to the first embodiment.

The first indoor unit 30 includes a first indoor heat exchanger 31, a first indoor fan 32, and a first indoor-unit control unit 34 like the indoor unit 30 according to the above-described first embodiment; and further a first indoor expansion valve 33 is provided on the liquid-side of the first indoor heat exchanger 31. The valve opening degree of the first indoor expansion valve 33 is controllable.

Similarly to the first indoor unit 30, the second indoor unit 35 includes a second indoor heat exchanger 36, a second indoor fan 37, a second indoor-unit control unit 39, and a second indoor expansion valve 38 provided on the liquid side of the second indoor heat exchanger 36. The valve opening degree of the second indoor expansion valve 38 is controllable.

A controller 7 according to the third embodiment is constituted of an outdoor-unit control unit 27, the first indoor-unit control unit 34, and the second indoor-unit control unit 39 that are communicably connected to one another.

In the cooling operating mode, the outdoor expansion valve 24 is controlled such that the degree of subcooling of the refrigerant passing through the liquid-side outlet of the outdoor heat exchanger 23 satisfies a predetermined condition. Also, in the cooling operating mode, the subcooling expansion valve 48 is controlled such that the degree of superheating of the refrigerant to be sucked by the compressor 21 satisfies a predetermined condition. Note that, in the cooling operating mode, the first indoor expansion valve 33 and the second indoor expansion valve 38 are controlled to be in a fully-opened state.

In the heating operating mode, the first indoor expansion valve 33 is controlled such that the degree of subcooling of the refrigerant passing through the liquid-side outlet of the first indoor heat exchanger 31 satisfies a predetermined condition. The second indoor expansion valve 38 is likewise controlled such that the degree of subcooling of the refrigerant flowing through the liquid-side outlet of the second indoor heat exchanger 36 satisfies a predetermined condition. Also, in the heating operating mode, the outdoor expansion valve 45 is controlled such that the degree of superheating of the refrigerant to be sucked by the compressor 21 satisfies a predetermined condition. Note that, in the heating operating mode, the subcooling expansion valve 48 is controlled such that the degree of superheating of the refrigerant to be sucked by the compressor 21 satisfies a predetermined condition.

In the air conditioning apparatus 1b provided with the above-described plurality of indoor units 30 and 35, the refrigerant circuit 10 is filled with the refrigerant such that the enclosure amount per 1 kW of refrigeration capacity is 190 g or more and 1660 g or less. The air conditioning apparatus 1b provided with the plurality of indoor units 30 and 35 may have a rated cooling capacity of, for example, 4.0 kW or more and 150.0 kW or less, more preferably 14.0 kW or more and 150.0 kW or less, or further preferably 22.4 kW or more and 150.0 kW or less when the outdoor unit 20 is top blowing type.

The air conditioning apparatus 1b provided with the plurality of indoor units according to the third embodiment uses a refrigerant which contains 1,2-difluoroethylene and which is any one of the above-described refrigerants A to E, and the refrigerant enclosure amount is set such that the enclosure amount per 1 kW of refrigeration capacity is 190 g or more and 1660 g or less.

Accordingly, also in the air conditioning apparatus 1b provided with the plurality of indoor units, since a refrigerant having a GWP sufficiently smaller than R32 is used and the enclosure amount per 1 kW of refrigeration capacity is not more than 1660 g, the LCCP can be kept low. Moreover, also in the air conditioning apparatus 1b provided with the plurality of indoor units, even when a refrigerant having a heat-transfer capacity lower than R32 is used, since the enclosure amount per 1 kW of refrigeration capacity is 190 g or more, a decrease in cycle efficiency due to an insufficiency of the refrigerant is suppressed, thereby suppressing an increase in the LCCP. As described above, also in the air conditioning apparatus 1b provided with the plurality of indoor units, when a heat cycle is performed using a refrigerant having a sufficiently small GWP, the LCCP can be kept low.

### (9) Fourth Embodiment

Regarding the enclosure refrigerant amount when a refrigerant which contains 1,2-difluoroethylene and which is one of the above-described refrigerants A to E is enclosed in the refrigerant circuit, for a refrigeration cycle apparatus provided with only one indoor unit 30 like the air conditioning apparatus 1 according to the first embodiment and the air conditioning apparatus 1a according to the second embodiment, the enclosure amount per 1 kW of refrigeration capacity is set to 160 g or more and 560 g or less; and for a refrigeration cycle apparatus provided with a plurality of indoor units 30 and 35 like the air conditioning apparatus 1b according to the third embodiment, the enclosure amount per 1 kW of refrigeration capacity is set to 190 g or more and 1660 g or less.

Accordingly, the GWP and the LCCP can be kept low in accordance with the type of the refrigeration cycle apparatus.

The embodiments of the present disclosure have been described above, and it is understood that the embodiments and details can be modified in various ways without departing from the idea and scope of the present disclosure described in the claims.

### REFERENCE SIGNS LIST

1, 1a, and 1b air conditioning apparatus (refrigeration cycle apparatus)
5 gas-side connection pipe (refrigerant pipe)
6 liquid-side connection pipe (refrigerant pipe)
10 refrigerant circuit
20 outdoor unit (heat source unit)
21 compressor
23 outdoor heat exchanger (heat-source-side heat exchanger)
30 indoor unit, first indoor unit (service unit, first service unit)
31 indoor heat exchanger, first indoor heat exchanger (first service-side heat exchanger)
35 second indoor unit (second service unit)
36 second indoor heat exchanger (second service-side heat exchanger)

### CITATION LIST

### Patent Literature

PTL 1: International Publication No. 2015/141678

1. A refrigeration cycle apparatus comprising:
a heat source unit including a compressor and a heat-source-side heat exchanger;
a service unit including a service-side heat exchanger; and
a refrigerant pipe that connects the heat source unit and the service unit to each other,
wherein a refrigerant containing at least 1,2-difluoroethylene is enclosed in a refrigerant circuit that is constituted by connecting the compressor, the heat-source-side heat exchanger, and the service-side heat exchanger to one another, and
wherein an enclosure amount of the refrigerant in the refrigerant circuit per 1 kW of refrigeration capacity satisfies a condition of 160 g or more and 560 g or less.

2. A refrigeration cycle apparatus comprising:
a heat source unit including a compressor and a heat-source-side heat exchanger;
a first service unit including a first service-side heat exchanger;
a second service unit including a second service-side heat exchanger; and
a refrigerant pipe that connects the heat source unit, the first service unit, and the second service unit to one another,
wherein a refrigerant containing at least 1,2-difluoroethylene is enclosed in a refrigerant circuit that is constituted by connecting the first service-side heat exchanger and the second service-side heat exchanger in parallel to the compressor and the heat-source-side heat exchanger, and
wherein an enclosure amount of the refrigerant in the refrigerant circuit per 1 kW of refrigeration capacity satisfies a condition of 190 g or more and 1660 g or less.

3. The refrigeration cycle apparatus according to claim 1,
wherein
the refrigerant comprises trans-1,2-difluoroethylene (HFO-1132(E)), trifluoroethylene (HFO-1123), and 2,3,3,3-tetrafluoro-1-propene (R1234yf).

4. The refrigeration cycle apparatus according to claim 3,
wherein
when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments AA′, A′B, BD, DC′, C′C, CO, and OA that connect the following 7 points:
point A (68.6, 0.0, 31.4),
point A′ (30.6, 30.0, 39.4),
point B (0.0, 58.7, 41.3),
point D (0.0, 80.4, 19.6),
point C′ (19.5, 70.5, 10.0),
point C (32.9, 67.1, 0.0), and
point O (100.0, 0.0, 0.0),
or on the above line segments (excluding the points on the line segments BD, CO, and OA);
the line segment AA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment DC′ is represented by coordinates (x, 0.0082x²−0.6671x+80.4, −0.0082x²−0.3329x+19.6),
the line segment C′C is represented by coordinates (x, 0.0067x²−0.6034x+79.729, −0.0067x²−0.3966x+20.271), and
the line segments BD, CO, and OA are straight lines.

5. The refrigeration cycle apparatus according to claim 3,
wherein
when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments GI, IA, AA′, A′B, BD, DC′, C′C, and CG that connect the following 8 points:
point G (72.0, 28.0, 0.0),
point I (72.0, 0.0, 28.0),
point A (68.6, 0.0, 31.4),
point A′ (30.6, 30.0, 39.4),
point B (0.0, 58.7, 41.3),
point D (0.0, 80.4, 19.6),
point C′ (19.5, 70.5, 10.0), and
point C (32.9, 67.1, 0.0),
or on the above line segments (excluding the points on the line segments IA, BD, and CG);
the line segment AA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment DC′ is represented by coordinates (x, 0.0082x²−0.6671x+80.4, −0.0082x²−0.3329x+19.6),
the line segment C′C is represented by coordinates (x, 0.0067x²−0.6034x+79.729, −0.0067x²−0.3966x+20.271), and
the line segments GI, IA, BD, and CG are straight lines.

6. The refrigeration cycle apparatus according to claim 3,
wherein
when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments JP, PN, NK, KA′, A′B, BD, DC′, C′C, and CJ that connect the following 9 points:
point J (47.1, 52.9, 0.0),
point P (55.8, 42.0, 2.2),
point N (68.6, 16.3, 15.1),
point K (61.3, 5.4, 33.3),
point A′ (30.6, 30.0, 39.4),
point B (0.0, 58.7, 41.3),
point D (0.0, 80.4, 19.6),
point C′ (19.5, 70.5, 10.0), and
point C (32.9, 67.1, 0.0),
or on the above line segments (excluding the points on the line segments BD and CJ);
the line segment PN is represented by coordinates (x, −0.1135x²+12.112x−280.43, 0.1135x²−13.112x+380.43),
the line segment NK is represented by coordinates (x, 0.2421x²−29.955x+931.91, −0.2421x²+28.955x−831.91),
the line segment KA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment DC′ is represented by coordinates (x, 0.0082x²−0.6671x+80.4, −0.0082x²−0.3329x+19.6),
the line segment C′C is represented by coordinates (x, 0.0067x²−0.6034x+79.729, −0.0067x²−0.3966x+20.271), and
the line segments JP, BD, and CG are straight lines.

7. The refrigeration cycle apparatus according to claim 3,
wherein
when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments JP, PL, LM, MA′, A′B, BD, DC′, C′C, and CJ that connect the following 9 points:
point J (47.1, 52.9, 0.0),
point P (55.8, 42.0, 2.2),
point L (63.1, 31.9, 5.0),
point M (60.3, 6.2, 33.5),
point A′ (30.6, 30.0, 39.4),
point B (0.0, 58.7, 41.3),
point D (0.0, 80.4, 19.6),
point C′ (19.5, 70.5, 10.0), and
point C (32.9, 67.1, 0.0),
or on the above line segments (excluding the points on the line segments BD and CJ);
the line segment PL is represented by coordinates (x, −0.1135x²+12.112x−280.43, 0.1135x²−13.112x+380.43) the line segment MA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment DC′ is represented by coordinates (x, 0.0082x²−0.6671x+80.4, −0.0082x²−0.3329x+19.6),
the line segment C′C is represented by coordinates (x, 0.0067x²−0.6034x+79.729, −0.0067x²−0.3966x+20.271), and
the line segments JP, LM, BD, and CG are straight lines.

8. The refrigeration cycle apparatus according to claim 3,
wherein
when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments PL, LM, MA′, A′B, BF, FT, and TP that connect the following 7 points:
point P (55.8, 42.0, 2.2),
point L (63.1, 31.9, 5.0),
point M (60.3, 6.2, 33.5),
point A′ (30.6, 30.0, 39.4),
point B (0.0, 58.7, 41.3),
point F (0.0, 61.8, 38.2), and
point T (35.8, 44.9, 19.3),
or on the above line segments (excluding the points on the line segment BF);
the line segment PL is represented by coordinates (x, −0.1135x²+12.112x−280.43, 0.1135x²−13.112x+380.43),
the line segment MA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment FT is represented by coordinates (x, 0.0078x²−0.7501x+61.8, −0.0078x²−0.2499x+38.2),
the line segment TP is represented by coordinates (x, 0.00672x²−0.7607x+63.525, −0.00672x²−0.2393x+36.475), and
the line segments LM and BF are straight lines.

9. The refrigeration cycle apparatus according to claim 3,
wherein
when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments PL, LQ, QR, and RP that connect the following 4 points:
point P (55.8, 42.0, 2.2),
point L (63.1, 31.9, 5.0),
point Q (62.8, 29.6, 7.6), and
point R (49.8, 42.3, 7.9),
or on the above line segments;
the line segment PL is represented by coordinates (x, −0.1135x²+12.112x−280.43, 0.1135x²−13.112x+380.43),
the line segment RP is represented by coordinates (x, 0.00672x²−0.7607x+63.525, −0.00672x²−0.2393x+36.475), and
the line segments LQ and QR are straight lines.

10. The refrigeration cycle apparatus according to claim 3,
wherein
when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments SM, MA′, A′B, BF, FT, and TS that connect the following 6 points:
point S (62.6, 28.3, 9.1),
point M (60.3, 6.2, 33.5),
point A′ (30.6, 30.0, 39.4),
point B (0.0, 58.7, 41.3),
point F (0.0, 61.8, 38.2), and
point T (35.8, 44.9, 19.3),
or on the above line segments,
the line segment MA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment FT is represented by coordinates (x, 0.0078x²−0.7501x+61.8, −0.0078x²−0.2499x+38.2),
the line segment TS is represented by coordinates (x, −0.0017x²−0.7869x+70.888, −0.0017x²−0.2131x+29.112), and
the line segments SM and BF are straight lines.

11. The refrigeration cycle apparatus according to claim 1,
wherein
the refrigerant comprises trans-1,2-difluoroethylene (HFO-1132(E)) and trifluoroethylene (HFO-1123) in a total amount of 99.5 mass % or more based on the entire refrigerant, and
the refrigerant comprises 62.0 mass % to 72.0 mass % of HFO-1132(E) based on the entire refrigerant.

12. The refrigeration cycle apparatus according to claim 1,
wherein
the refrigerant comprises trans-1,2-difluoroethylene (HFO-1132(E)), and trifluoroethylene (HFO-1123) in a total amount of 99.5 mass % or more based on the entire refrigerant, and
the refrigerant comprises 45.1 mass % to 47.1 mass % of HFO-1132(E) based on the entire refrigerant.

13. The refrigeration cycle apparatus according to claim 1,
wherein
the refrigerant comprises trans-1,2-difluoroethylene (HFO-1132(E)), trifluoroethylene (HFO-1123), 2,3,3,3-tetrafluoro-1-propene (R1234yf), and difluoromethane (R32),
wherein
when the mass % of HFO-1132(E), HFO-1123, R1234yf, and R32 based on their sum in the refrigerant is respectively represented by x, y, z, and a,
if 0<a≤11.1, coordinates (x,y,z) in a ternary composition diagram in which the sum of HFO-1132(E), HFO-1123, and R1234yf is (100−a) mass % are within the range of a figure surrounded by straight lines GI, IA, AB, BD′, D′C, and CG that connect the following 6 points:
point G (0.026a²−1.7478a+72.0, −0.026a²+0.7478a+28.0, 0.0),
point I (0.026a²−1.7478a+72.0, 0.0, −0.026a²+0.7478a+28.0),
point A (0.0134a²−1.9681a+68.6, 0.0, −0.0134a²+0.9681a+31.4),
point B (0.0, 0.0144a²−1.6377a+58.7, −0.0144a²+0.6377a+41.3),
point D′ (0.0, 0.0224a²+0.968a+75.4, −0.0224a²−1.968a+24.6), and
point C (−0.2304a²−0.4062a+32.9, 0.2304a²−0.5938a+67.1, 0.0),
or on the straight lines GI, AB, and D′C (excluding point G, point I, point A, point B, point D′, and point C);
if 11.1<a≤18.2, coordinates (x,y,z) in the ternary composition diagram are within the range of a figure surrounded by straight lines GI, IA, AB, BW, and WG that connect the following 5 points:
point G (0.02a²−1.6013a+71.105, −0.02a²+0.6013a+28.895, 0.0),
point I (0.02a²−1.6013a+71.105, 0.0, −0.02a²+0.6013a+28.895),
point A (0.0112a²−1.9337a+68.484, 0.0, −0.0112a²+0.9337a+31.516),
point B (0.0, 0.0075a²−1.5156a+58.199, −0.0075a²+0.5156a+41.801), and
point W (0.0, 100.0−a, 0.0),
or on the straight lines GI and AB (excluding point G, point I, point A, point B, and point W);
if 18.2<a≤26.7, coordinates (x,y,z) in the ternary composition diagram are within the range of a figure surrounded by straight lines GI, IA, AB, BW, and WG that connect the following 5 points:
point G (0.0135a²−1.4068a+69.727, −0.0135a²+0.4068a+30.273, 0.0),
point I (0.0135a²−1.4068a+69.727, 0.0, −0.0135a²+0.4068a+30.273),
point A (0.0107a²−1.9142a+68.305, 0.0, −0.0107a²+0.9142a+31.695),
point B (0.0, 0.009a²−1.6045a+59.318, −0.009a²+0.6045a+40.682), and
point W (0.0, 100.0−a, 0.0),
or on the straight lines GI and AB (excluding point G, point I, point A, point B, and point W);
if 26.7<a≤36.7, coordinates (x,y,z) in the ternary composition diagram are within the range of a figure surrounded by straight lines GI, IA, AB, BW, and WG that connect the following 5 points:
point G (0.0111a²−1.3152a+68.986, −0.0111a²+0.3152a+31.014, 0.0),
point I (0.0111a²−1.3152a+68.986, 0.0, −0.0111a²+0.3152a+31.014),
point A (0.0103a²−1.9225a+68.793, 0.0, −0.0103a²+0.9225a+31.207),
point B (0.0, 0.0046a²−1.41a+57.286, −0.0046a²+0.41a+42.714), and
point W (0.0, 100.0−a, 0.0),
or on the straight lines GI and AB (excluding point G, point I, point A, point B, and point W); and
if 36.7<a≤46.7, coordinates (x,y,z) in the ternary composition diagram are within the range of a figure surrounded by straight lines GI, IA, AB, BW, and WG that connect the following 5 points:
point G (0.0061a²−0.9918a+63.902, −0.0061a²−0.0082a+36.098, 0.0),
point I (0.0061a²−0.9918a+63.902, 0.0, −0.0061a²−0.0082a+36.098),
point A (0.0085a²−1.8102a+67.1, 0.0, −0.0085a²+0.8102a+32.9),
point B (0.0, 0.0012a²−1.1659a+52.95, −0.0012a²+0.1659a+47.05), and
point W (0.0, 100.0−a, 0.0),
or on the straight lines GI and AB (excluding point G, point I, point A, point B, and point W).

14. The refrigeration cycle apparatus according to claim 1,
wherein
the refrigerant comprises trans-1,2-difluoroethylene (HFO-1132(E)), trifluoroethylene (HFO-1123), 2,3,3,3-tetrafluoro-1-propene (R1234yf), and difluoromethane (R32),
wherein
when the mass % of HFO-1132(E), HFO-1123, R1234yf, and R32 based on their sum in the refrigerant is respectively represented by x, y, z, and a,
if 0<a≤11.1, coordinates (x,y,z) in a ternary composition diagram in which the sum of HFO-1132(E), HFO-1123, and R1234yf is (100−a) mass % are within the range of a figure surrounded by straight lines JK′, K′B, BD′, D′C, and CJ that connect the following 5 points:
point J (0.0049a²−0.9645a+47.1, −0.0049a²−0.0355a+52.9, 0.0),
point K′ (0.0514a²−2.4353a+61.7, −0.0323a²+0.4122a+5.9, −0.0191a²+1.0231a+32.4),
point B (0.0, 0.0144a²−1.6377a+58.7, −0.0144a²+0.6377a+41.3),
point D′ (0.0, 0.0224a²+0.968a+75.4, −0.0224a²−1.968a+24.6), and
point C (−0.2304a²−0.4062a+32.9, 0.2304a²−0.5938a+67.1, 0.0),
or on the straight lines JK′, K′B, and D′C (excluding point J, point B, point D′, and point C);
if 11.1<a≤18.2, coordinates (x,y,z) in the ternary composition diagram are within the range of a figure surrounded by straight lines JK′, K′B, BW, and WJ that connect the following 4 points:
point J (0.0243a²−1.4161a+49.725, −0.0243a²+0.4161a+50.275, 0.0),
point K′ (0.0341a²−2.1977a+61.187, −0.0236a²+0.34a+5.636,−0.0105a²+0.8577a+33.177),
point B (0.0, 0.0075a²−1.5156a+58.199, −0.0075a²+0.5156a+41.801), and
point W (0.0, 100.0−a, 0.0),
or on the straight lines JK′ and K′B (excluding point J, point B, and point W);
if 18.2<a≤26.7, coordinates (x,y,z) in the ternary composition diagram are within the range of a figure surrounded by straight lines JK′, K′B, BW, and WJ that connect the following 4 points:
point J (0.0246a²−1.4476a+50.184, −0.0246a²+0.4476a+49.816, 0.0),
point K′ (0.0196a²−1.7863a+58.515, −0.0079a²−0.1136a+8.702, −0.0117a²+0.8999a+32.783),
point B (0.0, 0.009a²−1.6045a+59.318, −0.009a²+0.6045a+40.682), and
point W (0.0, 100.0−a, 0.0),
or on the straight lines JK′ and K′B (excluding point J, point B, and point W);
if 26.7<a≤36.7, coordinates (x,y,z) in the ternary composition diagram are within the range of a figure surrounded by straight lines JK′, K′A, AB, BW, and WJ that connect the following 5 points:
point J (0.0183a²−1.1399a+46.493, −0.0183a²+0.1399a+53.507, 0.0),
point K′ (−0.0051a²+0.0929a+25.95, 0.0, 0.0051a²−1.0929a+74.05),
point A (0.0103a²−1.9225a+68.793, 0.0, −0.0103a²+0.9225a+31.207),
point B (0.0, 0.0046a²−1.41a+57.286, −0.0046a²+0.41a+42.714), and
point W (0.0, 100.0−a, 0.0),
or on the straight lines JK′, K′A, and AB (excluding point J, point B, and point W); and
if 36.7<a≤46.7, coordinates (x,y,z) in the ternary composition diagram are within the range of a figure surrounded by straight lines JK′, K′A, AB, BW, and WJ that connect the following 5 points:
point J (−0.0134a²+1.0956a+7.13, 0.0134a²−2.0956a+92.87, 0.0),
point K′ (−1.892a+29.443, 0.0, 0.892a+70.557),
point A (0.0085a²−1.8102a+67.1, 0.0, −0.0085a²+0.8102a+32.9),
point B (0.0, 0.0012a²−1.1659a+52.95, −0.0012a²+0.1659a+47.05), and
point W (0.0, 100.0−a, 0.0),
or on the straight lines JK′, K′A, and AB (excluding point J, point B, and point W).

15. The refrigeration cycle apparatus according to claim 1,
wherein
the refrigerant comprises trans-1,2-difluoroethylene (HFO-1132(E)), difluoromethane (R32), and 2,3,3,3-tetrafluoro-1-propene (R1234yf), wherein
when the mass % of HFO-1132(E), R32, and R1234yf based on their sum in the refrigerant is respectively represented by x, y, and z, coordinates (x,y,z) in a ternary composition diagram in which the sum of HFO-1132(E), R32, and R1234yf is 100 mass % are within the range of a figure surrounded by line segments IJ, JN, NE, and EI that connect the following 4 points:
point I (72.0, 0.0, 28.0),
point J (48.5, 18.3, 33.2),
point N (27.7, 18.2, 54.1), and
point E (58.3, 0.0, 41.7),
or on these line segments (excluding the points on the line segment EI;
the line segment IJ is represented by coordinates (0.0236y²−1.7616y+72.0, y, −0.0236y²+0.7616y+28.0);
the line segment NE is represented by coordinates (0.012y²−1.9003y+58.3, y, −0.012y²+0.9003y+41.7); and
the line segments JN and EI are straight lines.

16. The refrigeration cycle apparatus according to claim 1,
wherein
the refrigerant comprises trans-1,2-difluoroethylene (HFO-1132(E)), difluoromethane (R32), and 2,3,3,3-tetrafluoro-1-propene (R1234yf),
wherein
when the mass % of HFO-1132(E), R32, and R1234yf based on their sum in the refrigerant is respectively represented by x, y, and z, coordinates (x,y,z) in a ternary composition diagram in which the sum of HFO-1132(E), R32, and R1234yf is 100 mass % are within the range of a figure surrounded by line segments MM′, M′N, NV, VG, and GM that connect the following 5 points:
point M (52.6, 0.0, 47.4),
point M′(39.2, 5.0, 55.8),
point N (27.7, 18.2, 54.1),
point V (11.0, 18.1, 70.9), and
point G (39.6, 0.0, 60.4),
or on these line segments (excluding the points on the line segment GM);
the line segment MM′ is represented by coordinates (0.132y²−3.34y+52.6, y, −0.132y²+2.34y+47.4);
the line segment M′N is represented by coordinates (0.0596y²−2.2541y+48.98, y, −0.0596y²+1.2541y+51.02);
the line segment VG is represented by coordinates (0.0123y²−1.8033y+39.6, y, −0.0123y²+0.8033y+60.4); and
the line segments NV and GM are straight lines.

17. The refrigeration cycle apparatus according to claim 1,
wherein
the refrigerant comprises trans-1,2-difluoroethylene (HFO-1132(E)), difluoromethane (R32), and 2,3,3,3-tetrafluoro-1-propene (R1234yf),
wherein
when the mass % of HFO-1132(E), R32, and R1234yf based on their sum in the refrigerant is respectively represented by x, y and z, coordinates (x,y,z) in a ternary composition diagram in which the sum of HFO-1132(E), R32, and R1234yf is 100 mass % are within the range of a figure surrounded by line segments ON, NU, and UO that connect the following 3 points:
point O (22.6, 36.8, 40.6),
point N (27.7, 18.2, 54.1), and
point U (3.9, 36.7, 59.4),
or on these line segments;
the line segment ON is represented by coordinates (0.0072y²−0.6701y+37.512, y, −0.0072y²−0.3299y+62.488);
the line segment NU is represented by coordinates (0.0083y²−1.7403y+56.635, y, −0.0083y²+0.7403y+43.365); and
the line segment UO is a straight line.

18. The refrigeration cycle apparatus according to claim 1,
wherein
the refrigerant comprises trans-1,2-difluoroethylene (HFO-1132(E)), difluoromethane (R32), and 2,3,3,3-tetrafluoro-1-propene (R1234yf),
wherein
when the mass % of HFO-1132(E), R32, and R1234yf based on their sum in the refrigerant is respectively represented by x, y, and z, coordinates (x,y,z) in a ternary composition diagram in which the sum of HFO-1132(E), R32, and R1234yf is 100 mass % are within the range of a figure surrounded by line segments QR, RT, TL, LK, and KQ that connect the following 5 points:
point Q (44.6, 23.0, 32.4),
point R (25.5, 36.8, 37.7),
point T (8.6, 51.6, 39.8),
point L (28.9, 51.7, 19.4), and
point K (35.6, 36.8, 27.6),
or on these line segments;
the line segment QR is represented by coordinates (0.0099y²−1.975y+84.765, y, −0.0099y²+0.975y+15.235);
the line segment RT is represented by coordinates (0.0082y²−1.8683y+83.126, y, −0.0082y²+0.8683y+16.874);
the line segment LK is represented by coordinates (0.0049y²−0.8842y+61.488, y, −0.0049y²−0.1158y+38.512);
the line segment KQ is represented by coordinates (0.0095y²−1.2222y+67.676, y, −0.0095y²+0.2222y+32.324); and
the line segment TL is a straight line.

19. The refrigeration cycle apparatus according to claim 1,
wherein
the refrigerant comprises trans-1,2-difluoroethylene (HFO-1132(E)), difluoromethane (R32), and 2,3,3,3-tetrafluoro-1-propene (R1234yf),
wherein
when the mass % of HFO-1132(E), R32, and R1234yf based on their sum in the refrigerant is respectively represented by x, y, and z, coordinates (x,y,z) in a ternary composition diagram in which the sum of HFO-1132(E), R32, and R1234yf is 100 mass % are within the range of a figure surrounded by line segments PS, ST, and TP that connect the following 3 points:
point P (20.5, 51.7, 27.8),
point S (21.9, 39.7, 38.4), and
point T (8.6, 51.6, 39.8),
or on these line segments;
the line segment PS is represented by coordinates (0.0064y²−0.7103y+40.1, y, −0.0064y²−0.2897y+59.9);
the line segment ST is represented by coordinates (0.0082y²−1.8683y+83.126, y, −0.0082y²+0.8683y+16.874); and
the line segment TP is a straight line.

20. The refrigeration cycle apparatus according to claim 1,
wherein
the refrigerant comprises trans-1,2-difluoroethylene (HFO-1132(E)), trifluoroethylene (HFO-1123), and difluoromethane (R32),
wherein
when the mass % of HFO-1132(E), HFO-1123, and R32 based on their sum in the refrigerant is respectively represented by x, y, and z, coordinates (x,y,z) in a ternary composition diagram in which the sum of HFO-1132(E), HFO-1123, and R32 is 100 mass % are within the range of a figure surrounded by line segments IK, KB′, B′H, HR, RG, and GI that connect the following 6 points:
point I (72.0, 28.0, 0.0),
point K (48.4, 33.2, 18.4),
point B′ (0.0, 81.6, 18.4),
point H (0.0, 84.2, 15.8),
point R (23.1, 67.4, 9.5), and
point G (38.5, 61.5, 0.0),
or on these line segments (excluding the points on the line segments B′H and GI);
the line segment IK is represented by coordinates (0.025z²−1.7429z+72.00, −0.025z²+0.7429z+28.0, z),
the line segment HR is represented by coordinates (−0.3123z²+4.234z+11.06, 0.3123z²−5.234z+88.94, z),
the line segment RG is represented by coordinates (−0.0491z²−1.1544z+38.5, 0.0491z²+0.1544z+61.5, z), and
the line segments KB′ and GI are straight lines.

21. The refrigeration cycle apparatus according to claim 1,
wherein
the refrigerant comprises trans-1,2-difluoroethylene (HFO-1132(E)), trifluoroethylene (HFO-1123), and difluoromethane (R32), wherein
when the mass % of HFO-1132(E), HFO-1123, and R32 based on their sum in the refrigerant is respectively represented by x, y, and z, coordinates (x,y,z) in a ternary composition diagram in which the sum of HFO-1132(E), HFO-1123, and R32 is 100 mass % are within the range of a figure surrounded by line segments IJ, JR, RG, and GI that connect the following 4 points:
point I (72.0, 28.0, 0.0),
point J (57.7, 32.8, 9.5),
point R (23.1, 67.4, 9.5), and
point G (38.5, 61.5, 0.0),
or on these line segments (excluding the points on the line segment GI);
the line segment IJ is represented by coordinates (0.025z²−1.7429z+72.0, −0.025z²+0.7429z+28.0, z),
the line segment RG is represented by coordinates (−0.0491z²−1.1544z+38.5, 0.0491z²+0.1544z+61.5, z), and
the line segments JR and GI are straight lines.

22. The refrigeration cycle apparatus according to claim 1,
wherein
the refrigerant comprises HFO 1132(E), HFO 1123, and R32 trans-1,2-difluoroethylene (HFO-1132(E)), trifluoroethylene (HFO-1123), and difluoromethane (R32), wherein
when the mass % of HFO-1132(E), HFO-1123, and R32 based on their sum in the refrigerant is respectively represented by x, y, and z, coordinates (x,y,z) in a ternary composition diagram in which the sum of HFO-1132(E), HFO-1123, and R32 is 100 mass % are within the range of a figure surrounded by line segments MP, PB′, B′H, HR, RG, and GM that connect the following 6 points:
point M (47.1, 52.9, 0.0),
point P (31.8, 49.8, 18.4),
point B′ (0.0, 81.6, 18.4),
point H (0.0, 84.2, 15.8),
point R (23.1, 67.4, 9.5), and
point G (38.5, 61.5, 0.0),
or on these line segments (excluding the points on the line segments B′H and GM);
the line segment MP is represented by coordinates (0.0083z²−0.984z+47.1, −0.0083z²−0.016z+52.9, z),
the line segment HR is represented by coordinates (−0.3123z²+4.234z+11.06, 0.3123z²−5.234z+88.94, z),
the line segment RG is represented by coordinates (−0.0491z²−1.1544z+38.5, 0.0491z²+0.1544z+61.5, z), and
the line segments PB′ and GM are straight lines.

23. The refrigeration cycle apparatus according to claim 1,
wherein
the refrigerant comprises trans-1,2-difluoroethylene (HFO-1132(E)), trifluoroethylene (HFO-1123), and difluoromethane (R32), wherein
when the mass % of HFO-1132(E), HFO-1123, and R32 based on their sum in the refrigerant is respectively represented by x, y, and z, coordinates (x,y,z) in a ternary composition diagram in which the sum of HFO-1132(E), HFO-1123, and R32 is 100 mass % are within the range of a figure surrounded by line segments MN, NR, RG, and GM that connect the following 4 points:
point M (47.1, 52.9, 0.0),
point N (38.5, 52.1, 9.5),
point R (23.1, 67.4, 9.5), and
point G (38.5, 61.5, 0.0),
or on these line segments (excluding the points on the line segment GM);
the line segment MN is represented by coordinates (0.0083z²−0.984z+47.1, −0.0083z²−0.016z+52.9, z),
the line segment RG is represented by coordinates (−0.0491z²−1.1544z+38.5, 0.0491z²+0.1544z+61.5, z), and
the line segments JR and GI are straight lines.

24. The refrigeration cycle apparatus according to claim 1,
wherein
the refrigerant comprises trans-1,2-difluoroethylene (HFO-1132(E)), trifluoroethylene (HFO-1123), and difluoromethane (R32), wherein
when the mass % of HFO-1132(E), HFO-1123, and R32 based on their sum in the refrigerant is respectively represented by x, y, and z, coordinates (x,y,z) in a ternary composition diagram in which the sum of HFO-1132(E), HFO-1123, and R32 is 100 mass % are within the range of a figure surrounded by line segments PS, ST, and TP that connect the following 3 points:
point P (31.8, 49.8, 18.4),
point S (25.4, 56.2, 18.4), and
point T (34.8, 51.0, 14.2),
or on these line segments;
the line segment ST is represented by coordinates (−0.0982z²+0.9622z+40.931, 0.0982z²−1.9622z+59.069, z),
the line segment TP is represented by coordinates (0.0083z²−0.984z+47.1, −0.0083z²−0.016z+52.9, z), and
the line segment PS is a straight line.

25. The refrigeration cycle apparatus according to claim 1,
wherein
the refrigerant comprises trans-1,2-difluoroethylene (HFO-1132(E)), trifluoroethylene (HFO-1123), and difluoromethane (R32), wherein
when the mass % of HFO-1132(E), HFO-1123, and R32 based on their sum in the refrigerant is respectively represented by x, y, and z, coordinates (x,y,z) in a ternary composition diagram in which the sum of HFO-1132(E), HFO-1123, and R32 is 100 mass % are within the range of a figure surrounded by line segments QB″, B″D, DU, and UQ that connect the following 4 points:
point Q (28.6, 34.4, 37.0),
point B″ (0.0, 63.0, 37.0),
point D (0.0, 67.0, 33.0), and
point U (28.7, 41.2, 30.1),
or on these line segments (excluding the points on the line segment B″D);
the line segment DU is represented by coordinates (−3.4962z²+210.71z−3146.1, 3.4962z²−211.71z+3246.1, z),
the line segment UQ is represented by coordinates (0.0135z²−0.9181z+44.133, −0.0135z²−0.0819z+55.867, z), and
the line segments QB″ and B″D are straight lines.

26. A method of determining a refrigerant enclosure amount in a refrigeration cycle apparatus, comprising:
for a refrigeration cycle apparatus including a heat source unit including a compressor and a heat-source-side heat exchanger, a service unit including a service-side heat exchanger, and a refrigerant pipe that connects the heat source unit and the service unit to each other, and for a refrigerant containing at least 1,2-difluoroethylene being enclosed in a refrigerant circuit that is constituted by connecting the compressor, the heat-source-side heat exchanger, and the service-side heat exchanger to one another, setting an enclosure amount of the refrigerant in the refrigerant circuit per 1 kW of refrigeration capacity to 160 g or more and 560 g or less; and
for a refrigeration cycle apparatus including a heat source unit including a compressor and a heat-source-side heat exchanger, a first service unit including a first service-side heat exchanger, a second service unit including a second service-side heat exchanger, and a refrigerant pipe that connects the heat source unit, the first service unit, and the second service unit to one another, and for a refrigerant containing at least 1,2-difluoroethylene being enclosed in a refrigerant circuit that is constituted by connecting the first service-side heat exchanger and the second service-side heat exchanger in parallel to the compressor and the heat-source-side heat exchanger, setting an enclosure amount of the refrigerant in the refrigerant circuit per 1 kW of refrigeration capacity to 190 g or more and 1660 g or less.
